SEQUENCE LISTING (14 sequences)

SEQ ID NO: 1 - DNA, 1785 bp, Unknown
  CDC14Aiso1 coding sequence
atggcagcggagtcaggggaactaatcggggcttgtgagttcatgaaagatcggttatattttgctactttaaggaatagaccaaaaagcacagtaaatacccactatttctccatcgatgaggagctggtctatgaaaatttctatgcagattttggaccgctgaacttggcaatggtgtacagatattgctgcaaactaaacaagaaactaaaatcatacagtttgtcaagaaagaaaatagtgcactacacctgttttgaccaacggaaaagagcaaatgcagcatttttgataggtgcctatgcagtaatctatttaaagaagacaccagaagaagcctacagagcactcctgtctggctcaaaccccccctatcttccattcagggatgcttcctttggaaattgcacttacaatctcaccattctcgactgtttgcagggaatcagaaagggattacaacatggattttttgactttgagacatttgatgtggatgaatatgaacattatgagcgagttgaaaatggtgacttcaactggattgttccaggaaaatttttagcatttagtggaccacatcctaaaagcaaaattgagaatggttatcctcttcacgcccctgaagcctactttccttatttcaaaaagcataatgtgactgcagttgtgaggctaaacaaaaagatttatgaggcaaagcgcttcacagacgctggcttcgagcactatgacctcttcttcatagatggcagcacacccagtgacaacatcgtgcgaaggttcctgaacatctgtgagaacaccgaaggggccatcgccgttcactgcaaagctggtcttggaagaacagggacattgatagcctgttatgtaatgaaacactacaggtttacacatgctgaaataattgcttggattagaatatgccggccaggctctattataggaccccagcagcacttcctggaagaaaaacaagcatcgttgtgggtccaaggagacattttccgatccaaactgaaaaatcgaccatccagtgaaggaagtattaataaaattctttctggcctagatgatatgtctattggtggaaatctttcaaaaacacaaaacatggaacgatttggagaggataacttagaagatgatgatgtggaaatgaaaaatggtataacccagggagacaaactacgtgccttaaaaagtcagagacagccacgtacctcaccatcctgtgcatttaggtcagatgatacaaaaggacatccaagagcagtgtcccagcctttcagattaagttcatccctgcaaggatctgcagttactttgaagacatcaaaaatggcactgtccccttcagcaacggccaagaggatcaacagaacttctttgtcttcgggtgccactgtaagaagcttttccataaactcccggctagccagttctctagggaacttgaatgctgcaacagatgatccagagaacaaaaagacctcctcatcctctaaggcaggcttcacagccagcccgtttaccaacctcttgaatggcagctcccagccaactaccagaaattaccctgagctcaacaataatcagtacaacagaagcagcaacagcaacgggggcaacctgaacagccccccaggcccccacagcgccaagacagaggagcacaccaccatcctccgaccctcctacaccgggctttcttcttcttcagcgagattcctgagccgttctatcccttcccttcagtctgaatatgttcattactaa

SEQ ID NO: 2 - protein, 594 aa, Unknown
  CDC14Aisol translated sequence
MAAESGELIGACEFMKDRLYFATLRNRPKSTVNTHYFSIDEELVYENFYADFGPLNLAMVYRYCCKLNKKLKSYSLSRKKIVHYTCFDQRKRANAAFLIGAYAVIYLKKTPEEAYRALLSGSNPPYLPFRDASFGNCTYNLTILDCLQGIRKGLQHGFFDFETFDVDEYEHYERVENGDFNWIVPGKFLAFSGPHPKSKIENGYPLHAPEAYFPYFKKHNVTAVVRLNKKIYEAKRFTDAGFEHYDLFFIDGSTPSDNIVRRFLNICENTEGAIAVHCKAGLGRTGTLIACYVMKHYRFTHAEIIAWIRICRPGSIIGPQQHFLEEKQASLWVQGDIFRSKLKNRPSSEGSINKILSGLDDMSIGGNLSKTQNMERFGEDNLEDDDVEMKNGITQGDKLRALKSQRQPRTSPSCAFRSDDTKGHPRAVSQPFRLSSSLQGSAVTLKTSKMALSPSATAKRINRTSLSSGATVRSFSINSRLASSLGNLNAATDDPENKKTSSSSKAGFTASPFTNLLNGSSQPTTRNYPELNNNQYNRSSNSNGGNLNSPPGPHSAKTEEHTTILRPSYTGLSSSSARFLSRSIPSLQSEYVHY

SEQ ID NO: 3 - DNA, 1872 bp, Unknown
  CDC14Aiso2 coding sequence
atggcagcggagtcaggggaactaatcggggcttgtgagttcatgaaagatcggttatattttgctactttaaggaatagaccaaaaagcacagtaaatacccactatttctccatcgatgaggagctggtctatgaaaatttctatgcagattttggaccgctgaacttggcaatggtgtacagatattgctgcaaactaaacaagaaactaaaatcatacagtttgtcaagaaagaaaatagtgcactacacctgttttgaccaacggaaaagagcaaatgcagcatttttgataggtgcctatgcagtaatctatttaaagaagacaccagaagaagcctacagagcactcctgtctggctcaaaccccccctatcttccattcagggatgcttcctttggaaattgcacttacaatctcaccattctcgactgtttgcagggaatcagaaagggattacaacatggattttttgactttgagacatttgatgtggatgaatatgaacattatgagcgagttgaaaatggtgacttcaactggattgttccaggaaaatttttagcatttagtggaccacatcctaaaagcaaaattgagaatggttatcctcttcacgcccctgaagcctactttccttatttcaaaaagcataatgtgactgcagttgtgaggctaaacaaaaagatttatgaggcaaagcgcttcacagacgctggcttcgagcactatgacctcttcttcatagatggcagcacacccagtgacaacatcgtgcgaaggttcctgaacatctgtgagaacaccgaaggggccatcgccgttcactgcaaagctggtcttggaagaacagggacattgatagcctgttatgtaatgaaacactacaggtttacacatgctgaaataattgcttggattagaatatgccggccaggctctattataggaccccagcagcacttcctggaagaaaaacaagcatcgttgtgggtccaaggagacattttccgatccaaactgaaaaatcgaccatccagtgaaggaagtattaataaaattctttctggcctagatgatatgtctattggtggaaatctttcaaaaacacaaaacatggaacgatttggagaggataacttagaagatgatgatgtggaaatgaaaaatggtataacccagggagacaaactacgtgccttaaaaagtcagagacagccacgtacctcaccatcctgtgcatttaggtcagatgatacaaaaggacatccaagagcagtgtcccagcctttcagattaagttcatccctgcaaggatctgcagttactttgaagacatcaaaaatggcactgtccccttcagcaacggccaagaggatcaacagaacttctttgtcttcgggtgccactgtaagaagcttttccataaactcccggctagccagttctctagggaacttgaatgctgcaacagatgatccagagaacaaaaagacctcctcatcctctaaggcaggcttcacagccagcccgtttaccaacctcttgaatggcagctcccagccaactaccagaaattaccctgagctcaacaataatcagtacaacagaagcagcaacagcaacgggggcaacctgaacagccccccaggcccccacagcgccaagacagaggagcacaccaccatcctccgaccctcctacaccgggctttcttcttcttcagcgagattcctgagccgttctatccctgtaagtgcgcagacaccacctcctggtcctcagaaccctgaatgcaacttctgtgccttgccttcccagccgaggctgccaccaaagaaatttaatagtgccaaggaagccttctga

SEQ ID NO: 4 - protein, 623 aa, Unknown
  CDC14 Aiso2 translated sequence
MAAESGELIGACEFMKDRLYFATLRNRPKSTVNTHYFSIDEELVYENFYADFGPLNLAMVYRYCCKLNKKLKSYSLSRKKIVHYTCFDQRKRANAAFLIGAYAVIYLKKTPEEAYRALLSGSNPPYLPFRDASFGNCTYNLTILDCLQGIRKGLQHGFFDFETFDVDEYEHYERVENGDFNWIVPGKFLAFSGPHPKSKIENGYPLHAPEAYFPYFKKHNVTAVVRLNKKIYEAKRFTDAGFEHYDLFFIDGSTPSDNIVRRFLNICENTEGAIAVHCKAGLGRTGTLIACYVMKHYRFTHAEIIAWIRICRPGSIIGPQQHFLEEKQASLWVQGDIFRSKLKNRPSSEGSINKILSGLDDMSIGGNLSKTQNMERFGEDNLEDDDVEMKNGITQGDKLRALKSQRQPRTSPSCAFRSDDTKGHPRAVSQPFRLSSSLQGSAVTLKTSKMALSPSATAKRINRTSLSSGATVRSFSINSRLASSLGNLNAATDDPENKKTSSSSKAGFTASPFTNLLNGSSQPTTRNYPELNNNQYNRSSNSNGGNLNSPPGPHSAKTEEHTTILRPSYTGLSSSSARFLSRSIPVSAQTPPPGPQNPECNFCALPSQPRLPPKKFNSAKEAF

SEQ ID NO: 5 - DNA, 1152 bp, Unknown
  CDC14 Aiso3 coding sequence
atggcagcggagtcaggggaactaatcggggcttgtgagttcatgaaagatcggttatattttgctactttaaggaatagaccaaaaagcacagtaaatacccactatttctccatcgatgaggagctggtctatgaaaatttctatgcagattttggaccgctgaacttggcaatggtgtacagatattgctgcaaactaaacaagaaactaaaatcatacagtttgtcaagaaagaaaatagtgcactacacctgttttgaccaacggaaaagagcaaatgcagcatttttgataggtgcctatgcagtaatctatttaaagaagacaccagaagaagcctacagagcactcctgtctggctcaaaccccccctatcttccattcagggatgcttcctttggaaattgcacttacaatctcaccattctcgactgtttgcagggaatcagaaagggattacaacatggattttttgactttgagacatttgatgtggatgaatatgaacattatgagcgagttgaaaatggtgacttcaactggattgttccaggaaaatttttagcatttagtggaccacatcctaaaagcaaaattgagaatggttatcctcttcacgcccctgaagcctactttccttatttcaaaaagcataatgtgactgcagttgtgaggctaaacaaaaagatttatgaggcaaagcgcttcacagacgctggcttcgagcactatgacctcttcttcatagatggcagcacacccagtgacaacatcgtgcgaaggttcctgaacatctgtgagaacaccgaaggggccatcgccgttcactgcaaagctggtcttggaagaacagggacattgatagcctgttatgtaatgaaacactacaggtttacacatgctgaaataattgcttggattagaatatgccggccaggctctattataggaccccagcagcacttcctggaagaaaaacaagcatcgttgtgggtccaaggagacattttccgatccaaactgaaaaatcgaccatccagtgaaggaagtattaataaaattctttctggcctagatgatatgtctattggtggaaatctttcaaaaacacaaaacatggaacgatttggagaggtaagttttccctag

SEQ ID NO: 6 - protein, 383 aa, Unknown
  CDC14 Aiso3 translated sequence
MAAESGELIGACEFMKDRLYFATLRNRPKSTVNTHYFSIDEELVYENFYADFGPLNLAMVYRYCCKLNKKLKSYSLSRKKIVHYTCFDQRKRANAAFLIGAYAVIYLKKTPEEAYRALLSGSNPPYLPFRDASFGNCTYNLTILDCLQGIRKGLQHGFFDFETFDVDEYEHYERVENGDFNWIVPGKFLAFSGPHPKSKIENGYPLHAPEAYFPYFKKHNVTAVVRLNKKIYEAKRFTDAGFEHYDLFFIDGSTPSDNIVRRFLNICENTEGAIAVHCKAGLGRTGTLIACYVMKHYRFTHAEIIAWIRICRPGSIIGPQQHFLEEKQASLWVQGDIFRSKLKNRPSSEGSINKILSGLDDMSIGGNLSKTQNMERFGEVSFP

SEQ ID NO: 7 - DNA, 1380 bp, Unknown
  CDC14Biso1 coding sequence
atgaagcggaaaagcgagcggcggtcgagctgggccgccgcgcccccctgctcgcggcgctgctcgtcgacctcgccgggtgtgaagaagatccgcagctccacgcagcaagacccgcgccgccgggacccccaggacgacgtgtacctggacatcaccgatcgcctttgttttgccattctctacagcagaccaaagagtgcatcaaatgtacattatttcagcatagataatgaacttgaatatgagaacttctacgcagattttggaccactcaatctggcaatggtttacagatattgttgcaagatcaataagaaattaaagtccattacaatgttaaggaagaaaattgttcattttactggctctgatcagagaaaacaagcaaatgctgccttccttgttggatgctacatggttatatatttggggagaaccccagaagaagcatatagaatattaatctttggagagacatcctatattcctttcagagatgctgcctatggaagttgcaatttctacattacacttcttgactgttttcatgcagtaaagaaggcaatgcagtatggcttccttaatttcaactcatttaaccttgatgaatatgaacactatgaaaaagcagaaaatggagatttaaattggataataccagaccgatttattgccttctgtggacctcattcaagagccagacttgaaagtggttaccaccaacattctcctgagacttatattcaatattttaagaatcacaatgttactaccattattcgtctgaataaaaggatgtatgatgccaaacgctttacggatgctggcttcgatcaccatgatcttttctttgcggatggcagcacccctactgatgccattgtcaaagaattcctagatatctgtgaaaatgctgagggtgccattgcagtacattgcaaagctggccttggtcgcacgggcactctgatagcctgctacatcatgaagcattacaggatgacagcagccgagaccattgcgtgggtcaggatctgcagacctggctcggtgattgggcctcagcagcagtttttggtgatgaagcaaaccaacctctggctggaaggggactattttcgtcagaagttaaaggggcaggagaatggacaacacagagcagccttctccaaacttctctctggcgttgatgacatttccataaatggggtcgagaatcaagatcagcaagaacccgaaccgtacagtgatgatgacgaaatcaatggagtgacacaaggtgatagacttcgggccttgaaaagcagaagacaatccaaaacaaacgctattcctctcactctctccatttcaaggactaaaacagtcttgcgttaa

SEQ ID NO: 8 - protein, 459 aa, Unknown
  CDC14Biso1 translated sequence
MKRKSERRSSWAAAPPCSRRCSSTSPGVKKIRSSTQQDPRRRDPQDDVYLDITDRLCFAILYSRPKSASNVHYFSIDNELEYENFYADFGPLNLAMVYRYCCKINKKLKSITMLRKKIVHFTGSDQRKQANAAFLVGCYMVIYLGRTPEEAYRILIFGETSYIPFRDAAYGSCNFYITLLDCFHAVKKAMQYGFLNFNSFNLDEYEHYEKAENGDLNWIIPDRFIAFCGPHSRARLESGYHQHSPETYIQYFKNHNVTTIIRLNKRMYDAKRFTDAGFDHHDLFFADGSTPTDAIVKEFLDICENAEGAIAVHCKAGLGRTGTLIACYIMKHYRMTAAETIAWVRICRPGSVIGPQQQFLVMKQTNLWLEGDYFRQKLKGQENGQHRAAFSKLLSGVDDISINGVENQDQQEPEPYSDDDEINGVTQGDRLRALKSRRQSKTNAIPLTLSISRTKTVLR

SEQ ID NO: 9 - DNA, 1497 bp, Unknown
  CDC14Biso2 coding sequence
atgaagcggaaaagcgagcggcggtcgagctgggccgccgcgcccccctgctcgcggcgctgctcgtcgacctcgccgggtgtgaagaagatccgcagctccacgcagcaagacccgcgccgccgggacccccaggacgacgtgtacctggacatcaccgatcgcctttgttttgccattctctacagcagaccaaagagtgcatcaaatgtacattatttcagcatagataatgaacttgaatatgagaacttctacgcagattttggaccactcaatctggcaatggtttacagatattgttgcaagatcaataagaaattaaagtccattacaatgttaaggaagaaaattgttcattttactggctctgatcagagaaaacaagcaaatgctgccttccttgttggatgctacatggttatatatttggggagaaccccagaagaagcatatagaatattaatctttggagagacatcctatattcctttcagagatgctgcctatggaagttgcaatttctacattacacttcttgactgttttcatgcagtaaagaaggcaatgcagtatggcttccttaatttcaactcatttaaccttgatgaatatgaacactatgaaaaagcagaaaatggagatttaaattggataataccagaccgatttattgccttctgtggacctcattcaagagccagacttgaaagtggttaccaccaacattctcctgagacttatattcaatattttaagaatcacaatgttactaccattattcgtctgaataaaaggatgtatgatgccaaacgctttacggatgctggcttcgatcaccatgatcttttctttgcggatggcagcacccctactgatgccattgtcaaagaattcctagatatctgtgaaaatgctgagggtgccattgcagtacattgcaaagctggccttggtcgcacgggcactctgatagcctgctacatcatgaagcattacaggatgacagcagccgagaccattgcgtgggtcaggatctgcagacctggctcggtgattgggcctcagcagcagtttttggtgatgaagcaaaccaacctctggctggaaggggactattttcgtcagaagttaaaggggcaggagaatggacaacacagagcagccttctccaaacttctctctggcgttgatgacatttccataaatggggtcgagaatcaagatcagcaagaacccgaaccgtacagtgatgatgacgaaatcaatggagtgacacaaggtgatagacttcgggccttgaaaagcagaagacaatccaaaacaaacgctattcctctcacagtaattcttcaatccagtgttcagagctgtaaaacatctgaacctaacatttctggcagtgcaggcattactaaaagaaccaccagatctgcttcaaggaaaagcagtgttaaaagtctctccatttcaaggactaaaacagtcttgcgttaa

SEQ ID NO: 10 - protein, 498 aa, Unknown
  CDC14Biso2 translated sequence
MKRKSERRSSWAAAPPCSRRCSSTSPGVKKIRSSTQQDPRRRDPQDDVYLDITDRLCFAILYSRPKSASNVHYFSIDNELEYENFYADFGPLNLAMVYRYCCKINKKLKSITMLRKKIVHFTGSDQRKQANAAFLVGCYMVIYLGRTPEEAYRILIFGETSYIPFRDAAYGSCNFYITLLDCFHAVKKAMQYGFLNFNSFNLDEYEHYEKAENGDLNWIIPDRFIAFCGPHSRARLESGYHQHSPETYIQYFKNHNVTTIIRLNKRMYDAKRFTDAGFDHHDLFFADGSTPTDAIVKEFLDICENAEGAIAVHCKAGLGRTGTLIACYIMKHYRMTAAETIAWVRICRPGSVIGPQQQFLVMKQTNLWLEGDYFRQKLKGQENGQHRAAFSKLLSGVDDISINGVENQDQQEPEPYSDDDEINGVTQGDRLRALKSRRQSKTNAIPLTVILQSSVQSCKTSEPNISGSAGITKRTTRSASRKSSVKSLSISRTKTVLR

SEQ ID NO: 11 - DNA, 1416 bp, Unknown
  CDC14Biso3 coding sequence
atgaagcggaaaagcgagcggcggtcgagctgggccgccgcgcccccctgctcgcggcgctgctcgtcgacctcgccgggtgtgaagaagatccgcagctccacgcagcaagacccgcgccgccgggacccccaggacgacgtgtacctggacatcaccgatcgcctttgttttgccattctctacagcagaccaaagagtgcatcaaatgtacattatttcagcatagataatgaacttgaatatgagaacttctacgcagattttggaccactcaatctggcaatggtttacagatattgttgcaagatcaataagaaattaaagtccattacaatgttaaggaagaaaattgttcattttactggctctgatcagagaaaacaagcaaatgctgccttccttgttggatgctacatggttatatatttggggagaaccccagaagaagcatatagaatattaatctttggagagacatcctatattcctttcagagatgctgcctatggaagttgcaatttctacattacacttcttgactgttttcatgcagtaaagaaggcaatgcagtatggcttccttaatttcaactcatttaaccttgatgaatatgaacactatgaaaaagcagaaaatggagatttaaattggataataccagaccgatttattgccttctgtggacctcattcaagagccagacttgaaagtggttaccaccaacattctcctgagacttatattcaatattttaagaatcacaatgttactaccattattcgtctgaataaaaggatgtatgatgccaaacgctttacggatgctggcttcgatcaccatgatcttttctttgcggatggcagcacccctactgatgccattgtcaaagaattcctagatatctgtgaaaatgctgagggtgccattgcagtacattgcaaagctggccttggtcgcacgggcactctgatagcctgctacatcatgaagcattacaggatgacagcagccgagaccattgcgtgggtcaggatctgcagacctggctcggtgattgggcctcagcagcagtttttggtgatgaagcaaaccaacctctggctggaaggggactattttcgtcagaagttaaaggggcaggagaatggacaacacagagcagccttctccaaacttctctctggcgttgatgacatttccataaatggggtcgagaatcaagatcagcaagaacccgaaccgtacagtgatgatgacgaaatcaatggagtgacacaaggtgatagacttcgggccttgaaaagcagaagacaatccaaaacaaacgctattcctctcaccgatggttggctgtcccaggctgtcacctttctagaccggcttctgatctggctcgggatccacaaggactag

SEQ ID NO: 12 - protein, 471 aa, Unknown
  CDC14Biso3 translated sequence
MKRKSERRSSWAAAPPCSRRCSSTSPGVKKIRSSTQQDPRRRDPQDDVYLDITDRLCFAILYSRPKSASNVHYFSIDNELEYENFYADFGPLNLAMVYRYCCKINKKLKSITMLRKKIVHFTGSDQRKQANAAFLVGCYMVIYLGRTPEEAYRILIFGETSYIPFRDAAYGSCNFYITLLDCFHAVKKAMQYGFLNFNSFNLDEYEHYEKAENGDLNWIIPDRFIAFCGPHSRARLESGYHQHSPETYIQYFKNHNVTTIIRLNKRMYDAKRFTDAGFDHHDLFFADGSTPTDAIVKEFLDICENAEGAIAVHCKAGLGRTGTLIACYIMKHYRMTAAETIAWVRICRPGSVIGPQQQFLVMKQTNLWLEGDYFRQKLKGQENGQHRAAFSKLLSGVDDISINGVENQDQQEPEPYSDDDEINGVTQGDRLRALKSRRQSKTNAIPLTDGWLSQAVTFLDRLLIWLGIHKD

SEQ ID NO: 13 - protein, 585 aa, Unknown
  Concnesus sequence
MAAESGELIGACEFMKDRLYFATLRNRPKSTVNTHYFSIDEELVYENFYADFGPLNLAMVYRYCCKLNKKLKSYSLSRKKIVHYTCFDQRKRANAAFLIGAYAVIYLKKTPEEAYRALLSGSNPPYLPFRDASFGNCTYNLTILDCLQGIRKGLQHGFFDFETFDVDEYEHYERVENGDFNWIVPGKFLAFSGPHPKSKIENGYPLHAPEAYFPYFKKHNVTAVVRLNKKIYEAKRFTDAGFEHYDLFFIDGSTPSDNIVRRFLNICENTEGAIAVHCKAGLGRTGTLIACYVMKHYRFTHAEIIAWIRICRPGSIIGPQQHFLEEKQASLWVQGDIFRSKLKNRPSSEGSINKILSGLDDMSIGGNLSKTQNMERFGEDNLEDDDVEMKNGITQGDKLRALKSQRQPRTSPSCAFRSDDTKGHPRAVSQPFRLSSSLQGSAVTLKTSKMALSPSATAKRINRTSLSSGATVRSFSINSRLASSLGNLNAATDDPENKKTSSSSKAGFTASPFTNLLNGSSQPTTRNYPELNNNQYNRSSNSNGGNLNSPPGPHSAKTEEHTTILRPSYTGLSSSSARFLSRSIP

SEQ ID NO: 14 - protein, 456 aa, Unknown
  consensus sequence
MKRKSERRSSWAAAPPCSRRCSSTSPGVKKIRSSTQQDPRRRDPQDDVYLDITDRLCFAILYSRPKSASNVHYFSIDNELEYENFYADFGPLNLAMVYRYCCKINKKLKSITMLRKKIVHFTGSDQRKQANAAFLVGCYMVIYLGRTPEEAYRILIFGETSYIPFRDAAYGSCNFYITLLDCFHAVKKAMQYGFLNFNSFNLDEYEHYEKAENGDLNWIIPDRFIAFCGPHSRARLESGYHQHSPETYIQYFKNHNVTTIIRLNKRMYDAKRFTDAGFDHHDLFFADGSTPTDAIVKEFLDICENAEGAIAVHCKAGLGRTGTLIACYIMKHYRMTAAETIAWVRICRPGSVIGPQQQFLVMKQTNLWLEGDYFRQKLKGQENGQHRAAFSKLLSGVDDISINGVENQDQQEPEPYSDDDEINGVTQGDRLRALKSRRQSKTNAIPLTSSKTLGIK

(19) United States
(12) Patent Application Publication
(10) Pub. No.: US 2006/0173633 A1
(43) Pub. Date: Aug. 3, 2006

(54) Crystalline phosphatase and method for use thereof

(75) Inventor: Peter Benjamin Rupert, Seattle, WA (US)

Correspondence Address: BUCHANAN INGERSOLL LLP;(INCLUDING BURNS, DOANE, SWECKER & MATHIS), P.O. BOX 1404, ALEXANDRIA, VA, 22313-1404, US

(73) Assignee: Ceptyr, Inc., Bothell, WA (US)

(21) Appl. No.: 11/341,075

(22) Filed: Jan. 27, 2006

Related U.S. Application Data
(60) Provisional application No. 60/648,129, filed on Jan. 28, 2005.

(51) Int. Cl. G06F 19/00

(52) U.S. Cl. 702/19

(57) ABSTRACT

This disclosure is directed to a crystalline form of a human protein tyrosine phosphatase designated cdc14A and more particularly to a crystal of human cdc14A, a method of crystallization thereof, and its structure, obtained by x-ray diffraction. In addition, the disclosure relates to methods of identifying new PTP binding agents and more particularly cdc14 (A or B) substrates and inhibitors.

### CROSS REFERENCE TO RELATED APPLICATIONS

This application claims priority to U.S. Provisional Application Ser. No. 60/648,129 filed Jan. 28, 2005, the disclosure of which is incorporated herein by reference.

### TECHNICAL FIELD

This disclosure is directed to a crystalline form of a human protein tyrosine phosphatase designated cdc14A and more particularly to a crystal of human cdc14A, a method of crystallization thereof, and its structure, obtained by x-ray diffraction. In addition, the disclosure relates to methods of identifying new PTP binding agents and more particularly cdc14 (A or B) substrates and inhibitors.

### BACKGROUND

It is estimated that 1,334,100 new cancer cases will be diagnosed and 556,500 cancer deaths will occur in 2003-2004. The direct and indirect costs of cancer in the US are expected to reach $171.6 billion. Despite progress in treatment of many forms of cancer, the five-year survival rates for lung, pancreatic, and esophageal cancers between 1992 and 1998 were still below 20% (Cancer Facts and Figures, 2003. Atlanta, Ga.: American Cancer Society (2003)).

Chemotherapeutic drugs are a mainstay of cancer treatment. Most of these agents target key steps in DNA replication or cell division. Although chemotherapy targets rapidly growing tumor cells, it can also damage healthy proliferating tissues such as epithelium and bone marrow. Side effects can include hair loss, nausea and vomiting, diarrhea, anemia, and potentially fatal infections caused by neutropenia (Devita V T., In Cancer: principles and practice of oncology 4^{th} ed.; Devita V T; Hellman S; Rosenberg S A, Eds; J. B. Lippincott Co.: Philadelphia, Pa., 1993; pp. 276-292). Chemotherapy drugs are rarely associated with complete remission or cure of most cancers. For example, chemotherapy in lung cancers is primarily palliative (Rigas Semin. Oncol. 25 (suppl. 8): 5-9 (1998)). In addition to low therapeutic index, chemotherapeutic failure may be due to drug resistance, where cancers that are initially sensitive to chemotherapy progress to more aggressive forms with poor treatment response (Pratt et al. Chapter 4: Resistance to anticancer drugs. In: The anticancer drugs 2^{nd} ed. Oxford University Press, Inc.: New York, N.Y., (1994); pp. 50-66). Newer agents that target different mechanisms of cell survival or proliferation, and that exhibit an improved therapeutic index are desperately needed.

Reversible protein tyrosine phosphorylation, coordinated by the action of protein tyrosine kinases (PTKs) that phosphorylate certain tyrosine residues in polypeptides, and protein tyrosine phosphatases (“PTPs” ) that dephosphorylate certain phosphotyrosine residues, is a key mechanism in regulating many cellular activities. It is becoming apparent that the diversity and complexity of the PTPs and PTKs are comparable, and that PTPs are equally important in delivering both positive and negative signals for proper function of cellular machinery. Regulated tyrosine phosphorylation contributes to specific pathways for biological signal transduction, including those associated with cell division, proliferation and differentiation. Defects and/or malfunctions in these pathways may underlie certain disease conditions for which effective means for intervention remain elusive including, for example, malignancy, autoimmune disorders, diabetes, obesity, inflammation and infection.

The PTP family of enzymes consists of approximately 100 structurally diverse proteins that have in common a highly conserved amino acid PTP catalytic domain, but which display considerable variation in their non-catalytic segments. This structural diversity presumably reflects the diversity of physiological roles of individual PTP family members, which in certain cases have been demonstrated to have specific functions in growth, development and differentiation (Desai et al., Cell 84:599-609, 1996; Kishihara et al., Cell 74:143-156, 1993; Perkins et al., Cell 70:225-236, 1992; Pingel and Thomas, Cell 58:1055-1065, 1989; Schultz et al., Cell 73:1445-1454, 1993). PTPs participate in a variety of physiologic functions, providing a number of opportunities for therapeutic intervention in physiologic processes through alteration or modulation (e.g., up-regulation or down-regulation) of PTP activity. For example, therapeutic inhibition of PTPs such as PTP1B in the insulin-signaling pathway may serve to augment insulin action, thereby ameliorating the state of insulin resistance common in Type II diabetes patients.

Although recent studies have also generated considerable information regarding the structure, expression and regulation of PTPs, the identity of some of the tyrosine phosphorylated substrates through which the PTPs exert their effects remains to be determined. Studies with a limited number of synthetic phosphopeptide substrates have demonstrated some differences in the substrate selectivity of different PTPs (Cho et al., Protein Sci. 2:977-984, 1993; Dechert et al., Eur. J. Biochem. 231:673-681, 1995). Analyses of PTP-mediated dephosphorylation of PTP substrates suggest that catalytic activity may be favored by the presence of certain amino acid residues at specific positions in the substrate polypeptide relative to the phosphorylated tyrosine residue (Ruzzene et al., Eur. J. Biochem. 211:289-295, 1993; Zhang et al., Biochemistry. 33:2285-2290, 1994). Thus, although the physiological relevance of the substrates used in these studies is unclear, PTPs display a certain level of substrate selectivity in vitro. The family of PTPs can be subdivided into two categories: the classical PTPs, pTyr-specific enzymes typified by PTP1B and CD45, and the dual specificity phosphatases (“DSPs”), which dephosphorylate Ser, Thr as well as Tyr residues. The DSPs largely maintain the same catalytic mechanism as the classical PTPs but display differences in architecture of the active site and have been implicated in fundamentally important signaling events from control of MAP kinases in cell proliferation to the regulation of cyclin dependent kinases in the cell cycle.

Mitogen-activated protein kinases (MAP-kinases) are components of conserved cellular signal transduction pathways that have a variety of conserved members and that are integral to the cell's response to stimuli such as growth factors, hormones, cytokines, and environmental stresses. MAP-kinases are activated by phosphorylation by MAP-kinase kinases at a dual phosphorylation motif that has the sequence Thr-X-Tyr, in which phosphorylation at the tyrosine and threonine residues is required for activity. Activated MAP-kinases phosphorylate several transduction targets, including effector protein kinases and transcription factors. Inactivation of MAP-kinases is mediated by dephosphorylation at the Thr-X-Tyr site by dual-specificity phosphatases referred to as MAP-kinase phosphatases. In higher eukaryotes, the physiological role of MAP-kinase signaling has been correlated with cellular events such as proliferation, oncogenesis, development, and differentiation. Accordingly, the ability to regulate signal transduction via these pathways can lead to the development of treatments and preventive therapies for human diseases associated with MAP-kinase signaling, such as cancer.

As stated above, dual-specificity protein tyrosine phosphatases dephosphorylate both phosphotyrosine and phosphor-threonine/serine residues (Walton et al., Ann. Rev. Biochem. 62:101-120, 1993). More than 50 dual-specificity phosphatases that dephosphorylate and inactivate a MAP-kinase have been identified (Shen et al., Proc. Natl. Acad. Sci. USA 98:13613-18, 2001), including MKP-1 (WO 97/00315; Keyse and Emslie, Nature 59:644-647 (1992)); MKP-2 (WO97/00315); MKP-4, MKP-5, MKP-7, Hb5 (WO 97/06245); PAC1 (Ward et al., Nature 367:651-654, 1994); HVH2 (Guan and Butch, J. Biol. Chem. 270:7197-7203, 1995); and PYST1 (Groom et al., EMBO J. 15:3621-3632, 1996). These dual-specificity phosphatases differ in expression, tissue and subcellular distribution, and specificity for MAP-kinase family members. Expression of certain dual-specific phosphatases are induced by stress or mitogens, but others appear to be expressed constitutively in specific cell types. The regulation of dual-specific phosphatase expression and activity is critical for control of MAP-kinase mediated cellular functions, including cell proliferation, cell differentiation and cell survival. For example, dual-specific phosphatases may function as negative regulators of cell proliferation. It is likely that there are many such dual-specific phosphatases, with varying specificity with regard to cell type or activation.

cdc14p in Saccharomyces cerevisiae is an important cell cycle protein phosphatase that regulates exit from mitosis. cdc14p promotes mitosis by inducing degradation of Clb2p mitotic cyclin (equivalent to human cyclin-B), through two mechanisms. The first is by upregulation of the mitotic cyclin dependent kinase inhibitor Sic1p, and the second is by targeting Clb2p for degradation by the 26S proteasome via ubiquitination. cdc14p dephosphorylates the Anaphase Promoting Complex (APC) regulatory subunit Cdh1p, making Clb2p cyclin a better substrate for APC mediated ubiquitination. During most of the cell cycle cdc14p is sequestered in the nucleolus by Net1p, however during early anaphase it is released by activation of a pathway referred to as the Mitotic Exit Network (MEN). This shift in localization explains how cdc14p functions at the proper time to instigate mitotic exit (Gray et al., EMBO J 22:3524-3535, 2003).

In humans there are two homologs of yeast cdc14p referred to as cdc14A and cdc14B (Li et al., J Biol Chem; 272:29403-29406, 1997). cdc14A shares 64% identity with yeast cdc14. Furthermore, cdc14A is 85% identical to cdc14B, with the greatest alignment in the catalytic domain. The two cdc14 homologs vary in sequence predominantly at the N- and C-termini, and cdc14A has a functional nuclear export sequence while cdc14B does not. As a result cdc14B localizes to the nucleolus throughout the cell cycle while cdc14A is found at the centrosomes (Mailand et al., Nature Cell Biology; 4:317-322, 2002; Kaiser et al., Mol Biol Cell; 13:2289-2300, 2002). To date, a biological function for cdc14B has not been determined, although both cdc14A and cdc14B reportedly bind p53 and dephosphorylate pSer-315 in vitro (Li et al., J Biol Chem 275:2410-2414, 2002). A recent study demonstrated that cdc14A dephosphorylates the APC regulatory protein Cdh1 in vitro and that dephosphorylated APCCdh1 has activated ubiquitination of cyclin-B1 (Bembenek and Yu, J Biol Chem, 276:48237-48242, 2001). However, dephosphorylation of Cdh1 by cdc14A and regulation of the APC has not been reported in vivo. Overexpression of catalytically active cdc14A results in premature centrosomal splitting and supernumerary mitotic spindles (Mailand et al., Nature Cell Biology, 4:317-322, 2002; Kaiser et al., Mol Biol Cell, 13:2289-2300, 2002). Both overexpression and down regulation of cdc14A caused aberrant chromosome partitioning into daughter cells, premature centrosome splitting and the formation of supernumerary mitotic spindles (Mailand et al., supra). Down regulation of endogenous cdc14A by short inhibitory RNA duplexes induced mitotic defects, including impaired centrosome separation and failure to undergo cytokinesis (Mailand et al., supra; Gruneberg et al., J Cell Biol; 158:901-914, 2002). These studies implicate cdc14A as a positive regulator of the centrosome duplication cycle. Therefore, inhibition of cdc14A would be expected to block cell proliferation. Finally, very recent data indicate that yeast cdc14p is a master regulator of the inner centromere protein (INCENP)-Aurora kinase complex (Sli15-Ipl1), a complex conserved from yeast through mammalian cells (Pereira and Schiebel, Science, 302:2120-2124, 2003). As part of this complex, yeast cdc14p regulates mitotic exit by modulating spindle behavior through Sli15-Ipl1. It is not known whether mammalian Ccd14A regulates this complex. Notably, in mammalian cells, survivin, a caspase inhibitor implicated in mitosis and potentially cell survival is part of the INCENP complex. This could couple cell mitotic control to decisions for cell survival and apoptosis.

Inhibition of mitosis through the use of agents that perturb microtubule dynamics and disrupt the function of the mitotic spindle have proven useful as strategies for treating diseases involving excessive cell proliferation, most notable human cancers. New targets in this space include inhibitors of aurora-2 kinase and kinesin spindle protein, which are both undergoing evaluation for safety and efficacy in clinical trials involving select malignancies. From all available evidence, mammalian cdc14 homologs appear to regulate a master network of proteins and enzymes that modulate microtubule dynamics involved in chromosome segregation and mitotic exit. cdc14A is a fundamentally important target for cell cycle progression and cell survival. Modulating cdc14A with a selective inhibitor would be anticipated to evoke a conflict signal in the growth fraction of human tumors. Thus, a cdc14A inhibitor might be a novel anti-cancer agent expanding the arsenal of drugs available to better manage cancer, having potential synergies with other anti-mitotics, both classical (e.g. taxanes) and new (e.g. proteasome inhibitors). The design of such an inhibitor would be assisted by more detailed information on the cdc14A polypeptide, such as crystallographic information.

### SUMMARY

The disclosure provides a crystalline cdc14A polypeptide.

The disclosure further provides the three-dimensional coordinates of a crystalline cdc14A polypeptide.

The disclosure also provides a crystal formed by cdc14A that diffracts x-ray radiation to produce a diffraction pattern representing the three-dimensional structure of the cdc14A. Further provided by the disclosure is a crystalline polypeptide comprising the approximate cell constants of a=74 angstroms, b=81 angstroms, and c=69 angstroms.

The disclosure further provides a method of crystallizing cdc14A comprising (a) mixing an aqueous solution comprising cdc14A with a reservoir solution comprising a precipitant to form a mixed volume; and (b) crystallizing the mixed volume.

Also provided is a method for determining a three-dimensional structure of cdc14A comprising: (a) obtaining crystalline cdc14A; (b) irradiating the crystalline cdc14A to obtain a diffraction pattern characteristic of the crystalline cdc14A; and (c) transforming the diffraction pattern into a three-dimensional structure of the cdc14A.

The disclosure further provides a machine-readable data storage medium comprising a data storage material encoded with machine-readable data that, when read by an appropriate machine, displays a three-dimensional representation of a crystal of a molecule comprising cdc14A or fragment or variant thereof. Further included in the present disclosure is a computer means for producing a three-dimensional representation of a cdc14A crystal, or a cdc14A crystal: binding agent complex, or co-crystal.

The disclosure provides a method for evaluating the potential of a candidate binding agent to associate with a cdc14A polypeptide or a fragment thereof. The method includes (a) modeling (or producing a three-dimensional representation of) one or more domains of a cdc14A polypeptide, defined by a plurality of atomic coordinates of the cdc14A polypeptide; and (b) modeling (or producing a three-dimensional representation of) the association of a candidate binding agent with said modeled cdc14A polypeptide.

The disclosure further provides a computer program on a computer readable medium comprising instructions to cause a computer to: (a) define a cdc14A polypeptide or fragment thereof based on a plurality of atomic coordinates of the cdc14A polypeptide; and (b) model (or producing a three-dimensional representation of) a potential binding agent that interacts with the cdc14A polypeptide. Further disclosed is a computer with display means for displaying the atomic coordinates.

In yet a further aspect, the disclosure provides a method of designing a compound that mimics the 3-dimensional surface shape of cdc14A polypeptide comprising the steps of: (a) determining the 3-dimensional structure of a cdc14A polypeptide; and (b) designing a compound that complements the 3-dimensional surface configuration of the cdc14A polypeptide.

The disclosure provides a method for determining at least a portion of a three-dimensional structure of a molecular complex, said complex comprising cdc14A and said method comprising the steps of: (a) determining the structural coordinates of a crystal of a cdc14A polypeptide; (b) calculating phases from the structural coordinates; (c) calculating an electron density map from the phases obtained in step (b); and (d) determining the structure of at least a portion of the complex based on said electron density map.

The disclosure also provides a method for evaluating the ability of a chemical entity to associate with cdc14A or a complex thereof. The method includes (a) employing computational or experimental means to perform a fitting operation between the chemical entity and the cdc14A or complex thereof, thereby obtaining data related to the association; and (b) analyzing the data obtained in step (a) to determine the characteristics of the association between the chemical entity and the cdc14A or complex thereof.

The disclosure provides a heavy-atom derivative of a crystallized form of cdc14A.

In yet another aspect, the disclosure provides a method of computationally or experimentally evaluating a chemical entity, or binding agent to obtain information about its association with a domain of cdc14A using a crystal of cdc14A having the structural coordinates described in Table 2.

The disclosure provides a crystalline complex comprising a cdc14A polypeptide and a candidate binding agent.

The disclosure further provides a method for determining the binding of a candidate binding agent to cdc14A, comprising (a) introducing the candidate binding agent and a crystalline cdc14A in an environment such that the agent and crystalline cdc14A can interact; and (b) analyzing the crystalline cdc14A to determine whether the candidate binding agent binds thereto.

The disclosure provides a method of identifying a candidate binding agent for binding to cdc14A. The method includes (a) constructing a three-dimensional structure of cdc14A polypeptide using atomic coordinates shown in Table 2, (b) performing structure-based design of said candidate binding agent using said atomic coordinates of (a); and (c) identifying a candidate binding agent predicted by said structure based design to bind to cdc14A polypeptide.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1A shows pile-ups of cdc14Aiso1 (SEQ ID NO:2), cdc14Aiso2 (SEQ ID NO:4), and cdc14Aiso3 (SEQ ID NO:6) amino acid sequences in comparison to a consensus amino acid sequence (SEQ ID NO:13).

FIG. 1B shows pile-ups of cdc14Biso1 (SEQ ID NO:8), cdc14Biso2 (SEQ ID NO:10), and cdc14Biso3 (SEQ ID NO:12) amino acid sequences in comparison to a consensus amino acid sequence (SEQ ID NO:14).

FIG. 2A shows a catalytic domain and representative amino acid residues of cdc14 with a C-alpha backbone trace of the active site region.

FIG. 2B shows a catalytic domain and representative amino acid residues of cdc14 with an all-atom representation of the active site region in the same orientation as FIG. 2A.

FIG. 2C shows a catalytic domain and representative amino acid residues of cdc14 with an all-atom representation of the active site region rotated 90° with respect to FIG. 2B.

FIG. 3 shows a computer system useful with the methods of the disclosure.

FIG. 4A shows the nucleic acid sequence of the CDC14Aiso1 coding sequence (SEQ ID NO:1).

FIG. 4B shows the nucleic acid sequence of the CDC14Aiso2 coding sequence (SEQ ID NO:3).

FIG. 4C shows the nucleic acid sequence of the CDC14Aiso3 coding sequence (SEQ ID NO:5).

FIG. 4D shows the nucleic acid sequence of the CDC14Biso1 coding sequence (SEQ ID NO:7).

FIG. 4E shows the nucleic acid sequence of the CDC14Biso2 coding sequence (SEQ ID NO:9).

FIG. 4F shows the nucleic acid sequence of the CDC14Biso3 coding sequence (SEQ ID NO:11).

### DETAILED DESCRIPTION

As used in this disclosure, the phrase “modulating phosphorylation” and correlatives thereof such as “modulate” or “modulating” phosphorylation means increasing or decreasing a molecule's state of phosphorylation relative to a control or normal state. It will be appreciated that the degree of modulation provided by a PTP binding agent (e.g., an inhibitor or an activator) will vary and will depend upon the assay conditions. An inhibitor of cdc14 includes any agent that decreases dephosphorylation of a molecule relative to an untreated control. An activator of cdc14 includes any agent that increases dephosphorylation of a molecule compared to a control lacking such an agent.

The terms “cdc14A polypeptide” or “cdc14A” each refer to a polypeptide comprising an amino acid sequence as set forth in SEQ ID NO: 2, or to mutants, fragments, variants (e.g., SEQ ID Nos:4 or 6) and conservative substitutions thereof comprising L- or D-amino acids and includes modified forms thereof, such as glycoproteins.

A “cdc14B polypeptide” or “cdc14B” is intended to encompass a polypeptide comprising an amino acid sequence as set forth in SEQ ID NO:8, or to mutants, fragments, variants (e.g., SEQ ID Nos:10 or 12) and conservative substitutions thereof comprising L- or D-amino acids and include modified forms thereof, such as glycoproteins.

The terms “cdc14 polypeptide” and “cdc14” are each intended to encompass either or both a cdc14A and/or a cdc14B polypeptide, as the context requires.

The term “binding agent” means any compound that is capable of binding to or interacting with a cdc14 polypeptide's binding domain (e.g., active site or catalytic site) or other domain (e.g., an allosteric or exosite domain). For example, a binding agent can bind to or interact with a domain on the cdc14 polypeptide causing a change in the conformation of the polypeptide thereby rendering the cdc14 inactive. Such compounds can include polypeptides, peptidomimetics, antibodies, antibody fragments, small chemical molecules, and the like. The binding agent may inhibit activity of cdc14 polypeptide by acting as a competitive binding agent to a naturally occurring substrate of a cdc14 polypeptide. A binding agent may also be a natural or modified substrate for cdc14 polypeptide, such as, for example, p53 (J Biol Chem. 275(4):2410-4, 2000); hCdh1 (J Biol Chem. 276(51):48237-42, 2001); p27Kip1 (Mol Biol Cell. 13(7):2289-300, 2002); histone H1 (Mol Biol Cell. 13(7):2289-300, 2002); cdc15 (Curr Biol. 10(10):615-8, 2000); and Sic1 (Mol Cell. 2(6):709-18, 1998). Alternatively, a binding agent can be a fragment of a naturally occurring polypeptide or a synthetic polypeptide that is designed (based on the disclosure herein) to interact with a binding cavity of a cdc14 polypeptide.

The term “polypeptide” refers to a chain of amino acid residues, regardless of length or posttranslational modification (e.g., glycosylation or phosphorylation). A polypeptide refers to a polymer in which the monomers are amino acid residues that are joined together through amide bonds. When the amino acids are alpha-amino acids, either the L-optical isomer or the D-optical isomer can be used, the L-isomers being typical.

As used herein, a “substantially pure” polypeptide is a polypeptide that has been separated from components that naturally accompany it. Typically, a polypeptide is substantially pure when it is at least 60%, by weight, free from the proteins and naturally-occurring molecules with which it is naturally associated. Typically, the preparation is at least 75%, 90%, typically 95%, and most typically at least 99%, by weight, free from the proteins and naturally-occurring molecules with which it is naturally associated. A substantially pure polypeptide may be obtained, for example, by extraction from a natural source; by expression of a recombinant nucleic acid encoding a desired polypeptide; or by chemically synthesizing the polypeptide. Purity can be measured by any appropriate method (e.g., column chromatography, polyacrylamide gel electrophoresis, by HPLC analysis, and the like).

Accordingly, the polypeptides of the disclosure are intended to cover naturally occurring proteins, as well as those that are recombinantly or synthetically synthesized. Polypeptide fragments are also encompassed by the disclosure. Fragments have fewer amino acid residues than the polypeptides of SEQ ID NO:2 or SEQ ID NO:8, and therein can have the same or substantially the same amino acid sequence as the naturally occurring polypeptide over the corresponding region. A polypeptide or peptide having substantially the same sequence means that an amino acid sequence is largely, but not entirely, the same, and, for purposes of certain aspects of this invention, retains the three-dimensional structure conformation of the sequence to which it is related. Indeed, if a certain domain or region of a cdc14 is targeted for potential binding, the full-length protein may not need to be crystallized in order to provide the benefit of a three-dimensional representation of the conformation of such domain or region. A fragment containing the cdc14 region or domain of interest can be used and crystallized or even co-crystallized with a candidate binding agent. The representation of the fragment or domain or region can provide valuable information in the design of candidate binding agents, and in particular in rational drug design. In general, polypeptides of the disclosure include peptides, or full length polypeptides or fragments, that contain substitutions, deletions, or insertions into the protein backbone that would still have approximately 70%, 80%, 90%, 95% or 99% homology to the original polypeptide over the corresponding portion of the molecule. A yet greater degree of departure from homology is allowed if like-amino acids, i.e., conservative amino acid substitutions, are not considered a change in the sequence.

A polypeptide that is substantially related to a naturally occurring protein, but for a conservative variation, is also contemplated to be within the methods of the disclosure. For example, a binding agent can be modeled to interact with a variant cdc14 polypeptide based upon the structural coordinates described herein. In another aspect, a polypeptide binding agent can be modified to generate variants that interact with a cdc14 polypeptide. A conservative variation denotes the replacement of an amino acid residue by another, biologically similar residue. Examples of conservative variations include the substitution of one hydrophobic residue such as isoleucine, valine, leucine or methionine, for another hydrophobic residue, or the substitution of one polar residue for another, such as the substitution of arginine for lysine, glutamic acid for aspartic acids, or glutamine for asparagine, and the like. Other illustrative, non-limiting, examples of conservative substitutions include the changes of: alanine to serine; arginine to lysine; asparagine to glutamine or histidine; aspartate to glutamate; cysteine to serine; glutamine to asparagine; glutamate to aspartate; glycine to proline; histidine to asparagine or glutamine; isoleucine to leucine or valine; leucine to valine or isoleucine; lysine to arginine, glutamine, or glutamate; methionine to leucine or isoleucine; phenylalanine to tyrosine, leucine or methionine; serine to threonine; threonine to serine; tryptophan to tyrosine or phenylalanine; tryptophan to phenylalanine; tyrosine to tryptophan or phenylalanine; and valine to isoleucine or leucine.

Modifications and substitutions are not limited to replacement of amino acids. For a variety of purposes, such as increased stability, solubility, or configuration concerns, one skilled in the art will recognize the potential value of introducing, (by deletion, replacement, or addition) other modifications. Examples of such other modifications include incorporation of rare amino acids, D-amino acids, glycosylation sites, cytosine for specific disulfide bridge formation, and the like. The use of modified polypeptide binding agents that incorporate non-naturally occurring amino acids for increased stability can be developed for therapeutic administration. The modified polypeptide binding agents can be modeled to interact with the binding domain/catalytic domain of a cdc14A polypeptide based upon the structural coordinates described herein. The modified peptides can be chemically synthesized, or the isolated gene can be site-directed mutagenized, or a synthetic gene can be synthesized and expressed in bacteria, yeast, baculovirus, tissue culture, and the like, to obtain the modified polypeptide.

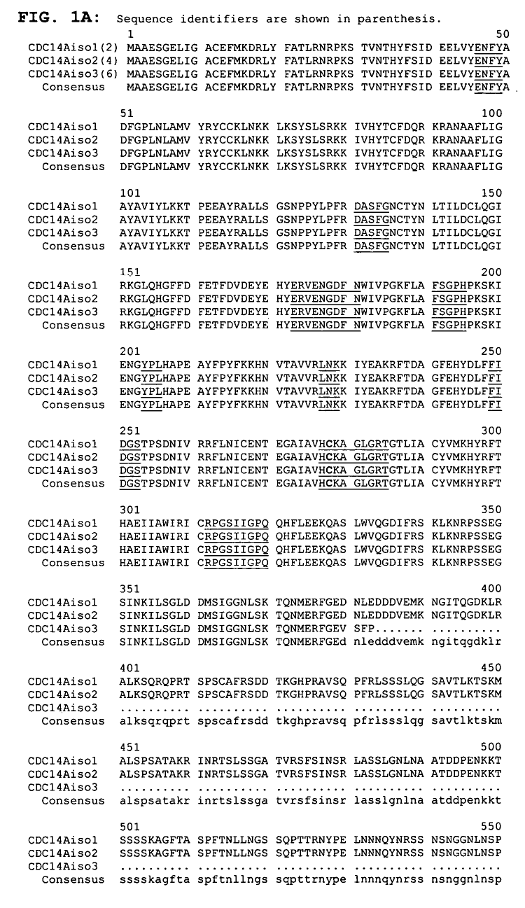

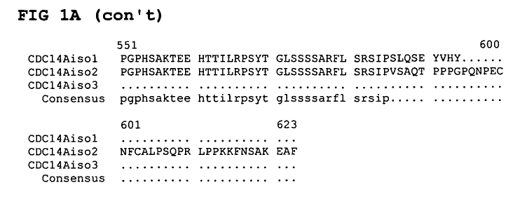

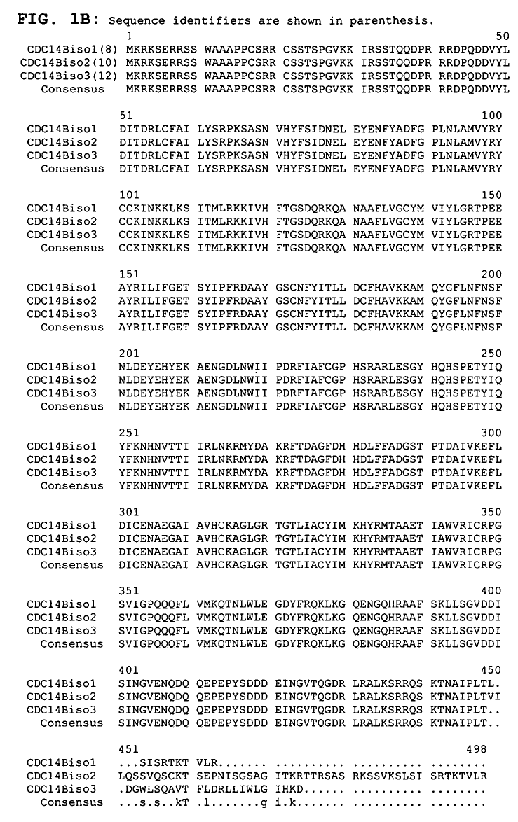

Variations to a cdc14A polypeptide wherein the polypeptide still retains its biological activity, can be made by any number of means known in the art. For example, variations can be obtained by such methods as error-prone PCR, shuffling, oligonucleotide-directed mutagenesis, assembly PCR, sexual PCR mutagenesis, and the like, as well as any combination of two or more thereof. The resulting varigated polypeptide can then be screened by high throughput screening techniques that measure the ability of the varigated polypeptide to function as a PTP or to function as a PTP substrate. With reference to FIG. 1A and 1B, one of skill in the art can easily identify the conserved amino acid residues and those amino acid residues that are not conserved and thus can be modified without destroying the activity of a cdc14 polypeptide.

The term “substantially identical” means a polypeptide or nucleic acid exhibiting at least 50%, 85%, 90%, but typically at least 95% identity to a reference amino acid or nucleic acid sequence.

Identity is often measured using sequence analysis software (e.g., Sequence Analysis Software Package of the Genetics Computer Group, University of Wisconsin Biotechnology Center, 1710 University Avenue, Madison, Wis. 53705). Such software matches sequences by assigning degrees of homology to various deletions, substitutions and other modifications. The terms “homology” and “identity” in the context of two or more nucleic acids or polypeptide sequences, refer to two or more sequences or subsequences that are the same or have a specified percentage of amino acid residues or nucleotides that are the same when compared and aligned for maximum correspondence over a comparison window or designated region as measured using any number of sequence comparison algorithms or by manual alignment and visual inspection.

For sequence comparison, one sequence acts as a reference sequence, to which test sequences are compared. When using a sequence comparison algorithm, test and reference sequences are entered into a computer, subsequence coordinates are designated, if necessary, and sequence algorithm program parameters are designated. Default program parameters can be used, or alternative parameters can be designated. The sequence comparison algorithm then calculates the percent sequence identities for the test sequences relative to the reference sequence, based on the program parameters.

A comparison window includes reference to a segment of any one of the number of contiguous positions falling in the range of about 20 to about 600, usually from about 50 to about 200, more usually from about 100 to about 150 in which a sequence may be compared to a reference sequence of the same number of contiguous positions after the two sequences are optimally aligned. Methods of alignment of sequences for comparison are well-known in the art. Optimal alignment of sequences for comparison can be conducted, e.g., by the local homology algorithm of Smith &Waterman, Adv Appl Math 2:482, 1981, by the homology alignment algorithm of Needleman and Wunsch, J Mol Biol 48:443, 1970, by the search for similarity method of person & Lipman, Proc. Nat'l. Acad. Sci. USA 85:2444,1988, by computerized implementations of these algorithms (GAP, BESTFIT, FASTA, and TFASTA in the Wisconsin Genetics Software Package, Genetics Computer Group, 575 Science Dr., Madison, Wis.), by manual alignment and visual inspection, and the like. Other algorithms for determining homology or identity include, for example, BLAST (Basic Local Alignment Search Tool), ALIGN, AMAS (Analysis of Multiply Aligned Sequences), AMPS (Protein Multiple Sequence Alignment), ASSET (Aligned Segment Statistical Evaluation Tool), BANDS, BESTSCOR, BIOSCAN (Biological Sequence Comparative Analysis Node), BLIMPS (BLocks IMProved Searcher), FASTA, Intervals &Points, BMB, CLUSTAL V, CLUSTAL W, CONSENSUS, LCONSENSUS, WCONSENSUS, Smith-Waterman algorithm, DARWIN, Las Vegas algorithm, FNAT (Forced Nucleotide Alignment Tool), Framealign, Framesearch, DYNAMIC, FILTER, FSAP (Fristensky Sequence Analysis Package), GAP (Global Alignment Program), GENAL, GIBBS, GenQuest, ISSC (Sensitive Sequence Comparison), LALIGN (Local Sequence Alignment), LCP (Local Content Program), MACAW (Multiple Alignment Construction & Analysis Workbench), MAP (Multiple Alignment Program), MBLKP, MBLKN, PIMA (Pattern-Induced Multi-sequence Alignment), SAGA (Sequence Alignment by Genetic Algorithms) and WHAT-IF. Such alignment programs can also be used to screen genome databases to identify polynucleotide sequences having substantially identical sequences. A number of genome databases are available.

Software for performing BLAST analyses is publicly available through the National Center for Biotechnology Information (http://www.ncbi.nlm.nih. gov). This algorithm involves first identifying high scoring sequence pairs (HSPs) by identifying short words of length W in the query sequence, which either match or satisfy some positive-valued threshold score T when aligned with a word of the same length in a database sequence. T is referred to as the neighborhood word score threshold (Altschul et al., supra). These initial neighborhood word hits act as seeds for initiating searches to find longer HSPs containing them. The word hits are extended in both directions along each sequence for as far as the cumulative alignment score can be increased. Cumulative scores are calculated using, for nucleotide sequences, the parameters M (reward score for a pair of matching residues; always >0). For amino acid sequences, a scoring matrix is used to calculate the cumulative score. Extension of the word hits in each direction are halted when: the cumulative alignment score falls off by the quantity X from its maximum achieved value; the cumulative score goes to zero or below, due to the accumulation of one or more negative-scoring residue alignments; or the end of either sequence is reached. The BLAST algorithm parameters W, T, and X determine the sensitivity and speed of the alignment. The BLASTN program (for nucleotide sequences) uses as defaults a wordlength (W) of 11, an expectation (E) of 10, M=5, N=−4 and a comparison of both strands. For amino acid sequences, the BLASTP program uses as defaults a wordlength of 3, and expectations (E) of 10, and the BLOSUM62 scoring matrix (see Henikoff &Henikoff, Proc. Natl. Acad. Sci. USA 89:10915,1989) alignments (B) of 50, expectation (E) of 10, M=5, N=−4, and a comparison of both strands.

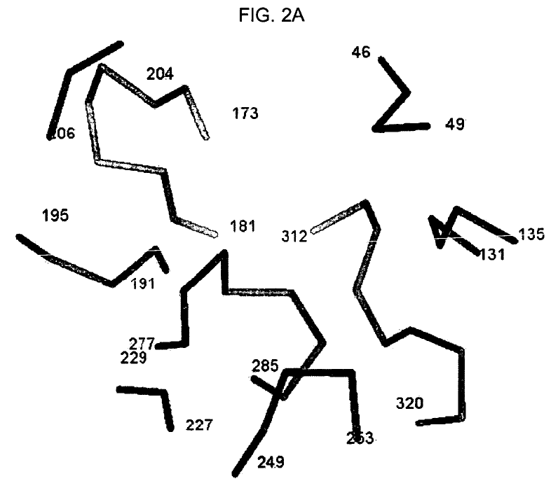

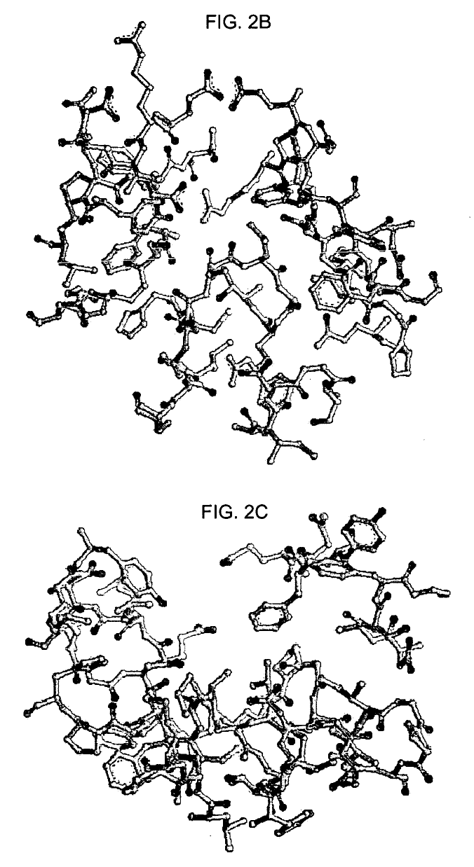

The disclosure provides a functional model based upon the crystal structure coordinates of cdc14A. Accordingly, the structure coordinates of cdc14A, or portions thereof, as provided by this disclosure are particularly useful to assist in solving the structure of a cdc14 (A or B) mutant. As discussed above, cdc14A shares a great deal of homology and identity with cdc14B. A sequence alignment of the cdc14A and B polypeptide sequences demonstrates the conserved nature of the two molecules (See FIGS. 1A-1B). Because cdc14A and B share conservation within their putative catalytic binding domains, a binding agent of a cdc14A catalytic binding domain identified by the crystal structure coordinates provided herein, may interact with a catalytic binding domain of cdc14B. For example, referring to FIG. 1A and FIG. 1B it will be apparent that the active sites of both cdc14A and B comprise, (from N- to C-) HCKAGLGRT (e.g., SEQ ID NO:2 from amino acid 277-285 (atom 2205 through atom 2268 as shown in Table 2); SEQ ID NO:8 from 313-321, respectively) in a central loop (FIGS. 2A-2C) comprising a catalytic cysteine residue. Other loop sections surround this central loop of cdc14A and B as set forth in Table 1 below:

TABLE 1

| SEQ ID NO: | amino acids | sequence |
|---|---|---|
| 2, 4, 6 | 46-49 | ENFY |
| 2, 4, 6 | 131-135 | DASFG |
| 2, 4, 6 | 173-181 | ERVENGDFN |
| 2, 4, 6 | 191-195 | FSGPH |
| 2, 4, 6 | 204-206 | YPL |
| 2, 4, 6 | 227-229 | LNK |
| 2, 4, 6 | 249-253 | FIDGS |
| 2, 4, 6 | 312-320 | RPGSIIGPQ |
| 8, 10, 12 | 83-86 | ENFY |
| 8, 10, 12 | 167-172 | DAAYGS |
| 8, 10, 12 | 209-217 | EKAENGDLN |
| 8, 10, 12 | 227-231 | FCGPH |
| 8, 10, 12 | 240-242 | YHQ |
| 8, 10, 12 | 263-265 | LNK |
| 8, 10, 12 | 285-289 | FADGS |
| 8, 10, 12 | 348-356 | RPGSVIGPQ |

For the first time, the disclosure permits the use of molecular design techniques to design, select and synthesize chemical entities and compounds, including inhibitory compounds, substrates, and the like, capable of binding to a cdc14A polypeptide alone, or both to a cdc14A polypeptide and a cdc14B polypeptide, in whole or in part.

One aspect of the disclosure resides in obtaining crystals of the cdc14A polypeptide of sufficient quality to determine the three dimensional (tertiary) structure of the protein by X-ray diffraction methods. The knowledge obtained concerning the three-dimensional structure of cdc14A can be used to assist in the determination of the three-dimensional structure of other PTP proteins. Candidate binding agents can also be designed by various computer models as described herein. Based on the structural coordinates of the cdc14A polypeptide (i.e., the three dimensional protein structure), as described herein, small molecules or polypeptides that mimic the shape or configuration or are capable of interacting with, a catalytic domain of a cdc14 can be designed and synthesized to modulate cdc14 biological functions (e.g., modulate dephosphorylation). Further, the structural coordinates of cdc14 may be used to design candidate binding agents that bind to non-catalytic regions of cdc14. Such agents are sometimes called “allosteric” or “exosite” binding agents. Such allosteric binding agents are useful if they are able to cause a change in the conformation of the polypeptide thus modulating the biological activity of cdc14, even though no binding to the catalytic domain occurs. Accordingly, in one embodiment, the disclosure provides a method of “rational” drug design. Another approach to rational drug design is based on a lead compound that is discovered using high-throughput screens; the lead compound can be further modified based on a crystal structure of the binding domains of cdc14A. Such lead compounds and related variants are resynthesized and can be co-crystallized with cdc14A. Accordingly, another aspect of the disclosure is to provide material, which is a starting material in the rational design of drugs, which modulate the action of cdc14A.

The term “crystal structure coordinates” refers to mathematical coordinates derived from mathematical equations related to the patterns obtained from diffraction of a monochromatic beam of X-rays by the atoms (scattering centers) of a polypeptide in crystal form (e.g., a cdc14A polypeptide). The diffraction data are used to calculate an electron density map of the repeating unit of the crystal. The electron density maps are used to establish the positions of the individual atoms within the unit cell of the crystal. The crystal structure coordinates of a cdc14A polypeptide crystal having space group P₂₁₂₁₂ (have the unique unit cell dimensions of a=74 Å, b=81 Å, c=69 Å, and contain one protein molecule per asymmetric unit) are set forth in Table 2. The coordinates of the cdc14A polypeptide can also be obtained by means of computational analysis.

Various methods for crystallization are known in the art. Selenomethionine substitution refers to a method of producing a chemically modified form of a crystal of cdc14A. For example, and not by way of limitation, the cdc14A polypeptide can be expressed by bacteria in media that is depleted in methionine and supplemented with selenomethionine. Selenium can be thereby incorporated into the crystal in place of the sulfur of methionine. The location(s) of selenium are then determined by X-ray diffraction analysis of the crystal. This information is used to generate the phase information used to construct a three-dimensional structure of the protein.

Heavy atom derivatization refers to a method of producing a chemically modified form of a crystal of cdc14A. For example, a crystal is soaked in a solution containing heavy metal atom salts or organometallic compounds, which can diffuse through the crystal and bind to the surface of a polypeptide. The location(s) of the bound heavy metal atom(s) are determined by X-ray diffraction analysis of the soaked crystal. This information is used to generate the phase information used to construct a three-dimensional structure of the polypeptide.

The term “unit cell” refers to the simplest volume element that by repeated translation describes the crystal. The term “asymmetric unit” refers to the smallest non-repeating element of the unit cell.

The term “space group” refers to the combination of symmetry operators that when applied to the asymmetric unit describes the contents of the unit cell.

The methods of the disclosure allow the modeling and identification of binding agents that can interact with the catalytic domains of both cdc14A and cdc14B, or one catalytic domain (e.g., a cdc14A catalytic domain) but not a catalytic domain of the other polypeptide (e.g., a cdc14B). Furthermore, binding agents for binding domains of related PTPs that share at least 80%, 90%, 95%, 98% or 99% identity to a cdc14A polypeptide or its binding domain can be identified by the methods and systems of the disclosure. For example, the catalytic domain of a cdc14A polypeptide includes residues 277-285 of SEQ ID NO:2, and can involve the interaction of additional amino acids such as those identified in Table 1. The coordinates of the atoms associated with the crystal structure of the cdc14A polypeptide are provided in Table 2. More specifically, the atoms associated with the catalytic domain of cdc14A extend from atom 2205 through atom 2268 (i.e., amino acid 277 285 of SEQ ID NO:2). As used herein a “binding domain” includes a site (such as an atom, a functional group of an amino acid residue or a plurality of such atoms and/or groups) in a cdc14A binding cavity. In one aspect, the binding domain is a catalytic domain, which may interact with a binding agent (e.g., a substrate, an inhibitor or an activator). In another embodiment, a binding domain may be allosteric. Depending on the particular molecule in the cavity, sites may exhibit attractive or repulsive binding interactions, brought about by charge, steric considerations and the like.

One approach enabled by the disclosure is to use the structure coordinates as set forth in Table 2 to design binding agents that bind to a cdc14A polypeptide. The physical properties of the binding agent can be modified in different ways (e.g., to alter solubility). For example, the disclosure enables the design of binding agents that act as inhibitors or substrates of a PTP polypeptide by binding to the cdc14A molecule.

In another approach a cdc14A polypeptide crystal is contacted with a variety of different binding entities to determine optimal sites for interaction between candidate binding agents (e.g., inhibitors or substrates) and a cdc14A binding domain.

In another embodiment, an approach made possible and enabled by the disclosure, is to screen computationally small molecule databases for putative binding entities that can bind in whole, or in part, to a cdc14A polypeptide or fragment thereof. In such screening, the quality of fit of such a binding entity to the binding domain may be judged in a variety of ways, e.g., by shape complementarity or by estimated interaction energy (Meng et al., J Comp Chem, 13:505-524, 1992). Candidate binding agents can then be synthesized using conventional methods and tested for cdc14 binding using conventional methods or using those methods described herein.

In addition, a cdc14A polypeptide mutant may be crystallized in association or complex with known binding agents, substrates, or inhibitors. The crystal structures of a series of such complexes may then be solved by molecular replacement and compared with that of a wild-type cdc14 molecule. Potential sites for modification within the cdc14 molecule may thus be identified. This information provides an additional tool for determining the most efficient binding interactions, for example, increased hydrophobic interactions, between a cdc14 polypeptide and a candidate binding agent or compound.

All of the complexes referred to above may be studied using known X-ray diffraction techniques and may be refined versus 2-3 Å resolution X-ray data to an R value of about 0.20 or less using computer software, such as X-PLOR (Yale University, 1992, distributed by Molecular Simulations, Inc.; see also, Methods in Enzymology, vol. 114 and 115, H. W. Wyckoff et al., eds., Academic Press (1985)). This information may thus be used to design, synthesize and optimize cdc14 binding agents (e.g., inhibitors or substrates).

The design of binding agents that bind to or inhibit a cdc14A polypeptide according to the disclosure generally involves consideration of two factors. First, the binding agent should be capable of physically and structurally associating with a cdc14A polypeptide. Non-covalent molecular interactions, important in the association of a PTP with a substrate, include hydrogen bonding, van der Waals and electrostatic interactions, and the like. Second, the binding agent should be able to assume a conformation that allows it to associate with a cdc14A polypeptide. Although certain portions of the binding agent will not directly participate in the association, those portions may still influence the overall conformation of the polypeptide. This, in turn, may have a significant impact on potency, and/or pharmacokinetic properties. Such conformational requirements include the overall three-dimensional structure and orientation of the binding agent in relation to all or a portion of the binding domain, e.g., active site or accessory binding site of a cdc14A polypeptide, or the spacing between functional groups of a compound comprising several chemical entities that directly interact with cdc14A.

The potential inhibitory or binding effect of a binding agent on cdc14A may be analyzed prior to its actual synthesis and testing by the use of computer modeling techniques as described herein or those known in the art using information provided herein. If the theoretical structure of the candidate or test binding agent has insufficient interaction and association between the binding agent and cdc14A, synthesis and testing of the binding agent may be obviated. However, if computer modeling indicates a potentially strong interaction, the binding agent may then be synthesized and tested for its ability to bind to cdc14A. Whether or not the binding agent possesses cdc14A or cdc14B inhibitory or modulating characteristics can be determined through routine assays. Methods of assaying for cdc14 activity are known in the art (as identified and discussed herein).

A candidate or test binding agent of cdc14A or cdc14B polypeptide may be computationally evaluated and designed by means of a series of steps in which putative binding agents are screened and selected for their ability to associate with the catalytic domain or other areas of cdc14.

One skilled in the art may use one of several methods to screen candidate binding agents for their ability to associate with a cdc14 polypeptide. This process may begin by visual inspection of, for example, the catalytic domain on a computer screen based on the cdc14A coordinates provided in Table 2 using methods and equipment described above and elsewhere herein; or used routinely in the art. A computer model of a selected binding agent may then be positioned in a variety of orientations, or docked, within an individual binding pocket. Docking may be accomplished using software such as, and without limitation, QUANTA and SYBYL, followed by energy minimization and molecular dynamics with standard molecular mechanics force fields, such as, and without limitation, CHARM and AMBER.

Specialized computer programs may also assist in the process of selecting candidate binding agents. These include but are not limited to:
1. GRID (Goodford, P. J., “A Computational Procedure for Determining Energetically Favorable Binding Sites on Biologically Important Macromolecules”, Med. Chem., 28, pp. 849-857 (1985)). GRID is available from Oxford University, Oxford, UK.
2. MCSS (Miranker, A. and M. Karplus, “Functionality Maps of Binding Sites: A Multiple Copy Simultaneous Search Method.” Proteins: Structure. Function and Genetics, 11, pp. 29-34 (1991)). MCSS is available from Molecular Simulations, Burlington, Mass.
3. AUTODOCK (Goodsell, D. S. and A. J. Olsen, “Automated Docking of Substrates to Proteins by Simulated Annealling, Proteins: Structure. Function, and Genetics, 8, pp. 195-202 (1990)). AUTODOCK is available from Scripps Research Institute, La Jolla, Calif.
4. DOCK (Kuntz, I. D. et al., “A Geometric Approach to Macromolecule-Ligand Interactions”, J. Mol. Biol., 161, pp. 269-288 (1982)). DOCK is available from The University of California, San Francisco, Calif.

Where fragments of candidate binding agents are modeled, those fragments can be altered using computer programs. Useful programs to aid one of skill in the art in connecting the individual fragments include:
1. CAVEAT (Bartlett, P. A. et al, “CAVEAT: A Program to Facilitate the Structure-Derived Design of Biologically Active Molecules”. In “Molecular Recognition in Chemical and Biological Problems”, Special Pub., Royal Chem. Soc., 78, pp. 182-196 (1989)). CAVEAT is available from the University of California, Berkeley, Calif.
2. Database systems such as MACCS-31) (MDL Information Systems, San Leandro, Calif.). This area is reviewed in Martin, Y. C., “31) Database Searching in Drug Design. Med. Chem., 35, pp. 2145-2154 (1992)).
3. HOOK (available from Molecular Simulations, Burlington, Mass.).

In addition to the method of building or identifying a binding agent in a step-wise fashion one fragment (or moiety) or chemical entity at a time as described above, or as otherwise known in the art, candidate binding agents may be designed as a whole or “de novo” using either an empty active site or optionally including some portion(s) of a known binding site, using methods, such as and without limitation:
1. LUDI (Bohm, et al., “The Computer Program LUDI: A New Method for the De Novo Design of Enzyme Inhibitors”, J. Comp. Aid. Molec. Design, 6, pp. 61-78 (1992)). LUDI is available from Biosym Technologies, San Diego, Calif.
2. LEGEND (Nishibata, Y. and A. Itai, Tetrahedron, 47, p. 8985 (1991)). LEGEND is available from Molecular Simulations, Burlington, Mass.
3. LeapFrog (available from Tripos Associates, St. Louis, Mo.).

Other molecular modeling techniques may also be employed in accordance with this disclosure. See, e.g., Cohen, N. C. et al., “Molecular Modeling Software and Methods for Medicinal Chemistry”, J. Med. Chem., 33, pp. 883-894 (1990). See also, Navia, M. A. and M. A. Murcko, “The Use of Structural Information in Drug Design, Current Opinions in Structural Biology,” 2, pp. 202-210 (1992).

Once a compound or binding agent has been designed or selected by the above methods, the potency with which that binding agent may bind to cdc14 may be tested and optimized by computational evaluation.

A candidate or test binding agent or compound designed or selected as cdc14A candidate binding agent may be further computationally optimized so that in its bound state it would lack repulsive electrostatic interaction with the target binding site. Such non-complementary (e.g., electrostatic) interactions include repulsive charge-charge, dipole-dipole and charge-dipole interactions. Specifically, the sum of all electrostatic interactions between the binding agent and cdc14A when the binding agent is bound to cdc14A, should have a neutral or favorable contribution to the enthalpy of binding.

Specific computer software is available in the art to evaluate compound deformation energy and electrostatic interaction. Examples of programs designed for such uses by way of non-limiting example include: Gaussian 92, revision C (M. J. Frisch, Gaussian, Inc., Pittsburgh, Pa., 1992); AMBER, version 4.0 (P. A. Kollman, University of California at San Francisco, 1994); QUANTA/CHARMM (Molecular Simulations, Inc., Burlington, Mass. 1994); and Insight H/Discover (Biosysm Technologies Inc., San Diego, Calif., 1994). These programs may be implemented, for example, using a Silicon Graphics workstation, IRIS 4D/35 or IBM RISC/6000 workstation model 550. Other hardware systems and software packages will be known to those skilled in the art of which the speed and capacity are frequently modified.

Once a candidate binding agent has been selected or designed, as described above, substitutions may then be made in some of its atoms or side groups in order to improve or modify the binding properties. Generally, initial substitutions are conservative, e.g., the replacement group will have approximately the same size, shape, hydrophobicity and charge as the original group. Such substituted binding agents may then be analyzed for efficiency of fit to a cdc14A binding domain by the same computer methods described, above. Other changes may not be conservative and can be used to test groups of differing sizes, charges, and the like.

Using the invention disclosed herein, those of skill in the art may identify binding agents or modulatory agents as inhibitors or activators by computer fitting kinetic data using standard equations according to Segel, I. H., Enzyme Kinetics, J. Wiley &Sons, (1975).

In one aspect, once a test binding agent has been modeled and synthesized, it can be soaked and then co-crystallized with a cdc14A polypeptide. The co-crystallization data comprising atomic coordinates can then be analyzed via computer to generate a 3D image of the test agent interacting or associating with the cdc14A polypeptide. Analysis of the interaction data can lead to the design of a more productive structure-activity-relationship analysis (commonly referred to in the art as “SAR”), or medicinal chemistry. An iterative process of co-crystallization, analysis, further SAR, can greatly enhance the rate at which rational drug design is performed. Described herein are methods of performing “soaks” to obtain co-crystallization data. Further provided are co-crystals of a complex comprising a cdc14A polypeptide and a binding agent.

The crystal structure data provided herein can be used in the design of new or improved binding agents. For example, the cdc14A polypeptide coordinates can be directly compared to the coordinates of similar enzymes that have inhibitors or substrate bound thereto to give an approximation of the way these and related inhibitors might bind to cdc14A. For example, the crystal structure of cdc14A (disclosed) can be overlaid with the crystal structure of cdc14B (see, e.g., EMBO J. 22(14):3524-35, 2003).

Alternatively, computer programs employed in the practice of rational drug design can be used to identify binding agents that reproduce interaction characteristics similar to those found between a cdc14A polypeptide and a co-crystallized binding agent (e.g., a substrate or inhibitor). Furthermore, detailed knowledge of the nature of binding site interactions allows for the modification of binding agents to alter or improve solubility, pharmacokinetics, and the like, without affecting binding activity. Such modifications can be made using known techniques.

Computer programs are widely available that are capable of carrying out the activities necessary to design binding agents using the crystal structure information provided herein. Examples include, but are not limited to, the computer programs listed below:
Catalyst Database^{STM}—an information retrieval program accessing chemical databases such as BioByte Master File, Derwent WDI and ACD;
Catalyst/HYPO™—generates models of compounds and hypotheses to explain variations of activity with the structure of binding candidates;
Ludi™—fits molecules into the active site of a protein by identifying and matching complementary polar and hydrophobic groups;
Leapfrog™—“grows” new ligands using a genetic algorithm with parameters under the control of the user.

In addition, various general purpose machines may be used with programs written in accordance with the teachings herein, or it may be more convenient to construct more specialized apparatus to perform the operations. However, the embodiment will typically be implemented in one or more computer programs executing on programmable systems each comprising at least one processor, at least one data storage system (including volatile and non-volatile memory and/or storage elements), at least one input device, and at least one output device. The program is executed on the processor to perform the functions described herein.

Each such program may be implemented in any desired computer language (including machine, assembly, high level procedural, or object oriented programming languages) to communicate with a computer system. In any case, the language may be a compiled or interpreted language. The computer program will typically be stored on a storage media or device (e.g., ROM, CD-ROM, or magnetic or optical media) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

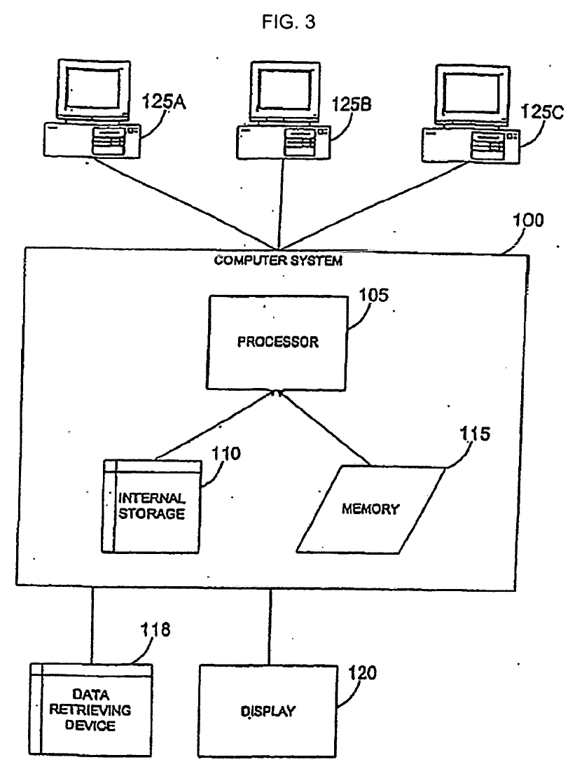

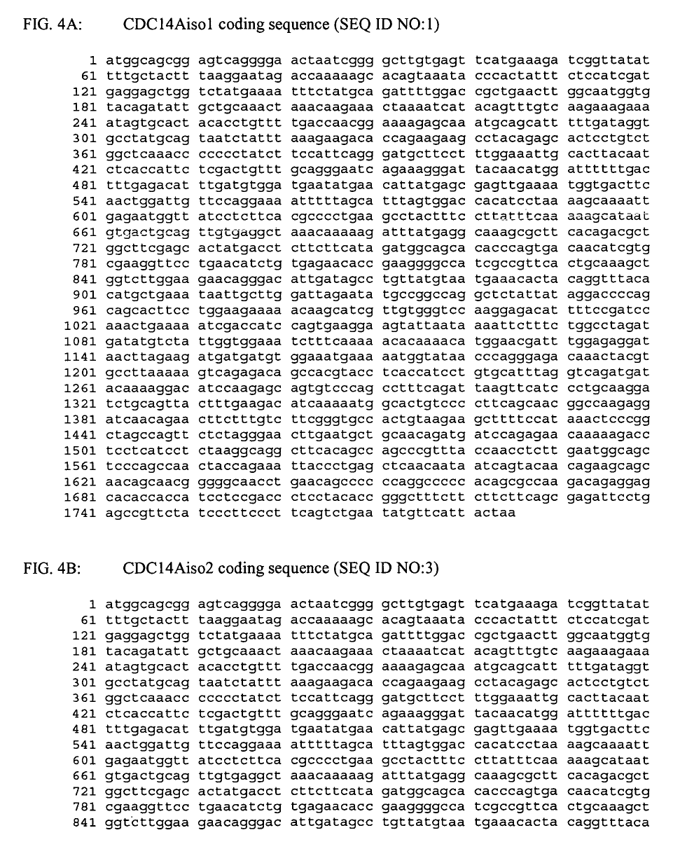

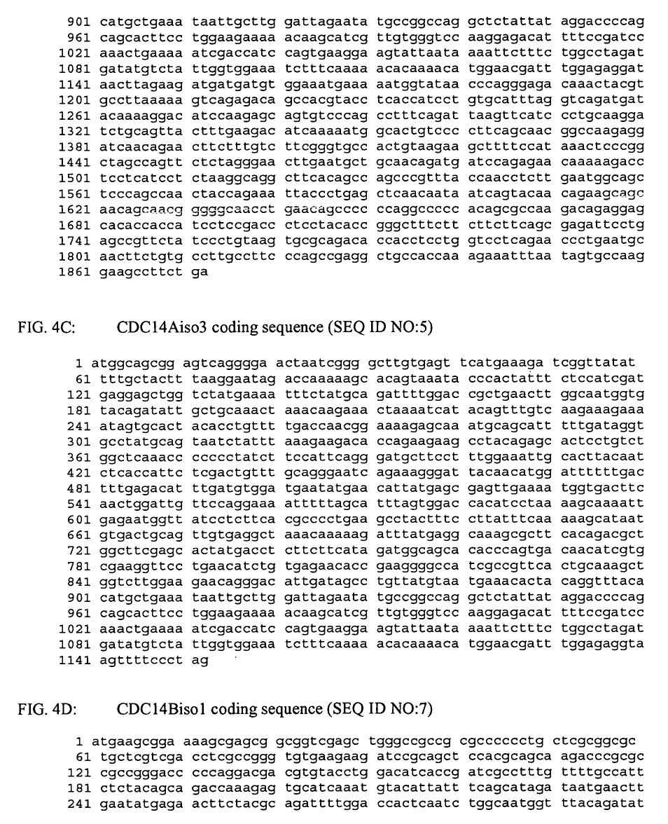

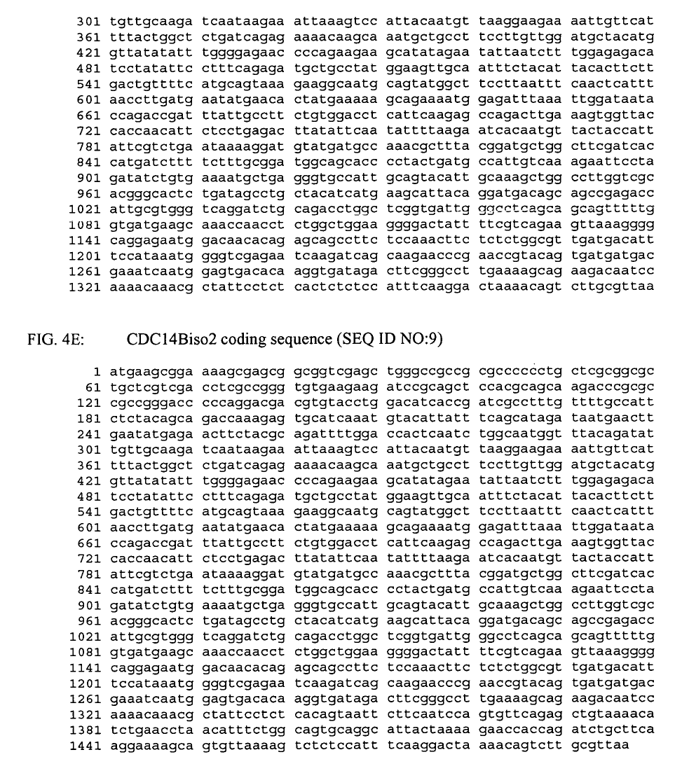

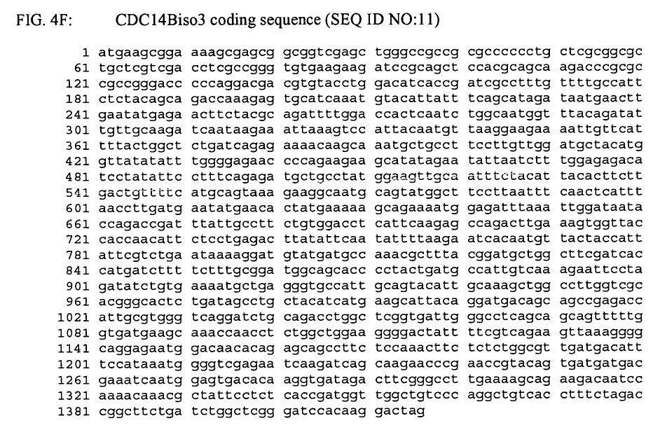

Embodiments of the disclosure include systems (e.g., internet based systems), particularly computer systems which store, display and manipulate the coordinate and sequence information described herein. One example of a computer system 100 is illustrated in block diagram form in FIG. 3. As used herein, “a computer system” refers to the hardware components, software components, and data storage components used to analyze the coordinates (see, e.g., Table 2) and sequences such as those set forth in SEQ ID Nos: 2, 4, 6, 8, 10, 12, and Table 2. The computer system 100 typically includes a processor for processing, e.g., data and instructions, accessing and manipulating the sequence data and structural coordinates. The processor 105 can be any well-known type of central processing unit, such as, for example, the Pentium IV from Intel Corporation, or a similar processor from other suppliers such as Sun, Motorola, Compaq, AMD or International Business Machines.

Typically the computer system 100 is a general purpose system that comprises the processor 105 and one or more internal data storage components 110 for storing data, and one or more data retrieving devices for retrieving the data stored on the data storage components. A skilled artisan can readily appreciate that any one of the currently available computer systems are suitable.

In one particular embodiment, the computer system 100 includes a processor 105 connected to a bus which is connected to a main memory 115 (typically implemented as RAM) and one or more internal data storage devices 110, such as a hard drive and/or other computer readable media having data recorded thereon. In some embodiments, the computer system 100 further includes one or more data retrieving means 118 for reading the data stored on the internal data storage means 110. The data retrieving means 118 may represent, for example, a floppy disk drive, a compact disk drive, a magnetic tape drive, or means for connecting to external data-retrieving means, such as ethernet, a modem capable of connection to a remote data storage system (e.g., via the internet), and the like. In some embodiments, the internal data storage means 110 is a removable computer readable medium such as a floppy disk, a compact disk, a magnetic tape, and the like, containing control logic and/or data recorded thereon. The computer system 100 may advantageously include or be programmed by appropriate software for reading the control logic and/or the data from the data storage component once inserted in the data retrieving means or device.

The computer system 100 includes a display means 120 which is used to display output, such as for example a three-dimensional model of a crystalline cdc14A polypeptide, or a complex comprising the crystalline cdc14A polypeptide with a candidate binding agent, to a computer user. It should also be noted that the computer system 100 can be linked to other computer systems 125a-c in a network or wide area network to provide centralized access to the computer system 100.

Software for accessing and processing the coordinates of Table 2 and sequences of SEQ ID Nos:2, 4, 6, 8, 10, 12 and Table 1 (such as search tools, compare tools, modeling tools and the like) may reside in main memory 115 during execution.

According to the disclosure, substrates of cdc14A may include full length tyrosine phosphorylated proteins and polypeptides as well as fragments (e.g., portions), derivatives or analogs thereof that can be phosphorylated at a tyrosine residue and that may, in certain embodiments, also be able to undergo phosphorylation at a serine or a threonine residue. Such fragments, derivatives and analogs include any naturally occurring or artificially engineered cdc14A substrate polypeptide that retains at least the biological function of interacting with a cdc14A as provided herein, for example by forming a complex with a cdc14A polypeptide.

cdc14A polypeptides may be tested for cdc14A activity using any suitable assay, e.g., for p53 and/or APC activity. For example, cdc14A binds p53 and dephosphorylate pSer-315 in vitro (Li et al., J Biol Chem 275:2410-2414, 2002). A recent study demonstrated that cdc14A dephosphorylates the APC regulatory protein Cdh1 in vitro and that dephosphorylated APCCdh1 has activated ubiquitination of cyclin-B1 (Bembenek and Yu, J Biol Chem, 276:48237-48242, 2001). Such assays may be performed in vitro or within a cell-based assay. For example, ³²P-radiolabeled substrate (e.g., p53 or APC) may be used for the kinase reaction, resulting in radiolabeled, activated protein. A cdc14A polypeptide may then be tested (in the presence and absence of an inhibitor) for the ability to dephosphorylate a p53 or APC by contacting the cdc14A polypeptide with the p53 or APC under conditions sufficient to promote dephosporylation of p53 or APC. Dephosphorylation of the APC, for example, may be detected by measuring ubiquitination of cyclin-B1 or measuring the loss of radioactive phosphate groups by (1) gel electrophoresis, followed by autoradiography; (2) the shift in electrophoretic mobility following dephosphorylation; (3) the loss of reactivity with an antibody specific for phosphotyrosine or phosphothreonine; or (4) a phosphoamino acid analysis of the p53 or APC protein. Modulation of a cdc14A activity can be determined by measuring the dephosphorylation activity in the presence and absence of binding agents identified by the methods of the disclosure. For example, a difference in cdc14A polypeptide dephosphorylation of a p53 or APC or a phosphorylated substrate (such as a tyrosine-, serine-, and/or threonine phosphorylated peptide) in the presence of a binding agent that is greater or less than the amount of dephosphorylation observed in the presence of a comparable amount of native human cdc14A is indicative of a binding agent that modulates cdc14A activity. It will be apparent that other substrates (i.e., binding agents) identified by the methods of the disclosure can be assayed in a similar manner as described herein for p53 or APC, or by using methods known in the art.

Candidate binding agents for use in a method of screening for a modulator of cdc14A according to the disclosure may be provided as “libraries” or collections of compounds, compositions or molecules. Such molecules typically include compounds known in the art as “small molecules” and having molecular weights less than 10⁴, less than 10³ and preferably less than 10². For example, candidate binding agents will typically have a molecular weight of 300-1000, typical for small molecule agents. For example, members of a library of test compounds can be administered to a plurality of samples, each containing at least one cdc14A polypeptide as provided herein, and then assayed for their ability to enhance or inhibit cdc14A-mediated dephosphorylation of, or binding to, a substrate. Compounds so identified as capable of modulating cdc14A function (e.g., phosphotyrosine and/or phosphoserine/threonine dephosphorylation) are valuable for potential therapeutic and/or diagnostic purposes, since they may permit treatment and/or detection of diseases associated with cdc14A activity. Such compounds are also valuable in research directed to molecular signaling mechanisms that involve cdc14A, and to refinements in the discovery and development of future cdc14A compounds exhibiting greater specificity.

Candidate binding agents further may be provided as members of a combinatorial library, which includes synthetic agents prepared according to a plurality of predetermined chemical reactions performed in a plurality of reaction vessels. For example, various starting compounds may be prepared employing one or more of solid-phase synthesis, recorded random mix methodologies and recorded reaction split techniques that permit a given constituent to traceably undergo a plurality of permutations and/or combinations of reaction conditions. The resulting products comprise a library that can be screened followed by iterative selection and synthesis procedures, such as a synthetic combinatorial library of peptides or other compositions that may include small molecules as provided herein (see e.g., PCT/US94/08542, EP 0774464, U.S. Pat. No. 5,798,035, U.S. Pat. No. 5,789,172, U.S. Pat. No. 5,751,629, which are hereby incorporated by reference in their entireties). Those having ordinary skill in the art will appreciate that a diverse assortment of such libraries may be prepared according to established procedures, and tested using cdc14A according to the present disclosure, by first modeling similar compounds and then testing likely candidates in vitro.

In certain embodiments, binding agents may be identified by combining a candidate binding agent with a cdc14A polypeptide in vitro or in vivo, and evaluating the effect of the candidate binding agent on the cdc14A phosphatase activity using, for example, a representative assay described herein. An increase or decrease in phosphatase activity can be measured by performing a representative assay provided herein in the presence and absence of a candidate binding agent. Briefly, a candidate binding agent is modeled using the structural coordinates of a catalytic domain of cdc14A. Likely candidate binding agents that interact in silico may be included in a mixture of active cdc14A polypeptide and substrate (e.g., a phosphorylated p53 or APC), with or without pre-incubation with one or more components of the mixture. The effect of the agent on cdc14A activity may then be evaluated by quantifying the loss of phosphate from the substrate, and comparing the loss with that achieved using cdc14A without the addition of a candidate binding agent.

Cdc14A activity may also be measured in whole cells transfected with a reporter gene whose expression is dependent upon the activation of an appropriate substrate. For example, appropriate cells (i.e., cells that express cdc14A) may be transfected with a substrate-dependent promoter linked to a reporter gene. In such a system, expression of the reporter gene (which may be readily detected using methods well known to those of ordinary skill in the art) depends upon activation of substrate. Dephosphorylation of substrate may be detected based on a decrease in reporter activity. Candidate modulating agents may be added to such a system, as described above, to evaluate their effect on cdc14A activity.

In another aspect, once an agent has been identified as a suitable binding agent using the in silico methods described herein, standard binding assays such as yeast two-hybrid screens, phage display and affinity techniques can be used to determine in vitro the ability of the binding agent to interact with cdc14A in vitro. Such techniques may be performed using routine protocols, which are well known to those having ordinary skill in the art (see, e.g., Bartel et al., In Cellular Interactions in Development: A Practical Approach, D. A. Harley, ed., Oxford University Press (Oxford, UK), pp. 153-179, 1993).

The invention will now be described by reference to the following non-limiting examples.

### EXAMPLES

Methods of Crystallization. Crystals were grown by the hanging-drop vapor-diffusion method. Purified cdc14A (10-339aa of SEQ ID NO:2) protein was concentrated to ˜10 mg/ml (0.33 mM) in a buffer containing 700 mM NaCl, 20 mM Tris (7.2), 1 mM EDTA, and 2 mM DTT, and stored at −80° C. Drops consisting of 2 μl of protein solution were mixed with 2 μl of reservoir solution (200-250 mM MgCl₂, 50 mM Tris (8.0), 16-18% PEG 8000, 5 mM DTT) on a coverslip. The coverslip was inverted and allowed to equilibrate over a 0.5 ml reservoir at 23° C. A greased seal isolated the hanging drop and the reservoir solution from the exterior environment. Over the course of several days the hanging drop equilibrated to the same osmotic strength as the reservoir and small protein crystals appeared (80×80×400 mm³) After crystals were identified and selected for exposure to X-rays, they were transferred first to a cryo-solution and then flash-cooled. The cryo-solution is identical to the reservoir solution except that the PEG 8000 is increased ˜5% and 10% 2-methyl-2,4-pentanediol (MPD) is included to impede ice formation.

The crystals belong to the space group P₂₁₂₁₂, have unit cell dimensions of a=74 Å, b=81 Å, c=69 Å, and contain one protein molecule per asymmetric unit.

The active site is comprised of a central loop, amino acid residues 277 to 285 (atom 2205 through atom 2268 as shown in Table 2), which contains the catalytic cysteine 278, as well as several additional loop sections that surround the central loop and provide residues for making specific contacts to substrates and inhibitors. The additional loop sections are comprised of residues 46 to 49, 131 to 135, 173 to 181, 191 to 195, 204 to 206, 227 to 229, 249 to 253, and 312 to 320 (see, e.g., FIG. 2A-2C).

Methods for soaking candidate binding agents into the active site: Crystals were stabilized in a solution comprising approximately 50 mM Tris (8.0), 25 mM MgCl₂, 50 mM NaCl, 5 mM DTT, 10% MPD, and 20% PEG8000 overnight. These crystals were then transferred to an identical solution that contains about 4-10 mM of candidate binding agent. After equilibrating for several hours in the candidate binding agent-containing solution, crystals were flash-cooled by plunging into liquid nitrogen. X-ray diffraction data was collected on a Raxis IV using 1.54 Å wavelength CuKα X-rays generated from a rotating anode. Crystals were mounted in cryoloops and maintained at about 150 K (−120° C.) throughout the data collections in a cryo stream. After the diffraction data were collected, the images were processed and reduced to a scaled and indexed set of unique intensities. The protein structural content of the unit cell was then determined by molecular replacement technique. For cdc14A, the initial search model is the homologous protein cdc14B (Pdb accession number:1OHC). After the correct rotation and translation has been applied to the search model, subsequent rounds of conventional refinement and manual model building are performed.

| COMPND | - - - | | | |
|---|---|---|---|---|
| REMARK | 3 | | | |
| REMARK | 3 | REFINEMENT. | | |
| REMARK | 3 | PROGRAM : REFMAC 5.1.24 | | |
| REMARK | 3 | | | |
| REMARK | 3 | REFINEMENT TARGET: MAXIMUM LIKELIHOOD | | |
| REMARK | 3 | | | |
| REMARK | 3 | DATA USED IN REFINEMENT. | | |
| REMARK | 3 | RESOLUTION RANGE HIGH | (ANGSTROMS) | : 2.40 |
| REMARK | 3 | RESOLUTION RANGE LOW | (ANGSTROMS) | : 30.00 |
| REMARK | 3 | DATA CUTOFF | (SIGMA(F)) | : NONE |
| REMARK | 3 | COMPLETENESS FOR RANGE | (%) | : 90.90 |
| REMARK | 3 | NUMBER OF REFLECTIONS | | : 14069 |
| REMARK | 3 | | | |

| REMARK | 3 | FIT TO DATA USED IN REFINEMENT. | | |
|---|---|---|---|---|
| REMARK | 3 | CROSS-VALIDATION METHOD | | : THROUGHOUT |
| REMARK | 3 | FREE R VALUE TEST SET SELECTION | | : RANDOM |
| REMARK | 3 | R VALUE | (WORKING + TEST SET) | : 0.19653 |
| REMARK | 3 | R VALUE | (WORKING SET) | : 0.19159 |

| REMARK | 3 | FREE R VALUE | | : 0.29120 |
|---|---|---|---|---|
| REMARK | 3 | FREE R VALUE TEST SET SIZE | (%) | : 5.0 |
| REMARK | 3 | FREE R VALUE TEST SET COUNT | | : 747 |
| REMARK | 3 | | | |

| REMARK | 3 | FIT IN THE HIGHEST RESOLUTION BIN. | | |
|---|---|---|---|---|
| REMARK | 3 | TOTAL NUMBER OF BINS USED | | : 20 |
| REMARK | 3 | BIN RESOLUTION RANGE HIGH | | : 2.400 |
| REMARK | 3 | BIN RESOLUTION RANGE LOW | | : 2.462 |
| REMARK | 3 | REFLECTION IN BIN | (WORKING SET) | : 602 |
| REMARK | 3 | BIN R VALUE | (WORKING SET) | : 0.207 |

| | | | |
|---|---|---|---|
| REMARK | 3 | BIN FREE R VALUE SET COUNT | : 27 |
| REMARK | 3 | BIN FREE R VALUE | : 0.290 |
| REMARK | 3 | | |

| REMARK | 3 | NUMBER OF NON-HYDROGEN ATOMS USED IN REFINEMENT. | |
|---|---|---|---|
| REMARK | 3 | ALL ATOMS | : 2796 |
| REMARK | 3 | | |
| REMARK | 3 | B VALUES. | |

| | | | | |
|---|---|---|---|---|
| REMARK | 3 | FROM WILSON PLOT | (A**2) | : NULL |
| REMARK | 3 | MEAN B VALUE | (OVERALL, A**2) | : 32.190 |

| REMARK | 3 | OVERALL ANISOTROPIC B VALUE. | | |
|---|---|---|---|---|
| REMARK | 3 | B11 (A**2): 2.14 | | |
| REMARK | 3 | B22 (A**2): −1.73 | | |
| REMARK | 3 | B33 (A**2): −0.41 | | |
| REMARK | 3 | B12 (A**2): 0.00 | | |
| REMARK | 3 | B13 (A**2): 0.00 | | |
| REMARK | 3 | B23 (A**2): 0.00 | | |
| REMARK | 3 | | | |
| REMARK | 3 | ESTIMATED OVERALL COORDINATE ERROR. | | |
| REMARK | 3 | ESU BASED ON R VALUE | (A): | 0.475 |
| REMARK | 3 | ESU BASED ON FREE R VALUE | (A): | 0.327 |
| REMARK | 3 | ESU BASED ON MAXIMUM LIKELIHOOD | (A): | 0.209 |
| REMARK | 3 | ESU FOR B VALUES BASED ON MAXIMUM LIKELIHOOD | (A**2): | 9.079 |
| REMARK | 3 | | | |
| REMARK | 3 | CORRELATION COEFFICIENTS. | | |

| | | | |
|---|---|---|---|
| REMARK | 3 | CORRELATION COEFFICIENT FO-FC | : 0.934 |
| REMARK | 3 | CORRELATION COEFFICIENT FO-FC FREE | : 0.834 |
| REMARK | 3 | | |

| REMARK | 3 | RMS DEVIATIONS FROM IDEAL VALUES | | COUNT | RMS | WEIGHT |
|---|---|---|---|---|---|---|
| REMARK | 3 | BOND LENGTHS REFINED ATOMS | (A): | 2783 ; | 0.023 ; | 0.021 |
| REMARK | 3 | BOND ANGLES REFINED ATOMS | (DEGREES): | 3763 ; | 1.929 ; | 1.935 |
| REMARK | 3 | TORSION ANGLES, PERIOD 1 | (DEGREES): | 329 ; | 8.319 ; | 5.000 |
| REMARK | 3 | CHIRAL-CENTER RESTRAINTS | (A**3): | 387 ; | 0.145 ; | 0.200 |
| REMARK | 3 | GENERAL PLANES REFINED ATOMS | (A): | 2167 ; | 0.008 ; | 0.020 |

| | | | | | | |
|---|---|---|---|---|---|---|
| REMARK | 3 | NON-BONDED CONTACTS REFINED ATOMS | (A): | 1307 ; | 0.228 ; | 0.200 |
| REMARK | 3 | H-BOND (X...Y) REFINED ATOMS | (A): | 136 ; | 0.162 ; | 0.200 |
| REMARK | 3 | SYMMETRY VDW REFINED ATOMS | (A): | 45 ; | 0.238 ; | 0.200 |
| REMARK | 3 | SYMMETRY H-BOND REFINED ATOMS | (A): | 7 ; | 0.095 ; | 0.200 |
| REMARK | 3 | | | | | |
| REMARK | 3 | ISOTROPIC THERMAL FACTOR RESTRAINTS. | | COUNT | RMS | WEIGHT |
| REMARK | 3 | MAIN-CHAIN BOND REFINED ATOMS | (A**2): | 1643 ; | 0.993 ; | 1.500 |
| REMARK | 3 | MAIN-CHAIN ANGLE REFINED ATOMS | (A**2): | 2645 ; | 1.878 ; | 2.000 |
| REMARK | 3 | SIDE-CHAIN BOND REFINED ATOMS | (A**2): | 1140 ; | 2.923 ; | 3.000 |
| REMARK | 3 | SIDE-CHAIN ANGLE REFINED ATOMS | (A**2): | 1118 ; | 4.595 ; | 4.500 |
| REMARK | 3 | | | | | |

| REMARK | 3 | NCS RESTRAINTS STATISTICS | |
|---|---|---|---|
| REMARK | 3 | NUMBER OF NCS GROUPS: NULL | |
| REMARK | 3 | | |
| REMARK | 3 | | |
| REMARK | 3 | TLS DETAILS | |
| REMARK | 3 | NUMBER OF TLS GROUPS: NULL | |
| REMARK | 3 | | |
| REMARK | 3 | | |
| REMARK | 3 | BULK SOLVENT MODELLING. | |
| REMARK | 3 | METHOD USED: BABINET MODEL WITH MASK | |
| REMARK | 3 | PARAMETERS FOR MASK CALCULATION | |
| REMARK | 3 | VDW PROBE RADIUS | : 1.40 |
| REMARK | 3 | ION PROBE RADIUS | : 0.80 |
| REMARK | 3 | SHRINKAGE RADIUS | : 0.80 |
| REMARK | 3 | | |

| REMARK | 3 | OTHER REFINEMENT REMARKS: NULL | |
|---|---|---|---|
| REMARK | 3 | | |
| CISPEP | 1 | GLY A | 53 PRO A 54 0.00 |
| CISPEP | 2 | ASN A | 123 PRO A 124 0.00 |

| | |
|---|---|
| CRYST1 | 72.011 81.064 68.759 90.00 90.00 90.00 P 21 21 2 |
| SCALE1 | 0.013887 0.000000 0.000000 0.00000 |
| SCALE2 | 0.000000 0.012336 0.000000 0.00000 |
| SCALE3 | 0.000000 0.000000 0.014544 0.00000 |

| | | | | | | | | | | | |
|---|---|---|---|---|---|---|---|---|---|---|---|
| ATOM | 1 | N | SER | A | 9 | 19.662 | 57.726 | 8.709 | 1.00 | 62.15 | N |
| ATOM | 2 | CA | SER | A | 9 | 18.895 | 58.913 | 9.205 | 1.00 | 61.84 | C |
| ATOM | 3 | CB | SER | A | 9 | 18.424 | 59.804 | 8.019 | 1.00 | 62.25 | C |
| ATOM | 4 | OG | SER | A | 9 | 17.775 | 59.048 | 6.990 | 1.00 | 61.94 | O |
| ATOM | 5 | C | SER | A | 9 | 17.716 | 58.464 | 10.113 | 1.00 | 61.37 | C |
| ATOM | 6 | O | SER | A | 9 | 16.630 | 58.071 | 9.604 | 1.00 | 61.58 | O |
| ATOM | 7 | N | GLY | A | 10 | 17.954 | 58.521 | 11.438 | 1.00 | 60.06 | N |
| ATOM | 8 | CA | GLY | A | 10 | 17.016 | 58.110 | 12.492 | 1.00 | 57.88 | C |
| ATOM | 9 | C | GLY | A | 10 | 17.699 | 57.490 | 13.741 | 1.00 | 56.74 | C |
| ATOM | 10 | O | GLY | A | 10 | 18.309 | 58.266 | 14.525 | 1.00 | 56.92 | O |
| ATOM | 11 | N | ALA | A | 11 | 17.638 | 56.120 | 13.862 | 1.00 | 54.20 | N |
| ATOM | 12 | CA | ALA | A | 11 | 17.996 | 55.246 | 15.021 | 1.00 | 50.29 | C |
| ATOM | 13 | CB | ALA | A | 11 | 16.715 | 54.774 | 15.653 | 1.00 | 49.91 | C |
| ATOM | 14 | C | ALA | A | 11 | 18.877 | 53.990 | 14.658 | 1.00 | 48.23 | C |
| ATOM | 15 | O | ALA | A | 11 | 18.785 | 53.545 | 13.517 | 1.00 | 48.84 | O |
| ATOM | 16 | N | CYS | A | 12 | 19.749 | 53.503 | 15.591 | 1.00 | 44.24 | N |
| ATOM | 17 | CA | CYS | A | 12 | 20.292 | 52.067 | 15.817 | 1.00 | 39.99 | C |
| ATOM | 18 | CB | CYS | A | 12 | 19.195 | 50.993 | 16.014 | 1.00 | 39.88 | C |
| ATOM | 19 | SG | CYS | A | 12 | 18.219 | 50.858 | 17.556 | 1.00 | 31.25 | S |
| ATOM | 20 | C | CYS | A | 12 | 21.502 | 51.373 | 15.079 | 1.00 | 38.96 | C |
| ATOM | 21 | O | CYS | A | 12 | 21.337 | 50.493 | 14.232 | 1.00 | 38.11 | O |
| ATOM | 22 | N | GLU | A | 13 | 22.714 | 51.673 | 15.506 | 1.00 | 37.26 | N |
| ATOM | 23 | CA | GLU | A | 13 | 23.906 | 51.314 | 14.742 | 1.00 | 37.01 | C |
| ATOM | 24 | CB | GLU | A | 13 | 24.893 | 52.482 | 14.724 | 1.00 | 36.96 | C |
| ATOM | 25 | CG | GLU | A | 13 | 26.295 | 52.184 | 14.214 | 1.00 | 39.82 | C |
| ATOM | 26 | CD | GLU | A | 13 | 27.190 | 53.437 | 14.288 | 1.00 | 45.97 | C |
| ATOM | 27 | OE1 | GLU | A | 13 | 26.863 | 54.478 | 13.653 | 1.00 | 46.25 | O |
| ATOM | 28 | OE2 | GLU | A | 13 | 28.212 | 53.410 | 14.991 | 1.00 | 46.97 | O |
| ATOM | 29 | C | GLU | A | 13 | 24.576 | 50.038 | 15.232 | 1.00 | 36.01 | C |
| ATOM | 30 | O | GLU | A | 13 | 24.823 | 49.874 | 16.433 | 1.00 | 34.64 | O |
| ATOM | 31 | N | PHE | A | 14 | 24.857 | 49.148 | 14.270 | 1.00 | 35.10 | N |
| ATOM | 32 | CA | PHE | A | 14 | 25.503 | 47.889 | 14.547 | 1.00 | 34.48 | C |
| ATOM | 33 | CB | PHE | A | 14 | 24.615 | 46.724 | 14.111 | 1.00 | 33.19 | C |
| ATOM | 34 | CG | PHE | A | 14 | 23.643 | 46.357 | 15.141 | 1.00 | 29.91 | C |
| ATOM | 35 | CD1 | PHE | A | 14 | 22.472 | 47.077 | 15.295 | 1.00 | 27.77 | C |
| ATOM | 36 | CE1 | PHE | A | 14 | 21.578 | 46.766 | 16.309 | 1.00 | 24.54 | C |
| ATOM | 37 | CZ | PHE | A | 14 | 21.873 | 45.736 | 17.185 | 1.00 | 22.84 | C |
| ATOM | 38 | CE2 | PHE | A | 14 | 23.035 | 45.021 | 17.043 | 1.00 | 24.99 | C |
| ATOM | 39 | CD2 | PHE | A | 14 | 23.923 | 45.331 | 16.039 | 1.00 | 27.65 | C |
| ATOM | 40 | C | PHE | A | 14 | 26.884 | 47.846 | 13.915 | 1.00 | 35.81 | C |
| ATOM | 41 | O | PHE | A | 14 | 27.818 | 47.369 | 14.531 | 1.00 | 35.24 | O |
| ATOM | 42 | N | MET | A | 15 | 27.008 | 48.337 | 12.683 | 1.00 | 37.23 | N |
| ATOM | 43 | CA | MET | A | 15 | 28.341 | 48.638 | 12.131 | 1.00 | 39.18 | C |
| ATOM | 44 | CB | MET | A | 15 | 28.736 | 47.670 | 11.043 | 1.00 | 38.92 | C |
| ATOM | 45 | CG | MET | A | 15 | 28.616 | 46.269 | 11.485 | 1.00 | 40.64 | C |
| ATOM | 46 | SD | MET | A | 15 | 28.426 | 45.291 | 10.021 | 1.00 | 49.13 | S |
| ATOM | 47 | CE | MET | A | 15 | 30.200 | 45.157 | 9.457 | 1.00 | 45.40 | C |
| ATOM | 48 | C | MET | A | 15 | 28.389 | 50.066 | 11.630 | 1.00 | 39.77 | C |
| ATOM | 49 | O | MET | A | 15 | 27.523 | 50.473 | 10.860 | 1.00 | 39.63 | O |
| ATOM | 50 | N | LYS | A | 16 | 29.372 | 50.825 | 12.114 | 1.00 | 41.22 | N |
| ATOM | 51 | CA | LYS | A | 16 | 29.562 | 52.237 | 11.746 | 1.00 | 42.40 | C |
| ATOM | 52 | CB | LYS | A | 16 | 30.999 | 52.657 | 12.134 | 1.00 | 43.34 | C |
| ATOM | 53 | CG | LYS | A | 16 | 31.249 | 54.158 | 12.245 | 1.00 | 46.60 | C |
| ATOM | 54 | CD | LYS | A | 16 | 32.355 | 54.448 | 13.275 | 1.00 | 54.40 | C |
| ATOM | 55 | CE | LYS | A | 16 | 31.864 | 54.266 | 14.760 | 1.00 | 58.20 | C |
| ATOM | 56 | NZ | LYS | A | 16 | 31.580 | 55.586 | 15.396 | 1.00 | 60.01 | N |
| ATOM | 57 | C | LYS | A | 16 | 29.352 | 52.436 | 10.236 | 1.00 | 41.31 | C |
| ATOM | 58 | O | LYS | A | 16 | 30.056 | 51.787 | 9.423 | 1.00 | 41.42 | O |
| ATOM | 59 | N | ASP | A | 17 | 28.360 | 53.265 | 9.877 | 1.00 | 39.88 | N |
| ATOM | 60 | CA | ASP | A | 17 | 28.080 | 53.652 | 8.468 | 1.00 | 39.08 | C |
| ATOM | 61 | CB | ASP | A | 17 | 29.237 | 54.491 | 7.868 | 1.00 | 38.82 | C |
| ATOM | 62 | CG | ASP | A | 17 | 29.575 | 55.764 | 8.724 | 1.00 | 42.67 | C |
| ATOM | 63 | OD1 | ASP | A | 17 | 28.665 | 56.597 | 9.012 | 1.00 | 42.03 | O |
| ATOM | 64 | OD2 | ASP | A | 17 | 30.733 | 55.990 | 9.170 | 1.00 | 43.25 | O |
| ATOM | 65 | C | ASP | A | 17 | 27.685 | 52.499 | 7.498 | 1.00 | 37.98 | C |
| ATOM | 66 | O | ASP | A | 17 | 27.609 | 52.697 | 6.276 | 1.00 | 38.24 | O |
| ATOM | 67 | N | ARG | A | 18 | 27.444 | 51.307 | 8.034 | 1.00 | 35.23 | N |
| ATOM | 68 | CA | ARG | A | 18 | 27.212 | 50.166 | 7.195 | 1.00 | 33.76 | C |
| ATOM | 69 | CB | ARG | A | 18 | 28.509 | 49.330 | 7.056 | 1.00 | 33.09 | C |
| ATOM | 70 | CG | ARG | A | 18 | 28.327 | 47.842 | 6.773 | 1.00 | 33.66 | C |
| ATOM | 71 | CD | ARG | A | 18 | 28.970 | 47.295 | 5.486 | 1.00 | 31.95 | C |
| ATOM | 72 | NE | ARG | A | 18 | 28.129 | 47.608 | 4.365 | 1.00 | 28.78 | N |
| ATOM | 73 | CZ | ARG | A | 18 | 27.983 | 46.890 | 3.261 | 1.00 | 28.49 | C |
| ATOM | 74 | NH1 | ARG | A | 18 | 28.643 | 45.725 | 3.062 | 1.00 | 21.52 | N |
| ATOM | 75 | NH2 | ARG | A | 18 | 27.123 | 47.376 | 2.346 | 1.00 | 25.02 | N |
| ATOM | 76 | C | ARG | A | 18 | 25.953 | 49.360 | 7.611 | 1.00 | 32.55 | C |
| ATOM | 77 | O | ARG | A | 18 | 25.181 | 48.993 | 6.756 | 1.00 | 31.32 | O |
| ATOM | 78 | N | LEU | A | 19 | 25.764 | 49.101 | 8.913 | 1.00 | 31.85 | N |
| ATOM | 79 | CA | LEU | A | 19 | 24.659 | 48.290 | 9.398 | 1.00 | 30.15 | C |
| ATOM | 80 | CB | LEU | A | 19 | 25.105 | 46.841 | 9.648 | 1.00 | 30.29 | C |
| ATOM | 81 | CG | LEU | A | 19 | 24.038 | 45.809 | 10.157 | 1.00 | 29.73 | C |
| ATOM | 82 | CD1 | LEU | A | 19 | 22.992 | 45.378 | 9.117 | 1.00 | 22.51 | C |
| ATOM | 83 | CD2 | LEU | A | 19 | 24.693 | 44.575 | 10.850 | 1.00 | 25.72 | C |
| ATOM | 84 | C | LEU | A | 19 | 23.798 | 48.872 | 10.549 | 1.00 | 29.89 | C |
| ATOM | 85 | O | LEU | A | 19 | 24.252 | 49.223 | 11.655 | 1.00 | 29.50 | O |
| ATOM | 86 | N | TYR | A | 20 | 22.515 | 48.953 | 10.261 | 1.00 | 29.58 | N |
| ATOM | 87 | CA | TYR | A | 20 | 21.587 | 49.655 | 11.106 | 1.00 | 28.97 | C |
| ATOM | 88 | CB | TYR | A | 20 | 21.235 | 50.989 | 10.486 | 1.00 | 29.76 | C |
| ATOM | 89 | CG | TYR | A | 20 | 22.383 | 51.951 | 10.535 | 1.00 | 34.15 | C |
| ATOM | 90 | CD1 | TYR | A | 20 | 23.289 | 52.025 | 9.481 | 1.00 | 34.82 | C |
| ATOM | 91 | CE1 | TYR | A | 20 | 24.356 | 52.865 | 9.536 | 1.00 | 36.86 | C |
| ATOM | 92 | CZ | TYR | A | 20 | 24.558 | 53.665 | 10.644 | 1.00 | 37.89 | C |
| ATOM | 93 | OH | TYR | A | 20 | 25.644 | 54.493 | 10.650 | 1.00 | 43.53 | O |
| ATOM | 94 | CE2 | TYR | A | 20 | 23.697 | 53.637 | 11.707 | 1.00 | 37.99 | C |
| ATOM | 95 | CD2 | TYR | A | 20 | 22.594 | 52.762 | 11.654 | 1.00 | 37.46 | C |
| ATOM | 96 | C | TYR | A | 20 | 20.347 | 48.841 | 11.214 | 1.00 | 27.82 | C |
| ATOM | 97 | O | TYR | A | 20 | 19.998 | 48.082 | 10.283 | 1.00 | 27.77 | O |
| ATOM | 98 | N | PHE | A | 21 | 19.701 | 49.001 | 12.364 | 1.00 | 26.31 | N |
| ATOM | 99 | CA | PHE | A | 21 | 18.402 | 48.437 | 12.644 | 1.00 | 25.46 | C |
| ATOM | 100 | CB | PHE | A | 21 | 18.436 | 47.516 | 13.891 | 1.00 | 24.90 | C |
| ATOM | 101 | CG | PHE | A | 21 | 17.058 | 47.019 | 14.320 | 1.00 | 25.37 | C |
| ATOM | 102 | CD1 | PHE | A | 21 | 16.287 | 46.179 | 13.455 | 1.00 | 25.42 | C |
| ATOM | 103 | CE1 | PHE | A | 21 | 14.998 | 45.749 | 13.806 | 1.00 | 25.23 | C |
| ATOM | 104 | CZ | PHE | A | 21 | 14.460 | 46.141 | 15.061 | 1.00 | 24.11 | C |
| ATOM | 105 | CE2 | PHE | A | 21 | 15.231 | 46.987 | 15.944 | 1.00 | 23.38 | C |
| ATOM | 106 | CD2 | PHE | A | 21 | 16.509 | 47.413 | 15.560 | 1.00 | 24.10 | C |
| ATOM | 107 | C | PHE | A | 21 | 17.425 | 49.581 | 12.851 | 1.00 | 24.92 | C |
| ATOM | 108 | O | PHE | A | 21 | 17.685 | 50.451 | 13.662 | 1.00 | 24.89 | O |
| ATOM | 109 | N | ALA | A | 22 | 16.303 | 49.606 | 12.149 | 1.00 | 24.43 | N |
| ATOM | 110 | CA | ALA | A | 22 | 15.365 | 50.669 | 12.451 | 1.00 | 26.30 | C |
| ATOM | 111 | CB | ALA | A | 22 | 15.567 | 51.901 | 11.493 | 1.00 | 25.37 | C |
| ATOM | 112 | C | ALA | A | 22 | 13.877 | 50.254 | 12.553 | 1.00 | 27.20 | C |
| ATOM | 113 | O | ALA | A | 22 | 13.445 | 49.274 | 11.955 | 1.00 | 28.31 | O |
| ATOM | 114 | N | THR | A | 23 | 13.109 | 51.013 | 13.328 | 1.00 | 28.54 | N |
| ATOM | 115 | CA | THR | A | 23 | 11.656 | 50.837 | 13.407 | 1.00 | 29.96 | C |
| ATOM | 116 | CB | THR | A | 23 | 11.177 | 50.774 | 14.932 | 1.00 | 29.64 | C |
| ATOM | 117 | OG1 | THR | A | 23 | 11.735 | 49.620 | 15.571 | 1.00 | 31.21 | O |
| ATOM | 118 | CG2 | THR | A | 23 | 9.688 | 50.559 | 15.049 | 1.00 | 27.42 | C |
| ATOM | 119 | C | THR | A | 23 | 11.019 | 52.004 | 12.656 | 1.00 | 30.17 | C |
| ATOM | 120 | O | THR | A | 23 | 11.219 | 53.168 | 13.005 | 1.00 | 30.14 | O |
| ATOM | 121 | N | LEU | A | 24 | 10.255 | 51.689 | 11.627 | 1.00 | 32.58 | N |
| ATOM | 122 | CA | LEU | A | 24 | 9.689 | 52.705 | 10.725 | 1.00 | 34.66 | C |
| ATOM | 123 | CB | LEU | A | 24 | 10.284 | 52.578 | 9.295 | 1.00 | 34.15 | C |
| ATOM | 124 | CG | LEU | A | 24 | 11.815 | 52.805 | 9.266 | 1.00 | 33.44 | C |
| ATOM | 125 | CD1 | LEU | A | 24 | 12.509 | 52.514 | 7.910 | 1.00 | 35.21 | C |
| ATOM | 126 | CD2 | LEU | A | 24 | 12.229 | 54.149 | 9.819 | 1.00 | 28.56 | C |
| ATOM | 127 | C | LEU | A | 24 | 8.197 | 52.563 | 10.682 | 1.00 | 37.23 | C |
| ATOM | 128 | O | LEU | A | 24 | 7.668 | 51.437 | 10.576 | 1.00 | 36.39 | O |
| ATOM | 129 | N | ARG | A | 25 | 7.535 | 53.717 | 10.828 | 1.00 | 40.96 | N |
| ATOM | 130 | CA | ARG | A | 25 | 6.091 | 53.888 | 10.613 | 1.00 | 43.72 | C |
| ATOM | 131 | CB | ARG | A | 25 | 5.652 | 55.304 | 10.977 | 1.00 | 44.00 | C |
| ATOM | 132 | CG | ARG | A | 25 | 6.337 | 55.881 | 12.265 | 1.00 | 49.11 | C |
| ATOM | 133 | CD | ARG | A | 25 | 5.399 | 56.505 | 13.374 | 1.00 | 55.41 | C |
| ATOM | 134 | NE | ARG | A | 25 | 4.743 | 55.546 | 14.298 | 1.00 | 59.34 | N |
| ATOM | 135 | CZ | ARG | A | 25 | 3.751 | 54.675 | 13.984 | 1.00 | 61.86 | C |
| ATOM | 136 | NH1 | ARG | A | 25 | 3.260 | 54.555 | 12.738 | 1.00 | 62.51 | N |
| ATOM | 137 | NH2 | ARG | A | 25 | 3.251 | 53.900 | 14.938 | 1.00 | 61.08 | N |
| ATOM | 138 | C | ARG | A | 25 | 5.735 | 53.570 | 9.175 | 1.00 | 45.25 | C |
| ATOM | 139 | O | ARG | A | 25 | 4.654 | 53.093 | 8.894 | 1.00 | 46.11 | O |
| ATOM | 140 | N | ASN | A | 26 | 6.640 | 53.778 | 8.233 | 1.00 | 47.16 | N |
| ATOM | 141 | CA | ASN | A | 26 | 6.303 | 53.318 | 6.876 | 1.00 | 49.13 | C |
| ATOM | 142 | CB | ASN | A | 26 | 5.822 | 54.499 | 5.997 | 1.00 | 50.22 | C |
| ATOM | 143 | CG | ASN | A | 26 | 4.648 | 55.255 | 6.632 | 1.00 | 53.43 | C |
| ATOM | 144 | OD1 | ASN | A | 26 | 3.581 | 54.657 | 6.904 | 1.00 | 56.04 | O |
| ATOM | 145 | ND2 | ASN | A | 26 | 4.847 | 56.551 | 6.901 | 1.00 | 51.11 | N |
| ATOM | 146 | C | ASN | A | 26 | 7.401 | 52.538 | 6.181 | 1.00 | 48.82 | C |
| ATOM | 147 | O | ASN | A | 26 | 8.566 | 52.629 | 6.548 | 1.00 | 49.78 | O |
| ATOM | 148 | N | ARG | A | 27 | 7.006 | 51.790 | 5.169 | 1.00 | 48.67 | N |
| ATOM | 149 | CA | ARG | A | 27 | 7.919 | 51.136 | 4.261 | 1.00 | 49.18 | C |
| ATOM | 150 | CB | ARG | A | 27 | 7.101 | 50.408 | 3.191 | 1.00 | 50.10 | C |
| ATOM | 151 | CG | ARG | A | 27 | 7.383 | 48.919 | 3.034 | 1.00 | 54.74 | C |
| ATOM | 152 | CD | ARG | A | 27 | 7.980 | 48.564 | 1.650 | 1.00 | 61.77 | C |
| ATOM | 153 | NE | ARG | A | 27 | 7.001 | 48.770 | 0.578 | 1.00 | 67.79 | N |
| ATOM | 154 | CZ | ARG | A | 27 | 6.927 | 49.840 | −0.236 | 1.00 | 69.53 | C |
| ATOM | 155 | NH1 | ARG | A | 27 | 7.793 | 50.867 | −0.157 | 1.00 | 66.65 | N |
| ATOM | 156 | NH2 | ARG | A | 27 | 5.961 | 49.863 | −1.155 | 1.00 | 70.95 | N |
| ATOM | 157 | C | ARG | A | 27 | 8.842 | 52.189 | 3.620 | 1.00 | 48.14 | C |
| ATOM | 158 | O | ARG | A | 27 | 8.368 | 53.159 | 3.015 | 1.00 | 48.52 | O |
| ATOM | 159 | N | PRO | A | 28 | 10.156 | 52.031 | 3.795 | 1.00 | 47.23 | N |
| ATOM | 160 | CA | PRO | A | 28 | 11.137 | 52.841 | 3.061 | 1.00 | 45.88 | C |
| ATOM | 161 | CB | PRO | A | 28 | 12.369 | 52.766 | 3.974 | 1.00 | 46.00 | C |
| ATOM | 162 | CG | PRO | A | 28 | 12.257 | 51.416 | 4.642 | 1.00 | 44.87 | C |
| ATOM | 163 | CD | PRO | A | 28 | 10.817 | 51.091 | 4.733 | 1.00 | 46.57 | C |
| ATOM | 164 | C | PRO | A | 28 | 11.453 | 52.235 | 1.678 | 1.00 | 45.12 | C |
| ATOM | 165 | O | PRO | A | 28 | 11.368 | 51.021 | 1.496 | 1.00 | 44.72 | O |
| ATOM | 166 | N | LYS | A | 29 | 11.805 | 53.068 | 0.712 | 1.00 | 44.59 | N |
| ATOM | 167 | CA | LYS | A | 29 | 12.299 | 52.550 | −0.566 | 1.00 | 44.92 | C |
| ATOM | 168 | CB | LYS | A | 29 | 11.773 | 53.369 | −1.774 | 1.00 | 46.13 | C |
| ATOM | 169 | CG | LYS | A | 29 | 10.343 | 54.003 | −1.581 | 1.00 | 52.89 | C |
| ATOM | 170 | CD | LYS | A | 29 | 10.174 | 55.427 | −2.237 | 1.00 | 60.91 | C |
| ATOM | 171 | CE | LYS | A | 29 | 9.219 | 56.355 | −1.404 | 1.00 | 64.61 | C |
| ATOM | 172 | NZ | LYS | A | 29 | 9.908 | 57.432 | −0.555 | 1.00 | 64.43 | N |
| ATOM | 173 | C | LYS | A | 29 | 13.837 | 52.575 | −0.512 | 1.00 | 42.59 | C |
| ATOM | 174 | O | LYS | A | 29 | 14.430 | 53.579 | −0.064 | 1.00 | 42.14 | O |
| ATOM | 175 | N | SER | A | 30 | 14.447 | 51.457 | −0.921 | 1.00 | 40.10 | N |
| ATOM | 176 | CA | SER | A | 30 | 15.899 | 51.322 | −1.078 | 1.00 | 38.26 | C |
| ATOM | 177 | CB | SER | A | 30 | 16.263 | 49.963 | −1.670 | 1.00 | 37.56 | C |
| ATOM | 178 | OG | SER | A | 30 | 16.339 | 48.939 | −0.698 | 1.00 | 37.00 | O |
| ATOM | 179 | C | SER | A | 30 | 16.368 | 52.426 | −2.036 | 1.00 | 37.84 | C |
| ATOM | 180 | O | SER | A | 30 | 15.693 | 52.716 | −3.026 | 1.00 | 36.80 | O |
| ATOM | 181 | N | THR | A | 31 | 17.485 | 53.068 | −1.719 | 1.00 | 36.75 | N |
| ATOM | 182 | CA | THR | A | 31 | 18.079 | 53.982 | −2.669 | 1.00 | 35.89 | C |
| ATOM | 183 | CB | THR | A | 31 | 18.330 | 55.358 | −2.076 | 1.00 | 36.18 | C |
| ATOM | 184 | OG1 | THR | A | 31 | 19.340 | 55.241 | −1.066 | 1.00 | 37.03 | O |
| ATOM | 185 | CG2 | THR | A | 31 | 17.064 | 55.984 | −1.421 | 1.00 | 34.55 | C |
| ATOM | 186 | C | THR | A | 31 | 19.413 | 53.518 | −3.181 | 1.00 | 35.24 | C |
| ATOM | 187 | O | THR | A | 31 | 19.951 | 52.482 | −2.803 | 1.00 | 35.24 | O |
| ATOM | 188 | N | VAL | A | 32 | 19.920 | 54.341 | −4.084 | 1.00 | 35.00 | N |
| ATOM | 189 | CA | VAL | A | 32 | 21.309 | 54.400 | −4.513 | 1.00 | 33.98 | C |
| ATOM | 190 | CB | VAL | A | 32 | 21.386 | 55.671 | −5.435 | 1.00 | 35.04 | C |
| ATOM | 191 | CG1 | VAL | A | 32 | 22.387 | 56.741 | −4.959 | 1.00 | 36.43 | C |
| ATOM | 192 | CG2 | VAL | A | 32 | 21.447 | 55.307 | −6.917 | 1.00 | 33.99 | C |
| ATOM | 193 | C | VAL | A | 32 | 22.300 | 54.370 | −3.298 | 1.00 | 32.70 | C |
| ATOM | 194 | O | VAL | A | 32 | 23.304 | 53.721 | −3.338 | 1.00 | 32.40 | O |
| ATOM | 195 | N | ASN | A | 33 | 21.969 | 54.995 | −2.183 | 1.00 | 31.77 | N |
| ATOM | 196 | CA | ASN | A | 33 | 22.841 | 54.937 | −1.007 | 1.00 | 31.55 | C |
| ATOM | 197 | CB | ASN | A | 33 | 22.961 | 56.344 | −0.418 | 1.00 | 31.36 | C |
| ATOM | 198 | CG | ASN | A | 33 | 23.644 | 57.297 | −1.395 | 1.00 | 34.53 | C |
| ATOM | 199 | OD1 | ASN | A | 33 | 24.854 | 57.135 | −1.701 | 1.00 | 35.37 | O |
| ATOM | 200 | ND2 | ASN | A | 33 | 22.870 | 58.231 | −1.954 | 1.00 | 34.78 | N |
| ATOM | 201 | C | ASN | A | 33 | 22.511 | 53.918 | 0.110 | 1.00 | 31.31 | C |
| ATOM | 202 | O | ASN | A | 33 | 23.401 | 53.577 | 0.928 | 1.00 | 31.11 | O |
| ATOM | 203 | N | THR | A | 34 | 21.253 | 53.444 | 0.141 | 1.00 | 30.05 | N |
| ATOM | 204 | CA | THR | A | 34 | 20.762 | 52.618 | 1.229 | 1.00 | 29.45 | C |
| ATOM | 205 | CB | THR | A | 34 | 19.990 | 53.464 | 2.250 | 1.00 | 28.90 | C |
| ATOM | 206 | OG1 | THR | A | 34 | 20.795 | 54.563 | 2.654 | 1.00 | 30.20 | O |
| ATOM | 207 | CG2 | THR | A | 34 | 19.828 | 52.723 | 3.551 | 1.00 | 29.93 | C |
| ATOM | 208 | C | THR | A | 34 | 19.865 | 51.517 | 0.737 | 1.00 | 28.85 | C |
| ATOM | 209 | O | THR | A | 34 | 18.903 | 51.782 | 0.019 | 1.00 | 30.03 | O |
| ATOM | 210 | N | HIS | A | 35 | 20.199 | 50.296 | 1.149 | 1.00 | 27.91 | N |
| ATOM | 211 | CA | HIS | A | 35 | 19.373 | 49.098 | 1.070 | 1.00 | 27.08 | C |
| ATOM | 212 | CB | HIS | A | 35 | 20.285 | 47.883 | 0.853 | 1.00 | 27.24 | C |
| ATOM | 213 | CG | HIS | A | 35 | 19.546 | 46.598 | 0.638 | 1.00 | 27.50 | C |
| ATOM | 214 | ND1 | HIS | A | 35 | 18.851 | 46.324 | −0.519 | 1.00 | 29.10 | N |
| ATOM | 215 | CE1 | HIS | A | 35 | 18.294 | 45.127 | −0.431 | 1.00 | 27.39 | C |
| ATOM | 216 | NE2 | HIS | A | 35 | 18.618 | 44.608 | 0.740 | 1.00 | 27.15 | N |
| ATOM | 217 | CD2 | HIS | A | 35 | 19.381 | 45.516 | 1.438 | 1.00 | 27.12 | C |
| ATOM | 218 | C | HIS | A | 35 | 18.577 | 48.869 | 2.375 | 1.00 | 27.25 | C |
| ATOM | 219 | O | HIS | A | 35 | 19.155 | 48.627 | 3.463 | 1.00 | 27.25 | O |
| ATOM | 220 | N | TYR | A | 36 | 17.257 | 48.917 | 2.265 | 1.00 | 26.68 | N |
| ATOM | 221 | CA | TYR | A | 36 | 16.356 | 48.562 | 3.368 | 1.00 | 26.09 | C |
| ATOM | 222 | CB | TYR | A | 36 | 15.184 | 49.481 | 3.394 | 1.00 | 24.96 | C |
| ATOM | 223 | CG | TYR | A | 36 | 15.542 | 50.915 | 3.670 | 1.00 | 25.94 | C |
| ATOM | 224 | CD1 | TYR | A | 36 | 15.705 | 51.840 | 2.617 | 1.00 | 24.06 | C |
| ATOM | 225 | CE1 | TYR | A | 36 | 16.037 | 53.140 | 2.881 | 1.00 | 21.69 | C |
| ATOM | 226 | CZ | TYR | A | 36 | 16.180 | 53.564 | 4.191 | 1.00 | 24.35 | C |
| ATOM | 227 | OH | TYR | A | 36 | 16.479 | 54.880 | 4.463 | 1.00 | 23.26 | O |
| ATOM | 228 | CE2 | TYR | A | 36 | 16.004 | 52.686 | 5.254 | 1.00 | 23.47 | C |
| ATOM | 229 | CD2 | TYR | A | 36 | 15.708 | 51.367 | 4.980 | 1.00 | 23.94 | C |
| ATOM | 230 | C | TYR | A | 36 | 15.797 | 47.164 | 3.136 | 1.00 | 26.98 | C |
| ATOM | 231 | O | TYR | A | 36 | 15.430 | 46.828 | 1.985 | 1.00 | 26.24 | O |
| ATOM | 232 | N | PHE | A | 37 | 15.770 | 46.327 | 4.193 | 1.00 | 26.52 | N |
| ATOM | 233 | CA | PHE | A | 37 | 15.034 | 45.055 | 4.088 | 1.00 | 26.46 | C |
| ATOM | 234 | CB | PHE | A | 37 | 15.945 | 43.897 | 3.671 | 1.00 | 25.81 | C |
| ATOM | 235 | CG | PHE | A | 37 | 16.855 | 43.383 | 4.799 | 1.00 | 29.24 | C |
| ATOM | 236 | CD1 | PHE | A | 37 | 16.544 | 42.179 | 5.484 | 1.00 | 29.15 | C |
| ATOM | 237 | CE1 | PHE | A | 37 | 17.374 | 41.719 | 6.526 | 1.00 | 30.92 | C |
| ATOM | 238 | CZ | PHE | A | 37 | 18.537 | 42.487 | 6.909 | 1.00 | 28.21 | C |
| ATOM | 239 | CE2 | PHE | A | 37 | 18.831 | 43.676 | 6.233 | 1.00 | 26.00 | C |
| ATOM | 240 | CD2 | PHE | A | 37 | 18.002 | 44.118 | 5.194 | 1.00 | 26.66 | C |
| ATOM | 241 | C | PHE | A | 37 | 14.300 | 44.768 | 5.390 | 1.00 | 26.04 | C |
| ATOM | 242 | O | PHE | A | 37 | 14.781 | 45.116 | 6.466 | 1.00 | 27.71 | O |
| ATOM | 243 | N | SER | A | 38 | 13.147 | 44.123 | 5.283 | 1.00 | 25.44 | N |
| ATOM | 244 | CA | SER | A | 38 | 12.383 | 43.673 | 6.432 | 1.00 | 23.69 | C |
| ATOM | 245 | CB | SER | A | 38 | 11.005 | 44.314 | 6.419 | 1.00 | 23.14 | C |
| ATOM | 246 | OG | SER | A | 38 | 10.202 | 43.780 | 7.443 | 1.00 | 19.48 | O |
| ATOM | 247 | C | SER | A | 38 | 12.227 | 42.161 | 6.353 | 1.00 | 24.13 | C |
| ATOM | 248 | O | SER | A | 38 | 12.267 | 41.604 | 5.273 | 1.00 | 23.27 | O |
| ATOM | 249 | N | ILE | A | 39 | 12.035 | 41.488 | 7.491 | 1.00 | 23.83 | N |
| ATOM | 250 | CA | ILE | A | 39 | 11.744 | 40.056 | 7.442 | 1.00 | 22.52 | C |
| ATOM | 251 | CB | ILE | A | 39 | 12.930 | 39.219 | 8.074 | 1.00 | 23.28 | C |
| ATOM | 252 | CG1 | ILE | A | 39 | 13.304 | 39.723 | 9.472 | 1.00 | 20.65 | C |
| ATOM | 253 | CD1 | ILE | A | 39 | 12.187 | 39.574 | 10.548 | 1.00 | 17.20 | C |
| ATOM | 254 | CG2 | ILE | A | 39 | 14.174 | 39.251 | 7.193 | 1.00 | 21.36 | C |
| ATOM | 255 | C | ILE | A | 39 | 10.440 | 39.766 | 8.160 | 1.00 | 22.79 | C |
| ATOM | 256 | O | ILE | A | 39 | 10.094 | 38.601 | 8.389 | 1.00 | 23.13 | O |
| ATOM | 257 | N | ASP | A | 40 | 9.731 | 40.829 | 8.530 | 1.00 | 23.09 | N |
| ATOM | 258 | CA | ASP | A | 40 | 8.484 | 40.748 | 9.305 | 1.00 | 24.11 | C |
| ATOM | 259 | CB | ASP | A | 40 | 7.845 | 42.154 | 9.486 | 1.00 | 22.64 | C |
| ATOM | 260 | CG | ASP | A | 40 | 8.597 | 43.036 | 10.534 | 1.00 | 24.02 | C |
| ATOM | 261 | OD1 | ASP | A | 40 | 9.618 | 42.611 | 11.201 | 1.00 | 20.71 | O |
| ATOM | 262 | OD2 | ASP | A | 40 | 8.217 | 44.200 | 10.760 | 1.00 | 26.51 | O |
| ATOM | 263 | C | ASP | A | 40 | 7.477 | 39.778 | 8.664 | 1.00 | 25.87 | C |
| ATOM | 264 | O | ASP | A | 40 | 6.740 | 39.053 | 9.392 | 1.00 | 26.77 | O |
| ATOM | 265 | N | GLU | A | 41 | 7.447 | 39.756 | 7.325 | 1.00 | 26.73 | N |
| ATOM | 266 | CA | GLU | A | 41 | 6.481 | 38.952 | 6.567 | 1.00 | 27.93 | C |
| ATOM | 267 | CB | GLU | A | 41 | 5.890 | 39.750 | 5.414 | 1.00 | 28.29 | C |
| ATOM | 268 | CG | GLU | A | 41 | 4.935 | 40.839 | 5.907 | 1.00 | 35.78 | C |
| ATOM | 269 | CD | GLU | A | 41 | 3.728 | 40.239 | 6.627 | 1.00 | 43.85 | C |
| ATOM | 270 | OE1 | GLU | A | 41 | 3.533 | 40.486 | 7.848 | 1.00 | 46.69 | O |
| ATOM | 271 | OE2 | GLU | A | 41 | 2.974 | 39.495 | 5.958 | 1.00 | 49.53 | O |
| ATOM | 272 | C | GLU | A | 41 | 7.159 | 37.740 | 6.044 | 1.00 | 27.13 | C |
| ATOM | 273 | O | GLU | A | 41 | 6.571 | 36.912 | 5.360 | 1.00 | 27.88 | O |
| ATOM | 274 | N | GLU | A | 42 | 8.423 | 37.599 | 6.382 | 1.00 | 26.98 | N |
| ATOM | 275 | CA | GLU | A | 42 | 9.158 | 36.471 | 5.844 | 1.00 | 26.62 | C |
| ATOM | 276 | CB | GLU | A | 42 | 10.410 | 36.941 | 5.136 | 1.00 | 25.66 | C |
| ATOM | 277 | CG | GLU | A | 42 | 11.262 | 35.771 | 4.674 | 1.00 | 29.23 | C |
| ATOM | 278 | CD | GLU | A | 42 | 12.585 | 36.257 | 4.169 | 1.00 | 33.29 | C |
| ATOM | 279 | OE1 | GLU | A | 42 | 12.662 | 37.495 | 4.009 | 1.00 | 39.18 | O |
| ATOM | 280 | OE2 | GLU | A | 42 | 13.509 | 35.446 | 3.942 | 1.00 | 32.02 | O |
| ATOM | 281 | C | GLU | A | 42 | 9.493 | 35.423 | 6.907 | 1.00 | 25.64 | C |
| ATOM | 282 | O | GLU | A | 42 | 9.402 | 34.194 | 6.660 | 1.00 | 25.35 | O |
| ATOM | 283 | N | LEU | A | 43 | 9.924 | 35.890 | 8.073 | 1.00 | 24.48 | N |
| ATOM | 284 | CA | LEU | A | 43 | 10.237 | 34.943 | 9.136 | 1.00 | 22.53 | C |
| ATOM | 285 | CB | LEU | A | 43 | 11.588 | 35.235 | 9.679 | 1.00 | 21.18 | C |
| ATOM | 286 | CG | LEU | A | 43 | 12.709 | 35.170 | 8.639 | 1.00 | 20.88 | C |
| ATOM | 287 | CD1 | LEU | A | 43 | 13.897 | 35.767 | 9.251 | 1.00 | 18.58 | C |
| ATOM | 288 | CD2 | LEU | A | 43 | 13.008 | 33.723 | 8.182 | 1.00 | 12.93 | C |
| ATOM | 289 | C | LEU | A | 43 | 9.132 | 35.094 | 10.176 | 1.00 | 23.87 | C |
| ATOM | 290 | O | LEU | A | 43 | 9.104 | 36.061 | 10.998 | 1.00 | 23.60 | O |
| ATOM | 291 | N | VAL | A | 44 | 8.203 | 34.152 | 10.127 | 1.00 | 22.85 | N |
| ATOM | 292 | CA | VAL | A | 44 | 6.982 | 34.352 | 10.840 | 1.00 | 23.80 | C |
| ATOM | 293 | CB | VAL | A | 44 | 5.759 | 34.393 | 9.821 | 1.00 | 25.82 | C |
| ATOM | 294 | CG1 | VAL | A | 44 | 4.391 | 34.323 | 10.566 | 1.00 | 22.76 | C |
| ATOM | 295 | CG2 | VAL | A | 44 | 5.885 | 35.639 | 8.770 | 1.00 | 22.93 | C |
| ATOM | 296 | C | VAL | A | 44 | 6.796 | 33.318 | 11.959 | 1.00 | 24.29 | C |
| ATOM | 297 | O | VAL | A | 44 | 6.654 | 32.112 | 11.710 | 1.00 | 25.56 | O |
| ATOM | 298 | N | TYR | A | 45 | 6.791 | 33.810 | 13.184 | 1.00 | 24.25 | N |
| ATOM | 299 | CA | TYR | A | 45 | 6.507 | 33.009 | 14.354 | 1.00 | 24.54 | C |
| ATOM | 300 | CB | TYR | A | 45 | 6.426 | 33.912 | 15.574 | 1.00 | 23.10 | C |
| ATOM | 301 | CG | TYR | A | 45 | 6.290 | 33.138 | 16.872 | 1.00 | 20.21 | C |
| ATOM | 302 | CD1 | TYR | A | 45 | 7.398 | 32.522 | 17.434 | 1.00 | 19.20 | C |
| ATOM | 303 | CE1 | TYR | A | 45 | 7.312 | 31.818 | 18.577 | 1.00 | 18.09 | C |
| ATOM | 304 | CZ | TYR | A | 45 | 6.114 | 31.703 | 19.244 | 1.00 | 18.00 | C |
| ATOM | 305 | OH | TYR | A | 45 | 6.113 | 30.982 | 20.458 | 1.00 | 13.97 | O |
| ATOM | 306 | CE2 | TYR | A | 45 | 4.982 | 32.320 | 18.714 | 1.00 | 16.93 | C |
| ATOM | 307 | CD2 | TYR | A | 45 | 5.084 | 33.021 | 17.524 | 1.00 | 15.67 | C |
| ATOM | 308 | C | TYR | A | 45 | 5.158 | 32.312 | 14.257 | 1.00 | 25.34 | C |
| ATOM | 309 | O | TYR | A | 45 | 4.148 | 32.983 | 13.973 | 1.00 | 25.82 | O |
| ATOM | 310 | N | GLU | A | 46 | 5.152 | 31.003 | 14.498 | 1.00 | 25.80 | N |
| ATOM | 311 | CA | GLU | A | 46 | 3.914 | 30.240 | 14.669 | 1.00 | 28.29 | C |
| ATOM | 312 | CB | GLU | A | 46 | 4.067 | 28.847 | 14.091 | 1.00 | 29.39 | C |
| ATOM | 313 | CG | GLU | A | 46 | 3.685 | 28.752 | 12.605 | 1.00 | 35.45 | C |
| ATOM | 314 | CD | GLU | A | 46 | 3.939 | 27.333 | 12.057 | 1.00 | 44.77 | C |
| ATOM | 315 | OE1 | GLU | A | 46 | 4.758 | 27.221 | 11.108 | 1.00 | 47.72 | O |
| ATOM | 316 | OE2 | GLU | A | 46 | 3.358 | 26.319 | 12.578 | 1.00 | 45.80 | O |
| ATOM | 317 | C | GLU | A | 46 | 3.457 | 30.149 | 16.147 | 1.00 | 27.92 | C |
| ATOM | 318 | O | GLU | A | 46 | 4.033 | 29.403 | 16.957 | 1.00 | 28.79 | O |
| ATOM | 319 | N | ASN | A | 47 | 2.447 | 30.933 | 16.497 | 1.00 | 26.95 | N |
| ATOM | 320 | CA | ASN | A | 47 | 1.996 | 31.010 | 17.878 | 1.00 | 26.35 | C |
| ATOM | 321 | CB | ASN | A | 47 | 1.134 | 32.267 | 18.076 | 1.00 | 25.57 | C |
| ATOM | 322 | CG | ASN | A | 47 | −0.105 | 32.275 | 17.168 | 1.00 | 26.38 | C |
| ATOM | 323 | OD1 | ASN | A | 47 | −0.006 | 32.506 | 15.950 | 1.00 | 24.60 | O |
| ATOM | 324 | ND2 | ASN | A | 47 | −1.268 | 32.020 | 17.755 | 1.00 | 23.51 | N |
| ATOM | 325 | C | ASN | A | 47 | 1.194 | 29.750 | 18.311 | 1.00 | 25.74 | C |
| ATOM | 326 | O | ASN | A | 47 | 0.391 | 29.253 | 17.545 | 1.00 | 24.46 | O |
| ATOM | 327 | N | PHE | A | 48 | 1.406 | 29.288 | 19.547 | 1.00 | 24.99 | N |
| ATOM | 328 | CA | PHE | A | 48 | 0.487 | 28.350 | 20.163 | 1.00 | 25.50 | C |
| ATOM | 329 | CB | PHE | A | 48 | 1.143 | 27.560 | 21.292 | 1.00 | 26.09 | C |
| ATOM | 330 | CG | PHE | A | 48 | 2.135 | 26.591 | 20.787 | 1.00 | 25.50 | C |
| ATOM | 331 | CD1 | PHE | A | 48 | 3.482 | 27.011 | 20.536 | 1.00 | 23.50 | C |
| ATOM | 332 | CE1 | PHE | A | 48 | 4.404 | 26.162 | 20.020 | 1.00 | 21.12 | C |
| ATOM | 333 | CZ | PHE | A | 48 | 4.022 | 24.819 | 19.724 | 1.00 | 21.91 | C |
| ATOM | 334 | CE2 | PHE | A | 48 | 2.689 | 24.380 | 19.925 | 1.00 | 23.87 | C |
| ATOM | 335 | CD2 | PHE | A | 48 | 1.736 | 25.296 | 20.457 | 1.00 | 24.44 | C |
| ATOM | 336 | C | PHE | A | 48 | −0.749 | 29.058 | 20.665 | 1.00 | 25.24 | C |
| ATOM | 337 | O | PHE | A | 48 | −1.847 | 28.651 | 20.351 | 1.00 | 24.76 | O |
| ATOM | 338 | N | TYR | A | 49 | −0.578 | 30.120 | 21.439 | 1.00 | 25.71 | N |
| ATOM | 339 | CA | TYR | A | 49 | −1.727 | 30.931 | 21.778 | 1.00 | 24.86 | C |
| ATOM | 340 | CB | TYR | A | 49 | −2.292 | 30.527 | 23.128 | 1.00 | 24.98 | C |
| ATOM | 341 | CG | TYR | A | 49 | −3.550 | 31.267 | 23.517 | 1.00 | 25.94 | C |
| ATOM | 342 | CD1 | TYR | A | 49 | −4.766 | 30.967 | 22.935 | 1.00 | 24.71 | C |
| ATOM | 343 | CE1 | TYR | A | 49 | −5.907 | 31.658 | 23.298 | 1.00 | 24.67 | C |
| ATOM | 344 | CZ | TYR | A | 49 | −5.842 | 32.661 | 24.256 | 1.00 | 24.24 | C |
| ATOM | 345 | OH | TYR | A | 49 | −6.993 | 33.383 | 24.628 | 1.00 | 20.90 | O |
| ATOM | 346 | CE2 | TYR | A | 49 | −4.624 | 32.981 | 24.819 | 1.00 | 22.17 | C |
| ATOM | 347 | CD2 | TYR | A | 49 | −3.510 | 32.282 | 24.483 | 1.00 | 23.72 | C |
| ATOM | 348 | C | TYR | A | 49 | −1.462 | 32.423 | 21.601 | 1.00 | 25.42 | C |
| ATOM | 349 | O | TYR | A | 49 | −1.594 | 32.907 | 20.458 | 1.00 | 26.08 | O |
| ATOM | 350 | N | ALA | A | 50 | −1.055 | 33.129 | 22.682 | 1.00 | 23.94 | N |
| ATOM | 351 | CA | ALA | A | 50 | −0.698 | 34.550 | 22.651 | 1.00 | 22.19 | C |
| ATOM | 352 | CB | ALA | A | 50 | −1.349 | 35.319 | 23.865 | 1.00 | 22.45 | C |
| ATOM | 353 | C | ALA | A | 50 | 0.825 | 34.829 | 22.623 | 1.00 | 21.88 | C |
| ATOM | 354 | O | ALA | A | 50 | 1.252 | 35.993 | 22.510 | 1.00 | 21.42 | O |
| ATOM | 355 | N | ASP | A | 51 | 1.646 | 33.794 | 22.753 | 1.00 | 21.12 | N |
| ATOM | 356 | CA | ASP | A | 51 | 3.076 | 33.935 | 22.495 | 1.00 | 20.63 | C |
| ATOM | 357 | CB | ASP | A | 51 | 3.794 | 32.602 | 22.706 | 1.00 | 19.89 | C |
| ATOM | 358 | CG | ASP | A | 51 | 3.098 | 31.458 | 22.038 | 1.00 | 22.43 | C |
| ATOM | 359 | OD1 | ASP | A | 51 | 1.935 | 31.139 | 22.430 | 1.00 | 19.30 | O |
| ATOM | 360 | OD2 | ASP | A | 51 | 3.653 | 30.785 | 21.103 | 1.00 | 27.20 | O |
| ATOM | 361 | C | ASP | A | 51 | 3.318 | 34.404 | 21.075 | 1.00 | 20.82 | C |
| ATOM | 362 | O | ASP | A | 51 | 2.546 | 34.057 | 20.163 | 1.00 | 20.23 | O |
| ATOM | 363 | N | PHE | A | 52 | 4.417 | 35.148 | 20.868 | 1.00 | 20.82 | N |
| ATOM | 364 | CA | PHE | A | 52 | 4.672 | 35.824 | 19.581 | 1.00 | 20.22 | C |
| ATOM | 365 | CB | PHE | A | 52 | 4.170 | 37.288 | 19.629 | 1.00 | 19.43 | C |
| ATOM | 366 | CG | PHE | A | 52 | 4.884 | 38.167 | 20.671 | 1.00 | 20.55 | C |
| ATOM | 367 | CD1 | PHE | A | 52 | 6.071 | 38.818 | 20.361 | 1.00 | 19.91 | C |
| ATOM | 368 | CE1 | PHE | A | 52 | 6.728 | 39.625 | 21.278 | 1.00 | 21.17 | C |
| ATOM | 369 | CZ | PHE | A | 52 | 6.214 | 39.782 | 22.534 | 1.00 | 22.23 | C |
| ATOM | 370 | CE2 | PHE | A | 52 | 4.994 | 39.131 | 22.881 | 1.00 | 21.22 | C |
| ATOM | 371 | CD2 | PHE | A | 52 | 4.360 | 38.327 | 21.950 | 1.00 | 20.06 | C |
| ATOM | 372 | C | PHE | A | 52 | 6.170 | 35.755 | 19.244 | 1.00 | 21.05 | C |
| ATOM | 373 | O | PHE | A | 52 | 6.635 | 36.298 | 18.207 | 1.00 | 20.41 | O |
| ATOM | 374 | N | GLY | A | 53 | 6.916 | 35.053 | 20.101 | 1.00 | 20.85 | N |
| ATOM | 375 | CA | GLY | A | 53 | 8.370 | 34.980 | 19.992 | 1.00 | 21.80 | C |
| ATOM | 376 | C | GLY | A | 53 | 9.002 | 34.419 | 21.261 | 1.00 | 22.23 | C |
| ATOM | 377 | O | GLY | A | 53 | 8.280 | 34.175 | 22.265 | 1.00 | 23.39 | O |
| ATOM | 378 | N | PRO | A | 54 | 10.317 | 34.220 | 21.278 | 1.00 | 21.95 | N |
| ATOM | 379 | CA | PRO | A | 54 | 11.240 | 34.656 | 20.229 | 1.00 | 22.68 | C |
| ATOM | 380 | CB | PRO | A | 54 | 12.613 | 34.563 | 20.939 | 1.00 | 21.95 | C |
| ATOM | 381 | CG | PRO | A | 54 | 12.463 | 33.382 | 21.864 | 1.00 | 20.71 | C |
| ATOM | 382 | CD | PRO | A | 54 | 11.016 | 33.461 | 22.350 | 1.00 | 21.92 | C |
| ATOM | 383 | C | PRO | A | 54 | 11.237 | 33.691 | 19.016 | 1.00 | 22.87 | C |
| ATOM | 384 | O | PRO | A | 54 | 10.827 | 32.528 | 19.195 | 1.00 | 23.94 | O |
| ATOM | 385 | N | LEU | A | 55 | 11.701 | 34.165 | 17.857 | 1.00 | 22.30 | N |
| ATOM | 386 | CA | LEU | A | 55 | 11.786 | 33.389 | 16.614 | 1.00 | 22.94 | C |
| ATOM | 387 | CB | LEU | A | 55 | 12.319 | 34.276 | 15.474 | 1.00 | 21.89 | C |
| ATOM | 388 | CG | LEU | A | 55 | 11.311 | 34.808 | 14.466 | 1.00 | 24.12 | C |
| ATOM | 389 | CD1 | LEU | A | 55 | 9.879 | 35.062 | 15.038 | 1.00 | 23.36 | C |
| ATOM | 390 | CD2 | LEU | A | 55 | 11.868 | 36.019 | 13.817 | 1.00 | 24.86 | C |
| ATOM | 391 | C | LEU | A | 55 | 12.700 | 32.172 | 16.795 | 1.00 | 23.23 | C |
| ATOM | 392 | O | LEU | A | 55 | 13.663 | 32.222 | 17.572 | 1.00 | 25.04 | O |
| ATOM | 393 | N | ASN | A | 56 | 12.432 | 31.089 | 16.091 | 1.00 | 22.62 | N |
| ATOM | 394 | CA | ASN | A | 56 | 13.149 | 29.881 | 16.370 | 1.00 | 21.13 | C |
| ATOM | 395 | CB | ASN | A | 56 | 12.293 | 28.665 | 16.078 | 1.00 | 20.76 | C |
| ATOM | 396 | CG | ASN | A | 56 | 12.085 | 28.386 | 14.594 | 1.00 | 20.89 | C |
| ATOM | 397 | OD1 | ASN | A | 56 | 13.009 | 28.462 | 13.772 | 1.00 | 22.96 | O |
| ATOM | 398 | ND2 | ASN | A | 56 | 10.871 | 27.931 | 14.263 | 1.00 | 20.12 | N |
| ATOM | 399 | C | ASN | A | 56 | 14.537 | 29.815 | 15.774 | 1.00 | 21.85 | C |
| ATOM | 400 | O | ASN | A | 56 | 14.912 | 30.678 | 14.990 | 1.00 | 21.40 | O |
| ATOM | 401 | N | LEU | A | 57 | 15.317 | 28.811 | 16.190 | 1.00 | 22.52 | N |
| ATOM | 402 | CA | LEU | A | 57 | 16.697 | 28.630 | 15.743 | 1.00 | 23.07 | C |
| ATOM | 403 | CB | LEU | A | 57 | 17.252 | 27.286 | 16.209 | 1.00 | 23.07 | C |
| ATOM | 404 | CG | LEU | A | 57 | 18.636 | 27.073 | 16.843 | 1.00 | 23.92 | C |
| ATOM | 405 | CD1 | LEU | A | 57 | 19.200 | 25.790 | 16.354 | 1.00 | 23.47 | C |
| ATOM | 406 | CD2 | LEU | A | 57 | 19.678 | 28.214 | 16.868 | 1.00 | 20.08 | C |
| ATOM | 407 | C | LEU | A | 57 | 16.810 | 28.674 | 14.226 | 1.00 | 23.71 | C |
| ATOM | 408 | O | LEU | A | 57 | 17.789 | 29.297 | 13.689 | 1.00 | 23.89 | O |
| ATOM | 409 | N | ALA | A | 58 | 15.836 | 28.026 | 13.550 | 1.00 | 22.25 | N |
| ATOM | 410 | CA | ALA | A | 58 | 15.819 | 27.952 | 12.075 | 1.00 | 22.65 | C |
| ATOM | 411 | CB | ALA | A | 58 | 14.630 | 27.009 | 11.490 | 1.00 | 22.39 | C |
| ATOM | 412 | C | ALA | A | 58 | 15.713 | 29.310 | 11.467 | 1.00 | 22.63 | C |
| ATOM | 413 | O | ALA | A | 58 | 16.371 | 29.611 | 10.452 | 1.00 | 22.40 | O |
| ATOM | 414 | N | MET | A | 59 | 14.832 | 30.129 | 12.045 | 1.00 | 22.67 | N |
| ATOM | 415 | CA | MET | A | 59 | 14.602 | 31.440 | 11.443 | 1.00 | 21.64 | C |
| ATOM | 416 | CB | MET | A | 59 | 13.253 | 31.945 | 11.817 | 1.00 | 21.65 | C |
| ATOM | 417 | CG | MET | A | 59 | 12.117 | 31.201 | 11.133 | 1.00 | 19.69 | C |
| ATOM | 418 | SD | MET | A | 59 | 10.562 | 31.918 | 11.777 | 1.00 | 25.76 | S |
| ATOM | 419 | CE | MET | A | 59 | 9.315 | 30.394 | 11.394 | 1.00 | 20.19 | C |
| ATOM | 420 | C | MET | A | 59 | 15.723 | 32.402 | 11.788 | 1.00 | 22.08 | C |
| ATOM | 421 | O | MET | A | 59 | 16.043 | 33.261 | 10.967 | 1.00 | 22.17 | O |
| ATOM | 422 | N | VAL | A | 60 | 16.359 | 32.203 | 12.962 | 1.00 | 21.46 | N |
| ATOM | 423 | CA | VAL | A | 60 | 17.592 | 32.904 | 13.334 | 1.00 | 21.58 | C |
| ATOM | 424 | CB | VAL | A | 60 | 18.031 | 32.557 | 14.799 | 1.00 | 22.34 | C |
| ATOM | 425 | CG1 | VAL | A | 60 | 19.413 | 33.118 | 15.121 | 1.00 | 20.93 | C |
| ATOM | 426 | CG2 | VAL | A | 60 | 16.993 | 33.042 | 15.818 | 1.00 | 20.43 | C |
| ATOM | 427 | C | VAL | A | 60 | 18.728 | 32.596 | 12.322 | 1.00 | 21.49 | C |
| ATOM | 428 | O | VAL | A | 60 | 19.454 | 33.503 | 11.870 | 1.00 | 20.76 | O |
| ATOM | 429 | N | TYR | A | 61 | 18.814 | 31.313 | 11.952 | 1.00 | 21.71 | N |
| ATOM | 430 | CA | TYR | A | 61 | 19.691 | 30.811 | 10.914 | 1.00 | 21.55 | C |
| ATOM | 431 | CB | TYR | A | 61 | 19.471 | 29.304 | 10.690 | 1.00 | 22.05 | C |
| ATOM | 432 | CG | TYR | A | 61 | 20.391 | 28.707 | 9.625 | 1.00 | 21.88 | C |
| ATOM | 433 | CD1 | TYR | A | 61 | 21.800 | 28.602 | 9.845 | 1.00 | 21.28 | C |
| ATOM | 434 | CE1 | TYR | A | 61 | 22.648 | 28.066 | 8.854 | 1.00 | 21.35 | C |
| ATOM | 435 | CZ | TYR | A | 61 | 22.086 | 27.604 | 7.606 | 1.00 | 23.78 | C |
| ATOM | 436 | OH | TYR | A | 61 | 22.909 | 27.032 | 6.603 | 1.00 | 26.98 | O |
| ATOM | 437 | CE2 | TYR | A | 61 | 20.710 | 27.677 | 7.393 | 1.00 | 19.42 | C |
| ATOM | 438 | CD2 | TYR | A | 61 | 19.874 | 28.251 | 8.411 | 1.00 | 20.84 | C |
| ATOM | 439 | C | TYR | A | 61 | 19.445 | 31.529 | 9.601 | 1.00 | 22.63 | C |
| ATOM | 440 | O | TYR | A | 61 | 20.391 | 32.193 | 9.068 | 1.00 | 22.99 | O |
| ATOM | 441 | N | ARG | A | 62 | 18.203 | 31.383 | 9.072 | 1.00 | 21.76 | N |
| ATOM | 442 | CA | ARG | A | 62 | 17.827 | 31.970 | 7.790 | 1.00 | 20.95 | C |
| ATOM | 443 | CB | ARG | A | 62 | 16.378 | 31.728 | 7.427 | 1.00 | 21.34 | C |
| ATOM | 444 | CG | ARG | A | 62 | 16.067 | 30.253 | 7.106 | 1.00 | 19.00 | C |
| ATOM | 445 | CD | ARG | A | 62 | 14.616 | 29.968 | 6.753 | 1.00 | 20.97 | C |
| ATOM | 446 | NE | ARG | A | 62 | 14.507 | 28.557 | 6.328 | 1.00 | 20.81 | N |
| ATOM | 447 | CZ | ARG | A | 62 | 14.993 | 28.091 | 5.188 | 1.00 | 24.90 | C |
| ATOM | 448 | NH1 | ARG | A | 62 | 15.567 | 28.909 | 4.317 | 1.00 | 19.33 | N |
| ATOM | 449 | NH2 | ARG | A | 62 | 14.899 | 26.800 | 4.894 | 1.00 | 29.25 | N |
| ATOM | 450 | C | ARG | A | 62 | 18.110 | 33.431 | 7.834 | 1.00 | 22.54 | C |
| ATOM | 451 | O | ARG | A | 62 | 18.647 | 33.970 | 6.894 | 1.00 | 24.20 | O |
| ATOM | 452 | N | TYR | A | 63 | 17.811 | 34.091 | 8.938 | 1.00 | 23.54 | N |
| ATOM | 453 | CA | TYR | A | 63 | 18.170 | 35.503 | 9.050 | 1.00 | 24.24 | C |
| ATOM | 454 | CB | TYR | A | 63 | 17.679 | 36.142 | 10.358 | 1.00 | 24.14 | C |
| ATOM | 455 | CG | TYR | A | 63 | 18.152 | 37.591 | 10.521 | 1.00 | 23.55 | C |
| ATOM | 456 | CD1 | TYR | A | 63 | 17.395 | 38.645 | 10.004 | 1.00 | 23.90 | C |
| ATOM | 457 | CE1 | TYR | A | 63 | 17.800 | 39.954 | 10.119 | 1.00 | 17.65 | C |
| ATOM | 458 | CZ | TYR | A | 63 | 18.948 | 40.273 | 10.797 | 1.00 | 20.07 | C |
| ATOM | 459 | OH | TYR | A | 63 | 19.242 | 41.626 | 10.964 | 1.00 | 19.48 | O |
| ATOM | 460 | CE2 | TYR | A | 63 | 19.745 | 39.255 | 11.358 | 1.00 | 22.70 | C |
| ATOM | 461 | CD2 | TYR | A | 63 | 19.333 | 37.908 | 11.206 | 1.00 | 24.54 | C |
| ATOM | 462 | C | TYR | A | 63 | 19.669 | 35.758 | 8.929 | 1.00 | 24.26 | C |
| ATOM | 463 | O | TYR | A | 63 | 20.055 | 36.695 | 8.227 | 1.00 | 25.67 | O |
| ATOM | 464 | N | CYS | A | 64 | 20.497 | 34.974 | 9.626 | 1.00 | 23.62 | N |
| ATOM | 465 | CA | CYS | A | 64 | 21.945 | 35.204 | 9.601 | 1.00 | 23.77 | C |
| ATOM | 466 | CB | CYS | A | 64 | 22.687 | 34.417 | 10.699 | 1.00 | 22.29 | C |
| ATOM | 467 | SG | CYS | A | 64 | 22.363 | 35.034 | 12.405 | 1.00 | 21.22 | S |
| ATOM | 468 | C | CYS | A | 64 | 22.513 | 34.970 | 8.194 | 1.00 | 24.86 | C |
| ATOM | 469 | O | CYS | A | 64 | 23.282 | 35.784 | 7.716 | 1.00 | 25.98 | O |
| ATOM | 470 | N | CYS | A | 65 | 22.105 | 33.894 | 7.529 | 1.00 | 26.06 | N |
| ATOM | 471 | CA | CYS | A | 65 | 22.454 | 33.651 | 6.123 | 1.00 | 28.12 | C |
| ATOM | 472 | CB | CYS | A | 65 | 21.778 | 32.384 | 5.620 | 1.00 | 27.83 | C |
| ATOM | 473 | SG | CYS | A | 65 | 22.378 | 30.987 | 6.591 | 1.00 | 34.44 | S |
| ATOM | 474 | C | CYS | A | 65 | 22.111 | 34.813 | 5.190 | 1.00 | 28.85 | C |
| ATOM | 475 | O | CYS | A | 65 | 22.936 | 35.215 | 4.328 | 1.00 | 30.99 | O |
| ATOM | 476 | N | LYS | A | 66 | 20.918 | 35.358 | 5.369 | 1.00 | 27.69 | N |
| ATOM | 477 | CA | LYS | A | 66 | 20.442 | 36.454 | 4.582 | 1.00 | 27.67 | C |
| ATOM | 478 | CB | LYS | A | 66 | 19.052 | 36.824 | 5.031 | 1.00 | 27.95 | C |
| ATOM | 479 | CG | LYS | A | 66 | 18.415 | 37.837 | 4.160 | 1.00 | 29.16 | C |
| ATOM | 480 | CD | LYS | A | 66 | 17.038 | 38.212 | 4.746 | 1.00 | 33.61 | C |
| ATOM | 481 | CE | LYS | A | 66 | 15.922 | 38.040 | 3.658 | 1.00 | 39.39 | C |
| ATOM | 482 | NZ | LYS | A | 66 | 15.608 | 39.407 | 3.061 | 1.00 | 40.02 | N |
| ATOM | 483 | C | LYS | A | 66 | 21.364 | 37.657 | 4.717 | 1.00 | 27.46 | C |
| ATOM | 484 | O | LYS | A | 66 | 21.906 | 38.160 | 3.715 | 1.00 | 27.88 | O |
| ATOM | 485 | N | LEU | A | 67 | 21.559 | 38.085 | 5.956 | 1.00 | 26.41 | N |
| ATOM | 486 | CA | LEU | A | 67 | 22.294 | 39.321 | 6.244 | 1.00 | 25.71 | C |
| ATOM | 487 | CB | LEU | A | 67 | 22.208 | 39.632 | 7.735 | 1.00 | 23.89 | C |
| ATOM | 488 | CG | LEU | A | 67 | 22.864 | 40.911 | 8.238 | 1.00 | 23.02 | C |
| ATOM | 489 | CD1 | LEU | A | 67 | 22.649 | 42.134 | 7.303 | 1.00 | 18.87 | C |
| ATOM | 490 | CD2 | LEU | A | 67 | 22.374 | 41.173 | 9.686 | 1.00 | 19.52 | C |
| ATOM | 491 | C | LEU | A | 67 | 23.733 | 39.153 | 5.798 | 1.00 | 26.43 | C |
| ATOM | 492 | O | LEU | A | 67 | 24.325 | 40.036 | 5.148 | 1.00 | 26.22 | O |
| ATOM | 493 | N | ASN | A | 68 | 24.288 | 38.008 | 6.156 | 1.00 | 27.02 | N |
| ATOM | 494 | CA | ASN | A | 68 | 25.593 | 37.631 | 5.695 | 1.00 | 29.37 | C |
| ATOM | 495 | CB | ASN | A | 68 | 25.889 | 36.230 | 6.188 | 1.00 | 29.90 | C |
| ATOM | 496 | CG | ASN | A | 68 | 27.116 | 36.204 | 6.977 | 1.00 | 34.36 | C |
| ATOM | 497 | OD1 | ASN | A | 68 | 28.193 | 36.439 | 6.417 | 1.00 | 42.15 | O |
| ATOM | 498 | ND2 | ASN | A | 68 | 27.002 | 35.996 | 8.300 | 1.00 | 36.36 | N |
| ATOM | 499 | C | ASN | A | 68 | 25.807 | 37.760 | 4.173 | 1.00 | 29.87 | C |
| ATOM | 500 | O | ASN | A | 68 | 26.765 | 38.380 | 3.741 | 1.00 | 29.85 | O |
| ATOM | 501 | N | LYS | A | 69 | 24.901 | 37.175 | 3.376 | 1.00 | 31.06 | N |
| ATOM | 502 | CA | LYS | A | 69 | 24.909 | 37.317 | 1.923 | 1.00 | 31.81 | C |
| ATOM | 503 | CB | LYS | A | 69 | 23.756 | 36.517 | 1.321 | 1.00 | 33.34 | C |
| ATOM | 504 | CG | LYS | A | 69 | 23.684 | 36.438 | −0.226 | 1.00 | 38.02 | C |
| ATOM | 505 | CD | LYS | A | 69 | 24.968 | 35.799 | −0.831 | 1.00 | 47.34 | C |
| ATOM | 506 | CE | LYS | A | 69 | 24.670 | 34.944 | −2.072 | 1.00 | 50.82 | C |
| ATOM | 507 | NZ | LYS | A | 69 | 25.384 | 33.614 | −1.934 | 1.00 | 51.61 | N |
| ATOM | 508 | C | LYS | A | 69 | 24.851 | 38.810 | 1.511 | 1.00 | 31.76 | C |
| ATOM | 509 | O | LYS | A | 69 | 25.646 | 39.236 | 0.670 | 1.00 | 32.11 | O |
| ATOM | 510 | N | LYS | A | 70 | 23.985 | 39.609 | 2.139 | 1.00 | 30.29 | N |
| ATOM | 511 | CA | LYS | A | 70 | 23.910 | 41.048 | 1.835 | 1.00 | 30.53 | C |
| ATOM | 512 | CB | LYS | A | 70 | 22.772 | 41.786 | 2.612 | 1.00 | 29.69 | C |
| ATOM | 513 | CG | LYS | A | 70 | 21.384 | 41.403 | 2.141 | 1.00 | 27.01 | C |
| ATOM | 514 | CD | LYS | A | 70 | 20.329 | 41.910 | 3.053 | 1.00 | 27.77 | C |
| ATOM | 515 | CE | LYS | A | 70 | 18.936 | 41.387 | 2.650 | 1.00 | 26.05 | C |
| ATOM | 516 | NZ | LYS | A | 70 | 18.434 | 42.096 | 1.406 | 1.00 | 28.59 | N |
| ATOM | 517 | C | LYS | A | 70 | 25.194 | 41.775 | 2.092 | 1.00 | 31.47 | C |
| ATOM | 518 | O | LYS | A | 70 | 25.555 | 42.676 | 1.348 | 1.00 | 32.01 | O |
| ATOM | 519 | N | LEU | A | 71 | 25.879 | 41.395 | 3.169 | 1.00 | 33.76 | N |
| ATOM | 520 | CA | LEU | A | 71 | 27.009 | 42.169 | 3.688 | 1.00 | 34.29 | C |
| ATOM | 521 | CB | LEU | A | 71 | 27.280 | 41.814 | 5.133 | 1.00 | 32.98 | C |
| ATOM | 522 | CG | LEU | A | 71 | 26.467 | 42.537 | 6.195 | 1.00 | 33.76 | C |
| ATOM | 523 | CD1 | LEU | A | 71 | 26.712 | 41.912 | 7.622 | 1.00 | 30.41 | C |
| ATOM | 524 | CD2 | LEU | A | 71 | 26.665 | 44.086 | 6.201 | 1.00 | 28.86 | C |
| ATOM | 525 | C | LEU | A | 71 | 28.240 | 41.899 | 2.822 | 1.00 | 35.52 | C |
| ATOM | 526 | O | LEU | A | 71 | 29.212 | 42.702 | 2.810 | 1.00 | 35.14 | O |
| ATOM | 527 | N | LYS | A | 72 | 28.140 | 40.805 | 2.064 | 1.00 | 36.68 | N |
| ATOM | 528 | CA | LYS | A | 72 | 29.218 | 40.315 | 1.192 | 1.00 | 38.91 | C |
| ATOM | 529 | CB | LYS | A | 72 | 29.399 | 38.807 | 1.350 | 1.00 | 38.84 | C |
| ATOM | 530 | CG | LYS | A | 72 | 30.101 | 38.385 | 2.659 | 1.00 | 43.37 | C |
| ATOM | 531 | CD | LYS | A | 72 | 30.072 | 36.855 | 2.787 | 1.00 | 49.95 | C |
| ATOM | 532 | CE | LYS | A | 72 | 30.207 | 36.395 | 4.242 | 1.00 | 55.10 | C |
| ATOM | 533 | NZ | LYS | A | 72 | 31.624 | 36.353 | 4.772 | 1.00 | 58.22 | N |
| ATOM | 534 | C | LYS | A | 72 | 29.014 | 40.643 | −0.280 | 1.00 | 38.89 | C |
| ATOM | 535 | O | LYS | A | 72 | 29.963 | 40.602 | −1.060 | 1.00 | 40.38 | O |
| ATOM | 536 | N | SER | A | 73 | 27.793 | 40.956 | −0.676 | 1.00 | 38.82 | N |
| ATOM | 537 | CA | SER | A | 73 | 27.532 | 41.184 | −2.087 | 1.00 | 38.78 | C |
| ATOM | 538 | CB | SER | A | 73 | 26.021 | 41.194 | −2.431 | 1.00 | 39.36 | C |
| ATOM | 539 | OG | SER | A | 73 | 25.392 | 42.379 | −1.977 | 1.00 | 38.87 | O |
| ATOM | 540 | C | SER | A | 73 | 28.219 | 42.441 | −2.588 | 1.00 | 38.82 | C |
| ATOM | 541 | O | SER | A | 73 | 28.231 | 43.532 | −1.948 | 1.00 | 38.16 | O |
| ATOM | 542 | N | TYR | A | 74 | 28.798 | 42.260 | −3.759 | 1.00 | 39.10 | N |
| ATOM | 543 | CA | TYR | A | 74 | 29.420 | 43.348 | −4.425 | 1.00 | 39.12 | C |
| ATOM | 544 | CB | TYR | A | 74 | 30.060 | 42.862 | −5.736 | 1.00 | 39.94 | C |
| ATOM | 545 | CG | TYR | A | 74 | 30.649 | 44.055 | −6.446 | 1.00 | 44.84 | C |
| ATOM | 546 | CD1 | TYR | A | 74 | 31.636 | 44.812 | −5.815 | 1.00 | 44.93 | C |
| ATOM | 547 | CE1 | TYR | A | 74 | 32.141 | 45.950 | −6.391 | 1.00 | 51.13 | C |
| ATOM | 548 | CZ | TYR | A | 74 | 31.659 | 46.377 | −7.628 | 1.00 | 52.41 | C |
| ATOM | 549 | OH | TYR | A | 74 | 32.223 | 47.512 | −8.146 | 1.00 | 54.97 | O |
| ATOM | 550 | CE2 | TYR | A | 74 | 30.657 | 45.661 | −8.300 | 1.00 | 52.47 | C |
| ATOM | 551 | CD2 | TYR | A | 74 | 30.140 | 44.497 | −7.693 | 1.00 | 48.92 | C |
| ATOM | 552 | C | TYR | A | 74 | 28.402 | 44.528 | −4.624 | 1.00 | 38.24 | C |
| ATOM | 553 | O | TYR | A | 74 | 28.726 | 45.692 | −4.303 | 1.00 | 37.75 | O |
| ATOM | 554 | N | SER | A | 75 | 27.180 | 44.230 | −5.082 | 1.00 | 36.39 | N |
| ATOM | 555 | CA | SER | A | 75 | 26.225 | 45.281 | −5.475 | 1.00 | 36.24 | C |
| ATOM | 556 | CB | SER | A | 75 | 25.085 | 44.685 | −6.321 | 1.00 | 35.91 | C |
| ATOM | 557 | OG | SER | A | 75 | 24.349 | 43.785 | −5.504 | 1.00 | 34.20 | O |
| ATOM | 558 | C | SER | A | 75 | 25.624 | 46.124 | −4.293 | 1.00 | 36.24 | C |
| ATOM | 559 | O | SER | A | 75 | 25.088 | 47.227 | −4.512 | 1.00 | 35.40 | O |
| ATOM | 560 | N | LEU | A | 76 | 25.687 | 45.585 | −3.070 | 1.00 | 35.22 | N |
| ATOM | 561 | CA | LEU | A | 76 | 25.246 | 46.314 | −1.883 | 1.00 | 34.96 | C |
| ATOM | 562 | CB | LEU | A | 76 | 24.444 | 45.435 | −0.926 | 1.00 | 33.68 | C |
| ATOM | 563 | CG | LEU | A | 76 | 23.221 | 44.853 | −1.625 | 1.00 | 32.74 | C |
| ATOM | 564 | CD1 | LEU | A | 76 | 22.453 | 43.981 | −0.664 | 1.00 | 32.03 | C |
| ATOM | 565 | CD2 | LEU | A | 76 | 22.347 | 45.957 | −2.156 | 1.00 | 30.02 | C |
| ATOM | 566 | C | LEU | A | 76 | 26.451 | 46.881 | −1.187 | 1.00 | 35.19 | C |
| ATOM | 567 | O | LEU | A | 76 | 26.319 | 47.615 | −0.208 | 1.00 | 35.57 | O |
| ATOM | 568 | N | LEU | A | 77 | 27.611 | 46.527 | −1.727 | 1.00 | 35.60 | N |
| ATOM | 569 | CA | LEU | A | 77 | 28.944 | 46.966 | −1.276 | 1.00 | 37.06 | C |
| ATOM | 570 | CB | LEU | A | 77 | 29.933 | 46.800 | −2.454 | 1.00 | 37.26 | C |
| ATOM | 571 | CG | LEU | A | 77 | 31.370 | 46.643 | −2.034 | 1.00 | 41.74 | C |
| ATOM | 572 | CD1 | LEU | A | 77 | 32.278 | 47.884 | −2.316 | 1.00 | 45.22 | C |
| ATOM | 573 | CD2 | LEU | A | 77 | 31.394 | 46.208 | −0.538 | 1.00 | 45.32 | C |
| ATOM | 574 | C | LEU | A | 77 | 29.088 | 48.406 | −0.736 | 1.00 | 36.23 | C |
| ATOM | 575 | O | LEU | A | 77 | 29.725 | 48.634 | 0.307 | 1.00 | 35.94 | O |
| ATOM | 576 | N | ARG | A | 78 | 28.550 | 49.361 | −1.492 | 1.00 | 35.16 | N |
| ATOM | 577 | CA | ARG | A | 78 | 28.822 | 50.744 | −1.264 | 1.00 | 35.98 | C |
| ATOM | 578 | CB | ARG | A | 78 | 29.283 | 51.384 | −2.582 | 1.00 | 36.55 | C |
| ATOM | 579 | CG | ARG | A | 78 | 30.678 | 50.918 | −3.103 | 1.00 | 39.84 | C |
| ATOM | 580 | CD | ARG | A | 78 | 30.948 | 51.248 | −4.592 | 1.00 | 45.88 | C |
| ATOM | 581 | NE | ARG | A | 78 | 30.779 | 52.690 | −4.811 | 1.00 | 49.47 | N |
| ATOM | 582 | CZ | ARG | A | 78 | 29.965 | 53.255 | −5.713 | 1.00 | 48.60 | C |
| ATOM | 583 | NH1 | ARG | A | 78 | 29.250 | 52.490 | −6.561 | 1.00 | 44.22 | N |
| ATOM | 584 | NH2 | ARG | A | 78 | 29.920 | 54.601 | −5.776 | 1.00 | 45.83 | N |
| ATOM | 585 | C | ARG | A | 78 | 27.567 | 51.411 | −0.741 | 1.00 | 36.22 | C |
| ATOM | 586 | O | ARG | A | 78 | 27.325 | 52.627 | −0.965 | 1.00 | 36.77 | O |
| ATOM | 587 | N | LYS | A | 79 | 26.753 | 50.603 | −0.053 | 1.00 | 35.92 | N |
| ATOM | 588 | CA | LYS | A | 79 | 25.482 | 51.032 | 0.534 | 1.00 | 34.46 | C |
| ATOM | 589 | CB | LYS | A | 79 | 24.365 | 50.250 | −0.122 | 1.00 | 33.75 | C |
| ATOM | 590 | CG | LYS | A | 79 | 24.315 | 50.445 | −1.610 | 1.00 | 32.90 | C |
| ATOM | 591 | CD | LYS | A | 79 | 22.905 | 50.267 | −2.122 | 1.00 | 33.09 | C |
| ATOM | 592 | CE | LYS | A | 79 | 22.795 | 50.379 | −3.657 | 1.00 | 34.16 | C |
| ATOM | 593 | NZ | LYS | A | 79 | 21.336 | 50.206 | −4.000 | 1.00 | 34.67 | N |
| ATOM | 594 | C | LYS | A | 79 | 25.472 | 50.800 | 2.048 | 1.00 | 34.30 | C |
| ATOM | 595 | O | LYS | A | 79 | 26.110 | 49.849 | 2.546 | 1.00 | 34.80 | O |
| ATOM | 596 | N | LYS | A | 80 | 24.765 | 51.676 | 2.769 | 1.00 | 33.17 | N |
| ATOM | 597 | CA | LYS | A | 80 | 24.309 | 51.388 | 4.119 | 1.00 | 32.58 | C |
| ATOM | 598 | CB | LYS | A | 80 | 23.643 | 52.608 | 4.757 | 1.00 | 33.33 | C |
| ATOM | 599 | CG | LYS | A | 80 | 24.533 | 53.687 | 5.287 | 1.00 | 35.93 | C |
| ATOM | 600 | CD | LYS | A | 80 | 23.684 | 54.930 | 5.708 | 1.00 | 43.43 | C |
| ATOM | 601 | CE | LYS | A | 80 | 22.634 | 54.620 | 6.813 | 1.00 | 46.31 | C |
| ATOM | 602 | NZ | LYS | A | 80 | 21.533 | 55.655 | 6.950 | 1.00 | 47.16 | N |
| ATOM | 603 | C | LYS | A | 80 | 23.238 | 50.290 | 4.025 | 1.00 | 31.30 | C |
| ATOM | 604 | O | LYS | A | 80 | 22.360 | 50.361 | 3.142 | 1.00 | 31.89 | O |
| ATOM | 605 | N | ILE | A | 81 | 23.326 | 49.283 | 4.894 | 1.00 | 28.79 | N |
| ATOM | 606 | CA | ILE | A | 81 | 22.279 | 48.305 | 5.062 | 1.00 | 27.54 | C |
| ATOM | 607 | CB | ILE | A | 81 | 22.823 | 46.852 | 4.953 | 1.00 | 28.44 | C |
| ATOM | 608 | CG1 | ILE | A | 81 | 23.258 | 46.542 | 3.506 | 1.00 | 26.56 | C |
| ATOM | 609 | CD1 | ILE | A | 81 | 24.341 | 45.457 | 3.461 | 1.00 | 25.49 | C |
| ATOM | 610 | CG2 | ILE | A | 81 | 21.718 | 45.814 | 5.246 | 1.00 | 27.21 | C |
| ATOM | 611 | C | ILE | A | 81 | 21.369 | 48.576 | 6.324 | 1.00 | 26.98 | C |
| ATOM | 612 | O | ILE | A | 81 | 21.826 | 48.834 | 7.453 | 1.00 | 25.28 | O |
| ATOM | 613 | N | VAL | A | 82 | 20.067 | 48.619 | 6.065 | 1.00 | 25.86 | N |
| ATOM | 614 | CA | VAL | A | 82 | 19.097 | 48.883 | 7.106 | 1.00 | 24.81 | C |
| ATOM | 615 | CB | VAL | A | 82 | 18.463 | 50.272 | 6.959 | 1.00 | 25.08 | C |
| ATOM | 616 | CG1 | VAL | A | 82 | 17.372 | 50.516 | 8.037 | 1.00 | 24.27 | C |
| ATOM | 617 | CG2 | VAL | A | 82 | 19.545 | 51.347 | 7.056 | 1.00 | 23.95 | C |
| ATOM | 618 | C | VAL | A | 82 | 18.062 | 47.765 | 7.141 | 1.00 | 24.34 | C |
| ATOM | 619 | O | VAL | A | 82 | 17.267 | 47.577 | 6.186 | 1.00 | 23.31 | O |
| ATOM | 620 | N | HIS | A | 83 | 18.168 | 46.977 | 8.218 | 1.00 | 23.68 | N |
| ATOM | 621 | CA | HIS | A | 83 | 17.140 | 46.036 | 8.638 | 1.00 | 23.40 | C |
| ATOM | 622 | CB | HIS | A | 83 | 17.710 | 44.994 | 9.618 | 1.00 | 23.75 | C |
| ATOM | 623 | CG | HIS | A | 83 | 16.667 | 44.047 | 10.157 | 1.00 | 25.25 | C |
| ATOM | 624 | ND1 | HIS | A | 83 | 16.947 | 43.089 | 11.108 | 1.00 | 25.43 | N |
| ATOM | 625 | CE1 | HIS | A | 83 | 15.841 | 42.416 | 11.392 | 1.00 | 24.89 | C |
| ATOM | 626 | NE2 | HIS | A | 83 | 14.862 | 42.886 | 10.641 | 1.00 | 25.43 | N |
| ATOM | 627 | CD2 | HIS | A | 83 | 15.354 | 43.897 | 9.848 | 1.00 | 23.41 | C |
| ATOM | 628 | C | HIS | A | 83 | 16.085 | 46.853 | 9.359 | 1.00 | 23.08 | C |
| ATOM | 629 | O | HIS | A | 83 | 16.356 | 47.386 | 10.399 | 1.00 | 22.98 | O |
| ATOM | 630 | N | TYR | A | 84 | 14.897 | 46.994 | 8.795 | 1.00 | 23.46 | N |
| ATOM | 631 | CA | TYR | A | 84 | 13.840 | 47.788 | 9.439 | 1.00 | 23.16 | C |
| ATOM | 632 | CB | TYR | A | 84 | 13.281 | 48.888 | 8.538 | 1.00 | 23.32 | C |
| ATOM | 633 | CG | TYR | A | 84 | 12.452 | 48.430 | 7.333 | 1.00 | 23.65 | C |
| ATOM | 634 | CD1 | TYR | A | 84 | 11.031 | 48.372 | 7.394 | 1.00 | 22.45 | C |
| ATOM | 635 | CE1 | TYR | A | 84 | 10.268 | 47.967 | 6.282 | 1.00 | 23.08 | C |
| ATOM | 636 | CZ | TYR | A | 84 | 10.946 | 47.620 | 5.086 | 1.00 | 25.73 | C |
| ATOM | 637 | OH | TYR | A | 84 | 10.256 | 47.211 | 3.975 | 1.00 | 27.67 | O |
| ATOM | 638 | CE2 | TYR | A | 84 | 12.344 | 47.691 | 4.994 | 1.00 | 22.09 | C |
| ATOM | 639 | CD2 | TYR | A | 84 | 13.085 | 48.106 | 6.116 | 1.00 | 23.02 | C |
| ATOM | 640 | C | TYR | A | 84 | 12.740 | 46.857 | 9.807 | 1.00 | 23.35 | C |
| ATOM | 641 | O | TYR | A | 84 | 12.655 | 45.738 | 9.255 | 1.00 | 22.88 | O |
| ATOM | 642 | N | THR | A | 85 | 11.938 | 47.289 | 10.771 | 1.00 | 22.98 | N |
| ATOM | 643 | CA | THR | A | 85 | 10.723 | 46.578 | 11.131 | 1.00 | 23.17 | C |
| ATOM | 644 | CB | THR | A | 85 | 10.950 | 45.731 | 12.436 | 1.00 | 23.24 | C |
| ATOM | 645 | OG1 | THR | A | 85 | 9.788 | 44.945 | 12.717 | 1.00 | 21.72 | O |
| ATOM | 646 | CG2 | THR | A | 85 | 11.125 | 46.621 | 13.685 | 1.00 | 21.59 | C |
| ATOM | 647 | C | THR | A | 85 | 9.631 | 47.671 | 11.234 | 1.00 | 24.47 | C |
| ATOM | 648 | O | THR | A | 85 | 9.892 | 48.831 | 10.806 | 1.00 | 25.06 | O |
| ATOM | 649 | N | CYS | A | 86 | 8.424 | 47.338 | 11.714 | 1.00 | 24.52 | N |
| ATOM | 650 | CA | CYS | A | 86 | 7.377 | 48.363 | 11.905 | 1.00 | 25.71 | C |
| ATOM | 651 | CB | CYS | A | 86 | 6.097 | 47.988 | 11.171 | 1.00 | 24.91 | C |
| ATOM | 652 | SG | CYS | A | 86 | 5.577 | 46.286 | 11.518 | 1.00 | 28.14 | S |
| ATOM | 653 | C | CYS | A | 86 | 7.049 | 48.561 | 13.365 | 1.00 | 26.56 | C |
| ATOM | 654 | O | CYS | A | 86 | 7.746 | 48.062 | 14.259 | 1.00 | 28.49 | O |
| ATOM | 655 | N | PHE | A | 87 | 5.947 | 49.236 | 13.609 | 1.00 | 27.49 | N |
| ATOM | 656 | CA | PHE | A | 87 | 5.474 | 49.520 | 14.957 | 1.00 | 28.28 | C |
| ATOM | 657 | CB | PHE | A | 87 | 4.905 | 50.944 | 15.004 | 1.00 | 30.20 | C |
| ATOM | 658 | CG | PHE | A | 87 | 5.978 | 52.011 | 15.157 | 1.00 | 32.60 | C |
| ATOM | 659 | CD1 | PHE | A | 87 | 6.670 | 52.483 | 14.039 | 1.00 | 33.30 | C |
| ATOM | 660 | CE1 | PHE | A | 87 | 7.667 | 53.427 | 14.163 | 1.00 | 36.55 | C |
| ATOM | 661 | CZ | PHE | A | 87 | 8.023 | 53.929 | 15.434 | 1.00 | 41.13 | C |
| ATOM | 662 | CE2 | PHE | A | 87 | 7.350 | 53.477 | 16.579 | 1.00 | 42.24 | C |
| ATOM | 663 | CD2 | PHE | A | 87 | 6.319 | 52.493 | 16.424 | 1.00 | 38.55 | C |
| ATOM | 664 | C | PHE | A | 87 | 4.486 | 48.509 | 15.550 | 1.00 | 27.81 | C |
| ATOM | 665 | O | PHE | A | 87 | 3.905 | 48.733 | 16.622 | 1.00 | 28.40 | O |
| ATOM | 666 | N | ASP | A | 88 | 4.281 | 47.406 | 14.839 | 1.00 | 26.53 | N |
| ATOM | 667 | CA | ASP | A | 88 | 3.817 | 46.180 | 15.438 | 1.00 | 25.44 | C |
| ATOM | 668 | CB | ASP | A | 88 | 3.559 | 45.168 | 14.277 | 1.00 | 25.07 | C |
| ATOM | 669 | CG | ASP | A | 88 | 2.998 | 43.816 | 14.751 | 1.00 | 27.95 | C |
| ATOM | 670 | OD1 | ASP | A | 88 | 3.205 | 43.384 | 15.903 | 1.00 | 29.33 | O |
| ATOM | 671 | OD2 | ASP | A | 88 | 2.325 | 43.076 | 13.998 | 1.00 | 33.99 | O |
| ATOM | 672 | C | ASP | A | 88 | 4.938 | 45.742 | 16.453 | 1.00 | 24.06 | C |
| ATOM | 673 | O | ASP | A | 88 | 5.998 | 45.271 | 16.087 | 1.00 | 24.52 | O |
| ATOM | 674 | N | GLN | A | 89 | 4.713 | 45.961 | 17.727 | 1.00 | 23.68 | N |
| ATOM | 675 | CA | GLN | A | 89 | 5.670 | 45.589 | 18.795 | 1.00 | 22.99 | C |
| ATOM | 676 | CB | GLN | A | 89 | 5.116 | 46.041 | 20.148 | 1.00 | 21.66 | C |
| ATOM | 677 | CG | GLN | A | 89 | 4.974 | 47.548 | 20.200 | 1.00 | 22.43 | C |
| ATOM | 678 | CD | GLN | A | 89 | 6.336 | 48.274 | 20.041 | 1.00 | 23.15 | C |
| ATOM | 679 | OE1 | GLN | A | 89 | 7.445 | 47.677 | 20.237 | 1.00 | 21.37 | O |
| ATOM | 680 | NE2 | GLN | A | 89 | 6.263 | 49.538 | 19.676 | 1.00 | 19.76 | N |
| ATOM | 681 | C | GLN | A | 89 | 6.118 | 44.106 | 18.888 | 1.00 | 23.50 | C |
| ATOM | 682 | O | GLN | A | 89 | 7.236 | 43.794 | 19.367 | 1.00 | 21.81 | O |
| ATOM | 683 | N | ARG | A | 90 | 5.234 | 43.197 | 18.456 | 1.00 | 22.98 | N |
| ATOM | 684 | CA | ARG | A | 90 | 5.568 | 41.789 | 18.475 | 1.00 | 22.87 | C |
| ATOM | 685 | CB | ARG | A | 90 | 4.290 | 40.930 | 18.521 | 1.00 | 23.02 | C |
| ATOM | 686 | CG | ARG | A | 90 | 3.435 | 41.371 | 19.725 | 1.00 | 22.17 | C |
| ATOM | 687 | CD | ARG | A | 90 | 2.147 | 40.597 | 20.019 | 1.00 | 23.75 | C |
| ATOM | 688 | NE | ARG | A | 90 | 1.522 | 41.136 | 21.230 | 1.00 | 25.10 | N |
| ATOM | 689 | CZ | ARG | A | 90 | 0.733 | 42.212 | 21.237 | 1.00 | 24.20 | C |
| ATOM | 690 | NH1 | ARG | A | 90 | 0.445 | 42.816 | 20.072 | 1.00 | 18.03 | N |
| ATOM | 691 | NH2 | ARG | A | 90 | 0.222 | 42.654 | 22.401 | 1.00 | 19.50 | N |
| ATOM | 692 | C | ARG | A | 90 | 6.508 | 41.412 | 17.341 | 1.00 | 22.91 | C |
| ATOM | 693 | O | ARG | A | 90 | 7.418 | 40.620 | 17.563 | 1.00 | 23.65 | O |
| ATOM | 694 | N | LYS | A | 91 | 6.261 | 41.945 | 16.135 | 1.00 | 22.85 | N |
| ATOM | 695 | CA | LYS | A | 91 | 7.202 | 41.868 | 15.026 | 1.00 | 22.49 | C |
| ATOM | 696 | CB | LYS | A | 91 | 6.621 | 42.553 | 13.778 | 1.00 | 24.25 | C |
| ATOM | 697 | CG | LYS | A | 91 | 5.408 | 41.838 | 13.161 | 1.00 | 25.33 | C |
| ATOM | 698 | CD | LYS | A | 91 | 5.816 | 40.790 | 12.183 | 1.00 | 29.92 | C |
| ATOM | 699 | CE | LYS | A | 91 | 4.742 | 39.696 | 12.059 | 1.00 | 28.71 | C |
| ATOM | 700 | NZ | LYS | A | 91 | 5.398 | 38.484 | 11.557 | 1.00 | 31.36 | N |
| ATOM | 701 | C | LYS | A | 91 | 8.515 | 42.556 | 15.362 | 1.00 | 21.22 | C |
| ATOM | 702 | O | LYS | A | 91 | 9.618 | 42.007 | 15.125 | 1.00 | 20.54 | O |
| ATOM | 703 | N | ARG | A | 92 | 8.392 | 43.764 | 15.905 | 1.00 | 19.60 | N |
| ATOM | 704 | CA | ARG | A | 92 | 9.544 | 44.577 | 16.258 | 1.00 | 18.86 | C |
| ATOM | 705 | CB | ARG | A | 92 | 9.068 | 45.884 | 16.833 | 1.00 | 18.24 | C |
| ATOM | 706 | CG | ARG | A | 92 | 10.211 | 46.787 | 17.242 | 1.00 | 17.54 | C |
| ATOM | 707 | CD | ARG | A | 92 | 9.732 | 47.982 | 18.039 | 1.00 | 19.99 | C |
| ATOM | 708 | NE | ARG | A | 92 | 10.732 | 48.998 | 18.357 | 1.00 | 22.45 | N |
| ATOM | 709 | CZ | ARG | A | 92 | 10.806 | 49.609 | 19.539 | 1.00 | 26.21 | C |
| ATOM | 710 | NH1 | ARG | A | 92 | 9.919 | 49.317 | 20.516 | 1.00 | 25.57 | N |
| ATOM | 711 | NH2 | ARG | A | 92 | 11.729 | 50.550 | 19.733 | 1.00 | 27.48 | N |
| ATOM | 712 | C | ARG | A | 92 | 10.527 | 43.910 | 17.255 | 1.00 | 19.97 | C |
| ATOM | 713 | O | ARG | A | 92 | 11.723 | 44.067 | 17.087 | 1.00 | 20.04 | O |
| ATOM | 714 | N | ALA | A | 93 | 10.022 | 43.156 | 18.256 | 1.00 | 19.68 | N |
| ATOM | 715 | CA | ALA | A | 93 | 10.868 | 42.520 | 19.263 | 1.00 | 20.02 | C |
| ATOM | 716 | CB | ALA | A | 93 | 10.051 | 42.008 | 20.408 | 1.00 | 17.43 | C |
| ATOM | 717 | C | ALA | A | 93 | 11.643 | 41.379 | 18.600 | 1.00 | 21.04 | C |
| ATOM | 718 | O | ALA | A | 93 | 12.830 | 41.187 | 18.832 | 1.00 | 20.73 | O |
| ATOM | 719 | N | ASN | A | 94 | 10.947 | 40.641 | 17.741 | 1.00 | 21.86 | N |
| ATOM | 720 | CA | ASN | A | 94 | 11.553 | 39.568 | 17.014 | 1.00 | 22.80 | C |
| ATOM | 721 | CB | ASN | A | 94 | 10.491 | 38.771 | 16.272 | 1.00 | 22.93 | C |
| ATOM | 722 | CG | ASN | A | 94 | 9.896 | 37.709 | 17.113 | 1.00 | 24.46 | C |
| ATOM | 723 | OD1 | ASN | A | 94 | 10.609 | 36.824 | 17.660 | 1.00 | 23.67 | O |
| ATOM | 724 | ND2 | ASN | A | 94 | 8.567 | 37.764 | 17.246 | 1.00 | 23.49 | N |
| ATOM | 725 | C | ASN | A | 94 | 12.591 | 40.079 | 16.017 | 1.00 | 23.68 | C |
| ATOM | 726 | O | ASN | A | 94 | 13.616 | 39.427 | 15.823 | 1.00 | 24.67 | O |
| ATOM | 727 | N | ALA | A | 95 | 12.330 | 41.223 | 15.365 | 1.00 | 23.75 | N |
| ATOM | 728 | CA | ALA | A | 95 | 13.303 | 41.780 | 14.423 | 1.00 | 23.02 | C |
| ATOM | 729 | CB | ALA | A | 95 | 12.706 | 42.938 | 13.686 | 1.00 | 22.91 | C |
| ATOM | 730 | C | ALA | A | 95 | 14.534 | 42.231 | 15.207 | 1.00 | 22.92 | C |
| ATOM | 731 | O | ALA | A | 95 | 15.674 | 41.975 | 14.798 | 1.00 | 23.39 | O |
| ATOM | 732 | N | ALA | A | 96 | 14.291 | 42.905 | 16.327 | 1.00 | 22.79 | N |
| ATOM | 733 | CA | ALA | A | 96 | 15.361 | 43.340 | 17.264 | 1.00 | 22.63 | C |
| ATOM | 734 | CB | ALA | A | 96 | 14.776 | 44.099 | 18.458 | 1.00 | 20.68 | C |
| ATOM | 735 | C | ALA | A | 96 | 16.195 | 42.141 | 17.721 | 1.00 | 23.09 | C |
| ATOM | 736 | O | ALA | A | 96 | 17.425 | 42.158 | 17.578 | 1.00 | 24.19 | O |
| ATOM | 737 | N | PHE | A | 97 | 15.518 | 41.080 | 18.185 | 1.00 | 22.58 | N |
| ATOM | 738 | CA | PHE | A | 97 | 16.157 | 39.844 | 18.588 | 1.00 | 21.23 | C |
| ATOM | 739 | CB | PHE | A | 97 | 15.082 | 38.826 | 19.021 | 1.00 | 21.64 | C |
| ATOM | 740 | CG | PHE | A | 97 | 15.573 | 37.360 | 19.027 | 1.00 | 22.22 | C |
| ATOM | 741 | CD1 | PHE | A | 97 | 16.621 | 36.956 | 19.860 | 1.00 | 18.26 | C |
| ATOM | 742 | CE1 | PHE | A | 97 | 17.068 | 35.634 | 19.859 | 1.00 | 20.21 | C |
| ATOM | 743 | CZ | PHE | A | 97 | 16.457 | 34.672 | 19.035 | 1.00 | 17.63 | C |
| ATOM | 744 | CE2 | PHE | A | 97 | 15.399 | 35.045 | 18.200 | 1.00 | 21.17 | C |
| ATOM | 745 | CD2 | PHE | A | 97 | 14.963 | 36.396 | 18.188 | 1.00 | 23.02 | C |
| ATOM | 746 | C | PHE | A | 97 | 17.069 | 39.240 | 17.504 | 1.00 | 20.49 | C |
| ATOM | 747 | O | PHE | A | 97 | 18.188 | 38.770 | 17.810 | 1.00 | 20.28 | O |
| ATOM | 748 | N | LEU | A | 98 | 16.578 | 39.250 | 16.260 | 1.00 | 19.14 | N |
| ATOM | 749 | CA | LEU | A | 98 | 17.280 | 38.669 | 15.123 | 1.00 | 18.12 | C |
| ATOM | 750 | CB | LEU | A | 98 | 16.436 | 38.729 | 13.852 | 1.00 | 17.22 | C |
| ATOM | 751 | CG | LEU | A | 98 | 15.285 | 37.705 | 13.808 | 1.00 | 12.82 | C |
| ATOM | 752 | CD1 | LEU | A | 98 | 14.570 | 37.771 | 12.495 | 1.00 | 13.88 | C |
| ATOM | 753 | CD2 | LEU | A | 98 | 15.795 | 36.325 | 14.010 | 1.00 | 10.79 | C |
| ATOM | 754 | C | LEU | A | 98 | 18.620 | 39.355 | 14.921 | 1.00 | 19.17 | C |
| ATOM | 755 | O | LEU | A | 98 | 19.677 | 38.698 | 14.931 | 1.00 | 18.82 | O |
| ATOM | 756 | N | ILE | A | 99 | 18.591 | 40.677 | 14.788 | 1.00 | 20.17 | N |
| ATOM | 757 | CA | ILE | A | 99 | 19.818 | 41.407 | 14.510 | 1.00 | 21.46 | C |
| ATOM | 758 | CB | ILE | A | 99 | 19.550 | 42.849 | 13.968 | 1.00 | 22.67 | C |
| ATOM | 759 | CG1 | ILE | A | 99 | 20.824 | 43.358 | 13.253 | 1.00 | 25.07 | C |
| ATOM | 760 | CD1 | ILE | A | 99 | 20.749 | 44.792 | 12.789 | 1.00 | 26.95 | C |
| ATOM | 761 | CG2 | ILE | A | 99 | 19.003 | 43.828 | 15.076 | 1.00 | 19.79 | C |
| ATOM | 762 | C | ILE | A | 99 | 20.780 | 41.383 | 15.707 | 1.00 | 22.23 | C |
| ATOM | 763 | O | ILE | A | 99 | 21.976 | 41.217 | 15.510 | 1.00 | 22.73 | O |
| ATOM | 764 | N | GLY | A | 100 | 20.275 | 41.522 | 16.940 | 1.00 | 22.57 | N |
| ATOM | 765 | CA | GLY | A | 100 | 21.081 | 41.242 | 18.131 | 1.00 | 22.63 | C |
| ATOM | 766 | C | GLY | A | 100 | 21.748 | 39.866 | 18.112 | 1.00 | 23.87 | C |
| ATOM | 767 | O | GLY | A | 100 | 22.891 | 39.710 | 18.531 | 1.00 | 23.91 | O |
| ATOM | 768 | N | ALA | A | 101 | 21.034 | 38.841 | 17.652 | 1.00 | 24.80 | N |
| ATOM | 769 | CA | ALA | A | 101 | 21.618 | 37.495 | 17.637 | 1.00 | 25.52 | C |
| ATOM | 770 | CB | ALA | A | 101 | 20.556 | 36.428 | 17.383 | 1.00 | 24.83 | C |
| ATOM | 771 | C | ALA | A | 101 | 22.724 | 37.432 | 16.570 | 1.00 | 26.10 | C |
| ATOM | 772 | O | ALA | A | 101 | 23.759 | 36.789 | 16.783 | 1.00 | 25.75 | O |
| ATOM | 773 | N | TYR | A | 102 | 22.489 | 38.091 | 15.430 | 1.00 | 25.89 | N |
| ATOM | 774 | CA | TYR | A | 102 | 23.548 | 38.231 | 14.434 | 1.00 | 27.00 | C |
| ATOM | 775 | CB | TYR | A | 102 | 23.061 | 38.997 | 13.198 | 1.00 | 26.28 | C |
| ATOM | 776 | CG | TYR | A | 102 | 24.157 | 39.098 | 12.133 | 1.00 | 28.41 | C |
| ATOM | 777 | CD1 | TYR | A | 102 | 24.246 | 38.149 | 11.106 | 1.00 | 26.73 | C |
| ATOM | 778 | CE1 | TYR | A | 102 | 25.238 | 38.220 | 10.130 | 1.00 | 25.58 | C |
| ATOM | 779 | CZ | TYR | A | 102 | 26.189 | 39.231 | 10.178 | 1.00 | 26.70 | C |
| ATOM | 780 | OH | TYR | A | 102 | 27.184 | 39.274 | 9.210 | 1.00 | 27.65 | O |
| ATOM | 781 | CE2 | TYR | A | 102 | 26.148 | 40.194 | 11.193 | 1.00 | 27.35 | C |
| ATOM | 782 | CD2 | TYR | A | 102 | 25.133 | 40.125 | 12.176 | 1.00 | 27.22 | C |
| ATOM | 783 | C | TYR | A | 102 | 24.852 | 38.906 | 15.024 | 1.00 | 27.41 | C |
| ATOM | 784 | O | TYR | A | 102 | 25.975 | 38.423 | 14.826 | 1.00 | 28.19 | O |
| ATOM | 785 | N | ALA | A | 103 | 24.669 | 40.022 | 15.717 | 1.00 | 26.71 | N |
| ATOM | 786 | CA | ALA | A | 103 | 25.722 | 40.767 | 16.347 | 1.00 | 26.63 | C |
| ATOM | 787 | CB | ALA | A | 103 | 25.116 | 41.945 | 17.093 | 1.00 | 26.52 | C |
| ATOM | 788 | C | ALA | A | 103 | 26.514 | 39.844 | 17.283 | 1.00 | 26.86 | C |
| ATOM | 789 | O | ALA | A | 103 | 27.743 | 39.774 | 17.205 | 1.00 | 27.99 | O |
| ATOM | 790 | N | VAL | A | 104 | 25.820 | 39.101 | 18.131 | 1.00 | 26.43 | N |
| ATOM | 791 | CA | VAL | A | 104 | 26.484 | 38.119 | 19.006 | 1.00 | 25.44 | C |
| ATOM | 792 | CB | VAL | A | 104 | 25.501 | 37.467 | 20.010 | 1.00 | 25.13 | C |
| ATOM | 793 | CG1 | VAL | A | 104 | 26.212 | 36.382 | 20.852 | 1.00 | 21.00 | C |
| ATOM | 794 | CG2 | VAL | A | 104 | 24.812 | 38.513 | 20.861 | 1.00 | 21.99 | C |
| ATOM | 795 | C | VAL | A | 104 | 27.201 | 36.993 | 18.254 | 1.00 | 25.58 | C |
| ATOM | 796 | O | VAL | A | 104 | 28.311 | 36.604 | 18.651 | 1.00 | 25.47 | O |
| ATOM | 797 | N | ILE | A | 105 | 26.591 | 36.468 | 17.189 | 1.00 | 25.87 | N |
| ATOM | 798 | CA | ILE | A | 105 | 27.198 | 35.313 | 16.503 | 1.00 | 26.40 | C |
| ATOM | 799 | CB | ILE | A | 105 | 26.181 | 34.410 | 15.758 | 1.00 | 26.12 | C |
| ATOM | 800 | CG1 | ILE | A | 105 | 25.234 | 33.724 | 16.740 | 1.00 | 24.84 | C |
| ATOM | 801 | CD1 | ILE | A | 105 | 23.832 | 33.527 | 16.179 | 1.00 | 22.42 | C |
| ATOM | 802 | CG2 | ILE | A | 105 | 26.897 | 33.349 | 14.957 | 1.00 | 23.46 | C |
| ATOM | 803 | C | ILE | A | 105 | 28.298 | 35.766 | 15.552 | 1.00 | 27.57 | C |
| ATOM | 804 | O | ILE | A | 105 | 29.393 | 35.197 | 15.552 | 1.00 | 26.48 | O |
| ATOM | 805 | N | TYR | A | 106 | 28.014 | 36.811 | 14.770 | 1.00 | 28.26 | N |
| ATOM | 806 | CA | TYR | A | 106 | 28.912 | 37.173 | 13.672 | 1.00 | 29.03 | C |
| ATOM | 807 | CB | TYR | A | 106 | 28.139 | 37.221 | 12.356 | 1.00 | 28.77 | C |
| ATOM | 808 | CG | TYR | A | 106 | 27.629 | 35.874 | 12.051 | 1.00 | 26.91 | C |
| ATOM | 809 | CD1 | TYR | A | 106 | 28.513 | 34.862 | 11.640 | 1.00 | 28.72 | C |
| ATOM | 810 | CE1 | TYR | A | 106 | 28.052 | 33.532 | 11.389 | 1.00 | 26.22 | C |
| ATOM | 811 | CZ | TYR | A | 106 | 26.724 | 33.260 | 11.554 | 1.00 | 23.02 | C |
| ATOM | 812 | OH | TYR | A | 106 | 26.296 | 31.968 | 11.353 | 1.00 | 27.51 | O |
| ATOM | 813 | CE2 | TYR | A | 106 | 25.832 | 34.273 | 11.952 | 1.00 | 24.11 | C |
| ATOM | 814 | CD2 | TYR | A | 106 | 26.292 | 35.562 | 12.218 | 1.00 | 23.29 | C |
| ATOM | 815 | C | TYR | A | 106 | 29.742 | 38.432 | 13.866 | 1.00 | 30.17 | C |
| ATOM | 816 | O | TYR | A | 106 | 30.730 | 38.614 | 13.149 | 1.00 | 30.38 | O |
| ATOM | 817 | N | LEU | A | 107 | 29.368 | 39.270 | 14.836 | 1.00 | 30.49 | N |
| ATOM | 818 | CA | LEU | A | 107 | 30.060 | 40.542 | 15.040 | 1.00 | 32.24 | C |
| ATOM | 819 | CB | LEU | A | 107 | 29.071 | 41.712 | 14.891 | 1.00 | 31.33 | C |
| ATOM | 820 | CG | LEU | A | 107 | 28.348 | 42.044 | 13.566 | 1.00 | 30.42 | C |
| ATOM | 821 | CD1 | LEU | A | 107 | 27.535 | 43.321 | 13.801 | 1.00 | 27.56 | C |
| ATOM | 822 | CD2 | LEU | A | 107 | 29.202 | 42.247 | 12.309 | 1.00 | 24.25 | C |
| ATOM | 823 | C | LEU | A | 107 | 30.843 | 40.639 | 16.375 | 1.00 | 32.88 | C |
| ATOM | 824 | O | LEU | A | 107 | 31.315 | 41.700 | 16.757 | 1.00 | 32.31 | O |
| ATOM | 825 | N | LYS | A | 108 | 30.921 | 39.514 | 17.078 | 1.00 | 34.97 | N |
| ATOM | 826 | CA | LYS | A | 108 | 31.642 | 39.355 | 18.367 | 1.00 | 36.91 | C |
| ATOM | 827 | CB | LYS | A | 108 | 33.161 | 39.369 | 18.172 | 1.00 | 38.04 | C |
| ATOM | 828 | CG | LYS | A | 108 | 33.752 | 37.921 | 18.065 | 1.00 | 45.38 | C |
| ATOM | 829 | CD | LYS | A | 108 | 34.774 | 37.750 | 16.877 | 1.00 | 53.27 | C |
| ATOM | 830 | CE | LYS | A | 108 | 36.255 | 38.020 | 17.301 | 1.00 | 55.83 | C |
| ATOM | 831 | NZ | LYS | A | 108 | 37.025 | 38.576 | 16.130 | 1.00 | 56.41 | N |
| ATOM | 832 | C | LYS | A | 108 | 31.238 | 40.325 | 19.437 | 1.00 | 36.01 | C |
| ATOM | 833 | O | LYS | A | 108 | 32.065 | 40.757 | 20.250 | 1.00 | 36.78 | O |
| ATOM | 834 | N | LYS | A | 109 | 29.960 | 40.687 | 19.432 | 1.00 | 34.53 | N |
| ATOM | 835 | CA | LYS | A | 109 | 29.434 | 41.571 | 20.449 | 1.00 | 32.34 | C |
| ATOM | 836 | CB | LYS | A | 109 | 28.324 | 42.439 | 19.877 | 1.00 | 32.47 | C |
| ATOM | 837 | CG | LYS | A | 109 | 28.849 | 43.578 | 19.041 | 1.00 | 34.25 | C |
| ATOM | 838 | CD | LYS | A | 109 | 27.887 | 43.944 | 17.966 | 1.00 | 40.41 | C |
| ATOM | 839 | CE | LYS | A | 109 | 27.819 | 45.454 | 17.781 | 1.00 | 44.11 | C |
| ATOM | 840 | NZ | LYS | A | 109 | 26.755 | 45.987 | 18.721 | 1.00 | 44.88 | N |
| ATOM | 841 | C | LYS | A | 109 | 28.946 | 40.724 | 21.592 | 1.00 | 30.94 | C |
| ATOM | 842 | O | LYS | A | 109 | 28.547 | 39.574 | 21.419 | 1.00 | 31.39 | O |
| ATOM | 843 | N | THR | A | 110 | 28.999 | 41.282 | 22.774 | 1.00 | 29.11 | N |
| ATOM | 844 | CA | THR | A | 110 | 28.409 | 40.623 | 23.901 | 1.00 | 27.95 | C |
| ATOM | 845 | CB | THR | A | 110 | 29.034 | 41.096 | 25.276 | 1.00 | 28.33 | C |
| ATOM | 846 | OG1 | THR | A | 110 | 28.761 | 42.493 | 25.475 | 1.00 | 26.85 | O |
| ATOM | 847 | CG2 | THR | A | 110 | 30.628 | 40.915 | 25.309 | 1.00 | 22.67 | C |
| ATOM | 848 | C | THR | A | 110 | 26.913 | 40.902 | 23.815 | 1.00 | 27.94 | C |
| ATOM | 849 | O | THR | A | 110 | 26.476 | 41.843 | 23.105 | 1.00 | 27.73 | O |
| ATOM | 850 | N | PRO | A | 111 | 26.116 | 40.083 | 24.497 | 1.00 | 27.19 | N |
| ATOM | 851 | CA | PRO | A | 111 | 24.674 | 40.355 | 24.573 | 1.00 | 27.89 | C |
| ATOM | 852 | CB | PRO | A | 111 | 24.175 | 39.302 | 25.548 | 1.00 | 27.39 | C |
| ATOM | 853 | CG | PRO | A | 111 | 25.169 | 38.113 | 25.259 | 1.00 | 27.23 | C |
| ATOM | 854 | CD | PRO | A | 111 | 26.493 | 38.823 | 25.154 | 1.00 | 26.12 | C |
| ATOM | 855 | C | PRO | A | 111 | 24.413 | 41.784 | 25.031 | 1.00 | 29.19 | C |
| ATOM | 856 | O | PRO | A | 111 | 23.555 | 42.416 | 24.417 | 1.00 | 29.81 | O |
| ATOM | 857 | N | GLU | A | 112 | 25.195 | 42.283 | 26.020 | 1.00 | 30.20 | N |
| ATOM | 858 | CA | GLU | A | 112 | 25.040 | 43.607 | 26.631 | 1.00 | 29.83 | C |
| ATOM | 859 | CB | GLU | A | 112 | 25.946 | 43.730 | 27.881 | 1.00 | 30.47 | C |
| ATOM | 860 | CG | GLU | A | 112 | 26.042 | 45.123 | 28.523 | 1.00 | 29.09 | C |
| ATOM | 861 | CD | GLU | A | 112 | 24.754 | 45.592 | 29.214 | 1.00 | 29.95 | C |
| ATOM | 862 | OE1 | GLU | A | 112 | 24.635 | 46.821 | 29.476 | 1.00 | 27.45 | O |
| ATOM | 863 | OE2 | GLU | A | 112 | 23.839 | 44.745 | 29.482 | 1.00 | 30.96 | O |
| ATOM | 864 | C | GLU | A | 112 | 25.311 | 44.713 | 25.626 | 1.00 | 29.55 | C |
| ATOM | 865 | O | GLU | A | 112 | 24.530 | 45.647 | 25.516 | 1.00 | 29.49 | O |
| ATOM | 866 | N | GLU | A | 113 | 26.426 | 44.608 | 24.917 | 1.00 | 29.44 | N |
| ATOM | 867 | CA | GLU | A | 113 | 26.733 | 45.497 | 23.808 | 1.00 | 29.90 | C |
| ATOM | 868 | CB | GLU | A | 113 | 28.004 | 45.023 | 23.116 | 1.00 | 29.87 | C |
| ATOM | 869 | CG | GLU | A | 113 | 29.331 | 45.490 | 23.641 | 1.00 | 34.06 | C |
| ATOM | 870 | CD | GLU | A | 113 | 30.451 | 44.724 | 22.934 | 1.00 | 39.46 | C |
| ATOM | 871 | OE1 | GLU | A | 113 | 31.229 | 45.296 | 22.150 | 1.00 | 46.18 | O |
| ATOM | 872 | OE2 | GLU | A | 113 | 30.553 | 43.514 | 23.090 | 1.00 | 41.26 | O |
| ATOM | 873 | C | GLU | A | 113 | 25.590 | 45.481 | 22.737 | 1.00 | 29.46 | C |
| ATOM | 874 | O | GLU | A | 113 | 25.137 | 46.539 | 22.275 | 1.00 | 29.52 | O |
| ATOM | 875 | N | ALA | A | 114 | 25.160 | 44.294 | 22.306 | 1.00 | 29.15 | N |
| ATOM | 876 | CA | ALA | A | 114 | 24.099 | 44.204 | 21.264 | 1.00 | 29.08 | C |
| ATOM | 877 | CB | ALA | A | 114 | 23.825 | 42.783 | 20.914 | 1.00 | 28.02 | C |
| ATOM | 878 | C | ALA | A | 114 | 22.823 | 44.870 | 21.776 | 1.00 | 29.47 | C |
| ATOM | 879 | O | ALA | A | 114 | 22.127 | 45.587 | 21.035 | 1.00 | 29.76 | O |
| ATOM | 880 | N | TYR | A | 115 | 22.555 | 44.657 | 23.064 | 1.00 | 28.65 | N |
| ATOM | 881 | CA | TYR | A | 115 | 21.335 | 45.111 | 23.650 | 1.00 | 28.89 | C |
| ATOM | 882 | CB | TYR | A | 115 | 21.092 | 44.422 | 24.999 | 1.00 | 29.03 | C |
| ATOM | 883 | CG | TYR | A | 115 | 19.793 | 44.838 | 25.669 | 1.00 | 30.80 | C |
| ATOM | 884 | CD1 | TYR | A | 115 | 18.558 | 44.612 | 25.060 | 1.00 | 35.00 | C |
| ATOM | 885 | CE1 | TYR | A | 115 | 17.358 | 44.964 | 25.694 | 1.00 | 35.83 | C |
| ATOM | 886 | CZ | TYR | A | 115 | 17.403 | 45.574 | 26.929 | 1.00 | 34.86 | C |
| ATOM | 887 | OH | TYR | A | 115 | 16.242 | 45.954 | 27.534 | 1.00 | 38.54 | O |
| ATOM | 888 | CE2 | TYR | A | 115 | 18.605 | 45.824 | 27.543 | 1.00 | 34.31 | C |
| ATOM | 889 | CD2 | TYR | A | 115 | 19.795 | 45.446 | 26.917 | 1.00 | 34.66 | C |
| ATOM | 890 | C | TYR | A | 115 | 21.428 | 46.606 | 23.793 | 1.00 | 28.40 | C |
| ATOM | 891 | O | TYR | A | 115 | 20.436 | 47.307 | 23.608 | 1.00 | 27.89 | O |
| ATOM | 892 | N | ARG | A | 116 | 22.635 | 47.073 | 24.138 | 1.00 | 27.90 | N |
| ATOM | 893 | CA | ARG | A | 116 | 22.903 | 48.498 | 24.305 | 1.00 | 27.17 | C |
| ATOM | 894 | CB | ARG | A | 116 | 24.359 | 48.723 | 24.764 | 1.00 | 27.73 | C |
| ATOM | 895 | CG | ARG | A | 116 | 24.531 | 49.360 | 26.147 | 1.00 | 27.66 | C |
| ATOM | 896 | CD | ARG | A | 116 | 25.268 | 48.564 | 27.200 | 1.00 | 27.14 | C |
| ATOM | 897 | NE | ARG | A | 116 | 26.480 | 49.287 | 27.444 | 1.00 | 31.22 | N |
| ATOM | 898 | CZ | ARG | A | 116 | 27.319 | 49.178 | 28.489 | 1.00 | 30.27 | C |
| ATOM | 899 | NH1 | ARG | A | 116 | 27.121 | 48.359 | 29.514 | 1.00 | 22.78 | N |
| ATOM | 900 | NH2 | ARG | A | 116 | 28.399 | 49.948 | 28.468 | 1.00 | 30.55 | N |
| ATOM | 901 | C | ARG | A | 116 | 22.640 | 49.162 | 22.955 | 1.00 | 26.79 | C |
| ATOM | 902 | O | ARG | A | 116 | 21.921 | 50.131 | 22.901 | 1.00 | 25.84 | O |
| ATOM | 903 | N | ALA | A | 117 | 23.174 | 48.589 | 21.859 | 1.00 | 25.50 | N |
| ATOM | 904 | CA | ALA | A | 117 | 22.916 | 49.087 | 20.526 | 1.00 | 24.83 | C |
| ATOM | 905 | CB | ALA | A | 117 | 23.617 | 48.252 | 19.503 | 1.00 | 24.55 | C |
| ATOM | 906 | C | ALA | A | 117 | 21.423 | 49.177 | 20.221 | 1.00 | 26.27 | C |
| ATOM | 907 | O | ALA | A | 117 | 20.991 | 50.170 | 19.666 | 1.00 | 25.96 | O |
| ATOM | 908 | N | LEU | A | 118 | 20.633 | 48.176 | 20.630 | 1.00 | 28.06 | N |
| ATOM | 909 | CA | LEU | A | 118 | 19.175 | 48.156 | 20.403 | 1.00 | 30.15 | C |
| ATOM | 910 | CB | LEU | A | 118 | 18.535 | 46.816 | 20.834 | 1.00 | 28.28 | C |
| ATOM | 911 | CG | LEU | A | 118 | 18.890 | 45.592 | 19.978 | 1.00 | 26.73 | C |
| ATOM | 912 | CD1 | LEU | A | 118 | 18.323 | 44.316 | 20.625 | 1.00 | 23.60 | C |
| ATOM | 913 | CD2 | LEU | A | 118 | 18.551 | 45.747 | 18.445 | 1.00 | 19.36 | C |
| ATOM | 914 | C | LEU | A | 118 | 18.425 | 49.243 | 21.141 | 1.00 | 33.49 | C |
| ATOM | 915 | O | LEU | A | 118 | 17.328 | 49.597 | 20.738 | 1.00 | 34.26 | O |
| ATOM | 916 | N | LEU | A | 119 | 18.958 | 49.730 | 22.262 | 1.00 | 37.01 | N |
| ATOM | 917 | CA | LEU | A | 119 | 18.163 | 50.641 | 23.067 | 1.00 | 40.25 | C |
| ATOM | 918 | CB | LEU | A | 119 | 18.245 | 50.368 | 24.573 | 1.00 | 40.28 | C |
| ATOM | 919 | CG | LEU | A | 119 | 19.496 | 49.992 | 25.366 | 1.00 | 42.24 | C |
| ATOM | 920 | CD1 | LEU | A | 119 | 20.677 | 51.138 | 25.505 | 1.00 | 44.50 | C |
| ATOM | 921 | CD2 | LEU | A | 119 | 19.020 | 49.531 | 26.725 | 1.00 | 39.51 | C |
| ATOM | 922 | C | LEU | A | 119 | 18.496 | 52.058 | 22.704 | 1.00 | 42.83 | C |
| ATOM | 923 | O | LEU | A | 119 | 18.006 | 53.005 | 23.346 | 1.00 | 43.04 | O |
| ATOM | 924 | N | SER | A | 120 | 19.277 | 52.186 | 21.622 | 1.00 | 45.43 | N |
| ATOM | 925 | CA | SER | A | 120 | 19.840 | 53.470 | 21.222 | 1.00 | 47.93 | C |
| ATOM | 926 | CB | SER | A | 120 | 21.365 | 53.378 | 20.889 | 1.00 | 47.58 | C |
| ATOM | 927 | OG | SER | A | 120 | 21.653 | 52.891 | 19.583 | 1.00 | 45.53 | O |
| ATOM | 928 | C | SER | A | 120 | 19.054 | 54.194 | 20.131 | 1.00 | 49.80 | C |
| ATOM | 929 | O | SER | A | 120 | 19.501 | 54.286 | 19.008 | 1.00 | 50.21 | O |
| ATOM | 930 | N | GLY | A | 121 | 17.889 | 54.729 | 20.474 | 1.00 | 52.03 | N |
| ATOM | 931 | CA | GLY | A | 121 | 17.262 | 55.732 | 19.619 | 1.00 | 54.16 | C |
| ATOM | 932 | C | GLY | A | 121 | 15.765 | 55.583 | 19.729 | 1.00 | 55.85 | C |
| ATOM | 933 | O | GLY | A | 121 | 15.029 | 56.449 | 20.308 | 1.00 | 56.66 | O |
| ATOM | 934 | N | SER | A | 122 | 15.305 | 54.456 | 19.182 | 1.00 | 55.84 | N |
| ATOM | 935 | CA | SER | A | 122 | 13.944 | 54.046 | 19.458 | 1.00 | 55.43 | C |
| ATOM | 936 | CB | SER | A | 122 | 13.323 | 53.255 | 18.307 | 1.00 | 55.58 | C |
| ATOM | 937 | OG | SER | A | 122 | 12.847 | 54.149 | 17.312 | 1.00 | 55.39 | O |
| ATOM | 938 | C | SER | A | 122 | 13.860 | 53.341 | 20.823 | 1.00 | 54.71 | C |
| ATOM | 939 | O | SER | A | 122 | 14.392 | 52.213 | 21.026 | 1.00 | 54.73 | O |
| ATOM | 940 | N | ASN | A | 123 | 13.381 | 54.157 | 21.781 | 1.00 | 52.84 | N |
| ATOM | 941 | CA | ASN | A | 123 | 12.287 | 53.813 | 22.683 | 1.00 | 49.95 | C |
| ATOM | 942 | CB | ASN | A | 123 | 12.409 | 54.527 | 24.053 | 1.00 | 51.19 | C |
| ATOM | 943 | CG | ASN | A | 123 | 12.687 | 53.523 | 25.243 | 1.00 | 54.07 | C |
| ATOM | 944 | OD1 | ASN | A | 123 | 12.220 | 53.729 | 26.393 | 1.00 | 51.68 | O |
| ATOM | 945 | ND2 | ASN | A | 123 | 13.447 | 52.425 | 24.944 | 1.00 | 56.52 | N |
| ATOM | 946 | C | ASN | A | 123 | 11.153 | 54.377 | 21.815 | 1.00 | 46.56 | C |
| ATOM | 947 | O | ASN | A | 123 | 11.401 | 55.361 | 21.111 | 1.00 | 47.75 | O |
| ATOM | 948 | N | PRO | A | 124 | 9.937 | 53.823 | 21.821 | 1.00 | 42.45 | N |
| ATOM | 949 | CA | PRO | A | 124 | 9.383 | 52.996 | 22.908 | 1.00 | 38.79 | C |
| ATOM | 950 | CB | PRO | A | 124 | 7.994 | 52.612 | 22.371 | 1.00 | 38.26 | C |
| ATOM | 951 | CG | PRO | A | 124 | 8.137 | 52.699 | 20.904 | 1.00 | 40.81 | C |
| ATOM | 952 | CD | PRO | A | 124 | 8.995 | 53.945 | 20.691 | 1.00 | 42.10 | C |
| ATOM | 953 | C | PRO | A | 124 | 10.207 | 51.745 | 23.273 | 1.00 | 35.01 | C |
| ATOM | 954 | O | PRO | A | 124 | 11.069 | 51.303 | 22.516 | 1.00 | 34.14 | O |
| ATOM | 955 | N | PRO | A | 125 | 9.945 | 51.194 | 24.442 | 1.00 | 32.31 | N |
| ATOM | 956 | CA | PRO | A | 125 | 10.600 | 49.946 | 24.831 | 1.00 | 31.12 | C |
| ATOM | 957 | CB | PRO | A | 125 | 10.197 | 49.755 | 26.301 | 1.00 | 30.53 | C |
| ATOM | 958 | CG | PRO | A | 125 | 9.512 | 50.992 | 26.699 | 1.00 | 32.36 | C |
| ATOM | 959 | CD | PRO | A | 125 | 9.016 | 51.702 | 25.474 | 1.00 | 31.76 | C |
| ATOM | 960 | C | PRO | A | 125 | 10.094 | 48.785 | 23.988 | 1.00 | 30.23 | C |
| ATOM | 961 | O | PRO | A | 125 | 9.026 | 48.865 | 23.368 | 1.00 | 30.66 | O |
| ATOM | 962 | N | TYR | A | 126 | 10.888 | 47.728 | 23.926 | 1.00 | 28.51 | N |
| ATOM | 963 | CA | TYR | A | 126 | 10.447 | 46.472 | 23.353 | 1.00 | 26.99 | C |
| ATOM | 964 | CB | TYR | A | 126 | 11.670 | 45.608 | 23.083 | 1.00 | 26.64 | C |
| ATOM | 965 | CG | TYR | A | 126 | 12.631 | 46.286 | 22.143 | 1.00 | 22.34 | C |
| ATOM | 966 | CD1 | TYR | A | 126 | 13.761 | 46.943 | 22.636 | 1.00 | 21.11 | C |
| ATOM | 967 | CE1 | TYR | A | 126 | 14.645 | 47.586 | 21.793 | 1.00 | 19.27 | C |
| ATOM | 968 | CZ | TYR | A | 126 | 14.412 | 47.584 | 20.393 | 1.00 | 20.18 | C |
| ATOM | 969 | OH | TYR | A | 126 | 15.300 | 48.263 | 19.587 | 1.00 | 19.55 | O |
| ATOM | 970 | CE2 | TYR | A | 126 | 13.278 | 46.989 | 19.857 | 1.00 | 18.19 | C |
| ATOM | 971 | CD2 | TYR | A | 126 | 12.378 | 46.333 | 20.745 | 1.00 | 22.38 | C |
| ATOM | 972 | C | TYR | A | 126 | 9.506 | 45.792 | 24.324 | 1.00 | 26.51 | C |
| ATOM | 973 | O | TYR | A | 126 | 9.736 | 45.951 | 25.539 | 1.00 | 25.01 | O |
| ATOM | 974 | N | LEU | A | 127 | 8.422 | 45.140 | 23.831 | 1.00 | 26.39 | N |
| ATOM | 975 | CA | LEU | A | 127 | 7.678 | 44.234 | 24.720 | 1.00 | 27.32 | C |
| ATOM | 976 | CB | LEU | A | 127 | 6.111 | 43.982 | 24.567 | 1.00 | 28.19 | C |
| ATOM | 977 | CG | LEU | A | 127 | 5.285 | 44.099 | 23.325 | 1.00 | 31.03 | C |
| ATOM | 978 | CD1 | LEU | A | 127 | 6.370 | 44.305 | 22.311 | 1.00 | 33.21 | C |
| ATOM | 979 | CD2 | LEU | A | 127 | 4.359 | 42.887 | 23.003 | 1.00 | 24.43 | C |
| ATOM | 980 | C | LEU | A | 127 | 8.399 | 42.956 | 24.888 | 1.00 | 26.39 | C |
| ATOM | 981 | O | LEU | A | 127 | 8.897 | 42.389 | 23.924 | 1.00 | 26.55 | O |
| ATOM | 982 | N | PRO | A | 128 | 8.442 | 42.529 | 26.151 | 1.00 | 25.75 | N |
| ATOM | 983 | CA | PRO | A | 128 | 9.022 | 41.236 | 26.543 | 1.00 | 24.92 | C |
| ATOM | 984 | CB | PRO | A | 128 | 8.809 | 41.211 | 28.043 | 1.00 | 23.92 | C |
| ATOM | 985 | CG | PRO | A | 128 | 8.688 | 42.697 | 28.423 | 1.00 | 27.53 | C |
| ATOM | 986 | CD | PRO | A | 128 | 7.904 | 43.297 | 27.301 | 1.00 | 24.75 | C |
| ATOM | 987 | C | PRO | A | 128 | 8.297 | 40.046 | 25.928 | 1.00 | 24.31 | C |
| ATOM | 988 | O | PRO | A | 128 | 7.101 | 40.102 | 25.689 | 1.00 | 23.14 | O |
| ATOM | 989 | N | PHE | A | 129 | 9.033 | 38.971 | 25.685 | 1.00 | 24.18 | N |
| ATOM | 990 | CA | PHE | A | 129 | 8.374 | 37.760 | 25.287 | 1.00 | 24.67 | C |
| ATOM | 991 | CB | PHE | A | 129 | 9.350 | 36.757 | 24.651 | 1.00 | 23.51 | C |
| ATOM | 992 | CG | PHE | A | 129 | 10.036 | 37.301 | 23.432 | 1.00 | 21.95 | C |
| ATOM | 993 | CD1 | PHE | A | 129 | 11.439 | 37.538 | 23.426 | 1.00 | 22.34 | C |
| ATOM | 994 | CE1 | PHE | A | 129 | 12.075 | 38.067 | 22.268 | 1.00 | 21.31 | C |
| ATOM | 995 | CZ | PHE | A | 129 | 11.296 | 38.390 | 21.150 | 1.00 | 18.80 | C |
| ATOM | 996 | CE2 | PHE | A | 129 | 9.914 | 38.172 | 21.155 | 1.00 | 15.81 | C |
| ATOM | 997 | CD2 | PHE | A | 129 | 9.294 | 37.649 | 22.297 | 1.00 | 20.43 | C |
| ATOM | 998 | C | PHE | A | 129 | 7.526 | 37.189 | 26.434 | 1.00 | 25.75 | C |
| ATOM | 999 | O | PHE | A | 129 | 7.782 | 37.398 | 27.634 | 1.00 | 25.54 | O |
| ATOM | 1000 | N | ARG | A | 130 | 6.532 | 36.428 | 26.015 | 1.00 | 25.77 | N |
| ATOM | 1001 | CA | ARG | A | 130 | 5.448 | 35.987 | 26.867 | 1.00 | 26.47 | C |
| ATOM | 1002 | CB | ARG | A | 130 | 4.262 | 36.752 | 26.330 | 1.00 | 26.57 | C |
| ATOM | 1003 | CG | ARG | A | 130 | 3.027 | 36.625 | 26.987 | 1.00 | 28.73 | C |
| ATOM | 1004 | CD | ARG | A | 130 | 1.874 | 36.157 | 26.079 | 1.00 | 25.43 | C |
| ATOM | 1005 | NE | ARG | A | 130 | 1.360 | 35.038 | 26.884 | 1.00 | 27.32 | N |
| ATOM | 1006 | CZ | ARG | A | 130 | 0.278 | 35.046 | 27.615 | 1.00 | 18.67 | C |
| ATOM | 1007 | NH1 | ARG | A | 130 | −0.558 | 36.083 | 27.607 | 1.00 | 17.78 | N |
| ATOM | 1008 | NH2 | ARG | A | 130 | 0.005 | 33.970 | 28.300 | 1.00 | 21.18 | N |
| ATOM | 1009 | C | ARG | A | 130 | 5.293 | 34.468 | 26.605 | 1.00 | 26.27 | C |
| ATOM | 1010 | O | ARG | A | 130 | 5.758 | 33.965 | 25.579 | 1.00 | 25.79 | O |
| ATOM | 1011 | N | ASP | A | 131 | 4.631 | 33.748 | 27.503 | 1.00 | 25.84 | N |
| ATOM | 1012 | CA | ASP | A | 131 | 4.573 | 32.290 | 27.422 | 1.00 | 24.74 | C |
| ATOM | 1013 | CB | ASP | A | 131 | 4.650 | 31.694 | 28.824 | 1.00 | 24.29 | C |
| ATOM | 1014 | CG | ASP | A | 131 | 3.282 | 31.656 | 29.548 | 1.00 | 26.41 | C |
| ATOM | 1015 | OD1 | ASP | A | 131 | 2.262 | 32.247 | 29.099 | 1.00 | 23.77 | O |
| ATOM | 1016 | OD2 | ASP | A | 131 | 3.127 | 31.019 | 30.606 | 1.00 | 28.99 | O |
| ATOM | 1017 | C | ASP | A | 131 | 3.347 | 31.828 | 26.629 | 1.00 | 24.73 | C |
| ATOM | 1018 | O | ASP | A | 131 | 2.663 | 32.647 | 26.042 | 1.00 | 23.44 | O |
| ATOM | 1019 | N | ALA | A | 132 | 3.062 | 30.524 | 26.600 | 1.00 | 25.90 | N |
| ATOM | 1020 | CA | ALA | A | 132 | 1.988 | 30.004 | 25.730 | 1.00 | 26.46 | C |
| ATOM | 1021 | CB | ALA | A | 132 | 2.461 | 28.828 | 24.910 | 1.00 | 26.22 | C |
| ATOM | 1022 | C | ALA | A | 132 | 0.748 | 29.622 | 26.503 | 1.00 | 27.31 | C |
| ATOM | 1023 | O | ALA | A | 132 | −0.067 | 28.834 | 26.021 | 1.00 | 28.17 | O |
| ATOM | 1024 | N | SER | A | 133 | 0.569 | 30.191 | 27.689 | 1.00 | 27.45 | N |
| ATOM | 1025 | CA | SER | A | 133 | −0.614 | 29.881 | 28.474 | 1.00 | 27.16 | C |
| ATOM | 1026 | CB | SER | A | 133 | −0.332 | 30.032 | 29.997 | 1.00 | 27.00 | C |
| ATOM | 1027 | OG | SER | A | 133 | −0.354 | 31.385 | 30.504 | 1.00 | 29.17 | O |
| ATOM | 1028 | C | SER | A | 133 | −1.754 | 30.758 | 27.970 | 1.00 | 28.05 | C |
| ATOM | 1029 | O | SER | A | 133 | −1.494 | 31.793 | 27.322 | 1.00 | 28.39 | O |
| ATOM | 1030 | N | PHE | A | 134 | −3.006 | 30.313 | 28.184 | 1.00 | 28.59 | N |
| ATOM | 1031 | CA | PHE | A | 134 | −4.192 | 31.162 | 28.147 | 1.00 | 29.09 | C |
| ATOM | 1032 | CB | PHE | A | 134 | −5.430 | 30.313 | 28.419 | 1.00 | 29.62 | C |
| ATOM | 1033 | CG | PHE | A | 134 | −5.650 | 29.134 | 27.465 | 1.00 | 29.14 | C |
| ATOM | 1034 | CD1 | PHE | A | 134 | −6.493 | 28.050 | 27.867 | 1.00 | 29.61 | C |
| ATOM | 1035 | CE1 | PHE | A | 134 | −6.782 | 26.948 | 27.014 | 1.00 | 28.32 | C |
| ATOM | 1036 | CZ | PHE | A | 134 | −6.210 | 26.921 | 25.709 | 1.00 | 31.09 | C |
| ATOM | 1037 | CE2 | PHE | A | 134 | −5.360 | 28.000 | 25.289 | 1.00 | 30.12 | C |
| ATOM | 1038 | CD2 | PHE | A | 134 | −5.118 | 29.117 | 26.177 | 1.00 | 29.55 | C |
| ATOM | 1039 | C | PHE | A | 134 | −3.991 | 32.134 | 29.315 | 1.00 | 30.40 | C |
| ATOM | 1040 | O | PHE | A | 134 | −3.250 | 31.860 | 30.252 | 1.00 | 31.30 | O |
| ATOM | 1041 | N | GLY | A | 135 | −4.565 | 33.302 | 29.345 | 1.00 | 31.88 | N |
| ATOM | 1042 | CA | GLY | A | 135 | −4.231 | 34.062 | 30.570 | 1.00 | 32.41 | C |
| ATOM | 1043 | C | GLY | A | 135 | −2.912 | 34.862 | 30.618 | 1.00 | 33.07 | C |
| ATOM | 1044 | O | GLY | A | 135 | −2.093 | 34.846 | 29.680 | 1.00 | 32.39 | O |
| ATOM | 1045 | N | ASN | A | 136 | −2.724 | 35.560 | 31.739 | 1.00 | 33.50 | N |
| ATOM | 1046 | CA | ASN | A | 136 | −1.743 | 36.645 | 31.893 | 1.00 | 34.47 | C |
| ATOM | 1047 | CB | ASN | A | 136 | −2.160 | 37.621 | 33.016 | 1.00 | 34.16 | C |
| ATOM | 1048 | CG | ASN | A | 136 | −1.378 | 38.954 | 32.978 | 1.00 | 40.33 | C |
| ATOM | 1049 | OD1 | ASN | A | 136 | −1.309 | 39.644 | 31.922 | 1.00 | 46.32 | O |
| ATOM | 1050 | ND2 | ASN | A | 136 | −0.784 | 39.336 | 34.132 | 1.00 | 40.72 | N |
| ATOM | 1051 | C | ASN | A | 136 | −0.409 | 36.026 | 32.232 | 1.00 | 34.00 | C |
| ATOM | 1052 | O | ASN | A | 136 | −0.349 | 35.067 | 33.025 | 1.00 | 35.04 | O |
| ATOM | 1053 | N | CYS | A | 137 | 0.643 | 36.569 | 31.638 | 1.00 | 31.87 | N |
| ATOM | 1054 | CA | CYS | A | 137 | 1.979 | 36.077 | 31.852 | 1.00 | 30.52 | C |
| ATOM | 1055 | CB | CYS | A | 137 | 2.661 | 35.634 | 30.539 | 1.00 | 30.04 | C |
| ATOM | 1056 | SG | CYS | A | 137 | 4.459 | 35.252 | 30.701 | 1.00 | 29.14 | S |
| ATOM | 1057 | C | CYS | A | 137 | 2.766 | 37.199 | 32.503 | 1.00 | 30.36 | C |
| ATOM | 1058 | O | CYS | A | 137 | 2.712 | 38.370 | 32.090 | 1.00 | 30.44 | O |
| ATOM | 1059 | N | THR | A | 138 | 3.539 | 36.810 | 33.495 | 1.00 | 29.99 | N |
| ATOM | 1060 | CA | THR | A | 138 | 4.212 | 37.750 | 34.364 | 1.00 | 31.65 | C |
| ATOM | 1061 | CB | THR | A | 138 | 3.767 | 37.396 | 35.803 | 1.00 | 32.14 | C |
| ATOM | 1062 | OG1 | THR | A | 138 | 2.537 | 38.090 | 36.064 | 1.00 | 34.20 | O |
| ATOM | 1063 | CG2 | THR | A | 138 | 4.765 | 37.873 | 36.838 | 1.00 | 33.17 | C |
| ATOM | 1064 | C | THR | A | 138 | 5.743 | 37.692 | 34.205 | 1.00 | 30.66 | C |
| ATOM | 1065 | O | THR | A | 138 | 6.458 | 38.638 | 34.608 | 1.00 | 30.21 | O |
| ATOM | 1066 | N | TYR | A | 139 | 6.204 | 36.546 | 33.669 | 1.00 | 29.09 | N |
| ATOM | 1067 | CA | TYR | A | 139 | 7.611 | 36.268 | 33.426 | 1.00 | 27.63 | C |
| ATOM | 1068 | CB | TYR | A | 139 | 7.889 | 34.743 | 33.415 | 1.00 | 27.44 | C |
| ATOM | 1069 | CG | TYR | A | 139 | 9.360 | 34.431 | 33.299 | 1.00 | 27.17 | C |
| ATOM | 1070 | CD1 | TYR | A | 139 | 10.019 | 34.464 | 32.038 | 1.00 | 24.30 | C |
| ATOM | 1071 | CE1 | TYR | A | 139 | 11.423 | 34.265 | 31.957 | 1.00 | 24.67 | C |
| ATOM | 1072 | CZ | TYR | A | 139 | 12.160 | 34.010 | 33.107 | 1.00 | 21.51 | C |
| ATOM | 1073 | OH | TYR | A | 139 | 13.496 | 33.755 | 32.996 | 1.00 | 22.68 | O |
| ATOM | 1074 | CE2 | TYR | A | 139 | 11.541 | 33.948 | 34.343 | 1.00 | 22.48 | C |
| ATOM | 1075 | CD2 | TYR | A | 139 | 10.135 | 34.180 | 34.444 | 1.00 | 24.80 | C |
| ATOM | 1076 | C | TYR | A | 139 | 7.883 | 36.909 | 32.069 | 1.00 | 27.07 | C |
| ATOM | 1077 | O | TYR | A | 139 | 7.316 | 36.501 | 31.055 | 1.00 | 26.68 | O |
| ATOM | 1078 | N | ASN | A | 140 | 8.693 | 37.959 | 32.075 | 1.00 | 26.50 | N |
| ATOM | 1079 | CA | ASN | A | 140 | 8.924 | 38.774 | 30.879 | 1.00 | 26.51 | C |
| ATOM | 1080 | CB | ASN | A | 140 | 9.042 | 40.254 | 31.238 | 1.00 | 25.51 | C |
| ATOM | 1081 | CG | ASN | A | 140 | 7.713 | 40.892 | 31.645 | 1.00 | 28.62 | C |
| ATOM | 1082 | OD1 | ASN | A | 140 | 6.625 | 40.507 | 31.217 | 1.00 | 30.72 | O |
| ATOM | 1083 | ND2 | ASN | A | 140 | 7.811 | 41.877 | 32.489 | 1.00 | 30.10 | N |
| ATOM | 1084 | C | ASN | A | 140 | 10.258 | 38.315 | 30.371 | 1.00 | 26.60 | C |
| ATOM | 1085 | O | ASN | A | 140 | 11.303 | 38.590 | 31.000 | 1.00 | 28.63 | O |
| ATOM | 1086 | N | LEU | A | 141 | 10.255 | 37.561 | 29.288 | 1.00 | 25.69 | N |
| ATOM | 1087 | CA | LEU | A | 141 | 11.520 | 37.099 | 28.716 | 1.00 | 24.92 | C |
| ATOM | 1088 | CB | LEU | A | 141 | 11.351 | 35.715 | 28.036 | 1.00 | 23.68 | C |
| ATOM | 1089 | CG | LEU | A | 141 | 12.586 | 35.119 | 27.357 | 1.00 | 21.71 | C |
| ATOM | 1090 | CD1 | LEU | A | 141 | 13.550 | 34.422 | 28.422 | 1.00 | 17.75 | C |
| ATOM | 1091 | CD2 | LEU | A | 141 | 12.111 | 34.113 | 26.273 | 1.00 | 16.16 | C |
| ATOM | 1092 | C | LEU | A | 141 | 11.996 | 38.168 | 27.719 | 1.00 | 24.66 | C |
| ATOM | 1093 | O | LEU | A | 141 | 11.392 | 38.299 | 26.680 | 1.00 | 25.07 | O |
| ATOM | 1094 | N | THR | A | 142 | 13.023 | 38.948 | 28.055 | 1.00 | 24.46 | N |
| ATOM | 1095 | CA | THR | A | 142 | 13.458 | 40.061 | 27.190 | 1.00 | 24.86 | C |
| ATOM | 1096 | CB | THR | A | 142 | 14.148 | 41.215 | 28.029 | 1.00 | 25.61 | C |
| ATOM | 1097 | OG1 | THR | A | 142 | 15.495 | 40.819 | 28.312 | 1.00 | 24.93 | O |
| ATOM | 1098 | CG2 | THR | A | 142 | 13.502 | 41.401 | 29.447 | 1.00 | 22.18 | C |
| ATOM | 1099 | C | THR | A | 142 | 14.432 | 39.645 | 26.083 | 1.00 | 25.39 | C |
| ATOM | 1100 | O | THR | A | 142 | 15.089 | 38.562 | 26.117 | 1.00 | 25.52 | O |
| ATOM | 1101 | N | ILE | A | 143 | 14.585 | 40.553 | 25.125 | 1.00 | 25.46 | N |
| ATOM | 1102 | CA | ILE | A | 143 | 15.592 | 40.368 | 24.075 | 1.00 | 25.21 | C |
| ATOM | 1103 | CB | ILE | A | 143 | 15.621 | 41.589 | 23.130 | 1.00 | 25.23 | C |
| ATOM | 1104 | CG1 | ILE | A | 143 | 14.283 | 41.725 | 22.363 | 1.00 | 24.13 | C |
| ATOM | 1105 | CD1 | ILE | A | 143 | 13.974 | 43.153 | 21.870 | 1.00 | 19.79 | C |
| ATOM | 1106 | CG2 | ILE | A | 143 | 16.798 | 41.475 | 22.179 | 1.00 | 23.27 | C |
| ATOM | 1107 | C | ILE | A | 143 | 16.997 | 40.099 | 24.646 | 1.00 | 25.28 | C |
| ATOM | 1108 | O | ILE | A | 143 | 17.801 | 39.365 | 24.020 | 1.00 | 26.31 | O |
| ATOM | 1109 | N | LEU | A | 144 | 17.326 | 40.708 | 25.787 | 1.00 | 23.71 | N |
| ATOM | 1110 | CA | LEU | A | 144 | 18.646 | 40.457 | 26.404 | 1.00 | 23.32 | C |
| ATOM | 1111 | CB | LEU | A | 144 | 18.959 | 41.474 | 27.479 | 1.00 | 23.06 | C |
| ATOM | 1112 | CG | LEU | A | 144 | 20.236 | 41.277 | 28.259 | 1.00 | 23.66 | C |
| ATOM | 1113 | CD1 | LEU | A | 144 | 21.489 | 41.498 | 27.371 | 1.00 | 21.51 | C |
| ATOM | 1114 | CD2 | LEU | A | 144 | 20.222 | 42.231 | 29.537 | 1.00 | 23.81 | C |
| ATOM | 1115 | C | LEU | A | 144 | 18.792 | 39.032 | 26.965 | 1.00 | 23.36 | C |
| ATOM | 1116 | O | LEU | A | 144 | 19.888 | 38.414 | 26.784 | 1.00 | 23.64 | O |
| ATOM | 1117 | N | ASP | A | 145 | 17.726 | 38.526 | 27.640 | 1.00 | 21.96 | N |
| ATOM | 1118 | CA | ASP | A | 145 | 17.644 | 37.119 | 27.994 | 1.00 | 21.81 | C |
| ATOM | 1119 | CB | ASP | A | 145 | 16.282 | 36.709 | 28.628 | 1.00 | 21.69 | C |
| ATOM | 1120 | CG | ASP | A | 145 | 15.913 | 37.562 | 29.833 | 1.00 | 24.03 | C |
| ATOM | 1121 | OD1 | ASP | A | 145 | 16.833 | 38.066 | 30.507 | 1.00 | 24.77 | O |
| ATOM | 1122 | OD2 | ASP | A | 145 | 14.728 | 37.803 | 30.185 | 1.00 | 26.80 | O |
| ATOM | 1123 | C | ASP | A | 145 | 17.894 | 36.281 | 26.746 | 1.00 | 21.79 | C |
| ATOM | 1124 | O | ASP | A | 145 | 18.666 | 35.281 | 26.799 | 1.00 | 21.14 | O |
| ATOM | 1125 | N | CYS | A | 146 | 17.245 | 36.650 | 25.629 | 1.00 | 20.55 | N |
| ATOM | 1126 | CA | CYS | A | 146 | 17.371 | 35.792 | 24.453 | 1.00 | 20.45 | C |
| ATOM | 1127 | CB | CYS | A | 146 | 16.357 | 36.156 | 23.374 | 1.00 | 19.54 | C |
| ATOM | 1128 | SG | CYS | A | 146 | 14.598 | 35.956 | 23.930 | 1.00 | 20.53 | S |
| ATOM | 1129 | C | CYS | A | 146 | 18.832 | 35.779 | 23.953 | 1.00 | 21.59 | C |
| ATOM | 1130 | O | CYS | A | 146 | 19.417 | 34.704 | 23.680 | 1.00 | 22.81 | O |
| ATOM | 1131 | N | LEU | A | 147 | 19.438 | 36.960 | 23.892 | 1.00 | 22.04 | N |
| ATOM | 1132 | CA | LEU | A | 147 | 20.798 | 37.126 | 23.435 | 1.00 | 23.01 | C |
| ATOM | 1133 | CB | LEU | A | 147 | 21.103 | 38.631 | 23.344 | 1.00 | 24.08 | C |
| ATOM | 1134 | CG | LEU | A | 147 | 20.277 | 39.337 | 22.260 | 1.00 | 24.35 | C |
| ATOM | 1135 | CD1 | LEU | A | 147 | 20.757 | 40.790 | 21.963 | 1.00 | 24.20 | C |
| ATOM | 1136 | CD2 | LEU | A | 147 | 20.369 | 38.494 | 21.013 | 1.00 | 22.13 | C |
| ATOM | 1137 | C | LEU | A | 147 | 21.767 | 36.400 | 24.355 | 1.00 | 22.97 | C |
| ATOM | 1138 | O | LEU | A | 147 | 22.663 | 35.712 | 23.873 | 1.00 | 23.50 | O |
| ATOM | 1139 | N | GLN | A | 148 | 21.568 | 36.504 | 25.670 | 1.00 | 23.59 | N |
| ATOM | 1140 | CA | GLN | A | 148 | 22.360 | 35.718 | 26.643 | 1.00 | 24.35 | C |
| ATOM | 1141 | CB | GLN | A | 148 | 22.014 | 36.089 | 28.084 | 1.00 | 24.65 | C |
| ATOM | 1142 | CG | GLN | A | 148 | 22.367 | 37.533 | 28.439 | 1.00 | 26.89 | C |
| ATOM | 1143 | CD | GLN | A | 148 | 22.030 | 37.903 | 29.858 | 1.00 | 28.07 | C |
| ATOM | 1144 | OE1 | GLN | A | 148 | 21.033 | 37.428 | 30.439 | 1.00 | 32.47 | O |
| ATOM | 1145 | NE2 | GLN | A | 148 | 22.830 | 38.776 | 30.414 | 1.00 | 29.22 | N |
| ATOM | 1146 | C | GLN | A | 148 | 22.167 | 34.220 | 26.490 | 1.00 | 25.26 | C |
| ATOM | 1147 | O | GLN | A | 148 | 23.146 | 33.439 | 26.625 | 1.00 | 26.88 | O |
| ATOM | 1148 | N | GLY | A | 149 | 20.928 | 33.806 | 26.224 | 1.00 | 23.85 | N |
| ATOM | 1149 | CA | GLY | A | 149 | 20.653 | 32.409 | 25.910 | 1.00 | 23.60 | C |
| ATOM | 1150 | C | GLY | A | 149 | 21.367 | 31.960 | 24.664 | 1.00 | 23.74 | C |
| ATOM | 1151 | O | GLY | A | 149 | 21.987 | 30.866 | 24.663 | 1.00 | 23.01 | O |
| ATOM | 1152 | N | ILE | A | 150 | 21.310 | 32.799 | 23.615 | 1.00 | 23.39 | N |
| ATOM | 1153 | CA | ILE | A | 150 | 22.057 | 32.526 | 22.397 | 1.00 | 24.08 | C |
| ATOM | 1154 | CB | ILE | A | 150 | 21.807 | 33.600 | 21.312 | 1.00 | 24.63 | C |
| ATOM | 1155 | CG1 | ILE | A | 150 | 20.376 | 33.453 | 20.716 | 1.00 | 23.89 | C |
| ATOM | 1156 | CD1 | ILE | A | 150 | 20.238 | 32.293 | 19.678 | 1.00 | 23.89 | C |
| ATOM | 1157 | CG2 | ILE | A | 150 | 22.933 | 33.499 | 20.225 | 1.00 | 22.80 | C |
| ATOM | 1158 | C | ILE | A | 150 | 23.569 | 32.390 | 22.662 | 1.00 | 25.15 | C |
| ATOM | 1159 | O | ILE | A | 150 | 24.210 | 31.461 | 22.188 | 1.00 | 23.67 | O |
| ATOM | 1160 | N | ARG | A | 151 | 24.119 | 33.326 | 23.438 | 1.00 | 26.84 | N |
| ATOM | 1161 | CA | ARG | A | 151 | 25.540 | 33.324 | 23.740 | 1.00 | 29.01 | C |
| ATOM | 1162 | CB | ARG | A | 151 | 25.946 | 34.568 | 24.530 | 1.00 | 29.88 | C |
| ATOM | 1163 | CG | ARG | A | 151 | 27.466 | 34.733 | 24.539 | 1.00 | 36.14 | C |
| ATOM | 1164 | CD | ARG | A | 151 | 27.998 | 35.469 | 25.726 | 1.00 | 45.97 | C |
| ATOM | 1165 | NE | ARG | A | 151 | 28.346 | 34.540 | 26.803 | 1.00 | 54.94 | N |
| ATOM | 1166 | CZ | ARG | A | 151 | 27.700 | 34.482 | 27.970 | 1.00 | 57.24 | C |
| ATOM | 1167 | NH1 | ARG | A | 151 | 26.651 | 35.293 | 28.225 | 1.00 | 55.92 | N |
| ATOM | 1168 | NH2 | ARG | A | 151 | 28.113 | 33.610 | 28.874 | 1.00 | 57.54 | N |
| ATOM | 1169 | C | ARG | A | 151 | 26.001 | 32.068 | 24.495 | 1.00 | 28.39 | C |
| ATOM | 1170 | O | ARG | A | 151 | 27.092 | 31.522 | 24.218 | 1.00 | 27.88 | O |
| ATOM | 1171 | N | LYS | A | 152 | 25.173 | 31.651 | 25.454 | 1.00 | 28.26 | N |
| ATOM | 1172 | CA | LYS | A | 152 | 25.469 | 30.517 | 26.328 | 1.00 | 28.39 | C |
| ATOM | 1173 | CB | LYS | A | 152 | 24.655 | 30.648 | 27.637 | 1.00 | 28.19 | C |
| ATOM | 1174 | CG | LYS | A | 152 | 25.286 | 30.028 | 28.948 | 1.00 | 31.16 | C |
| ATOM | 1175 | CD | LYS | A | 152 | 26.406 | 30.824 | 29.609 | 1.00 | 32.05 | C |
| ATOM | 1176 | CE | LYS | A | 152 | 26.001 | 31.318 | 31.007 | 1.00 | 37.78 | C |
| ATOM | 1177 | NZ | LYS | A | 152 | 26.976 | 32.373 | 31.591 | 1.00 | 40.05 | N |
| ATOM | 1178 | C | LYS | A | 152 | 25.299 | 29.153 | 25.563 | 1.00 | 28.23 | C |
| ATOM | 1179 | O | LYS | A | 152 | 26.095 | 28.224 | 25.789 | 1.00 | 28.57 | O |
| ATOM | 1180 | N | GLY | A | 153 | 24.335 | 29.074 | 24.625 | 1.00 | 26.69 | N |
| ATOM | 1181 | CA | GLY | A | 153 | 24.224 | 27.954 | 23.692 | 1.00 | 26.81 | C |
| ATOM | 1182 | C | GLY | A | 153 | 25.430 | 27.808 | 22.784 | 1.00 | 27.48 | C |
| ATOM | 1183 | O | GLY | A | 153 | 25.924 | 26.720 | 22.536 | 1.00 | 26.19 | O |
| ATOM | 1184 | N | LEU | A | 154 | 25.921 | 28.940 | 22.303 | 1.00 | 29.26 | N |
| ATOM | 1185 | CA | LEU | A | 154 | 27.121 | 28.986 | 21.492 | 1.00 | 31.32 | C |
| ATOM | 1186 | CB | LEU | A | 154 | 27.382 | 30.426 | 21.008 | 1.00 | 31.37 | C |
| ATOM | 1187 | CG | LEU | A | 154 | 28.211 | 30.534 | 19.720 | 1.00 | 29.91 | C |
| ATOM | 1188 | CD1 | LEU | A | 154 | 27.762 | 29.539 | 18.710 | 1.00 | 28.79 | C |
| ATOM | 1189 | CD2 | LEU | A | 154 | 28.029 | 31.923 | 19.179 | 1.00 | 31.99 | C |
| ATOM | 1190 | C | LEU | A | 154 | 28.323 | 28.486 | 22.268 | 1.00 | 33.26 | C |
| ATOM | 1191 | O | LEU | A | 154 | 29.074 | 27.594 | 21.780 | 1.00 | 34.36 | O |
| ATOM | 1192 | N | GLN | A | 155 | 28.485 | 29.063 | 23.470 | 1.00 | 34.05 | N |
| ATOM | 1193 | CA | GLN | A | 155 | 29.617 | 28.841 | 24.382 | 1.00 | 35.31 | C |
| ATOM | 1194 | CB | GLN | A | 155 | 29.368 | 29.645 | 25.684 | 1.00 | 36.22 | C |
| ATOM | 1195 | CG | GLN | A | 155 | 30.582 | 30.047 | 26.563 | 1.00 | 42.94 | C |
| ATOM | 1196 | CD | GLN | A | 155 | 30.943 | 31.570 | 26.415 | 1.00 | 52.44 | C |
| ATOM | 1197 | OE1 | GLN | A | 155 | 30.097 | 32.463 | 26.705 | 1.00 | 54.15 | O |
| ATOM | 1198 | NE2 | GLN | A | 155 | 32.194 | 31.863 | 25.946 | 1.00 | 53.26 | N |
| ATOM | 1199 | C | GLN | A | 155 | 29.768 | 27.315 | 24.642 | 1.00 | 34.24 | C |
| ATOM | 1200 | O | GLN | A | 155 | 30.861 | 26.759 | 24.569 | 1.00 | 33.35 | O |
| ATOM | 1201 | N | HIS | A | 156 | 28.645 | 26.638 | 24.882 | 1.00 | 33.47 | N |
| ATOM | 1202 | CA | HIS | A | 156 | 28.678 | 25.187 | 25.085 | 1.00 | 32.43 | C |
| ATOM | 1203 | CB | HIS | A | 156 | 27.774 | 24.829 | 26.240 | 1.00 | 31.60 | C |
| ATOM | 1204 | CG | HIS | A | 156 | 28.247 | 25.407 | 27.528 | 1.00 | 31.75 | C |
| ATOM | 1205 | ND1 | HIS | A | 156 | 27.744 | 26.591 | 28.043 | 1.00 | 30.94 | N |
| ATOM | 1206 | CE1 | HIS | A | 156 | 28.373 | 26.869 | 29.175 | 1.00 | 33.28 | C |
| ATOM | 1207 | NE2 | HIS | A | 156 | 29.278 | 25.923 | 29.399 | 1.00 | 33.82 | N |
| ATOM | 1208 | CD2 | HIS | A | 156 | 29.234 | 25.006 | 28.371 | 1.00 | 31.29 | C |
| ATOM | 1209 | C | HIS | A | 156 | 28.466 | 24.268 | 23.870 | 1.00 | 31.74 | C |
| ATOM | 1210 | O | HIS | A | 156 | 28.266 | 23.099 | 24.054 | 1.00 | 30.84 | O |
| ATOM | 1211 | N | GLY | A | 157 | 28.560 | 24.805 | 22.641 | 1.00 | 31.76 | N |
| ATOM | 1212 | CA | GLY | A | 157 | 28.396 | 24.016 | 21.414 | 1.00 | 30.84 | C |
| ATOM | 1213 | C | GLY | A | 157 | 26.980 | 23.446 | 21.211 | 1.00 | 30.55 | C |
| ATOM | 1214 | O | GLY | A | 157 | 26.836 | 22.365 | 20.626 | 1.00 | 30.95 | O |
| ATOM | 1215 | N | PHE | A | 158 | 25.947 | 24.152 | 21.687 | 1.00 | 28.74 | N |
| ATOM | 1216 | CA | PHE | A | 158 | 24.571 | 23.655 | 21.609 | 1.00 | 28.97 | C |
| ATOM | 1217 | CB | PHE | A | 158 | 23.627 | 24.341 | 22.629 | 1.00 | 29.04 | C |
| ATOM | 1218 | CG | PHE | A | 158 | 23.797 | 23.865 | 24.078 | 1.00 | 27.97 | C |
| ATOM | 1219 | CD1 | PHE | A | 158 | 22.916 | 24.288 | 25.058 | 1.00 | 28.65 | C |
| ATOM | 1220 | CE1 | PHE | A | 158 | 23.064 | 23.862 | 26.393 | 1.00 | 29.02 | C |
| ATOM | 1221 | CZ | PHE | A | 158 | 24.089 | 23.000 | 26.736 | 1.00 | 26.60 | C |
| ATOM | 1222 | CE2 | PHE | A | 158 | 24.975 | 22.585 | 25.779 | 1.00 | 28.52 | C |
| ATOM | 1223 | CD2 | PHE | A | 158 | 24.826 | 23.013 | 24.447 | 1.00 | 27.88 | C |
| ATOM | 1224 | C | PHE | A | 158 | 24.040 | 23.907 | 20.206 | 1.00 | 29.45 | C |
| ATOM | 1225 | O | PHE | A | 158 | 23.023 | 23.357 | 19.819 | 1.00 | 29.58 | O |
| ATOM | 1226 | N | PHE | A | 159 | 24.731 | 24.770 | 19.464 | 1.00 | 29.35 | N |
| ATOM | 1227 | CA | PHE | A | 159 | 24.491 | 24.941 | 18.039 | 1.00 | 28.99 | C |
| ATOM | 1228 | CB | PHE | A | 159 | 23.280 | 25.863 | 17.764 | 1.00 | 28.70 | C |
| ATOM | 1229 | CG | PHE | A | 159 | 23.546 | 27.320 | 17.960 | 1.00 | 26.56 | C |
| ATOM | 1230 | CD1 | PHE | A | 159 | 23.736 | 28.165 | 16.859 | 1.00 | 28.40 | C |
| ATOM | 1231 | CE1 | PHE | A | 159 | 23.957 | 29.564 | 17.017 | 1.00 | 24.25 | C |
| ATOM | 1232 | CZ | PHE | A | 159 | 23.953 | 30.078 | 18.270 | 1.00 | 21.56 | C |
| ATOM | 1233 | CE2 | PHE | A | 159 | 23.771 | 29.220 | 19.377 | 1.00 | 22.57 | C |
| ATOM | 1234 | CD2 | PHE | A | 159 | 23.557 | 27.865 | 19.210 | 1.00 | 22.83 | C |
| ATOM | 1235 | C | PHE | A | 159 | 25.720 | 25.463 | 17.321 | 1.00 | 29.25 | C |
| ATOM | 1236 | O | PHE | A | 159 | 26.619 | 26.033 | 17.908 | 1.00 | 29.22 | O |
| ATOM | 1237 | N | ASP | A | 160 | 25.723 | 25.282 | 16.022 | 1.00 | 30.21 | N |
| ATOM | 1238 | CA | ASP | A | 160 | 26.841 | 25.679 | 15.194 | 1.00 | 31.35 | C |
| ATOM | 1239 | CB | ASP | A | 160 | 27.866 | 24.520 | 15.071 | 1.00 | 31.26 | C |
| ATOM | 1240 | CG | ASP | A | 160 | 29.181 | 24.968 | 14.450 | 1.00 | 33.00 | C |
| ATOM | 1241 | OD1 | ASP | A | 160 | 29.287 | 26.150 | 14.017 | 1.00 | 34.51 | O |
| ATOM | 1242 | OD2 | ASP | A | 160 | 30.164 | 24.191 | 14.350 | 1.00 | 36.44 | O |
| ATOM | 1243 | C | ASP | A | 160 | 26.253 | 25.933 | 13.847 | 1.00 | 30.90 | C |
| ATOM | 1244 | O | ASP | A | 160 | 25.877 | 24.979 | 13.127 | 1.00 | 30.50 | O |
| ATOM | 1245 | N | PHE | A | 161 | 26.184 | 27.205 | 13.488 | 1.00 | 31.02 | N |
| ATOM | 1246 | CA | PHE | A | 161 | 25.593 | 27.561 | 12.196 | 1.00 | 31.11 | C |
| ATOM | 1247 | CB | PHE | A | 161 | 25.251 | 29.039 | 12.138 | 1.00 | 30.24 | C |
| ATOM | 1248 | CG | PHE | A | 161 | 23.980 | 29.390 | 12.815 | 1.00 | 28.13 | C |
| ATOM | 1249 | CD1 | PHE | A | 161 | 23.651 | 30.746 | 13.042 | 1.00 | 27.47 | C |
| ATOM | 1250 | CE1 | PHE | A | 161 | 22.445 | 31.105 | 13.675 | 1.00 | 24.39 | C |
| ATOM | 1251 | CZ | PHE | A | 161 | 21.538 | 30.085 | 14.073 | 1.00 | 24.13 | C |
| ATOM | 1252 | CE2 | PHE | A | 161 | 21.867 | 28.745 | 13.838 | 1.00 | 24.09 | C |
| ATOM | 1253 | CD2 | PHE | A | 161 | 23.079 | 28.407 | 13.193 | 1.00 | 26.67 | C |
| ATOM | 1254 | C | PHE | A | 161 | 26.486 | 27.115 | 11.003 | 1.00 | 32.30 | C |
| ATOM | 1255 | O | PHE | A | 161 | 26.053 | 27.161 | 9.825 | 1.00 | 32.47 | O |
| ATOM | 1256 | N | GLU | A | 162 | 27.707 | 26.663 | 11.287 | 1.00 | 33.13 | N |
| ATOM | 1257 | CA | GLU | A | 162 | 28.495 | 26.052 | 10.212 | 1.00 | 34.78 | C |
| ATOM | 1258 | CB | GLU | A | 162 | 29.982 | 26.100 | 10.500 | 1.00 | 35.08 | C |
| ATOM | 1259 | CG | GLU | A | 162 | 30.638 | 27.343 | 9.910 | 1.00 | 42.53 | C |
| ATOM | 1260 | CD | GLU | A | 162 | 32.009 | 27.616 | 10.528 | 1.00 | 52.76 | C |
| ATOM | 1261 | OE1 | GLU | A | 162 | 32.602 | 26.674 | 11.133 | 1.00 | 55.95 | O |
| ATOM | 1262 | OE2 | GLU | A | 162 | 32.500 | 28.774 | 10.427 | 1.00 | 55.62 | O |
| ATOM | 1263 | C | GLU | A | 162 | 28.039 | 24.649 | 9.824 | 1.00 | 34.02 | C |
| ATOM | 1264 | O | GLU | A | 162 | 28.167 | 24.286 | 8.685 | 1.00 | 34.49 | O |
| ATOM | 1265 | N | THR | A | 163 | 27.484 | 23.861 | 10.744 | 1.00 | 33.62 | N |
| ATOM | 1266 | CA | THR | A | 163 | 27.070 | 22.481 | 10.420 | 1.00 | 32.12 | C |
| ATOM | 1267 | CB | THR | A | 163 | 27.629 | 21.439 | 11.460 | 1.00 | 33.09 | C |
| ATOM | 1268 | OG1 | THR | A | 163 | 27.349 | 21.875 | 12.801 | 1.00 | 31.88 | O |
| ATOM | 1269 | CG2 | THR | A | 163 | 29.173 | 21.336 | 11.422 | 1.00 | 34.37 | C |
| ATOM | 1270 | C | THR | A | 163 | 25.568 | 22.334 | 10.423 | 1.00 | 31.00 | C |
| ATOM | 1271 | O | THR | A | 163 | 25.070 | 21.327 | 9.914 | 1.00 | 31.20 | O |
| ATOM | 1272 | N | PHE | A | 164 | 24.853 | 23.284 | 11.064 | 1.00 | 29.22 | N |
| ATOM | 1273 | CA | PHE | A | 164 | 23.395 | 23.234 | 11.248 | 1.00 | 26.33 | C |
| ATOM | 1274 | CB | PHE | A | 164 | 22.895 | 24.592 | 11.639 | 1.00 | 26.85 | C |
| ATOM | 1275 | CG | PHE | A | 164 | 21.399 | 24.681 | 11.887 | 1.00 | 24.78 | C |
| ATOM | 1276 | CD1 | PHE | A | 164 | 20.788 | 23.940 | 12.905 | 1.00 | 23.14 | C |
| ATOM | 1277 | CE1 | PHE | A | 164 | 19.458 | 24.077 | 13.173 | 1.00 | 24.88 | C |
| ATOM | 1278 | CZ | PHE | A | 164 | 18.674 | 25.000 | 12.472 | 1.00 | 23.98 | C |
| ATOM | 1279 | CE2 | PHE | A | 164 | 19.246 | 25.754 | 11.465 | 1.00 | 26.35 | C |
| ATOM | 1280 | CD2 | PHE | A | 164 | 20.622 | 25.591 | 11.171 | 1.00 | 26.63 | C |
| ATOM | 1281 | C | PHE | A | 164 | 22.685 | 22.941 | 9.982 | 1.00 | 26.50 | C |
| ATOM | 1282 | O | PHE | A | 164 | 22.978 | 23.538 | 8.937 | 1.00 | 26.06 | O |
| ATOM | 1283 | N | ASP | A | 165 | 21.689 | 22.085 | 10.085 | 1.00 | 26.20 | N |
| ATOM | 1284 | CA | ASP | A | 165 | 20.954 | 21.636 | 8.929 | 1.00 | 27.29 | C |
| ATOM | 1285 | CB | ASP | A | 165 | 21.047 | 20.088 | 8.821 | 1.00 | 27.81 | C |
| ATOM | 1286 | CG | ASP | A | 165 | 20.579 | 19.559 | 7.455 | 1.00 | 33.34 | C |
| ATOM | 1287 | OD1 | ASP | A | 165 | 19.854 | 20.277 | 6.676 | 1.00 | 36.53 | O |
| ATOM | 1288 | OD2 | ASP | A | 165 | 20.911 | 18.407 | 7.074 | 1.00 | 40.25 | O |
| ATOM | 1289 | C | ASP | A | 165 | 19.506 | 22.133 | 9.042 | 1.00 | 26.26 | C |
| ATOM | 1290 | O | ASP | A | 165 | 18.699 | 21.566 | 9.754 | 1.00 | 26.93 | O |
| ATOM | 1291 | N | VAL | A | 166 | 19.179 | 23.197 | 8.332 | 1.00 | 26.16 | N |
| ATOM | 1292 | CA | VAL | A | 166 | 17.932 | 23.883 | 8.564 | 1.00 | 25.89 | C |
| ATOM | 1293 | CB | VAL | A | 166 | 17.990 | 25.309 | 7.916 | 1.00 | 27.36 | C |
| ATOM | 1294 | CG1 | VAL | A | 166 | 18.128 | 25.264 | 6.280 | 1.00 | 24.30 | C |
| ATOM | 1295 | CG2 | VAL | A | 166 | 16.847 | 26.249 | 8.477 | 1.00 | 21.96 | C |
| ATOM | 1296 | C | VAL | A | 166 | 16.761 | 23.080 | 7.990 | 1.00 | 27.26 | C |
| ATOM | 1297 | O | VAL | A | 166 | 15.599 | 23.243 | 8.398 | 1.00 | 27.08 | O |
| ATOM | 1298 | N | ASP | A | 167 | 17.065 | 22.227 | 7.018 | 1.00 | 27.61 | N |
| ATOM | 1299 | CA | ASP | A | 167 | 16.059 | 21.384 | 6.416 | 1.00 | 28.47 | C |
| ATOM | 1300 | CB | ASP | A | 167 | 16.529 | 20.823 | 5.050 | 1.00 | 29.05 | C |
| ATOM | 1301 | CG | ASP | A | 167 | 16.753 | 21.926 | 4.013 | 1.00 | 30.75 | C |
| ATOM | 1302 | OD1 | ASP | A | 167 | 15.913 | 22.841 | 3.892 | 1.00 | 31.04 | O |
| ATOM | 1303 | OD2 | ASP | A | 167 | 17.750 | 21.974 | 3.275 | 1.00 | 32.55 | O |
| ATOM | 1304 | C | ASP | A | 167 | 15.624 | 20.278 | 7.384 | 1.00 | 28.44 | C |
| ATOM | 1305 | O | ASP | A | 167 | 14.444 | 19.895 | 7.397 | 1.00 | 28.39 | O |
| ATOM | 1306 | N | GLU | A | 168 | 16.563 | 19.769 | 8.182 | 1.00 | 28.88 | N |
| ATOM | 1307 | CA | GLU | A | 168 | 16.245 | 18.673 | 9.101 | 1.00 | 29.52 | C |
| ATOM | 1308 | CB | GLU | A | 168 | 17.498 | 17.917 | 9.619 | 1.00 | 30.17 | C |
| ATOM | 1309 | CG | GLU | A | 168 | 18.237 | 17.086 | 8.561 | 1.00 | 32.86 | C |
| ATOM | 1310 | CD | GLU | A | 168 | 18.509 | 15.619 | 8.929 | 1.00 | 37.43 | C |
| ATOM | 1311 | OE1 | GLU | A | 168 | 18.933 | 14.856 | 8.015 | 1.00 | 38.97 | O |
| ATOM | 1312 | OE2 | GLU | A | 168 | 18.329 | 15.188 | 10.108 | 1.00 | 39.49 | O |
| ATOM | 1313 | C | GLU | A | 168 | 15.447 | 19.260 | 10.245 | 1.00 | 29.28 | C |
| ATOM | 1314 | O | GLU | A | 168 | 14.441 | 18.642 | 10.710 | 1.00 | 29.71 | O |
| ATOM | 1315 | N | TYR | A | 169 | 15.863 | 20.463 | 10.660 | 1.00 | 27.40 | N |
| ATOM | 1316 | CA | TYR | A | 169 | 15.185 | 21.174 | 11.706 | 1.00 | 26.54 | C |
| ATOM | 1317 | CB | TYR | A | 169 | 15.857 | 22.518 | 11.962 | 1.00 | 27.66 | C |
| ATOM | 1318 | CG | TYR | A | 169 | 15.220 | 23.246 | 13.121 | 1.00 | 26.69 | C |
| ATOM | 1319 | CD1 | TYR | A | 169 | 15.692 | 23.106 | 14.422 | 1.00 | 23.65 | C |
| ATOM | 1320 | CE1 | TYR | A | 169 | 15.008 | 23.817 | 15.533 | 1.00 | 20.94 | C |
| ATOM | 1321 | CZ | TYR | A | 169 | 13.914 | 24.609 | 15.271 | 1.00 | 18.98 | C |
| ATOM | 1322 | OH | TYR | A | 169 | 13.236 | 25.297 | 16.261 | 1.00 | 20.44 | O |
| ATOM | 1323 | CE2 | TYR | A | 169 | 13.439 | 24.732 | 13.975 | 1.00 | 22.43 | C |
| ATOM | 1324 | CD2 | TYR | A | 169 | 14.101 | 24.078 | 12.911 | 1.00 | 26.21 | C |
| ATOM | 1325 | C | TYR | A | 169 | 13.735 | 21.402 | 11.365 | 1.00 | 26.33 | C |
| ATOM | 1326 | O | TYR | A | 169 | 12.838 | 21.064 | 12.165 | 1.00 | 27.10 | O |
| ATOM | 1327 | N | GLU | A | 170 | 13.507 | 21.977 | 10.186 | 1.00 | 25.59 | N |
| ATOM | 1328 | CA | GLU | A | 170 | 12.166 | 22.344 | 9.695 | 1.00 | 25.25 | C |
| ATOM | 1329 | CB | GLU | A | 170 | 12.237 | 23.348 | 8.508 | 1.00 | 25.52 | C |
| ATOM | 1330 | CG | GLU | A | 170 | 12.859 | 24.687 | 8.934 | 1.00 | 25.86 | C |
| ATOM | 1331 | CD | GLU | A | 170 | 13.088 | 25.676 | 7.794 | 1.00 | 28.33 | C |
| ATOM | 1332 | OE1 | GLU | A | 170 | 12.960 | 25.276 | 6.587 | 1.00 | 33.24 | O |
| ATOM | 1333 | OE2 | GLU | A | 170 | 13.384 | 26.868 | 8.105 | 1.00 | 20.68 | O |
| ATOM | 1334 | C | GLU | A | 170 | 11.296 | 21.160 | 9.317 | 1.00 | 24.78 | C |
| ATOM | 1335 | O | GLU | A | 170 | 10.071 | 21.290 | 9.317 | 1.00 | 24.84 | O |
| ATOM | 1336 | N | HIS | A | 171 | 11.909 | 20.010 | 9.022 | 1.00 | 24.26 | N |
| ATOM | 1337 | CA | HIS | A | 171 | 11.171 | 18.785 | 8.674 | 1.00 | 23.40 | C |
| ATOM | 1338 | CB | HIS | A | 171 | 12.158 | 17.789 | 8.001 | 1.00 | 22.83 | C |
| ATOM | 1339 | CG | HIS | A | 171 | 11.549 | 16.468 | 7.616 | 1.00 | 25.54 | C |
| ATOM | 1340 | ND1 | HIS | A | 171 | 10.689 | 16.316 | 6.532 | 1.00 | 24.70 | N |
| ATOM | 1341 | CE1 | HIS | A | 171 | 10.332 | 15.042 | 6.434 | 1.00 | 24.97 | C |
| ATOM | 1342 | NE2 | HIS | A | 171 | 10.917 | 14.360 | 7.419 | 1.00 | 27.27 | N |
| ATOM | 1343 | CD2 | HIS | A | 171 | 11.677 | 15.228 | 8.178 | 1.00 | 24.54 | C |
| ATOM | 1344 | C | HIS | A | 171 | 10.585 | 18.203 | 9.944 | 1.00 | 22.99 | C |
| ATOM | 1345 | O | HIS | A | 171 | 9.367 | 17.971 | 10.099 | 1.00 | 22.63 | O |
| ATOM | 1346 | N | TYR | A | 172 | 11.487 | 18.008 | 10.887 | 1.00 | 23.01 | N |
| ATOM | 1347 | CA | TYR | A | 172 | 11.188 | 17.274 | 12.100 | 1.00 | 23.19 | C |
| ATOM | 1348 | CB | TYR | A | 172 | 12.490 | 16.705 | 12.712 | 1.00 | 22.67 | C |
| ATOM | 1349 | CG | TYR | A | 172 | 13.052 | 15.554 | 11.930 | 1.00 | 25.00 | C |
| ATOM | 1350 | CD1 | TYR | A | 172 | 14.381 | 15.597 | 11.454 | 1.00 | 28.66 | C |
| ATOM | 1351 | CE1 | TYR | A | 172 | 14.908 | 14.542 | 10.728 | 1.00 | 28.38 | C |
| ATOM | 1352 | CZ | TYR | A | 172 | 14.103 | 13.428 | 10.478 | 1.00 | 29.24 | C |
| ATOM | 1353 | OH | TYR | A | 172 | 14.634 | 12.425 | 9.741 | 1.00 | 29.26 | O |
| ATOM | 1354 | CE2 | TYR | A | 172 | 12.777 | 13.352 | 10.920 | 1.00 | 26.08 | C |
| ATOM | 1355 | CD2 | TYR | A | 172 | 12.263 | 14.417 | 11.632 | 1.00 | 25.04 | C |
| ATOM | 1356 | C | TYR | A | 172 | 10.385 | 18.106 | 13.110 | 1.00 | 23.00 | C |
| ATOM | 1357 | O | TYR | A | 172 | 9.796 | 17.529 | 14.011 | 1.00 | 23.59 | O |
| ATOM | 1358 | N | GLU | A | 173 | 10.317 | 19.434 | 12.957 | 1.00 | 22.98 | N |
| ATOM | 1359 | CA | GLU | A | 173 | 9.571 | 20.234 | 13.955 | 1.00 | 23.51 | C |
| ATOM | 1360 | CB | GLU | A | 173 | 10.005 | 21.715 | 13.926 | 1.00 | 22.17 | C |
| ATOM | 1361 | CG | GLU | A | 173 | 9.439 | 22.479 | 12.734 | 1.00 | 23.15 | C |
| ATOM | 1362 | CD | GLU | A | 173 | 9.706 | 23.962 | 12.771 | 1.00 | 22.09 | C |
| ATOM | 1363 | OE1 | GLU | A | 173 | 10.296 | 24.486 | 11.812 | 1.00 | 22.18 | O |
| ATOM | 1364 | OE2 | GLU | A | 173 | 9.257 | 24.613 | 13.741 | 1.00 | 24.64 | O |
| ATOM | 1365 | C | GLU | A | 173 | 8.078 | 20.110 | 13.706 | 1.00 | 24.37 | C |
| ATOM | 1366 | O | GLU | A | 173 | 7.236 | 20.387 | 14.577 | 1.00 | 24.83 | O |
| ATOM | 1367 | N | ARG | A | 174 | 7.772 | 19.745 | 12.470 | 1.00 | 26.23 | N |
| ATOM | 1368 | CA | ARG | A | 174 | 6.421 | 19.576 | 11.999 | 1.00 | 27.17 | C |
| ATOM | 1369 | CB | ARG | A | 174 | 6.427 | 19.503 | 10.477 | 1.00 | 28.20 | C |
| ATOM | 1370 | CG | ARG | A | 174 | 6.812 | 20.772 | 9.730 | 1.00 | 29.82 | C |
| ATOM | 1371 | CD | ARG | A | 174 | 6.618 | 20.624 | 8.189 | 1.00 | 38.21 | C |
| ATOM | 1372 | NE | ARG | A | 174 | 7.817 | 21.063 | 7.471 | 1.00 | 43.10 | N |
| ATOM | 1373 | CZ | ARG | A | 174 | 8.432 | 20.373 | 6.500 | 1.00 | 45.83 | C |
| ATOM | 1374 | NH1 | ARG | A | 174 | 7.947 | 19.188 | 6.100 | 1.00 | 46.06 | N |
| ATOM | 1375 | NH2 | ARG | A | 174 | 9.548 | 20.867 | 5.938 | 1.00 | 42.94 | N |
| ATOM | 1376 | C | ARG | A | 174 | 5.787 | 18.308 | 12.569 | 1.00 | 27.32 | C |
| ATOM | 1377 | O | ARG | A | 174 | 6.425 | 17.239 | 12.705 | 1.00 | 26.29 | O |
| ATOM | 1378 | N | VAL | A | 175 | 4.504 | 18.433 | 12.884 | 1.00 | 28.58 | N |
| ATOM | 1379 | CA | VAL | A | 175 | 3.726 | 17.305 | 13.401 | 1.00 | 29.08 | C |
| ATOM | 1380 | CB | VAL | A | 175 | 2.289 | 17.711 | 13.713 | 1.00 | 29.27 | C |
| ATOM | 1381 | CG1 | VAL | A | 175 | 1.567 | 16.539 | 14.471 | 1.00 | 28.96 | C |
| ATOM | 1382 | CG2 | VAL | A | 175 | 2.313 | 18.973 | 14.570 | 1.00 | 30.24 | C |
| ATOM | 1383 | C | VAL | A | 175 | 3.776 | 16.080 | 12.474 | 1.00 | 28.66 | C |
| ATOM | 1384 | O | VAL | A | 175 | 4.038 | 14.982 | 12.958 | 1.00 | 29.34 | O |
| ATOM | 1385 | N | GLU | A | 176 | 3.592 | 16.265 | 11.169 | 1.00 | 28.55 | N |
| ATOM | 1386 | CA | GLU | A | 176 | 3.741 | 15.142 | 10.186 | 1.00 | 30.23 | C |
| ATOM | 1387 | CB | GLU | A | 176 | 3.545 | 15.522 | 8.658 | 1.00 | 30.04 | C |
| ATOM | 1388 | CG | GLU | A | 176 | 2.701 | 16.734 | 8.343 | 1.00 | 35.06 | C |
| ATOM | 1389 | CD | GLU | A | 176 | 3.477 | 18.025 | 8.467 | 1.00 | 42.21 | C |
| ATOM | 1390 | OE1 | GLU | A | 176 | 3.304 | 18.697 | 9.503 | 1.00 | 41.78 | O |
| ATOM | 1391 | OE2 | GLU | A | 176 | 4.270 | 18.360 | 7.530 | 1.00 | 46.19 | O |
| ATOM | 1392 | C | GLU | A | 176 | 5.074 | 14.395 | 10.270 | 1.00 | 29.66 | C |
| ATOM | 1393 | O | GLU | A | 176 | 5.116 | 13.284 | 9.774 | 1.00 | 30.67 | O |
| ATOM | 1394 | N | ASN | A | 177 | 6.157 | 14.997 | 10.798 | 1.00 | 28.71 | N |
| ATOM | 1395 | CA | ASN | A | 177 | 7.405 | 14.248 | 11.021 | 1.00 | 28.29 | C |
| ATOM | 1396 | CB | ASN | A | 177 | 8.531 | 14.799 | 10.160 | 1.00 | 28.16 | C |
| ATOM | 1397 | CG | ASN | A | 177 | 8.067 | 15.089 | 8.748 | 1.00 | 30.59 | C |
| ATOM | 1398 | OD1 | ASN | A | 177 | 7.576 | 14.187 | 8.056 | 1.00 | 35.73 | O |
| ATOM | 1399 | ND2 | ASN | A | 177 | 8.184 | 16.331 | 8.318 | 1.00 | 26.97 | N |
| ATOM | 1400 | C | ASN | A | 177 | 7.813 | 13.977 | 12.491 | 1.00 | 28.69 | C |
| ATOM | 1401 | O | ASN | A | 177 | 8.944 | 13.656 | 12.797 | 1.00 | 29.52 | O |
| ATOM | 1402 | N | GLY | A | 178 | 6.861 | 14.050 | 13.401 | 1.00 | 28.56 | N |
| ATOM | 1403 | CA | GLY | A | 178 | 7.077 | 13.515 | 14.725 | 1.00 | 28.29 | C |
| ATOM | 1404 | C | GLY | A | 178 | 7.180 | 14.565 | 15.820 | 1.00 | 28.73 | C |
| ATOM | 1405 | O | GLY | A | 178 | 7.510 | 14.230 | 16.967 | 1.00 | 28.00 | O |
| ATOM | 1406 | N | ASP | A | 179 | 6.897 | 15.818 | 15.454 | 1.00 | 28.21 | N |
| ATOM | 1407 | CA | ASP | A | 179 | 7.051 | 16.968 | 16.334 | 1.00 | 28.09 | C |
| ATOM | 1408 | CB | ASP | A | 179 | 5.736 | 17.217 | 17.068 | 1.00 | 28.08 | C |
| ATOM | 1409 | CG | ASP | A | 179 | 5.769 | 18.508 | 17.837 | 1.00 | 30.36 | C |
| ATOM | 1410 | OD1 | ASP | A | 179 | 6.702 | 19.310 | 17.550 | 1.00 | 32.17 | O |
| ATOM | 1411 | OD2 | ASP | A | 179 | 4.947 | 18.803 | 18.730 | 1.00 | 30.94 | O |
| ATOM | 1412 | C | ASP | A | 179 | 8.253 | 16.975 | 17.337 | 1.00 | 26.72 | C |
| ATOM | 1413 | O | ASP | A | 179 | 8.099 | 16.744 | 18.544 | 1.00 | 26.87 | O |
| ATOM | 1414 | N | PHE | A | 180 | 9.446 | 17.225 | 16.842 | 1.00 | 25.72 | N |
| ATOM | 1415 | CA | PHE | A | 180 | 10.617 | 17.216 | 17.725 | 1.00 | 24.58 | C |
| ATOM | 1416 | CB | PHE | A | 180 | 11.164 | 15.785 | 17.965 | 1.00 | 24.35 | C |
| ATOM | 1417 | CG | PHE | A | 180 | 11.967 | 15.175 | 16.803 | 1.00 | 23.08 | C |
| ATOM | 1418 | CD1 | PHE | A | 180 | 13.280 | 15.568 | 16.542 | 1.00 | 25.09 | C |
| ATOM | 1419 | CE1 | PHE | A | 180 | 14.011 | 14.999 | 15.507 | 1.00 | 25.23 | C |
| ATOM | 1420 | CZ | PHE | A | 180 | 13.432 | 13.969 | 14.742 | 1.00 | 25.63 | C |
| ATOM | 1421 | CE2 | PHE | A | 180 | 12.137 | 13.574 | 14.988 | 1.00 | 23.36 | C |
| ATOM | 1422 | CD2 | PHE | A | 180 | 11.413 | 14.169 | 16.014 | 1.00 | 22.24 | C |
| ATOM | 1423 | C | PHE | A | 180 | 11.695 | 18.229 | 17.331 | 1.00 | 24.09 | C |
| ATOM | 1424 | O | PHE | A | 180 | 11.741 | 18.677 | 16.174 | 1.00 | 23.50 | O |
| ATOM | 1425 | N | ASN | A | 181 | 12.486 | 18.605 | 18.338 | 1.00 | 22.86 | N |
| ATOM | 1426 | CA | ASN | A | 181 | 13.673 | 19.463 | 18.250 | 1.00 | 23.07 | C |
| ATOM | 1427 | CB | ASN | A | 181 | 13.321 | 20.877 | 18.712 | 1.00 | 21.79 | C |
| ATOM | 1428 | CG | ASN | A | 181 | 12.132 | 21.446 | 17.973 | 1.00 | 24.49 | C |
| ATOM | 1429 | OD1 | ASN | A | 181 | 10.966 | 21.374 | 18.457 | 1.00 | 22.41 | O |
| ATOM | 1430 | ND2 | ASN | A | 181 | 12.399 | 22.000 | 16.765 | 1.00 | 20.86 | N |
| ATOM | 1431 | C | ASN | A | 181 | 14.781 | 18.974 | 19.200 | 1.00 | 23.38 | C |
| ATOM | 1432 | O | ASN | A | 181 | 14.503 | 18.584 | 20.355 | 1.00 | 22.70 | O |
| ATOM | 1433 | N | TRP | A | 182 | 16.018 | 19.001 | 18.736 | 1.00 | 23.27 | N |
| ATOM | 1434 | CA | TRP | A | 182 | 17.149 | 18.904 | 19.666 | 1.00 | 25.06 | C |
| ATOM | 1435 | CB | TRP | A | 182 | 18.475 | 18.697 | 18.910 | 1.00 | 25.23 | C |
| ATOM | 1436 | CG | TRP | A | 182 | 18.528 | 17.268 | 18.364 | 1.00 | 27.65 | C |
| ATOM | 1437 | CD1 | TRP | A | 182 | 18.152 | 16.856 | 17.110 | 1.00 | 29.08 | C |
| ATOM | 1438 | NE1 | TRP | A | 182 | 18.297 | 15.492 | 16.996 | 1.00 | 31.04 | N |
| ATOM | 1439 | CE2 | TRP | A | 182 | 18.789 | 14.990 | 18.173 | 1.00 | 31.05 | C |
| ATOM | 1440 | CD2 | TRP | A | 182 | 18.926 | 16.083 | 19.073 | 1.00 | 28.54 | C |
| ATOM | 1441 | CE3 | TRP | A | 182 | 19.393 | 15.828 | 20.378 | 1.00 | 24.47 | C |
| ATOM | 1442 | CZ3 | TRP | A | 182 | 19.695 | 14.547 | 20.743 | 1.00 | 26.36 | C |
| ATOM | 1443 | CH2 | TRP | A | 182 | 19.548 | 13.451 | 19.821 | 1.00 | 28.93 | C |
| ATOM | 1444 | CZ2 | TRP | A | 182 | 19.082 | 13.661 | 18.544 | 1.00 | 30.64 | C |
| ATOM | 1445 | C | TRP | A | 182 | 17.225 | 20.157 | 20.547 | 1.00 | 24.67 | C |
| ATOM | 1446 | O | TRP | A | 182 | 17.130 | 21.253 | 20.056 | 1.00 | 24.96 | O |
| ATOM | 1447 | N | ILE | A | 183 | 17.366 | 19.977 | 21.851 | 1.00 | 25.06 | N |
| ATOM | 1448 | CA | ILE | A | 183 | 17.682 | 21.088 | 22.750 | 1.00 | 24.58 | C |
| ATOM | 1449 | CB | ILE | A | 183 | 16.909 | 20.949 | 24.058 | 1.00 | 24.64 | C |
| ATOM | 1450 | CG1 | ILE | A | 183 | 15.423 | 20.559 | 23.783 | 1.00 | 22.81 | C |
| ATOM | 1451 | CD1 | ILE | A | 183 | 14.529 | 21.630 | 23.056 | 1.00 | 16.30 | C |
| ATOM | 1452 | CG2 | ILE | A | 183 | 17.139 | 22.205 | 24.933 | 1.00 | 21.67 | C |
| ATOM | 1453 | C | ILE | A | 183 | 19.143 | 21.128 | 23.094 | 1.00 | 26.01 | C |
| ATOM | 1454 | O | ILE | A | 183 | 19.702 | 22.221 | 23.241 | 1.00 | 27.10 | O |
| ATOM | 1455 | N | VAL | A | 184 | 19.732 | 19.937 | 23.312 | 1.00 | 26.51 | N |
| ATOM | 1456 | CA | VAL | A | 184 | 21.146 | 19.762 | 23.484 | 1.00 | 25.87 | C |
| ATOM | 1457 | CB | VAL | A | 184 | 21.564 | 19.495 | 24.947 | 1.00 | 26.64 | C |
| ATOM | 1458 | CG1 | VAL | A | 184 | 23.080 | 19.294 | 25.053 | 1.00 | 24.48 | C |
| ATOM | 1459 | CG2 | VAL | A | 184 | 21.097 | 20.641 | 25.935 | 1.00 | 23.34 | C |
| ATOM | 1460 | C | VAL | A | 184 | 21.564 | 18.607 | 22.601 | 1.00 | 27.80 | C |
| ATOM | 1461 | O | VAL | A | 184 | 21.165 | 17.418 | 22.832 | 1.00 | 27.84 | O |
| ATOM | 1462 | N | PRO | A | 185 | 22.379 | 18.946 | 21.587 | 1.00 | 28.75 | N |
| ATOM | 1463 | CA | PRO | A | 185 | 22.902 | 17.945 | 20.633 | 1.00 | 29.60 | C |
| ATOM | 1464 | CB | PRO | A | 185 | 23.962 | 18.742 | 19.841 | 1.00 | 29.75 | C |
| ATOM | 1465 | CG | PRO | A | 185 | 23.386 | 20.164 | 19.879 | 1.00 | 29.45 | C |
| ATOM | 1466 | CD | PRO | A | 185 | 22.872 | 20.305 | 21.285 | 1.00 | 28.09 | C |
| ATOM | 1467 | C | PRO | A | 185 | 23.568 | 16.766 | 21.378 | 1.00 | 29.43 | C |
| ATOM | 1468 | O | PRO | A | 185 | 24.381 | 17.020 | 22.297 | 1.00 | 29.15 | O |
| ATOM | 1469 | N | GLY | A | 186 | 23.220 | 15.529 | 20.988 | 1.00 | 28.64 | N |
| ATOM | 1470 | CA | GLY | A | 186 | 23.797 | 14.330 | 21.570 | 1.00 | 28.38 | C |
| ATOM | 1471 | C | GLY | A | 186 | 23.289 | 14.020 | 22.977 | 1.00 | 28.74 | C |
| ATOM | 1472 | O | GLY | A | 186 | 23.836 | 13.153 | 23.642 | 1.00 | 29.89 | O |
| ATOM | 1473 | N | LYS | A | 187 | 22.230 | 14.702 | 23.429 | 1.00 | 28.05 | N |
| ATOM | 1474 | CA | LYS | A | 187 | 21.941 | 14.747 | 24.839 | 1.00 | 26.20 | C |
| ATOM | 1475 | CB | LYS | A | 187 | 22.707 | 15.908 | 25.535 | 1.00 | 26.76 | C |
| ATOM | 1476 | CG | LYS | A | 187 | 22.700 | 15.774 | 27.113 | 1.00 | 30.34 | C |
| ATOM | 1477 | CD | LYS | A | 187 | 23.083 | 14.333 | 27.589 | 1.00 | 32.58 | C |
| ATOM | 1478 | CE | LYS | A | 187 | 23.409 | 14.251 | 29.083 | 1.00 | 37.04 | C |
| ATOM | 1479 | NZ | LYS | A | 187 | 23.782 | 12.872 | 29.420 | 1.00 | 39.18 | N |
| ATOM | 1480 | C | LYS | A | 187 | 20.480 | 14.832 | 25.113 | 1.00 | 24.99 | C |
| ATOM | 1481 | O | LYS | A | 187 | 19.945 | 13.999 | 25.840 | 1.00 | 25.34 | O |
| ATOM | 1482 | N | PHE | A | 188 | 19.815 | 15.837 | 24.542 | 1.00 | 23.98 | N |
| ATOM | 1483 | CA | PHE | A | 188 | 18.399 | 16.007 | 24.784 | 1.00 | 22.58 | C |
| ATOM | 1484 | CB | PHE | A | 188 | 18.136 | 17.136 | 25.757 | 1.00 | 22.50 | C |
| ATOM | 1485 | CG | PHE | A | 188 | 18.363 | 16.793 | 27.172 | 1.00 | 23.86 | C |
| ATOM | 1486 | CD1 | PHE | A | 188 | 19.392 | 17.431 | 27.895 | 1.00 | 25.27 | C |
| ATOM | 1487 | CE1 | PHE | A | 188 | 19.620 | 17.150 | 29.247 | 1.00 | 24.43 | C |
| ATOM | 1488 | CZ | PHE | A | 188 | 18.820 | 16.215 | 29.902 | 1.00 | 25.35 | C |
| ATOM | 1489 | CE2 | PHE | A | 188 | 17.770 | 15.556 | 29.195 | 1.00 | 29.14 | C |
| ATOM | 1490 | CD2 | PHE | A | 188 | 17.546 | 15.860 | 27.824 | 1.00 | 27.02 | C |
| ATOM | 1491 | C | PHE | A | 188 | 17.646 | 16.290 | 23.499 | 1.00 | 23.01 | C |
| ATOM | 1492 | O | PHE | A | 188 | 17.946 | 17.250 | 22.735 | 1.00 | 22.53 | O |
| ATOM | 1493 | N | LEU | A | 189 | 16.661 | 15.440 | 23.288 | 1.00 | 22.98 | N |
| ATOM | 1494 | CA | LEU | A | 189 | 15.670 | 15.597 | 22.250 | 1.00 | 24.38 | C |
| ATOM | 1495 | CB | LEU | A | 189 | 15.625 | 14.328 | 21.351 | 1.00 | 24.36 | C |
| ATOM | 1496 | CG | LEU | A | 189 | 14.620 | 14.323 | 20.172 | 1.00 | 23.50 | C |
| ATOM | 1497 | CD1 | LEU | A | 189 | 15.134 | 13.571 | 18.945 | 1.00 | 21.90 | C |
| ATOM | 1498 | CD2 | LEU | A | 189 | 13.281 | 13.789 | 20.635 | 1.00 | 19.56 | C |
| ATOM | 1499 | C | LEU | A | 189 | 14.308 | 15.760 | 22.959 | 1.00 | 24.64 | C |
| ATOM | 1500 | O | LEU | A | 189 | 13.990 | 14.978 | 23.882 | 1.00 | 25.03 | O |
| ATOM | 1501 | N | ALA | A | 190 | 13.529 | 16.762 | 22.545 | 1.00 | 23.75 | N |
| ATOM | 1502 | CA | ALA | A | 190 | 12.188 | 16.963 | 23.095 | 1.00 | 24.54 | C |
| ATOM | 1503 | CB | ALA | A | 190 | 12.042 | 18.370 | 23.703 | 1.00 | 23.54 | C |
| ATOM | 1504 | C | ALA | A | 190 | 11.147 | 16.720 | 22.000 | 1.00 | 24.22 | C |
| ATOM | 1505 | O | ALA | A | 190 | 11.309 | 17.189 | 20.862 | 1.00 | 25.33 | O |
| ATOM | 1506 | N | PHE | A | 191 | 10.111 | 15.956 | 22.311 | 1.00 | 23.92 | N |
| ATOM | 1507 | CA | PHE | A | 191 | 9.020 | 15.708 | 21.351 | 1.00 | 23.85 | C |
| ATOM | 1508 | CB | PHE | A | 191 | 9.325 | 14.512 | 20.461 | 1.00 | 22.29 | C |
| ATOM | 1509 | CG | PHE | A | 191 | 9.366 | 13.172 | 21.186 | 1.00 | 24.53 | C |
| ATOM | 1510 | CD1 | PHE | A | 191 | 8.678 | 12.070 | 20.656 | 1.00 | 21.17 | C |
| ATOM | 1511 | CE1 | PHE | A | 191 | 8.714 | 10.806 | 21.297 | 1.00 | 25.15 | C |
| ATOM | 1512 | CZ | PHE | A | 191 | 9.469 | 10.621 | 22.482 | 1.00 | 27.06 | C |
| ATOM | 1513 | CE2 | PHE | A | 191 | 10.171 | 11.741 | 23.051 | 1.00 | 27.19 | C |
| ATOM | 1514 | CD2 | PHE | A | 191 | 10.117 | 13.001 | 22.389 | 1.00 | 25.19 | C |
| ATOM | 1515 | C | PHE | A | 191 | 7.632 | 15.567 | 21.963 | 1.00 | 24.92 | C |
| ATOM | 1516 | O | PHE | A | 191 | 7.442 | 15.511 | 23.192 | 1.00 | 25.19 | O |
| ATOM | 1517 | N | SER | A | 192 | 6.664 | 15.516 | 21.068 | 1.00 | 26.49 | N |
| ATOM | 1518 | CA | SER | A | 192 | 5.312 | 15.058 | 21.358 | 1.00 | 27.84 | C |
| ATOM | 1519 | CB | SER | A | 192 | 4.455 | 15.334 | 20.134 | 1.00 | 27.26 | C |
| ATOM | 1520 | OG | SER | A | 192 | 3.892 | 16.585 | 20.385 | 1.00 | 27.76 | O |
| ATOM | 1521 | C | SER | A | 192 | 5.186 | 13.568 | 21.737 | 1.00 | 28.10 | C |
| ATOM | 1522 | O | SER | A | 192 | 5.811 | 12.718 | 21.130 | 1.00 | 27.68 | O |
| ATOM | 1523 | N | GLY | A | 193 | 4.377 | 13.267 | 22.743 | 1.00 | 29.67 | N |
| ATOM | 1524 | CA | GLY | A | 193 | 4.243 | 11.903 | 23.216 | 1.00 | 32.97 | C |
| ATOM | 1525 | C | GLY | A | 193 | 3.618 | 11.055 | 22.124 | 1.00 | 35.23 | C |
| ATOM | 1526 | O | GLY | A | 193 | 2.563 | 11.435 | 21.621 | 1.00 | 35.83 | O |
| ATOM | 1527 | N | PRO | A | 194 | 4.272 | 9.953 | 21.724 | 1.00 | 36.70 | N |
| ATOM | 1528 | CA | PRO | A | 194 | 3.687 | 8.984 | 20.783 | 1.00 | 37.38 | C |
| ATOM | 1529 | CB | PRO | A | 194 | 4.672 | 7.811 | 20.821 | 1.00 | 37.27 | C |
| ATOM | 1530 | CG | PRO | A | 194 | 5.959 | 8.353 | 21.346 | 1.00 | 37.18 | C |
| ATOM | 1531 | CD | PRO | A | 194 | 5.627 | 9.558 | 22.146 | 1.00 | 37.05 | C |
| ATOM | 1532 | C | PRO | A | 194 | 2.288 | 8.477 | 21.216 | 1.00 | 38.18 | C |
| ATOM | 1533 | O | PRO | A | 194 | 1.845 | 8.646 | 22.362 | 1.00 | 35.98 | O |
| ATOM | 1534 | N | HIS | A | 195 | 1.614 | 7.860 | 20.247 | 1.00 | 39.82 | N |
| ATOM | 1535 | CA | HIS | A | 195 | 0.207 | 7.464 | 20.370 | 1.00 | 41.17 | C |
| ATOM | 1536 | CB | HIS | A | 195 | −0.712 | 8.249 | 19.373 | 1.00 | 40.62 | C |
| ATOM | 1537 | CG | HIS | A | 195 | −1.198 | 9.555 | 19.944 | 1.00 | 41.35 | C |
| ATOM | 1538 | ND1 | HIS | A | 195 | −0.460 | 10.723 | 19.866 | 1.00 | 40.13 | N |
| ATOM | 1539 | CE1 | HIS | A | 195 | −1.079 | 11.678 | 20.548 | 1.00 | 41.11 | C |
| ATOM | 1540 | NE2 | HIS | A | 195 | −2.190 | 11.175 | 21.067 | 1.00 | 41.61 | N |
| ATOM | 1541 | CD2 | HIS | A | 195 | −2.288 | 9.849 | 20.709 | 1.00 | 40.35 | C |
| ATOM | 1542 | C | HIS | A | 195 | 0.190 | 5.946 | 20.208 | 1.00 | 42.44 | C |
| ATOM | 1543 | O | HIS | A | 195 | 1.131 | 5.367 | 19.601 | 1.00 | 42.18 | O |
| ATOM | 1544 | N | PRO | A | 196 | −0.829 | 5.312 | 20.810 | 1.00 | 43.69 | N |
| ATOM | 1545 | CA | PRO | A | 196 | −0.978 | 3.834 | 20.810 | 1.00 | 44.56 | C |
| ATOM | 1546 | CB | PRO | A | 196 | −2.323 | 3.606 | 21.513 | 1.00 | 44.52 | C |
| ATOM | 1547 | CG | PRO | A | 196 | −3.008 | 5.007 | 21.558 | 1.00 | 44.93 | C |
| ATOM | 1548 | CD | PRO | A | 196 | −1.904 | 6.008 | 21.548 | 1.00 | 42.99 | C |
| ATOM | 1549 | C | PRO | A | 196 | −0.978 | 3.230 | 19.399 | 1.00 | 46.29 | C |
| ATOM | 1550 | O | PRO | A | 196 | −0.345 | 2.187 | 19.203 | 1.00 | 46.94 | O |
| ATOM | 1551 | N | LYS | A | 197 | −1.678 | 3.841 | 18.435 | 1.00 | 47.65 | N |
| ATOM | 1552 | CA | LYS | A | 197 | −1.292 | 3.643 | 17.029 | 1.00 | 49.00 | C |
| ATOM | 1553 | CB | LYS | A | 197 | −1.936 | 2.388 | 16.387 | 1.00 | 49.53 | C |
| ATOM | 1554 | CG | LYS | A | 197 | −3.191 | 2.589 | 15.527 | 1.00 | 50.00 | C |
| ATOM | 1555 | CD | LYS | A | 197 | −3.068 | 1.756 | 14.266 | 1.00 | 54.69 | C |
| ATOM | 1556 | CE | LYS | A | 197 | −4.108 | 2.116 | 13.220 | 1.00 | 55.60 | C |
| ATOM | 1557 | NZ | LYS | A | 197 | −5.001 | 0.946 | 13.078 | 1.00 | 58.34 | N |
| ATOM | 1558 | C | LYS | A | 197 | −1.370 | 4.883 | 16.124 | 1.00 | 49.84 | C |
| ATOM | 1559 | O | LYS | A | 197 | −2.100 | 5.843 | 16.407 | 1.00 | 48.18 | O |
| ATOM | 1560 | N | SER | A | 198 | −0.566 | 4.783 | 15.055 | 1.00 | 52.12 | N |
| ATOM | 1561 | CA | SER | A | 198 | −0.359 | 5.726 | 13.951 | 1.00 | 54.78 | C |
| ATOM | 1562 | CB | SER | A | 198 | 0.719 | 5.159 | 13.023 | 1.00 | 54.45 | C |
| ATOM | 1563 | OG | SER | A | 198 | 2.004 | 5.217 | 13.625 | 1.00 | 57.82 | O |
| ATOM | 1564 | C | SER | A | 198 | −1.582 | 6.033 | 13.081 | 1.00 | 56.53 | C |
| ATOM | 1565 | O | SER | A | 198 | −1.560 | 5.769 | 11.875 | 1.00 | 57.00 | O |
| ATOM | 1566 | N | LYS | A | 199 | −2.627 | 6.603 | 13.680 | 1.00 | 58.23 | N |
| ATOM | 1567 | CA | LYS | A | 199 | −3.815 | 7.002 | 12.943 | 1.00 | 59.63 | C |
| ATOM | 1568 | CB | LYS | A | 199 | −5.062 | 6.726 | 13.802 | 1.00 | 59.35 | C |
| ATOM | 1569 | CG | LYS | A | 199 | −5.425 | 7.837 | 14.820 | 1.00 | 59.90 | C |
| ATOM | 1570 | CD | LYS | A | 199 | −6.238 | 7.329 | 16.017 | 1.00 | 59.89 | C |
| ATOM | 1571 | CE | LYS | A | 199 | −7.732 | 7.251 | 15.715 | 1.00 | 61.84 | C |
| ATOM | 1572 | NZ | LYS | A | 199 | −8.480 | 6.824 | 16.936 | 1.00 | 61.00 | N |
| ATOM | 1573 | C | LYS | A | 199 | −3.701 | 8.481 | 12.469 | 1.00 | 60.97 | C |
| ATOM | 1574 | O | LYS | A | 199 | −2.652 | 9.109 | 12.617 | 1.00 | 60.83 | O |
| ATOM | 1575 | N | ILE | A | 200 | −4.761 | 9.007 | 11.853 | 1.00 | 62.78 | N |
| ATOM | 1576 | CA | ILE | A | 200 | −4.901 | 10.447 | 11.615 | 1.00 | 64.28 | C |
| ATOM | 1577 | CB | ILE | A | 200 | −4.878 | 10.813 | 10.072 | 1.00 | 64.26 | C |
| ATOM | 1578 | CG1 | ILE | A | 200 | −3.464 | 10.604 | 9.495 | 1.00 | 64.64 | C |
| ATOM | 1579 | CD1 | ILE | A | 200 | −3.381 | 10.271 | 7.991 | 1.00 | 66.22 | C |
| ATOM | 1580 | CG2 | ILE | A | 200 | −5.405 | 12.265 | 9.823 | 1.00 | 64.05 | C |
| ATOM | 1581 | C | ILE | A | 200 | −6.176 | 10.902 | 12.332 | 1.00 | 65.19 | C |
| ATOM | 1582 | O | ILE | A | 200 | −7.265 | 10.411 | 12.053 | 1.00 | 65.26 | O |
| ATOM | 1583 | N | GLU | A | 201 | −6.032 | 11.799 | 13.296 | 1.00 | 66.49 | N |
| ATOM | 1584 | CA | GLU | A | 201 | −7.176 | 12.197 | 14.090 | 1.00 | 68.20 | C |
| ATOM | 1585 | CB | GLU | A | 201 | −6.991 | 11.903 | 15.585 | 1.00 | 68.23 | C |
| ATOM | 1586 | CG | GLU | A | 201 | −8.315 | 11.584 | 16.276 | 1.00 | 70.09 | C |
| ATOM | 1587 | CD | GLU | A | 201 | −8.242 | 11.565 | 17.807 | 1.00 | 72.03 | C |
| ATOM | 1588 | OE1 | GLU | A | 201 | −7.333 | 12.218 | 18.392 | 1.00 | 71.86 | O |
| ATOM | 1589 | OE2 | GLU | A | 201 | −9.111 | 10.896 | 18.430 | 1.00 | 71.14 | O |
| ATOM | 1590 | C | GLU | A | 201 | −7.535 | 13.656 | 13.841 | 1.00 | 69.14 | C |
| ATOM | 1591 | O | GLU | A | 201 | −6.976 | 14.574 | 14.471 | 1.00 | 68.93 | O |
| ATOM | 1592 | N | ASN | A | 202 | −8.465 | 13.837 | 12.890 | 1.00 | 70.17 | N |
| ATOM | 1593 | CA | ASN | A | 202 | −9.124 | 15.120 | 12.626 | 1.00 | 70.58 | C |
| ATOM | 1594 | CB | ASN | A | 202 | −9.978 | 15.550 | 13.844 | 1.00 | 70.91 | C |
| ATOM | 1595 | CG | ASN | A | 202 | −10.864 | 14.397 | 14.391 | 1.00 | 72.18 | C |
| ATOM | 1596 | OD1 | ASN | A | 202 | −10.817 | 13.241 | 13.906 | 1.00 | 71.09 | O |
| ATOM | 1597 | ND2 | ASN | A | 202 | −11.674 | 14.716 | 15.405 | 1.00 | 73.05 | N |
| ATOM | 1598 | C | ASN | A | 202 | −8.102 | 16.172 | 12.151 | 1.00 | 70.44 | C |
| ATOM | 1599 | O | ASN | A | 202 | −7.740 | 17.132 | 12.877 | 1.00 | 69.89 | O |
| ATOM | 1600 | N | GLY | A | 203 | −7.629 | 15.933 | 10.921 | 1.00 | 70.23 | N |
| ATOM | 1601 | CA | GLY | A | 203 | −6.522 | 16.668 | 10.325 | 1.00 | 69.97 | C |
| ATOM | 1602 | C | GLY | A | 203 | −5.160 | 16.130 | 10.750 | 1.00 | 69.43 | C |
| ATOM | 1603 | O | GLY | A | 203 | −4.269 | 15.930 | 9.918 | 1.00 | 68.50 | O |
| ATOM | 1604 | N | TYR | A | 204 | −5.050 | 15.850 | 12.053 | 1.00 | 69.24 | N |
| ATOM | 1605 | CA | TYR | A | 204 | −3.787 | 15.628 | 12.778 | 1.00 | 68.98 | C |
| ATOM | 1606 | CB | TYR | A | 204 | −4.026 | 15.928 | 14.275 | 1.00 | 70.26 | C |
| ATOM | 1607 | CG | TYR | A | 204 | −3.086 | 16.955 | 14.871 | 1.00 | 73.85 | C |
| ATOM | 1608 | CD1 | TYR | A | 204 | −3.023 | 18.258 | 14.352 | 1.00 | 76.57 | C |
| ATOM | 1609 | CE1 | TYR | A | 204 | −2.146 | 19.210 | 14.895 | 1.00 | 78.69 | C |
| ATOM | 1610 | CZ | TYR | A | 204 | −1.332 | 18.858 | 15.971 | 1.00 | 79.10 | C |
| ATOM | 1611 | OH | TYR | A | 204 | −0.475 | 19.797 | 16.504 | 1.00 | 79.76 | O |
| ATOM | 1612 | CE2 | TYR | A | 204 | −1.382 | 17.566 | 16.509 | 1.00 | 78.94 | C |
| ATOM | 1613 | CD2 | TYR | A | 204 | −2.256 | 16.625 | 15.959 | 1.00 | 76.89 | C |
| ATOM | 1614 | C | TYR | A | 204 | −3.110 | 14.244 | 12.611 | 1.00 | 66.93 | C |
| ATOM | 1615 | O | TYR | A | 204 | −3.746 | 13.217 | 12.827 | 1.00 | 67.00 | O |
| ATOM | 1616 | N | PRO | A | 205 | −1.824 | 14.225 | 12.244 | 1.00 | 65.07 | N |
| ATOM | 1617 | CA | PRO | A | 205 | −1.029 | 12.987 | 12.241 | 1.00 | 63.61 | C |
| ATOM | 1618 | CB | PRO | A | 205 | 0.189 | 13.345 | 11.391 | 1.00 | 63.43 | C |
| ATOM | 1619 | CG | PRO | A | 205 | −0.086 | 14.711 | 10.866 | 1.00 | 64.39 | C |
| ATOM | 1620 | CD | PRO | A | 205 | −1.035 | 15.377 | 11.787 | 1.00 | 64.74 | C |
| ATOM | 1621 | C | PRO | A | 205 | −0.569 | 12.555 | 13.647 | 1.00 | 61.93 | C |
| ATOM | 1622 | O | PRO | A | 205 | −0.036 | 13.371 | 14.410 | 1.00 | 61.56 | O |
| ATOM | 1623 | N | LEU | A | 206 | −0.792 | 11.274 | 13.958 | 1.00 | 60.19 | N |
| ATOM | 1624 | CA | LEU | A | 206 | −0.420 | 10.652 | 15.245 | 1.00 | 58.09 | C |
| ATOM | 1625 | CB | LEU | A | 206 | −1.615 | 10.005 | 15.960 | 1.00 | 57.94 | C |
| ATOM | 1626 | CG | LEU | A | 206 | −2.737 | 10.948 | 16.434 | 1.00 | 57.99 | C |
| ATOM | 1627 | CD1 | LEU | A | 206 | −3.806 | 10.194 | 17.194 | 1.00 | 58.59 | C |
| ATOM | 1628 | CD2 | LEU | A | 206 | −2.219 | 12.129 | 17.291 | 1.00 | 57.80 | C |
| ATOM | 1629 | C | LEU | A | 206 | 0.628 | 9.621 | 14.962 | 1.00 | 56.60 | C |
| ATOM | 1630 | O | LEU | A | 206 | 0.523 | 8.904 | 13.974 | 1.00 | 56.64 | O |
| ATOM | 1631 | N | HIS | A | 207 | 1.664 | 9.592 | 15.803 | 1.00 | 54.99 | N |
| ATOM | 1632 | CA | HIS | A | 207 | 2.818 | 8.718 | 15.595 | 1.00 | 52.67 | C |
| ATOM | 1633 | CB | HIS | A | 207 | 4.102 | 9.541 | 15.442 | 1.00 | 53.00 | C |
| ATOM | 1634 | CG | HIS | A | 207 | 4.076 | 10.479 | 14.268 | 1.00 | 53.89 | C |
| ATOM | 1635 | ND1 | HIS | A | 207 | 4.580 | 10.137 | 13.027 | 1.00 | 54.73 | N |
| ATOM | 1636 | CE1 | HIS | A | 207 | 4.397 | 11.140 | 12.186 | 1.00 | 56.05 | C |
| ATOM | 1637 | NE2 | HIS | A | 207 | 3.788 | 12.119 | 12.834 | 1.00 | 56.79 | N |
| ATOM | 1638 | CD2 | HIS | A | 207 | 3.569 | 11.728 | 14.137 | 1.00 | 54.65 | C |
| ATOM | 1639 | C | HIS | A | 207 | 2.919 | 7.671 | 16.713 | 1.00 | 51.17 | C |
| ATOM | 1640 | O | HIS | A | 207 | 2.801 | 7.990 | 17.916 | 1.00 | 50.68 | O |
| ATOM | 1641 | N | ALA | A | 208 | 3.072 | 6.412 | 16.309 | 1.00 | 48.68 | N |
| ATOM | 1642 | CA | ALA | A | 208 | 3.257 | 5.348 | 17.283 | 1.00 | 46.56 | C |
| ATOM | 1643 | CB | ALA | A | 208 | 2.638 | 4.058 | 16.787 | 1.00 | 46.66 | C |
| ATOM | 1644 | C | ALA | A | 208 | 4.771 | 5.180 | 17.562 | 1.00 | 44.74 | C |
| ATOM | 1645 | O | ALA | A | 208 | 5.603 | 5.486 | 16.674 | 1.00 | 44.01 | O |
| ATOM | 1646 | N | PRO | A | 209 | 5.128 | 4.686 | 18.764 | 1.00 | 42.41 | N |
| ATOM | 1647 | CA | PRO | A | 209 | 6.533 | 4.678 | 19.187 | 1.00 | 40.46 | C |
| ATOM | 1648 | CB | PRO | A | 209 | 6.535 | 3.722 | 20.389 | 1.00 | 40.29 | C |
| ATOM | 1649 | CG | PRO | A | 209 | 5.168 | 3.776 | 20.956 | 1.00 | 39.85 | C |
| ATOM | 1650 | CD | PRO | A | 209 | 4.238 | 4.101 | 19.797 | 1.00 | 41.61 | C |
| ATOM | 1651 | C | PRO | A | 209 | 7.478 | 4.205 | 18.082 | 1.00 | 39.38 | C |
| ATOM | 1652 | O | PRO | A | 209 | 8.527 | 4.796 | 17.912 | 1.00 | 39.18 | O |
| ATOM | 1653 | N | GLU | A | 210 | 7.090 | 3.201 | 17.310 | 1.00 | 38.71 | N |
| ATOM | 1654 | CA | GLU | A | 210 | 7.973 | 2.569 | 16.318 | 1.00 | 38.62 | C |
| ATOM | 1655 | CB | GLU | A | 210 | 7.329 | 1.283 | 15.762 | 1.00 | 38.71 | C |
| ATOM | 1656 | CG | GLU | A | 210 | 7.116 | 0.150 | 16.778 | 1.00 | 39.01 | C |
| ATOM | 1657 | CD | GLU | A | 210 | 5.852 | 0.298 | 17.636 | 1.00 | 39.09 | C |
| ATOM | 1658 | OE1 | GLU | A | 210 | 5.586 | −0.553 | 18.514 | 1.00 | 38.08 | O |
| ATOM | 1659 | OE2 | GLU | A | 210 | 5.097 | 1.261 | 17.444 | 1.00 | 42.37 | O |
| ATOM | 1660 | C | GLU | A | 210 | 8.473 | 3.500 | 15.187 | 1.00 | 38.55 | C |
| ATOM | 1661 | O | GLU | A | 210 | 9.549 | 3.262 | 14.606 | 1.00 | 39.94 | O |
| ATOM | 1662 | N | ALA | A | 211 | 7.738 | 4.574 | 14.898 | 1.00 | 38.25 | N |
| ATOM | 1663 | CA | ALA | A | 211 | 8.186 | 5.601 | 13.918 | 1.00 | 38.00 | C |
| ATOM | 1664 | CB | ALA | A | 211 | 7.113 | 6.629 | 13.713 | 1.00 | 37.25 | C |
| ATOM | 1665 | C | ALA | A | 211 | 9.509 | 6.276 | 14.318 | 1.00 | 37.70 | C |
| ATOM | 1666 | O | ALA | A | 211 | 10.278 | 6.734 | 13.485 | 1.00 | 37.84 | O |
| ATOM | 1667 | N | TYR | A | 212 | 9.810 | 6.293 | 15.600 | 1.00 | 37.71 | N |
| ATOM | 1668 | CA | TYR | A | 212 | 10.995 | 7.031 | 16.058 | 1.00 | 37.21 | C |
| ATOM | 1669 | CB | TYR | A | 212 | 10.705 | 7.628 | 17.418 | 1.00 | 35.73 | C |
| ATOM | 1670 | CG | TYR | A | 212 | 9.681 | 8.703 | 17.363 | 1.00 | 31.92 | C |
| ATOM | 1671 | CD1 | TYR | A | 212 | 10.040 | 10.016 | 17.064 | 1.00 | 33.63 | C |
| ATOM | 1672 | CE1 | TYR | A | 212 | 9.095 | 11.035 | 17.009 | 1.00 | 29.78 | C |
| ATOM | 1673 | CZ | TYR | A | 212 | 7.791 | 10.732 | 17.248 | 1.00 | 29.81 | C |
| ATOM | 1674 | OH | TYR | A | 212 | 6.847 | 11.733 | 17.219 | 1.00 | 27.16 | O |
| ATOM | 1675 | CE2 | TYR | A | 212 | 7.417 | 9.424 | 17.546 | 1.00 | 31.56 | C |
| ATOM | 1676 | CD2 | TYR | A | 212 | 8.369 | 8.427 | 17.599 | 1.00 | 30.00 | C |
| ATOM | 1677 | C | TYR | A | 212 | 12.252 | 6.193 | 16.163 | 1.00 | 37.65 | C |
| ATOM | 1678 | O | TYR | A | 212 | 13.341 | 6.723 | 16.299 | 1.00 | 38.01 | O |
| ATOM | 1679 | N | PHE | A | 213 | 12.068 | 4.879 | 16.100 | 1.00 | 38.12 | N |
| ATOM | 1680 | CA | PHE | A | 213 | 13.108 | 3.911 | 16.379 | 1.00 | 37.80 | C |
| ATOM | 1681 | CB | PHE | A | 213 | 12.547 | 2.504 | 16.184 | 1.00 | 38.29 | C |
| ATOM | 1682 | CG | PHE | A | 213 | 11.567 | 2.064 | 17.268 | 1.00 | 37.57 | C |
| ATOM | 1683 | CD1 | PHE | A | 213 | 11.055 | 2.969 | 18.185 | 1.00 | 34.48 | C |
| ATOM | 1684 | CE1 | PHE | A | 213 | 10.162 | 2.553 | 19.187 | 1.00 | 34.46 | C |
| ATOM | 1685 | CZ | PHE | A | 213 | 9.804 | 1.223 | 19.265 | 1.00 | 35.33 | C |
| ATOM | 1686 | CE2 | PHE | A | 213 | 10.313 | 0.286 | 18.352 | 1.00 | 32.71 | C |
| ATOM | 1687 | CD2 | PHE | A | 213 | 11.190 | 0.700 | 17.376 | 1.00 | 37.42 | C |
| ATOM | 1688 | C | PHE | A | 213 | 14.313 | 4.126 | 15.489 | 1.00 | 37.94 | C |
| ATOM | 1689 | O | PHE | A | 213 | 15.431 | 4.214 | 16.015 | 1.00 | 37.70 | O |
| ATOM | 1690 | N | PRO | A | 214 | 14.120 | 4.195 | 14.153 | 1.00 | 37.43 | N |
| ATOM | 1691 | CA | PRO | A | 214 | 15.270 | 4.351 | 13.245 | 1.00 | 36.90 | C |
| ATOM | 1692 | CB | PRO | A | 214 | 14.646 | 4.308 | 11.817 | 1.00 | 37.01 | C |
| ATOM | 1693 | CG | PRO | A | 214 | 13.287 | 3.731 | 11.955 | 1.00 | 35.10 | C |
| ATOM | 1694 | CD | PRO | A | 214 | 12.853 | 4.032 | 13.405 | 1.00 | 37.24 | C |
| ATOM | 1695 | C | PRO | A | 214 | 16.018 | 5.648 | 13.505 | 1.00 | 37.03 | C |
| ATOM | 1696 | O | PRO | A | 214 | 17.259 | 5.652 | 13.556 | 1.00 | 36.87 | O |
| ATOM | 1697 | N | TYR | A | 215 | 15.280 | 6.751 | 13.699 | 1.00 | 36.89 | N |
| ATOM | 1698 | CA | TYR | A | 215 | 15.952 | 8.042 | 13.993 | 1.00 | 35.30 | C |
| ATOM | 1699 | CB | TYR | A | 215 | 15.001 | 9.227 | 13.729 | 1.00 | 34.41 | C |
| ATOM | 1700 | CG | TYR | A | 215 | 15.642 | 10.600 | 13.935 | 1.00 | 33.51 | C |
| ATOM | 1701 | CD1 | TYR | A | 215 | 16.036 | 11.380 | 12.841 | 1.00 | 30.80 | C |
| ATOM | 1702 | CE1 | TYR | A | 215 | 16.604 | 12.621 | 13.019 | 1.00 | 31.79 | C |
| ATOM | 1703 | CZ | TYR | A | 215 | 16.802 | 13.123 | 14.323 | 1.00 | 35.40 | C |
| ATOM | 1704 | OH | TYR | A | 215 | 17.358 | 14.372 | 14.518 | 1.00 | 31.69 | O |
| ATOM | 1705 | CE2 | TYR | A | 215 | 16.418 | 12.360 | 15.442 | 1.00 | 34.03 | C |
| ATOM | 1706 | CD2 | TYR | A | 215 | 15.822 | 11.124 | 15.239 | 1.00 | 30.82 | C |
| ATOM | 1707 | C | TYR | A | 215 | 16.638 | 8.084 | 15.413 | 1.00 | 34.15 | C |
| ATOM | 1708 | O | TYR | A | 215 | 17.771 | 8.545 | 15.544 | 1.00 | 32.85 | O |
| ATOM | 1709 | N | PHE | A | 216 | 15.909 | 7.650 | 16.442 | 1.00 | 34.08 | N |
| ATOM | 1710 | CA | PHE | A | 216 | 16.426 | 7.474 | 17.804 | 1.00 | 35.04 | C |
| ATOM | 1711 | CB | PHE | A | 216 | 15.382 | 6.812 | 18.696 | 1.00 | 34.04 | C |
| ATOM | 1712 | CG | PHE | A | 216 | 14.287 | 7.736 | 19.171 | 1.00 | 32.22 | C |
| ATOM | 1713 | CD1 | PHE | A | 216 | 14.095 | 9.012 | 18.614 | 1.00 | 29.44 | C |
| ATOM | 1714 | CE1 | PHE | A | 216 | 13.097 | 9.879 | 19.085 | 1.00 | 25.12 | C |
| ATOM | 1715 | CZ | PHE | A | 216 | 12.255 | 9.471 | 20.096 | 1.00 | 27.88 | C |
| ATOM | 1716 | CE2 | PHE | A | 216 | 12.426 | 8.201 | 20.676 | 1.00 | 29.00 | C |
| ATOM | 1717 | CD2 | PHE | A | 216 | 13.463 | 7.348 | 20.217 | 1.00 | 31.23 | C |
| ATOM | 1718 | C | PHE | A | 216 | 17.712 | 6.622 | 17.811 | 1.00 | 36.90 | C |
| ATOM | 1719 | O | PHE | A | 216 | 18.758 | 7.060 | 18.318 | 1.00 | 37.19 | O |
| ATOM | 1720 | N | LYS | A | 217 | 17.655 | 5.447 | 17.177 | 1.00 | 38.00 | N |
| ATOM | 1721 | CA | LYS | A | 217 | 18.794 | 4.535 | 17.190 | 1.00 | 39.43 | C |
| ATOM | 1722 | CB | LYS | A | 217 | 18.392 | 3.096 | 16.772 | 1.00 | 39.74 | C |
| ATOM | 1723 | CG | LYS | A | 217 | 19.025 | 2.005 | 17.691 | 1.00 | 44.88 | C |
| ATOM | 1724 | CD | LYS | A | 217 | 18.215 | 1.632 | 18.979 | 1.00 | 48.78 | C |
| ATOM | 1725 | CE | LYS | A | 217 | 17.539 | 0.195 | 18.897 | 1.00 | 52.10 | C |
| ATOM | 1726 | NZ | LYS | A | 217 | 16.470 | −0.007 | 17.788 | 1.00 | 51.63 | N |
| ATOM | 1727 | C | LYS | A | 217 | 20.014 | 5.116 | 16.460 | 1.00 | 39.25 | C |
| ATOM | 1728 | O | LYS | A | 217 | 21.153 | 4.971 | 16.928 | 1.00 | 39.72 | O |
| ATOM | 1729 | N | LYS | A | 218 | 19.775 | 5.858 | 15.381 | 1.00 | 39.38 | N |
| ATOM | 1730 | CA | LYS | A | 218 | 20.835 | 6.565 | 14.656 | 1.00 | 39.17 | C |
| ATOM | 1731 | CB | LYS | A | 218 | 20.392 | 6.821 | 13.206 | 1.00 | 39.37 | C |
| ATOM | 1732 | CG | LYS | A | 218 | 20.204 | 8.243 | 12.763 | 1.00 | 40.46 | C |
| ATOM | 1733 | CD | LYS | A | 218 | 20.826 | 8.491 | 11.379 | 1.00 | 46.84 | C |
| ATOM | 1734 | CE | LYS | A | 218 | 19.901 | 9.273 | 10.409 | 1.00 | 49.08 | C |
| ATOM | 1735 | NZ | LYS | A | 218 | 19.650 | 10.751 | 10.763 | 1.00 | 52.18 | N |
| ATOM | 1736 | C | LYS | A | 218 | 21.403 | 7.843 | 15.326 | 1.00 | 39.76 | C |
| ATOM | 1737 | O | LYS | A | 218 | 22.464 | 8.355 | 14.904 | 1.00 | 40.14 | O |
| ATOM | 1738 | N | HIS | A | 219 | 20.710 | 8.379 | 16.338 | 1.00 | 39.66 | N |
| ATOM | 1739 | CA | HIS | A | 219 | 21.235 | 9.509 | 17.110 | 1.00 | 39.01 | C |
| ATOM | 1740 | CB | HIS | A | 219 | 20.321 | 10.696 | 17.014 | 1.00 | 39.15 | C |
| ATOM | 1741 | CG | HIS | A | 219 | 20.427 | 11.402 | 15.696 | 1.00 | 40.67 | C |
| ATOM | 1742 | ND1 | HIS | A | 219 | 19.545 | 11.175 | 14.659 | 1.00 | 39.13 | N |
| ATOM | 1743 | CE1 | HIS | A | 219 | 19.900 | 11.908 | 13.620 | 1.00 | 38.12 | C |
| ATOM | 1744 | NE2 | HIS | A | 219 | 20.982 | 12.596 | 13.945 | 1.00 | 40.67 | N |
| ATOM | 1745 | CD2 | HIS | A | 219 | 21.342 | 12.291 | 15.234 | 1.00 | 39.39 | C |
| ATOM | 1746 | C | HIS | A | 219 | 21.493 | 9.153 | 18.546 | 1.00 | 39.34 | C |
| ATOM | 1747 | O | HIS | A | 219 | 21.627 | 10.033 | 19.417 | 1.00 | 41.02 | O |
| ATOM | 1748 | N | ASN | A | 220 | 21.564 | 7.849 | 18.784 | 1.00 | 38.15 | N |
| ATOM | 1749 | CA | ASN | A | 220 | 22.151 | 7.286 | 19.978 | 1.00 | 37.53 | C |
| ATOM | 1750 | CB | ASN | A | 220 | 23.620 | 7.736 | 20.102 | 1.00 | 36.97 | C |
| ATOM | 1751 | CG | ASN | A | 220 | 24.344 | 7.114 | 21.298 | 1.00 | 39.01 | C |
| ATOM | 1752 | OD1 | ASN | A | 220 | 24.059 | 5.981 | 21.689 | 1.00 | 38.31 | O |
| ATOM | 1753 | ND2 | ASN | A | 220 | 25.304 | 7.863 | 21.880 | 1.00 | 38.93 | N |
| ATOM | 1754 | C | ASN | A | 220 | 21.302 | 7.681 | 21.179 | 1.00 | 37.06 | C |
| ATOM | 1755 | O | ASN | A | 220 | 21.846 | 8.038 | 22.246 | 1.00 | 36.97 | O |
| ATOM | 1756 | N | VAL | A | 221 | 19.984 | 7.609 | 20.977 | 1.00 | 35.09 | N |
| ATOM | 1757 | CA | VAL | A | 221 | 19.015 | 7.763 | 22.028 | 1.00 | 34.42 | C |
| ATOM | 1758 | CB | VAL | A | 221 | 17.557 | 8.020 | 21.490 | 1.00 | 34.52 | C |
| ATOM | 1759 | CG1 | VAL | A | 221 | 16.508 | 8.010 | 22.652 | 1.00 | 33.88 | C |
| ATOM | 1760 | CG2 | VAL | A | 221 | 17.428 | 9.309 | 20.691 | 1.00 | 33.03 | C |
| ATOM | 1761 | C | VAL | A | 221 | 18.990 | 6.436 | 22.783 | 1.00 | 35.49 | C |
| ATOM | 1762 | O | VAL | A | 221 | 18.655 | 5.374 | 22.208 | 1.00 | 36.40 | O |
| ATOM | 1763 | N | THR | A | 222 | 19.318 | 6.487 | 24.072 | 1.00 | 34.76 | N |
| ATOM | 1764 | CA | THR | A | 222 | 19.301 | 5.318 | 24.919 | 1.00 | 33.92 | C |
| ATOM | 1765 | CB | THR | A | 222 | 20.700 | 5.114 | 25.572 | 1.00 | 34.73 | C |
| ATOM | 1766 | OG1 | THR | A | 222 | 21.049 | 6.271 | 26.364 | 1.00 | 35.15 | O |
| ATOM | 1767 | CG2 | THR | A | 222 | 21.831 | 4.981 | 24.497 | 1.00 | 32.40 | C |
| ATOM | 1768 | C | THR | A | 222 | 18.219 | 5.410 | 25.997 | 1.00 | 34.65 | C |
| ATOM | 1769 | O | THR | A | 222 | 17.935 | 4.420 | 26.698 | 1.00 | 36.12 | O |
| ATOM | 1770 | N | ALA | A | 223 | 17.615 | 6.588 | 26.188 | 1.00 | 32.78 | N |
| ATOM | 1771 | CA | ALA | A | 223 | 16.509 | 6.666 | 27.118 | 1.00 | 29.51 | C |
| ATOM | 1772 | CB | ALA | A | 223 | 16.965 | 7.257 | 28.449 | 1.00 | 28.07 | C |
| ATOM | 1773 | C | ALA | A | 223 | 15.331 | 7.468 | 26.527 | 1.00 | 28.41 | C |
| ATOM | 1774 | O | ALA | A | 223 | 15.510 | 8.447 | 25.811 | 1.00 | 27.82 | O |
| ATOM | 1775 | N | VAL | A | 224 | 14.137 | 7.012 | 26.855 | 1.00 | 27.08 | N |
| ATOM | 1776 | CA | VAL | A | 224 | 12.939 | 7.753 | 26.688 | 1.00 | 27.15 | C |
| ATOM | 1777 | CB | VAL | A | 224 | 11.957 | 7.003 | 25.747 | 1.00 | 27.55 | C |
| ATOM | 1778 | CG1 | VAL | A | 224 | 10.618 | 7.748 | 25.636 | 1.00 | 26.78 | C |
| ATOM | 1779 | CG2 | VAL | A | 224 | 12.600 | 6.839 | 24.359 | 1.00 | 26.91 | C |
| ATOM | 1780 | C | VAL | A | 224 | 12.347 | 7.983 | 28.070 | 1.00 | 27.03 | C |
| ATOM | 1781 | O | VAL | A | 224 | 12.255 | 7.054 | 28.862 | 1.00 | 27.48 | O |
| ATOM | 1782 | N | VAL | A | 225 | 11.968 | 9.232 | 28.352 | 1.00 | 26.97 | N |
| ATOM | 1783 | CA | VAL | A | 225 | 11.332 | 9.614 | 29.619 | 1.00 | 27.02 | C |
| ATOM | 1784 | CB | VAL | A | 225 | 12.158 | 10.695 | 30.334 | 1.00 | 26.85 | C |
| ATOM | 1785 | CG1 | VAL | A | 225 | 11.409 | 11.234 | 31.536 | 1.00 | 26.21 | C |
| ATOM | 1786 | CG2 | VAL | A | 225 | 13.537 | 10.173 | 30.709 | 1.00 | 25.31 | C |
| ATOM | 1787 | C | VAL | A | 225 | 9.931 | 10.189 | 29.349 | 1.00 | 27.86 | C |
| ATOM | 1788 | O | VAL | A | 225 | 9.789 | 11.153 | 28.571 | 1.00 | 27.89 | O |
| ATOM | 1789 | N | ARG | A | 226 | 8.901 | 9.583 | 29.955 | 1.00 | 28.09 | N |
| ATOM | 1790 | CA | ARG | A | 226 | 7.554 | 10.083 | 29.785 | 1.00 | 27.85 | C |
| ATOM | 1791 | CB | ARG | A | 226 | 6.600 | 8.951 | 29.450 | 1.00 | 28.36 | C |
| ATOM | 1792 | CG | ARG | A | 226 | 5.081 | 9.309 | 29.616 | 1.00 | 30.26 | C |
| ATOM | 1793 | CD | ARG | A | 226 | 4.102 | 8.251 | 29.082 | 1.00 | 36.13 | C |
| ATOM | 1794 | NE | ARG | A | 226 | 4.480 | 6.944 | 29.586 | 1.00 | 38.35 | N |
| ATOM | 1795 | CZ | ARG | A | 226 | 4.057 | 5.775 | 29.132 | 1.00 | 38.86 | C |
| ATOM | 1796 | NH1 | ARG | A | 226 | 3.189 | 5.724 | 28.137 | 1.00 | 36.80 | N |
| ATOM | 1797 | NH2 | ARG | A | 226 | 4.532 | 4.644 | 29.687 | 1.00 | 36.90 | N |
| ATOM | 1798 | C | ARG | A | 226 | 7.098 | 10.822 | 31.047 | 1.00 | 27.86 | C |
| ATOM | 1799 | O | ARG | A | 226 | 7.215 | 10.295 | 32.150 | 1.00 | 26.60 | O |
| ATOM | 1800 | N | LEU | A | 227 | 6.576 | 12.038 | 30.863 | 1.00 | 27.48 | N |
| ATOM | 1801 | CA | LEU | A | 227 | 6.106 | 12.876 | 31.974 | 1.00 | 28.27 | C |
| ATOM | 1802 | CB | LEU | A | 227 | 6.712 | 14.292 | 31.869 | 1.00 | 27.87 | C |
| ATOM | 1803 | CG | LEU | A | 227 | 8.223 | 14.332 | 31.568 | 1.00 | 28.82 | C |
| ATOM | 1804 | CD1 | LEU | A | 227 | 8.624 | 15.782 | 31.352 | 1.00 | 27.85 | C |
| ATOM | 1805 | CD2 | LEU | A | 227 | 9.060 | 13.663 | 32.709 | 1.00 | 25.02 | C |
| ATOM | 1806 | C | LEU | A | 227 | 4.583 | 12.970 | 32.014 | 1.00 | 28.25 | C |
| ATOM | 1807 | O | LEU | A | 227 | 3.978 | 13.472 | 32.972 | 1.00 | 27.00 | O |
| ATOM | 1808 | N | ASN | A | 228 | 3.960 | 12.473 | 30.969 | 1.00 | 28.67 | N |
| ATOM | 1809 | CA | ASN | A | 228 | 2.521 | 12.556 | 30.935 | 1.00 | 31.25 | C |
| ATOM | 1810 | CB | ASN | A | 228 | 2.088 | 13.217 | 29.631 | 1.00 | 29.75 | C |
| ATOM | 1811 | CG | ASN | A | 228 | 2.354 | 12.364 | 28.433 | 1.00 | 28.21 | C |
| ATOM | 1812 | OD1 | ASN | A | 228 | 3.428 | 11.794 | 28.280 | 1.00 | 28.19 | O |
| ATOM | 1813 | ND2 | ASN | A | 228 | 1.388 | 12.294 | 27.552 | 1.00 | 30.94 | N |
| ATOM | 1814 | C | ASN | A | 228 | 1.836 | 11.190 | 31.181 | 1.00 | 32.96 | C |
| ATOM | 1815 | O | ASN | A | 228 | 2.508 | 10.151 | 31.199 | 1.00 | 33.48 | O |
| ATOM | 1816 | N | LYS | A | 229 | 0.516 | 11.183 | 31.347 | 1.00 | 35.64 | N |
| ATOM | 1817 | CA | LYS | A | 229 | −0.187 | 9.917 | 31.639 | 1.00 | 38.66 | C |
| ATOM | 1818 | CB | LYS | A | 229 | −1.637 | 10.140 | 32.112 | 1.00 | 38.02 | C |
| ATOM | 1819 | CG | LYS | A | 229 | −2.648 | 10.172 | 31.032 | 1.00 | 41.80 | C |
| ATOM | 1820 | CD | LYS | A | 229 | −3.801 | 11.224 | 31.265 | 1.00 | 46.00 | C |
| ATOM | 1821 | CE | LYS | A | 229 | −4.225 | 11.939 | 29.896 | 1.00 | 44.34 | C |
| ATOM | 1822 | NZ | LYS | A | 229 | −4.417 | 10.990 | 28.726 | 1.00 | 42.38 | N |
| ATOM | 1823 | C | LYS | A | 229 | −0.037 | 8.961 | 30.468 | 1.00 | 39.82 | C |
| ATOM | 1824 | O | LYS | A | 229 | 0.134 | 9.439 | 29.334 | 1.00 | 41.23 | O |
| ATOM | 1825 | N | LYS | A | 230 | −0.038 | 7.636 | 30.742 | 1.00 | 41.15 | N |
| ATOM | 1826 | CA | LYS | A | 230 | 0.320 | 6.589 | 29.737 | 1.00 | 41.74 | C |
| ATOM | 1827 | CB | LYS | A | 230 | 0.890 | 5.294 | 30.366 | 1.00 | 41.79 | C |
| ATOM | 1828 | CG | LYS | A | 230 | 1.080 | 5.287 | 31.896 | 1.00 | 43.14 | C |
| ATOM | 1829 | CD | LYS | A | 230 | 2.348 | 4.512 | 32.297 | 1.00 | 44.36 | C |
| ATOM | 1830 | CE | LYS | A | 230 | 2.057 | 3.231 | 33.103 | 1.00 | 44.40 | C |
| ATOM | 1831 | NZ | LYS | A | 230 | 1.194 | 3.402 | 34.291 | 1.00 | 43.43 | N |
| ATOM | 1832 | C | LYS | A | 230 | −0.777 | 6.256 | 28.721 | 1.00 | 42.04 | C |
| ATOM | 1833 | O | LYS | A | 230 | −1.963 | 6.178 | 29.044 | 1.00 | 42.75 | O |
| ATOM | 1834 | N | ILE | A | 231 | −3.356 | 6.030 | 27.489 | 1.00 | 42.06 | N |
| ATOM | 1835 | CA | ILE | A | 231 | −1.254 | 6.065 | 26.362 | 1.00 | 42.57 | C |
| ATOM | 1836 | CB | ILE | A | 231 | −1.206 | 7.503 | 25.740 | 1.00 | 43.10 | C |
| ATOM | 1837 | CG1 | ILE | A | 231 | −2.563 | 8.184 | 25.826 | 1.00 | 43.77 | C |
| ATOM | 1838 | CD1 | ILE | A | 231 | −2.657 | 9.379 | 24.863 | 1.00 | 48.89 | C |
| ATOM | 1839 | CG2 | ILE | A | 231 | −0.700 | 7.540 | 24.296 | 1.00 | 41.89 | C |
| ATOM | 1840 | C | ILE | A | 231 | −0.753 | 5.032 | 25.400 | 1.00 | 42.99 | C |
| ATOM | 1841 | O | ILE | A | 231 | −1.432 | 4.677 | 24.421 | 1.00 | 43.33 | O |
| ATOM | 1842 | N | TYR | A | 232 | 0.467 | 4.598 | 25.666 | 1.00 | 42.56 | N |
| ATOM | 1843 | CA | TYR | A | 232 | 1.133 | 3.558 | 24.924 | 1.00 | 43.70 | C |
| ATOM | 1844 | CB | TYR | A | 232 | 2.142 | 4.154 | 23.891 | 1.00 | 43.71 | C |
| ATOM | 1845 | CG | TYR | A | 232 | 3.366 | 4.920 | 24.483 | 1.00 | 44.23 | C |
| ATOM | 1846 | CD1 | TYR | A | 232 | 4.570 | 4.279 | 24.736 | 1.00 | 43.18 | C |
| ATOM | 1847 | CE1 | TYR | A | 232 | 5.664 | 4.987 | 25.245 | 1.00 | 43.34 | C |
| ATOM | 1848 | CZ | TYR | A | 232 | 5.546 | 6.329 | 25.532 | 1.00 | 40.78 | C |
| ATOM | 1849 | OH | TYR | A | 232 | 6.605 | 7.047 | 26.088 | 1.00 | 36.91 | O |
| ATOM | 1850 | CE2 | TYR | A | 232 | 4.360 | 6.968 | 25.287 | 1.00 | 42.31 | C |
| ATOM | 1851 | CD2 | TYR | A | 232 | 3.294 | 6.283 | 24.780 | 1.00 | 43.88 | C |
| ATOM | 1852 | C | TYR | A | 232 | 1.836 | 2.676 | 25.985 | 1.00 | 44.08 | C |
| ATOM | 1853 | O | TYR | A | 232 | 2.106 | 3.145 | 27.121 | 1.00 | 43.69 | O |
| ATOM | 1854 | N | GLU | A | 233 | 2.173 | 1.448 | 25.593 | 1.00 | 43.70 | N |
| ATOM | 1855 | CA | GLU | A | 233 | 2.794 | 0.473 | 26.472 | 1.00 | 44.26 | C |
| ATOM | 1856 | CB | GLU | A | 233 | 2.388 | −0.938 | 25.982 | 1.00 | 45.45 | C |
| ATOM | 1857 | CG | GLU | A | 233 | 2.847 | −2.167 | 26.787 | 1.00 | 49.43 | C |
| ATOM | 1858 | CD | GLU | A | 233 | 2.883 | −1.973 | 28.312 | 1.00 | 54.59 | C |
| ATOM | 1859 | OE1 | GLU | A | 233 | 4.013 | −1.759 | 28.836 | 1.00 | 55.60 | O |
| ATOM | 1860 | OE2 | GLU | A | 233 | 1.803 | −2.061 | 28.979 | 1.00 | 55.74 | O |
| ATOM | 1861 | C | GLU | A | 233 | 4.306 | 0.702 | 26.404 | 1.00 | 43.66 | C |
| ATOM | 1862 | O | GLU | A | 233 | 4.902 | 0.492 | 25.344 | 1.00 | 44.27 | O |
| ATOM | 1863 | N | ALA | A | 234 | 4.946 | 1.130 | 27.504 | 1.00 | 43.05 | N |
| ATOM | 1864 | CA | ALA | A | 234 | 6.411 | 1.376 | 27.472 | 1.00 | 42.22 | C |
| ATOM | 1865 | CB | ALA | A | 234 | 6.977 | 1.670 | 28.887 | 1.00 | 42.17 | C |
| ATOM | 1866 | C | ALA | A | 234 | 7.244 | 0.285 | 26.779 | 1.00 | 41.83 | C |
| ATOM | 1867 | O | ALA | A | 234 | 8.293 | 0.600 | 26.197 | 1.00 | 42.45 | O |
| ATOM | 1868 | N | LYS | A | 235 | 6.780 | −0.973 | 26.829 | 1.00 | 41.10 | N |
| ATOM | 1869 | CA | LYS | A | 235 | 7.510 | −2.144 | 26.306 | 1.00 | 40.88 | C |
| ATOM | 1870 | CB | LYS | A | 235 | 6.712 | −3.430 | 26.534 | 1.00 | 41.57 | C |
| ATOM | 1871 | CG | LYS | A | 235 | 7.051 | −4.180 | 27.828 | 1.00 | 44.74 | C |
| ATOM | 1872 | CD | LYS | A | 235 | 7.748 | −5.577 | 27.558 | 1.00 | 47.48 | C |
| ATOM | 1873 | CE | LYS | A | 235 | 8.112 | −6.246 | 28.948 | 1.00 | 50.15 | C |
| ATOM | 1874 | NZ | LYS | A | 235 | 9.530 | −6.020 | 29.495 | 1.00 | 45.13 | N |
| ATOM | 1875 | C | LYS | A | 235 | 7.911 | −2.084 | 24.830 | 1.00 | 40.48 | C |
| ATOM | 1876 | O | LYS | A | 235 | 8.893 | −2.719 | 24.400 | 1.00 | 39.16 | O |
| ATOM | 1877 | N | ARG | A | 236 | 7.135 | −1.330 | 24.049 | 1.00 | 40.16 | N |
| ATOM | 1878 | CA | ARG | A | 236 | 7.424 | −1.145 | 22.641 | 1.00 | 39.07 | C |
| ATOM | 1879 | CB | ARG | A | 236 | 6.269 | −0.405 | 21.964 | 1.00 | 39.40 | C |
| ATOM | 1880 | CG | ARG | A | 236 | 4.890 | −0.956 | 22.362 | 1.00 | 37.54 | C |
| ATOM | 1881 | CD | ARG | A | 236 | 3.691 | −0.133 | 21.934 | 1.00 | 34.61 | C |
| ATOM | 1882 | NE | ARG | A | 236 | 3.717 | 0.138 | 20.498 | 1.00 | 34.15 | N |
| ATOM | 1883 | CZ | ARG | A | 236 | 2.677 | 0.631 | 19.807 | 1.00 | 35.58 | C |
| ATOM | 1884 | NH1 | ARG | A | 236 | 1.554 | 0.941 | 20.456 | 1.00 | 28.19 | N |
| ATOM | 1885 | NH2 | ARG | A | 236 | 2.784 | 0.884 | 18.475 | 1.00 | 33.74 | N |
| ATOM | 1886 | C | ARG | A | 236 | 8.745 | −0.417 | 22.480 | 1.00 | 38.83 | C |
| ATOM | 1887 | O | ARG | A | 236 | 9.488 | −0.681 | 21.531 | 1.00 | 39.65 | O |
| ATOM | 1888 | N | PHE | A | 237 | 9.046 | 0.487 | 23.414 | 1.00 | 38.24 | N |
| ATOM | 1889 | CA | PHE | A | 237 | 10.392 | 1.073 | 23.531 | 1.00 | 37.24 | C |
| ATOM | 1890 | CB | PHE | A | 237 | 10.374 | 2.429 | 24.300 | 1.00 | 36.68 | C |
| ATOM | 1891 | CG | PHE | A | 237 | 10.024 | 3.622 | 23.432 | 1.00 | 30.94 | C |
| ATOM | 1892 | CD1 | PHE | A | 237 | 10.849 | 4.004 | 22.410 | 1.00 | 27.15 | C |
| ATOM | 1893 | CE1 | PHE | A | 237 | 10.535 | 5.057 | 21.605 | 1.00 | 27.94 | C |
| ATOM | 1894 | CZ | PHE | A | 237 | 9.365 | 5.745 | 21.822 | 1.00 | 27.16 | C |
| ATOM | 1895 | CE2 | PHE | A | 237 | 8.539 | 5.406 | 22.824 | 1.00 | 25.28 | C |
| ATOM | 1896 | CD2 | PHE | A | 237 | 8.862 | 4.323 | 23.631 | 1.00 | 31.30 | C |
| ATOM | 1897 | C | PHE | A | 237 | 11.361 | 0.069 | 24.156 | 1.00 | 37.27 | C |
| ATOM | 1898 | O | PHE | A | 237 | 12.431 | −0.150 | 23.622 | 1.00 | 36.59 | O |
| ATOM | 1899 | N | THR | A | 238 | 10.963 | −0.574 | 25.251 | 1.00 | 38.47 | N |
| ATOM | 1900 | CA | THR | A | 238 | 11.898 | −1.466 | 25.938 | 1.00 | 41.11 | C |
| ATOM | 1901 | CB | THR | A | 238 | 11.518 | −1.701 | 27.425 | 1.00 | 41.38 | C |
| ATOM | 1902 | OG1 | THR | A | 238 | 10.103 | −1.921 | 27.577 | 1.00 | 43.82 | O |
| ATOM | 1903 | CG2 | THR | A | 238 | 11.704 | −0.400 | 28.235 | 1.00 | 42.85 | C |
| ATOM | 1904 | C | THR | A | 238 | 12.282 | −2.759 | 25.156 | 1.00 | 42.23 | C |
| ATOM | 1905 | O | THR | A | 238 | 13.435 | −3.225 | 25.283 | 1.00 | 42.40 | O |
| ATOM | 1906 | N | ASP | A | 239 | 11.384 | −3.290 | 24.300 | 1.00 | 42.91 | N |
| ATOM | 1907 | CA | ASP | A | 239 | 11.780 | −4.416 | 23.415 | 1.00 | 43.62 | C |
| ATOM | 1908 | CB | ASP | A | 239 | 10.656 | −5.016 | 22.535 | 1.00 | 43.54 | C |
| ATOM | 1909 | CG | ASP | A | 239 | 9.446 | −5.549 | 23.333 | 1.00 | 45.80 | C |
| ATOM | 1910 | OD1 | ASP | A | 239 | 9.538 | −5.917 | 24.544 | 1.00 | 42.75 | O |
| ATOM | 1911 | OD2 | ASP | A | 239 | 8.313 | −5.623 | 22.774 | 1.00 | 51.39 | O |
| ATOM | 1912 | C | ASP | A | 239 | 12.884 | −3.938 | 22.518 | 1.00 | 42.96 | C |
| ATOM | 1913 | O | ASP | A | 239 | 13.880 | −4.628 | 22.367 | 1.00 | 43.19 | O |
| ATOM | 1914 | N | ALA | A | 240 | 12.745 | −2.724 | 21.984 | 1.00 | 43.01 | N |
| ATOM | 1915 | CA | ALA | A | 240 | 13.660 | −2.238 | 20.918 | 1.00 | 42.90 | C |
| ATOM | 1916 | CB | ALA | A | 240 | 13.020 | −1.148 | 20.104 | 1.00 | 43.06 | C |
| ATOM | 1917 | C | ALA | A | 240 | 15.039 | −1.805 | 21.370 | 1.00 | 42.95 | C |
| ATOM | 1918 | O | ALA | A | 240 | 15.879 | −1.408 | 20.531 | 1.00 | 43.55 | O |
| ATOM | 1919 | N | GLY | A | 241 | 15.298 | −1.911 | 22.673 | 1.00 | 43.13 | N |
| ATOM | 1920 | CA | GLY | A | 241 | 16.606 | −1.581 | 23.222 | 1.00 | 42.68 | C |
| ATOM | 1921 | C | GLY | A | 241 | 16.574 | −0.378 | 24.165 | 1.00 | 42.42 | C |
| ATOM | 1922 | O | GLY | A | 241 | 17.365 | −0.318 | 25.119 | 1.00 | 43.37 | O |
| ATOM | 1923 | N | PHE | A | 242 | 15.664 | 0.571 | 23.921 | 1.00 | 40.27 | N |
| ATOM | 1924 | CA | PHE | A | 242 | 15.675 | 1.822 | 24.667 | 1.00 | 38.64 | C |
| ATOM | 1925 | CB | PHE | A | 242 | 14.784 | 2.888 | 24.005 | 1.00 | 38.33 | C |
| ATOM | 1926 | CG | PHE | A | 242 | 14.895 | 2.975 | 22.483 | 1.00 | 37.73 | C |
| ATOM | 1927 | CD1 | PHE | A | 242 | 15.896 | 3.741 | 21.881 | 1.00 | 34.04 | C |
| ATOM | 1928 | CE1 | PHE | A | 242 | 15.982 | 3.864 | 20.506 | 1.00 | 32.34 | C |
| ATOM | 1929 | CZ | PHE | A | 242 | 15.028 | 3.240 | 19.707 | 1.00 | 35.96 | C |
| ATOM | 1930 | CE2 | PHE | A | 242 | 13.993 | 2.487 | 20.291 | 1.00 | 35.46 | C |
| ATOM | 1931 | CD2 | PHE | A | 242 | 13.929 | 2.361 | 21.662 | 1.00 | 37.05 | C |
| ATOM | 1932 | C | PHE | A | 242 | 15.259 | 1.613 | 26.158 | 1.00 | 38.09 | C |
| ATOM | 1933 | O | PHE | A | 242 | 14.373 | 0.767 | 26.477 | 1.00 | 37.60 | O |
| ATOM | 1934 | N | GLU | A | 243 | 15.905 | 2.363 | 27.057 | 1.00 | 35.83 | N |
| ATOM | 1935 | CA | GLU | A | 243 | 15.437 | 2.415 | 28.432 | 1.00 | 35.24 | C |
| ATOM | 1936 | CB | GLU | A | 243 | 16.464 | 3.028 | 29.428 | 1.00 | 34.84 | C |
| ATOM | 1937 | CG | GLU | A | 243 | 17.805 | 2.305 | 29.542 | 1.00 | 39.39 | C |
| ATOM | 1938 | CD | GLU | A | 243 | 18.971 | 3.294 | 29.717 | 1.00 | 45.45 | C |
| ATOM | 1939 | OE1 | GLU | A | 243 | 19.980 | 3.133 | 28.962 | 1.00 | 44.87 | O |
| ATOM | 1940 | OE2 | GLU | A | 243 | 18.869 | 4.240 | 30.594 | 1.00 | 42.25 | O |
| ATOM | 1941 | C | GLU | A | 243 | 14.227 | 3.324 | 28.364 | 1.00 | 33.37 | C |
| ATOM | 1942 | O | GLU | A | 243 | 14.213 | 4.277 | 27.577 | 1.00 | 32.60 | O |
| ATOM | 1943 | N | HIS | A | 244 | 13.250 | 3.053 | 29.224 | 1.00 | 31.08 | N |
| ATOM | 1944 | CA | HIS | A | 244 | 12.089 | 3.887 | 29.368 | 1.00 | 29.13 | C |
| ATOM | 1945 | CB | HIS | A | 244 | 10.915 | 3.273 | 28.617 | 1.00 | 27.66 | C |
| ATOM | 1946 | CG | HIS | A | 244 | 9.698 | 4.144 | 28.563 | 1.00 | 21.87 | C |
| ATOM | 1947 | ND1 | HIS | A | 244 | 8.867 | 4.318 | 29.646 | 1.00 | 17.46 | N |
| ATOM | 1948 | CE1 | HIS | A | 244 | 7.874 | 5.120 | 29.321 | 1.00 | 20.24 | C |
| ATOM | 1949 | NE2 | HIS | A | 244 | 8.008 | 5.436 | 28.045 | 1.00 | 21.82 | N |
| ATOM | 1950 | CD2 | HIS | A | 244 | 9.140 | 4.837 | 27.546 | 1.00 | 18.54 | C |
| ATOM | 1951 | C | HIS | A | 244 | 11.762 | 4.136 | 30.847 | 1.00 | 30.55 | C |
| ATOM | 1952 | O | HIS | A | 244 | 11.902 | 3.239 | 31.714 | 1.00 | 31.45 | O |
| ATOM | 1953 | N | TYR | A | 245 | 11.323 | 5.365 | 31.124 | 1.00 | 30.58 | N |
| ATOM | 1954 | CA | TYR | A | 245 | 11.086 | 5.822 | 32.470 | 1.00 | 30.95 | C |
| ATOM | 1955 | CB | TYR | A | 245 | 12.250 | 6.722 | 32.960 | 1.00 | 30.16 | C |
| ATOM | 1956 | CG | TYR | A | 245 | 13.653 | 6.091 | 32.852 | 1.00 | 28.65 | C |
| ATOM | 1957 | CD1 | TYR | A | 245 | 14.395 | 6.215 | 31.693 | 1.00 | 27.94 | C |
| ATOM | 1958 | CE1 | TYR | A | 245 | 15.681 | 5.644 | 31.591 | 1.00 | 27.22 | C |
| ATOM | 1959 | CZ | TYR | A | 245 | 16.260 | 4.943 | 32.668 | 1.00 | 28.94 | C |
| ATOM | 1960 | OH | TYR | A | 245 | 17.550 | 4.424 | 32.493 | 1.00 | 27.52 | O |
| ATOM | 1961 | CE2 | TYR | A | 245 | 15.558 | 4.790 | 33.835 | 1.00 | 22.12 | C |
| ATOM | 1962 | CD2 | TYR | A | 245 | 14.229 | 5.378 | 33.922 | 1.00 | 26.55 | C |
| ATOM | 1963 | C | TYR | A | 245 | 9.801 | 6.585 | 32.505 | 1.00 | 32.22 | C |
| ATOM | 1964 | O | TYR | A | 245 | 9.461 | 7.309 | 31.565 | 1.00 | 32.35 | O |
| ATOM | 1965 | N | ASP | A | 246 | 9.072 | 6.416 | 33.594 | 1.00 | 33.96 | N |
| ATOM | 1966 | CA | ASP | A | 246 | 7.837 | 7.141 | 33.785 | 1.00 | 35.29 | C |
| ATOM | 1967 | CB | ASP | A | 246 | 6.652 | 6.196 | 34.033 | 1.00 | 36.07 | C |
| ATOM | 1968 | CG | ASP | A | 246 | 5.931 | 5.853 | 32.758 | 1.00 | 38.43 | C |
| ATOM | 1969 | OD1 | ASP | A | 246 | 6.038 | 4.680 | 32.352 | 1.00 | 39.32 | O |
| ATOM | 1970 | OD2 | ASP | A | 246 | 5.295 | 6.705 | 32.075 | 1.00 | 40.60 | O |
| ATOM | 1971 | C | ASP | A | 246 | 8.036 | 8.045 | 34.945 | 1.00 | 35.45 | C |
| ATOM | 1972 | O | ASP | A | 246 | 8.350 | 7.598 | 36.082 | 1.00 | 37.00 | O |
| ATOM | 1973 | N | LEU | A | 247 | 7.849 | 9.320 | 34.668 | 1.00 | 34.92 | N |
| ATOM | 1974 | CA | LEU | A | 247 | 8.195 | 10.342 | 35.620 | 1.00 | 34.71 | C |
| ATOM | 1975 | CB | LEU | A | 247 | 9.540 | 10.973 | 35.234 | 1.00 | 34.09 | C |
| ATOM | 1976 | CG | LEU | A | 247 | 10.744 | 10.960 | 36.170 | 1.00 | 32.78 | C |
| ATOM | 1977 | CD1 | LEU | A | 247 | 11.424 | 12.273 | 36.047 | 1.00 | 31.61 | C |
| ATOM | 1978 | CD2 | LEU | A | 247 | 10.388 | 10.756 | 37.609 | 1.00 | 35.22 | C |
| ATOM | 1979 | C | LEU | A | 247 | 7.042 | 11.278 | 35.542 | 1.00 | 34.29 | C |
| ATOM | 1980 | O | LEU | A | 247 | 7.139 | 12.376 | 35.044 | 1.00 | 35.70 | O |
| ATOM | 1981 | N | PHE | A | 248 | 5.913 | 10.784 | 35.988 | 1.00 | 34.49 | N |
| ATOM | 1982 | CA | PHE | A | 248 | 4.682 | 11.532 | 35.921 | 1.00 | 35.03 | C |
| ATOM | 1983 | CB | PHE | A | 248 | 3.450 | 10.624 | 36.149 | 1.00 | 35.31 | C |
| ATOM | 1984 | CG | PHE | A | 248 | 2.149 | 11.372 | 36.116 | 1.00 | 34.16 | C |
| ATOM | 1985 | CD1 | PHE | A | 248 | 1.581 | 11.762 | 34.888 | 1.00 | 34.27 | C |
| ATOM | 1986 | CE1 | PHE | A | 248 | 0.367 | 12.476 | 34.818 | 1.00 | 31.97 | C |
| ATOM | 1987 | CZ | PHE | A | 248 | −0.276 | 12.811 | 35.979 | 1.00 | 34.83 | C |
| ATOM | 1988 | CE2 | PHE | A | 248 | 0.292 | 12.419 | 37.249 | 1.00 | 34.87 | C |
| ATOM | 1989 | CD2 | PHE | A | 248 | 1.504 | 11.706 | 37.290 | 1.00 | 33.55 | C |
| ATOM | 1990 | C | PHE | A | 248 | 4.649 | 12.688 | 36.928 | 1.00 | 35.60 | C |
| ATOM | 1991 | O | PHE | A | 248 | 4.901 | 12.498 | 38.121 | 1.00 | 35.37 | O |
| ATOM | 1992 | N | PHE | A | 249 | 4.354 | 13.884 | 36.415 | 1.00 | 35.44 | N |
| ATOM | 1993 | CA | PHE | A | 249 | 3.748 | 14.904 | 37.221 | 1.00 | 35.94 | C |
| ATOM | 1994 | CB | PHE | A | 249 | 4.734 | 15.895 | 37.845 | 1.00 | 34.76 | C |
| ATOM | 1995 | CG | PHE | A | 249 | 5.564 | 16.650 | 36.870 | 1.00 | 34.05 | C |
| ATOM | 1996 | CD1 | PHE | A | 249 | 5.467 | 18.051 | 36.816 | 1.00 | 30.40 | C |
| ATOM | 1997 | CE1 | PHE | A | 249 | 6.276 | 18.780 | 35.970 | 1.00 | 30.04 | C |
| ATOM | 1998 | CZ | PHE | A | 249 | 7.206 | 18.106 | 35.118 | 1.00 | 27.36 | C |
| ATOM | 1999 | CE2 | PHE | A | 249 | 7.279 | 16.686 | 35.129 | 1.00 | 29.07 | C |
| ATOM | 2000 | CD2 | PHE | A | 249 | 6.486 | 15.973 | 36.017 | 1.00 | 31.77 | C |
| ATOM | 2001 | C | PHE | A | 249 | 2.649 | 15.581 | 36.457 | 1.00 | 37.24 | C |
| ATOM | 2002 | O | PHE | A | 249 | 2.590 | 15.536 | 35.205 | 1.00 | 37.41 | O |
| ATOM | 2003 | N | ILE | A | 250 | 1.755 | 16.178 | 37.232 | 1.00 | 38.35 | N |
| ATOM | 2004 | CA | ILE | A | 250 | 0.501 | 16.703 | 36.691 | 1.00 | 40.18 | C |
| ATOM | 2005 | CB | ILE | A | 250 | −0.450 | 17.080 | 37.919 | 1.00 | 40.19 | C |
| ATOM | 2006 | CG1 | ILE | A | 250 | −1.390 | 15.901 | 38.299 | 1.00 | 42.73 | C |
| ATOM | 2007 | CD1 | ILE | A | 250 | −2.597 | 15.568 | 37.259 | 1.00 | 49.36 | C |
| ATOM | 2008 | CG2 | ILE | A | 250 | −1.173 | 18.393 | 37.754 | 1.00 | 40.85 | C |
| ATOM | 2009 | C | ILE | A | 250 | 0.790 | 17.840 | 35.643 | 1.00 | 39.62 | C |
| ATOM | 2010 | O | ILE | A | 250 | 1.670 | 18.685 | 35.865 | 1.00 | 39.16 | O |
| ATOM | 2011 | N | ASP | A | 251 | 0.093 | 17.790 | 34.509 | 1.00 | 38.79 | N |
| ATOM | 2012 | CA | ASP | A | 251 | 0.067 | 18.872 | 33.528 | 1.00 | 38.62 | C |
| ATOM | 2013 | CB | ASP | A | 251 | −0.961 | 18.584 | 32.412 | 1.00 | 39.07 | C |
| ATOM | 2014 | CG | ASP | A | 251 | −0.787 | 19.513 | 31.185 | 1.00 | 39.25 | C |
| ATOM | 2015 | OD1 | ASP | A | 251 | 0.202 | 20.273 | 31.145 | 1.00 | 41.44 | O |
| ATOM | 2016 | OD2 | ASP | A | 251 | −1.568 | 19.561 | 30.221 | 1.00 | 37.02 | O |
| ATOM | 2017 | C | ASP | A | 251 | −0.203 | 20.255 | 34.118 | 1.00 | 38.15 | C |
| ATOM | 2018 | O | ASP | A | 251 | −1.098 | 20.427 | 34.935 | 1.00 | 38.39 | O |
| ATOM | 2019 | N | GLY | A | 252 | 0.593 | 21.237 | 33.698 | 1.00 | 38.07 | N |
| ATOM | 2020 | CA | GLY | A | 252 | 0.483 | 22.606 | 34.197 | 1.00 | 37.90 | C |
| ATOM | 2021 | C | GLY | A | 252 | 1.097 | 22.904 | 35.561 | 1.00 | 37.77 | C |
| ATOM | 2022 | O | GLY | A | 252 | 0.871 | 23.975 | 36.156 | 1.00 | 38.18 | O |
| ATOM | 2023 | N | SER | A | 253 | 1.882 | 21.962 | 36.069 | 1.00 | 37.46 | N |
| ATOM | 2024 | CA | SER | A | 253 | 2.410 | 22.064 | 37.432 | 1.00 | 36.50 | C |
| ATOM | 2025 | CB | SER | A | 253 | 1.830 | 20.963 | 38.331 | 1.00 | 36.53 | C |
| ATOM | 2026 | OG | SER | A | 253 | 2.736 | 19.869 | 38.455 | 1.00 | 36.46 | O |
| ATOM | 2027 | C | SER | A | 253 | 3.938 | 22.000 | 37.418 | 1.00 | 35.52 | C |
| ATOM | 2028 | O | SER | A | 253 | 4.552 | 21.611 | 36.411 | 1.00 | 33.73 | O |
| ATOM | 2029 | N | THR | A | 254 | 4.544 | 22.374 | 38.548 | 1.00 | 34.92 | N |
| ATOM | 2030 | CA | THR | A | 254 | 5.991 | 22.227 | 38.660 | 1.00 | 34.27 | C |
| ATOM | 2031 | CB | THR | A | 254 | 6.569 | 23.400 | 39.419 | 1.00 | 34.14 | C |
| ATOM | 2032 | OG1 | THR | A | 254 | 6.024 | 23.361 | 40.715 | 1.00 | 34.47 | O |
| ATOM | 2033 | CG2 | THR | A | 254 | 6.051 | 24.737 | 38.835 | 1.00 | 33.34 | C |
| ATOM | 2034 | C | THR | A | 254 | 6.399 | 20.864 | 39.268 | 1.00 | 33.63 | C |
| ATOM | 2035 | O | THR | A | 254 | 5.666 | 20.310 | 40.117 | 1.00 | 32.44 | O |
| ATOM | 2036 | N | PRO | A | 255 | 7.562 | 20.341 | 38.838 | 1.00 | 33.32 | N |
| ATOM | 2037 | CA | PRO | A | 255 | 8.063 | 19.027 | 39.298 | 1.00 | 33.83 | C |
| ATOM | 2038 | CB | PRO | A | 255 | 9.251 | 18.749 | 38.339 | 1.00 | 32.84 | C |
| ATOM | 2039 | CG | PRO | A | 255 | 9.749 | 20.086 | 37.939 | 1.00 | 31.39 | C |
| ATOM | 2040 | CD | PRO | A | 255 | 8.543 | 20.988 | 37.949 | 1.00 | 32.83 | C |
| ATOM | 2041 | C | PRO | A | 255 | 8.561 | 19.091 | 40.769 | 1.00 | 33.79 | C |
| ATOM | 2042 | O | PRO | A | 255 | 9.333 | 20.014 | 41.093 | 1.00 | 33.22 | O |
| ATOM | 2043 | N | SER | A | 256 | 8.086 | 18.176 | 41.628 | 1.00 | 34.22 | N |
| ATOM | 2044 | CA | SER | A | 256 | 8.593 | 18.060 | 43.015 | 1.00 | 34.71 | C |
| ATOM | 2045 | CB | SER | A | 256 | 7.912 | 16.934 | 43.813 | 1.00 | 33.96 | C |
| ATOM | 2046 | OG | SER | A | 256 | 8.289 | 15.651 | 43.323 | 1.00 | 33.61 | O |
| ATOM | 2047 | C | SER | A | 256 | 10.058 | 17.791 | 42.979 | 1.00 | 34.97 | C |
| ATOM | 2048 | O | SER | A | 256 | 10.644 | 17.488 | 41.933 | 1.00 | 35.81 | O |
| ATOM | 2049 | N | ASP | A | 257 | 10.655 | 17.904 | 44.143 | 1.00 | 36.74 | N |
| ATOM | 2050 | CA | ASP | A | 257 | 12.075 | 17.634 | 44.315 | 1.00 | 37.33 | C |
| ATOM | 2051 | CB | ASP | A | 257 | 12.530 | 18.132 | 45.691 | 1.00 | 38.23 | C |
| ATOM | 2052 | CG | ASP | A | 257 | 12.611 | 19.682 | 45.728 | 1.00 | 41.57 | C |
| ATOM | 2053 | OD1 | ASP | A | 257 | 11.975 | 20.302 | 44.853 | 1.00 | 43.82 | O |
| ATOM | 2054 | OD2 | ASP | A | 257 | 13.287 | 20.376 | 46.531 | 1.00 | 47.11 | O |
| ATOM | 2055 | C | ASP | A | 257 | 12.494 | 16.214 | 43.939 | 1.00 | 36.53 | C |
| ATOM | 2056 | O | ASP | A | 257 | 13.515 | 16.030 | 43.256 | 1.00 | 36.07 | O |
| ATOM | 2057 | N | ASN | A | 258 | 11.662 | 15.245 | 44.292 | 1.00 | 36.12 | N |
| ATOM | 2058 | CA | ASN | A | 258 | 11.899 | 13.838 | 43.947 | 1.00 | 37.33 | C |
| ATOM | 2059 | CB | ASN | A | 258 | 10.797 | 12.925 | 44.572 | 1.00 | 38.74 | C |
| ATOM | 2060 | CG | ASN | A | 258 | 11.218 | 12.323 | 45.902 | 1.00 | 44.26 | C |
| ATOM | 2061 | OD1 | ASN | A | 258 | 12.281 | 12.701 | 46.478 | 1.00 | 47.97 | O |
| ATOM | 2062 | ND2 | ASN | A | 258 | 10.383 | 11.402 | 46.431 | 1.00 | 47.79 | N |
| ATOM | 2063 | C | ASN | A | 258 | 11.917 | 13.606 | 42.439 | 1.00 | 36.01 | C |
| ATOM | 2064 | O | ASN | A | 258 | 12.784 | 12.883 | 41.915 | 1.00 | 36.05 | O |
| ATOM | 2065 | N | ILE | A | 259 | 10.921 | 14.188 | 41.756 | 1.00 | 34.53 | N |
| ATOM | 2066 | CA | ILE | A | 259 | 10.875 | 14.124 | 40.323 | 1.00 | 33.32 | C |
| ATOM | 2067 | CB | ILE | A | 259 | 9.523 | 14.646 | 39.802 | 1.00 | 33.47 | C |
| ATOM | 2068 | CG1 | ILE | A | 259 | 8.511 | 13.486 | 39.905 | 1.00 | 35.12 | C |
| ATOM | 2069 | CD1 | ILE | A | 259 | 7.082 | 13.868 | 39.969 | 1.00 | 37.39 | C |
| ATOM | 2070 | CG2 | ILE | A | 259 | 9.638 | 15.080 | 38.356 | 1.00 | 30.26 | C |
| ATOM | 2071 | C | ILE | A | 259 | 12.140 | 14.789 | 39.707 | 1.00 | 33.37 | C |
| ATOM | 2072 | O | ILE | A | 259 | 12.829 | 14.181 | 38.833 | 1.00 | 32.48 | O |
| ATOM | 2073 | N | VAL | A | 260 | 12.488 | 16.002 | 40.174 | 1.00 | 31.92 | N |
| ATOM | 2074 | CA | VAL | A | 260 | 13.665 | 16.624 | 39.573 | 1.00 | 30.84 | C |
| ATOM | 2075 | CB | VAL | A | 260 | 13.997 | 18.052 | 40.113 | 1.00 | 31.16 | C |
| ATOM | 2076 | CG1 | VAL | A | 260 | 15.340 | 18.546 | 39.510 | 1.00 | 30.06 | C |
| ATOM | 2077 | CG2 | VAL | A | 260 | 12.875 | 19.038 | 39.815 | 1.00 | 28.07 | C |
| ATOM | 2078 | C | VAL | A | 260 | 14.848 | 15.690 | 39.750 | 1.00 | 30.24 | C |
| ATOM | 2079 | O | VAL | A | 260 | 15.535 | 15.393 | 38.785 | 1.00 | 30.14 | O |
| ATOM | 2080 | N | ARG | A | 261 | 15.038 | 15.188 | 40.978 | 1.00 | 30.19 | N |
| ATOM | 2081 | CA | ARG | A | 261 | 16.202 | 14.363 | 41.344 | 1.00 | 29.99 | C |
| ATOM | 2082 | CB | ARG | A | 261 | 16.280 | 14.169 | 42.858 | 1.00 | 30.77 | C |
| ATOM | 2083 | CG | ARG | A | 261 | 17.027 | 15.331 | 43.599 | 1.00 | 37.31 | C |
| ATOM | 2084 | CD | ARG | A | 261 | 16.369 | 15.758 | 44.964 | 1.00 | 48.99 | C |
| ATOM | 2085 | NE | ARG | A | 261 | 16.832 | 17.067 | 45.521 | 1.00 | 55.00 | N |
| ATOM | 2086 | CZ | ARG | A | 261 | 16.454 | 18.304 | 45.089 | 1.00 | 56.95 | C |
| ATOM | 2087 | NH1 | ARG | A | 261 | 15.605 | 18.487 | 44.064 | 1.00 | 57.23 | N |
| ATOM | 2088 | NH2 | ARG | A | 261 | 16.955 | 19.376 | 45.683 | 1.00 | 56.62 | N |
| ATOM | 2089 | C | ARG | A | 261 | 16.241 | 13.018 | 40.586 | 1.00 | 28.88 | C |
| ATOM | 2090 | O | ARG | A | 261 | 17.337 | 12.551 | 40.154 | 1.00 | 28.49 | O |
| ATOM | 2091 | N | ARG | A | 262 | 15.061 | 12.416 | 40.362 | 1.00 | 26.25 | N |
| ATOM | 2092 | CA | ARG | A | 262 | 15.043 | 11.186 | 39.571 | 1.00 | 24.69 | C |
| ATOM | 2093 | CB | ARG | A | 262 | 13.726 | 10.426 | 39.683 | 1.00 | 25.43 | C |
| ATOM | 2094 | CG | ARG | A | 262 | 13.751 | 9.053 | 39.038 | 1.00 | 26.17 | C |
| ATOM | 2095 | CD | ARG | A | 262 | 14.476 | 7.919 | 39.782 | 1.00 | 24.92 | C |
| ATOM | 2096 | NE | ARG | A | 262 | 14.134 | 6.611 | 39.188 | 1.00 | 22.17 | N |
| ATOM | 2097 | CZ | ARG | A | 262 | 14.883 | 5.963 | 38.283 | 1.00 | 22.83 | C |
| ATOM | 2098 | NH1 | ARG | A | 262 | 16.049 | 6.466 | 37.896 | 1.00 | 17.65 | N |
| ATOM | 2099 | NH2 | ARG | A | 262 | 14.467 | 4.794 | 37.765 | 1.00 | 19.57 | N |
| ATOM | 2100 | C | ARG | A | 262 | 15.354 | 11.486 | 38.136 | 1.00 | 23.79 | C |
| ATOM | 2101 | O | ARG | A | 262 | 16.069 | 10.718 | 37.510 | 1.00 | 22.36 | O |
| ATOM | 2102 | N | PHE | A | 263 | 14.874 | 12.640 | 37.651 | 1.00 | 23.30 | N |
| ATOM | 2103 | CA | PHE | A | 263 | 15.188 | 13.072 | 36.329 | 1.00 | 23.64 | C |
| ATOM | 2104 | CB | PHE | A | 263 | 14.390 | 14.322 | 35.934 | 1.00 | 22.73 | C |
| ATOM | 2105 | CG | PHE | A | 263 | 14.607 | 14.723 | 34.469 | 1.00 | 22.71 | C |
| ATOM | 2106 | CD1 | PHE | A | 263 | 13.964 | 14.028 | 33.447 | 1.00 | 18.84 | C |
| ATOM | 2107 | CE1 | PHE | A | 263 | 14.140 | 14.363 | 32.082 | 1.00 | 20.04 | C |
| ATOM | 2108 | CZ | PHE | A | 263 | 14.957 | 15.406 | 31.705 | 1.00 | 19.05 | C |
| ATOM | 2109 | CE2 | PHE | A | 263 | 15.657 | 16.123 | 32.730 | 1.00 | 24.61 | C |
| ATOM | 2110 | CD2 | PHE | A | 263 | 15.495 | 15.759 | 34.117 | 1.00 | 23.48 | C |
| ATOM | 2111 | C | PHE | A | 263 | 16.701 | 13.295 | 36.138 | 1.00 | 24.87 | C |
| ATOM | 2112 | O | PHE | A | 263 | 17.323 | 12.790 | 35.190 | 1.00 | 25.68 | O |
| ATOM | 2113 | N | LEU | A | 264 | 17.293 | 14.100 | 37.008 | 1.00 | 25.79 | N |
| ATOM | 2114 | CA | LEU | A | 264 | 18.739 | 14.301 | 36.968 | 1.00 | 25.94 | C |
| ATOM | 2115 | CB | LEU | A | 264 | 19.152 | 15.073 | 38.208 | 1.00 | 25.48 | C |
| ATOM | 2116 | CG | LEU | A | 264 | 18.665 | 16.505 | 38.145 | 1.00 | 24.23 | C |
| ATOM | 2117 | CD1 | LEU | A | 264 | 19.103 | 17.310 | 39.402 | 1.00 | 25.19 | C |
| ATOM | 2118 | CD2 | LEU | A | 264 | 19.166 | 17.121 | 36.763 | 1.00 | 25.71 | C |
| ATOM | 2119 | C | LEU | A | 264 | 19.469 | 12.976 | 36.959 | 1.00 | 27.03 | C |
| ATOM | 2120 | O | LEU | A | 264 | 20.374 | 12.750 | 36.157 | 1.00 | 26.99 | O |
| ATOM | 2121 | N | ASN | A | 265 | 19.070 | 12.098 | 37.878 | 1.00 | 27.75 | N |
| ATOM | 2122 | CA | ASN | A | 265 | 19.735 | 10.800 | 38.047 | 1.00 | 28.08 | C |
| ATOM | 2123 | CB | ASN | A | 265 | 19.143 | 10.114 | 39.281 | 1.00 | 27.71 | C |
| ATOM | 2124 | CG | ASN | A | 265 | 19.390 | 8.614 | 39.321 | 1.00 | 29.77 | C |
| ATOM | 2125 | OD1 | ASN | A | 265 | 18.538 | 7.818 | 38.877 | 1.00 | 28.58 | O |
| ATOM | 2126 | ND2 | ASN | A | 265 | 20.545 | 8.210 | 39.885 | 1.00 | 28.45 | N |
| ATOM | 2127 | C | ASN | A | 265 | 19.611 | 9.944 | 36.796 | 1.00 | 27.97 | C |
| ATOM | 2128 | O | ASN | A | 265 | 20.556 | 9.310 | 36.411 | 1.00 | 29.56 | O |
| ATOM | 2129 | N | ILE | A | 266 | 18.451 | 9.939 | 36.155 | 1.00 | 27.72 | N |
| ATOM | 2130 | CA | ILE | A | 266 | 18.272 | 9.264 | 34.874 | 1.00 | 27.43 | C |
| ATOM | 2131 | CB | ILE | A | 266 | 16.764 | 9.318 | 34.387 | 1.00 | 27.09 | C |
| ATOM | 2132 | CG1 | ILE | A | 266 | 15.903 | 8.450 | 35.302 | 1.00 | 24.67 | C |
| ATOM | 2133 | CD1 | ILE | A | 266 | 14.411 | 8.920 | 35.477 | 1.00 | 22.89 | C |
| ATOM | 2134 | CG2 | ILE | A | 266 | 16.637 | 8.852 | 32.888 | 1.00 | 22.91 | C |
| ATOM | 2135 | C | ILE | A | 266 | 19.221 | 9.801 | 33.797 | 1.00 | 28.75 | C |
| ATOM | 2136 | O | ILE | A | 266 | 19.894 | 9.010 | 33.110 | 1.00 | 29.64 | O |
| ATOM | 2137 | N | CYS | A | 267 | 19.298 | 11.135 | 33.659 | 1.00 | 29.82 | N |
| ATOM | 2138 | CA | CYS | A | 267 | 20.094 | 11.732 | 32.571 | 1.00 | 30.23 | C |
| ATOM | 2139 | CB | CYS | A | 267 | 19.643 | 13.150 | 32.192 | 1.00 | 29.11 | C |
| ATOM | 2140 | SG | CYS | A | 267 | 17.883 | 13.155 | 31.972 | 1.00 | 30.61 | S |
| ATOM | 2141 | C | CYS | A | 267 | 21.574 | 11.632 | 32.831 | 1.00 | 30.73 | C |
| ATOM | 2142 | O | CYS | A | 267 | 22.399 | 11.555 | 31.890 | 1.00 | 31.62 | O |
| ATOM | 2143 | N | GLU | A | 268 | 21.922 | 11.609 | 34.101 | 1.00 | 31.75 | N |
| ATOM | 2144 | CA | GLU | A | 268 | 23.318 | 11.528 | 34.463 | 1.00 | 32.58 | C |
| ATOM | 2145 | CB | GLU | A | 268 | 23.514 | 11.982 | 35.900 | 1.00 | 31.69 | C |
| ATOM | 2146 | CG | GLU | A | 268 | 23.590 | 13.457 | 36.087 | 1.00 | 29.64 | C |
| ATOM | 2147 | CD | GLU | A | 268 | 23.137 | 13.905 | 37.468 | 1.00 | 32.21 | C |
| ATOM | 2148 | OE1 | GLU | A | 268 | 22.900 | 13.025 | 38.337 | 1.00 | 32.99 | O |
| ATOM | 2149 | OE2 | GLU | A | 268 | 23.021 | 15.156 | 37.701 | 1.00 | 32.37 | O |
| ATOM | 2150 | C | GLU | A | 268 | 23.807 | 10.084 | 34.240 | 1.00 | 34.08 | C |
| ATOM | 2151 | O | GLU | A | 268 | 24.967 | 9.875 | 33.936 | 1.00 | 34.79 | O |
| ATOM | 2152 | N | ASN | A | 269 | 22.928 | 9.091 | 34.359 | 1.00 | 35.31 | N |
| ATOM | 2153 | CA | ASN | A | 269 | 23.404 | 7.712 | 34.353 | 1.00 | 36.46 | C |
| ATOM | 2154 | CB | ASN | A | 269 | 22.877 | 6.928 | 35.578 | 1.00 | 36.54 | C |
| ATOM | 2155 | CG | ASN | A | 269 | 23.394 | 7.516 | 36.897 | 1.00 | 37.53 | C |
| ATOM | 2156 | OD1 | ASN | A | 269 | 24.602 | 7.657 | 37.087 | 1.00 | 37.87 | O |
| ATOM | 2157 | ND2 | ASN | A | 269 | 22.473 | 7.909 | 37.788 | 1.00 | 34.48 | N |
| ATOM | 2158 | C | ASN | A | 269 | 23.156 | 6.966 | 33.060 | 1.00 | 37.25 | C |
| ATOM | 2159 | O | ASN | A | 269 | 23.554 | 5.800 | 32.930 | 1.00 | 37.33 | O |
| ATOM | 2160 | N | THR | A | 270 | 22.493 | 7.634 | 32.116 | 1.00 | 38.07 | N |
| ATOM | 2161 | CA | THR | A | 270 | 22.181 | 7.023 | 30.820 | 1.00 | 38.56 | C |
| ATOM | 2162 | CB | THR | A | 270 | 20.727 | 7.459 | 30.346 | 1.00 | 38.64 | C |
| ATOM | 2163 | OG1 | THR | A | 270 | 20.282 | 6.653 | 29.241 | 1.00 | 39.90 | O |
| ATOM | 2164 | CG2 | THR | A | 270 | 20.716 | 8.844 | 29.804 | 1.00 | 38.79 | C |
| ATOM | 2165 | C | THR | A | 270 | 23.329 | 7.313 | 29.831 | 1.00 | 38.44 | C |
| ATOM | 2166 | O | THR | A | 270 | 24.016 | 8.340 | 29.990 | 1.00 | 37.92 | O |
| ATOM | 2167 | N | GLU | A | 271 | 23.592 | 6.423 | 28.852 | 1.00 | 38.52 | N |
| ATOM | 2168 | CA | GLU | A | 271 | 24.832 | 6.618 | 28.038 | 1.00 | 38.99 | C |
| ATOM | 2169 | CB | GLU | A | 271 | 25.495 | 5.316 | 27.585 | 1.00 | 39.60 | C |
| ATOM | 2170 | CG | GLU | A | 271 | 26.889 | 5.138 | 28.186 | 1.00 | 44.95 | C |
| ATOM | 2171 | CD | GLU | A | 271 | 26.990 | 3.887 | 29.076 | 1.00 | 53.61 | C |
| ATOM | 2172 | OE1 | GLU | A | 271 | 26.316 | 3.843 | 30.144 | 1.00 | 55.28 | O |
| ATOM | 2173 | OE2 | GLU | A | 271 | 27.724 | 2.922 | 28.700 | 1.00 | 56.66 | O |
| ATOM | 2174 | C | GLU | A | 271 | 24.882 | 7.685 | 26.923 | 1.00 | 37.61 | C |
| ATOM | 2175 | O | GLU | A | 271 | 25.876 | 8.377 | 26.820 | 1.00 | 37.56 | O |
| ATOM | 2176 | N | GLY | A | 272 | 23.850 | 7.797 | 26.086 | 1.00 | 36.48 | N |
| ATOM | 2177 | CA | GLY | A | 272 | 23.789 | 8.877 | 25.094 | 1.00 | 34.76 | C |
| ATOM | 2178 | C | GLY | A | 272 | 22.536 | 9.753 | 25.267 | 1.00 | 33.52 | C |
| ATOM | 2179 | O | GLY | A | 272 | 22.256 | 10.237 | 26.376 | 1.00 | 32.95 | O |
| ATOM | 2180 | N | ALA | A | 273 | 21.744 | 9.895 | 24.201 | 1.00 | 31.04 | N |
| ATOM | 2181 | CA | ALA | A | 273 | 20.674 | 10.870 | 24.211 | 1.00 | 29.58 | C |
| ATOM | 2182 | CB | ALA | A | 273 | 20.396 | 11.388 | 22.805 | 1.00 | 29.41 | C |
| ATOM | 2183 | C | ALA | A | 273 | 19.399 | 10.466 | 24.977 | 1.00 | 29.57 | C |
| ATOM | 2184 | O | ALA | A | 273 | 19.077 | 9.257 | 25.140 | 1.00 | 30.10 | O |
| ATOM | 2185 | N | ILE | A | 274 | 18.723 | 11.473 | 25.537 | 1.00 | 28.07 | N |
| ATOM | 2186 | CA | ILE | A | 274 | 17.456 | 11.266 | 26.239 | 1.00 | 26.92 | C |
| ATOM | 2187 | CB | ILE | A | 274 | 17.501 | 11.801 | 27.714 | 1.00 | 26.71 | C |
| ATOM | 2188 | CG1 | ILE | A | 274 | 18.649 | 11.195 | 28.516 | 1.00 | 26.40 | C |
| ATOM | 2189 | CD1 | ILE | A | 274 | 19.761 | 12.230 | 28.830 | 1.00 | 28.28 | C |
| ATOM | 2190 | CG2 | ILE | A | 274 | 16.168 | 11.575 | 28.487 | 1.00 | 26.66 | C |
| ATOM | 2191 | C | ILE | A | 274 | 16.411 | 12.034 | 25.417 | 1.00 | 27.28 | C |
| ATOM | 2192 | O | ILE | A | 274 | 16.576 | 13.215 | 25.121 | 1.00 | 27.82 | O |
| ATOM | 2193 | N | ALA | A | 275 | 15.364 | 11.328 | 25.007 | 1.00 | 27.11 | N |
| ATOM | 2194 | CA | ALA | A | 275 | 14.207 | 11.880 | 24.340 | 1.00 | 25.37 | C |
| ATOM | 2195 | CB | ALA | A | 275 | 13.769 | 10.913 | 23.272 | 1.00 | 25.99 | C |
| ATOM | 2196 | C | ALA | A | 275 | 13.147 | 11.995 | 25.408 | 1.00 | 25.03 | C |
| ATOM | 2197 | O | ALA | A | 275 | 12.789 | 10.975 | 26.045 | 1.00 | 25.22 | O |
| ATOM | 2198 | N | VAL | A | 276 | 12.685 | 13.224 | 25.653 | 1.00 | 23.73 | N |
| ATOM | 2199 | CA | VAL | A | 276 | 11.738 | 13.507 | 26.737 | 1.00 | 23.38 | C |
| ATOM | 2200 | CB | VAL | A | 276 | 12.322 | 14.607 | 27.713 | 1.00 | 23.75 | C |
| ATOM | 2201 | CG1 | VAL | A | 276 | 11.316 | 15.047 | 28.819 | 1.00 | 20.32 | C |
| ATOM | 2202 | CG2 | VAL | A | 276 | 13.597 | 14.086 | 28.342 | 1.00 | 20.65 | C |
| ATOM | 2203 | C | VAL | A | 276 | 10.421 | 13.973 | 26.153 | 1.00 | 24.51 | C |
| ATOM | 2204 | O | VAL | A | 276 | 10.434 | 14.814 | 25.250 | 1.00 | 23.65 | O |
| ATOM | 2205 | N | HIS | A | 277 | 9.288 | 13.433 | 26.642 | 1.00 | 25.56 | N |
| ATOM | 2206 | CA | HIS | A | 277 | 7.990 | 13.971 | 26.210 | 1.00 | 26.31 | C |
| ATOM | 2207 | CB | HIS | A | 277 | 7.358 | 13.182 | 25.037 | 1.00 | 27.21 | C |
| ATOM | 2208 | CG | HIS | A | 277 | 6.820 | 11.828 | 25.412 | 1.00 | 27.05 | C |
| ATOM | 2209 | ND1 | HIS | A | 277 | 5.580 | 11.650 | 25.990 | 1.00 | 27.12 | N |
| ATOM | 2210 | CE1 | HIS | A | 277 | 5.384 | 10.357 | 26.208 | 1.00 | 25.84 | C |
| ATOM | 2211 | NE2 | HIS | A | 277 | 6.455 | 9.696 | 25.793 | 1.00 | 22.78 | N |
| ATOM | 2212 | CD2 | HIS | A | 277 | 7.359 | 10.589 | 25.285 | 1.00 | 23.62 | C |
| ATOM | 2213 | C | HIS | A | 277 | 7.016 | 14.097 | 27.297 | 1.00 | 26.54 | C |
| ATOM | 2214 | O | HIS | A | 277 | 7.133 | 13.429 | 28.317 | 1.00 | 27.98 | O |
| ATOM | 2215 | N | CYS | A | 278 | 6.069 | 15.012 | 27.104 | 1.00 | 27.54 | N |
| ATOM | 2216 | CA | CYS | A | 278 | 4.803 | 14.966 | 27.804 | 1.00 | 27.10 | C |
| ATOM | 2217 | CB | CYS | A | 278 | 4.612 | 16.194 | 28.674 | 1.00 | 27.51 | C |
| ATOM | 2218 | SG | CYS | A | 278 | 5.254 | 17.706 | 27.937 | 1.00 | 29.54 | S |
| ATOM | 2219 | C | CYS | A | 278 | 3.691 | 14.759 | 26.738 | 1.00 | 27.18 | C |
| ATOM | 2220 | O | CYS | A | 278 | 3.762 | 13.843 | 25.915 | 1.00 | 26.85 | O |
| ATOM | 2221 | N | LYS | A | 279 | 2.660 | 15.568 | 26.730 | 1.00 | 27.77 | N |
| ATOM | 2222 | CA | LYS | A | 279 | 1.682 | 15.440 | 25.618 | 1.00 | 29.27 | C |
| ATOM | 2223 | CB | LYS | A | 279 | 0.300 | 16.018 | 26.025 | 1.00 | 28.72 | C |
| ATOM | 2224 | CG | LYS | A | 279 | −0.874 | 15.522 | 25.242 | 1.00 | 32.93 | C |
| ATOM | 2225 | CD | LYS | A | 279 | −2.119 | 15.405 | 26.206 | 1.00 | 43.60 | C |
| ATOM | 2226 | CE | LYS | A | 279 | −1.711 | 15.163 | 27.751 | 1.00 | 44.22 | C |
| ATOM | 2227 | NZ | LYS | A | 279 | −2.214 | 16.261 | 28.672 | 1.00 | 44.01 | N |
| ATOM | 2228 | C | LYS | A | 279 | 2.228 | 16.171 | 24.363 | 1.00 | 27.26 | C |
| ATOM | 2229 | O | LYS | A | 279 | 2.372 | 15.587 | 23.316 | 1.00 | 26.12 | O |
| ATOM | 2230 | N | ALA | A | 280 | 2.498 | 17.464 | 24.517 | 1.00 | 28.21 | N |
| ATOM | 2231 | CA | ALA | A | 280 | 3.022 | 18.354 | 23.442 | 1.00 | 28.48 | C |
| ATOM | 2232 | CB | ALA | A | 280 | 2.313 | 19.711 | 23.490 | 1.00 | 27.53 | C |
| ATOM | 2233 | C | ALA | A | 280 | 4.560 | 18.521 | 23.492 | 1.00 | 28.26 | C |
| ATOM | 2234 | O | ALA | A | 280 | 5.130 | 19.057 | 22.571 | 1.00 | 29.70 | O |
| ATOM | 2235 | N | GLY | A | 281 | 5.215 | 18.037 | 24.554 | 1.00 | 27.46 | N |
| ATOM | 2236 | CA | GLY | A | 281 | 6.653 | 18.178 | 24.729 | 1.00 | 26.71 | C |
| ATOM | 2237 | C | GLY | A | 281 | 7.142 | 19.607 | 24.975 | 1.00 | 26.35 | C |
| ATOM | 2238 | O | GLY | A | 281 | 8.279 | 19.955 | 24.589 | 1.00 | 26.47 | O |
| ATOM | 2239 | N | LEU | A | 282 | 6.304 | 20.415 | 25.625 | 1.00 | 24.58 | N |
| ATOM | 2240 | CA | LEU | A | 282 | 6.583 | 21.825 | 25.849 | 1.00 | 24.44 | C |
| ATOM | 2241 | CB | LEU | A | 282 | 5.424 | 22.690 | 25.337 | 1.00 | 24.07 | C |
| ATOM | 2242 | CG | LEU | A | 282 | 5.287 | 23.309 | 23.930 | 1.00 | 25.60 | C |
| ATOM | 2243 | CD1 | LEU | A | 282 | 6.055 | 22.615 | 22.782 | 1.00 | 19.91 | C |
| ATOM | 2244 | CD2 | LEU | A | 282 | 3.771 | 23.469 | 23.613 | 1.00 | 22.25 | C |
| ATOM | 2245 | C | LEU | A | 282 | 6.829 | 22.167 | 27.339 | 1.00 | 23.73 | C |
| ATOM | 2246 | O | LEU | A | 282 | 7.904 | 22.637 | 27.689 | 1.00 | 22.83 | O |
| ATOM | 2247 | N | GLY | A | 283 | 5.822 | 21.951 | 28.194 | 1.00 | 23.40 | N |
| ATOM | 2248 | CA | GLY | A | 283 | 5.844 | 22.485 | 29.545 | 1.00 | 22.27 | C |
| ATOM | 2249 | C | GLY | A | 283 | 6.738 | 21.671 | 30.435 | 1.00 | 21.96 | C |
| ATOM | 2250 | O | GLY | A | 283 | 7.848 | 22.063 | 30.792 | 1.00 | 22.22 | O |
| ATOM | 2251 | N | ARG | A | 284 | 6.248 | 20.504 | 30.784 | 1.00 | 22.52 | N |
| ATOM | 2252 | CA | ARG | A | 284 | 6.889 | 19.608 | 31.743 | 1.00 | 23.41 | C |
| ATOM | 2253 | CB | ARG | A | 284 | 6.021 | 18.369 | 31.918 | 1.00 | 23.96 | C |
| ATOM | 2254 | CG | ARG | A | 284 | 4.765 | 18.661 | 32.728 | 1.00 | 26.31 | C |
| ATOM | 2255 | CD | ARG | A | 284 | 3.811 | 17.545 | 32.753 | 1.00 | 29.52 | C |
| ATOM | 2256 | NE | ARG | A | 284 | 3.016 | 17.507 | 31.527 | 1.00 | 34.12 | N |
| ATOM | 2257 | CZ | ARG | A | 284 | 2.004 | 16.672 | 31.322 | 1.00 | 35.39 | C |
| ATOM | 2258 | NH1 | ARG | A | 284 | 1.674 | 15.835 | 32.307 | 1.00 | 37.21 | N |
| ATOM | 2259 | NH2 | ARG | A | 284 | 1.305 | 16.691 | 30.161 | 1.00 | 33.18 | N |
| ATOM | 2260 | C | ARG | A | 284 | 8.202 | 19.202 | 31.162 | 1.00 | 23.93 | C |
| ATOM | 2261 | O | ARG | A | 284 | 9.245 | 19.206 | 31.845 | 1.00 | 24.51 | O |
| ATOM | 2262 | N | THR | A | 285 | 8.153 | 18.875 | 29.874 | 1.00 | 24.20 | N |
| ATOM | 2263 | CA | THR | A | 285 | 9.329 | 18.502 | 29.119 | 1.00 | 24.46 | C |
| ATOM | 2264 | CB | THR | A | 285 | 8.933 | 18.271 | 27.659 | 1.00 | 24.48 | C |
| ATOM | 2265 | OG1 | THR | A | 285 | 8.176 | 17.058 | 27.609 | 1.00 | 24.78 | O |
| ATOM | 2266 | CG2 | THR | A | 285 | 10.169 | 17.986 | 26.739 | 1.00 | 23.96 | C |
| ATOM | 2267 | C | THR | A | 285 | 10.463 | 19.522 | 29.238 | 1.00 | 24.65 | C |
| ATOM | 2268 | O | THR | A | 285 | 11.563 | 19.199 | 29.729 | 1.00 | 25.01 | O |
| ATOM | 2269 | N | GLY | A | 286 | 10.201 | 20.730 | 28.766 | 1.00 | 23.81 | N |
| ATOM | 2270 | CA | GLY | A | 286 | 11.212 | 21.765 | 28.773 | 1.00 | 22.58 | C |
| ATOM | 2271 | C | GLY | A | 286 | 11.541 | 22.134 | 30.188 | 1.00 | 21.56 | C |
| ATOM | 2272 | O | GLY | A | 286 | 12.663 | 22.508 | 30.439 | 1.00 | 20.38 | O |
| ATOM | 2273 | N | THR | A | 287 | 10.594 | 21.999 | 31.114 | 1.00 | 20.80 | N |
| ATOM | 2274 | CA | THR | A | 287 | 10.950 | 22.257 | 32.506 | 1.00 | 21.40 | C |
| ATOM | 2275 | CB | THR | A | 287 | 9.729 | 22.318 | 33.397 | 1.00 | 21.58 | C |
| ATOM | 2276 | OG1 | THR | A | 287 | 8.949 | 23.458 | 32.982 | 1.00 | 21.94 | O |
| ATOM | 2277 | CG2 | THR | A | 287 | 10.131 | 22.614 | 34.884 | 1.00 | 16.63 | C |
| ATOM | 2278 | C | THR | A | 287 | 12.047 | 21.324 | 33.077 | 1.00 | 22.39 | C |
| ATOM | 2279 | O | THR | A | 287 | 13.062 | 21.806 | 33.661 | 1.00 | 23.25 | O |
| ATOM | 2280 | N | LEU | A | 288 | 11.882 | 20.010 | 32.909 | 1.00 | 21.73 | N |
| ATOM | 2281 | CA | LEU | A | 288 | 12.908 | 19.089 | 33.420 | 1.00 | 21.17 | C |
| ATOM | 2282 | CB | LEU | A | 288 | 12.411 | 17.646 | 33.428 | 1.00 | 21.17 | C |
| ATOM | 2283 | CG | LEU | A | 288 | 11.334 | 17.443 | 34.496 | 1.00 | 21.85 | C |
| ATOM | 2284 | CD1 | LEU | A | 288 | 10.975 | 15.992 | 34.421 | 1.00 | 21.26 | C |
| ATOM | 2285 | CD2 | LEU | A | 288 | 11.910 | 17.821 | 35.850 | 1.00 | 16.90 | C |
| ATOM | 2286 | C | LEU | A | 288 | 14.244 | 19.197 | 32.695 | 1.00 | 20.31 | C |
| ATOM | 2287 | O | LEU | A | 288 | 15.296 | 19.029 | 33.322 | 1.00 | 20.94 | O |
| ATOM | 2288 | N | ILE | A | 289 | 14.222 | 19.467 | 31.389 | 1.00 | 19.36 | N |
| ATOM | 2289 | CA | ILE | A | 289 | 15.451 | 19.485 | 30.601 | 1.00 | 18.68 | C |
| ATOM | 2290 | CB | ILE | A | 289 | 15.205 | 19.556 | 29.127 | 1.00 | 18.04 | C |
| ATOM | 2291 | CG1 | ILE | A | 289 | 14.671 | 18.210 | 28.629 | 1.00 | 16.59 | C |
| ATOM | 2292 | CD1 | ILE | A | 289 | 14.154 | 18.282 | 27.183 | 1.00 | 11.62 | C |
| ATOM | 2293 | CG2 | ILE | A | 289 | 16.532 | 20.043 | 28.322 | 1.00 | 18.05 | C |
| ATOM | 2294 | C | ILE | A | 289 | 16.196 | 20.699 | 31.036 | 1.00 | 20.66 | C |
| ATOM | 2295 | O | ILE | A | 289 | 17.422 | 20.644 | 31.183 | 1.00 | 20.84 | O |
| ATOM | 2296 | N | ALA | A | 290 | 15.438 | 21.780 | 31.249 | 1.00 | 21.68 | N |
| ATOM | 2297 | CA | ALA | A | 290 | 15.921 | 23.042 | 31.766 | 1.00 | 22.16 | C |
| ATOM | 2298 | CB | ALA | A | 290 | 14.760 | 23.941 | 31.940 | 1.00 | 22.74 | C |
| ATOM | 2299 | C | ALA | A | 290 | 16.635 | 22.878 | 33.116 | 1.00 | 23.34 | C |
| ATOM | 2300 | O | ALA | A | 290 | 17.703 | 23.495 | 33.335 | 1.00 | 22.51 | O |
| ATOM | 2301 | N | CYS | A | 291 | 16.072 | 22.027 | 33.997 | 1.00 | 22.67 | N |
| ATOM | 2302 | CA | CYS | A | 291 | 16.675 | 21.824 | 35.293 | 1.00 | 22.31 | C |
| ATOM | 2303 | CB | CYS | A | 291 | 15.827 | 20.931 | 36.166 | 1.00 | 21.32 | C |
| ATOM | 2304 | SG | CYS | A | 291 | 14.340 | 21.678 | 36.841 | 1.00 | 21.82 | S |
| ATOM | 2305 | C | CYS | A | 291 | 18.074 | 21.231 | 35.111 | 1.00 | 23.11 | C |
| ATOM | 2306 | O | CYS | A | 291 | 19.014 | 21.698 | 35.732 | 1.00 | 24.51 | O |
| ATOM | 2307 | N | TYR | A | 292 | 18.200 | 20.205 | 34.287 | 1.00 | 23.44 | N |
| ATOM | 2308 | CA | TYR | A | 292 | 19.473 | 19.537 | 34.033 | 1.00 | 23.61 | C |
| ATOM | 2309 | CB | TYR | A | 292 | 19.280 | 18.350 | 33.064 | 1.00 | 23.51 | C |
| ATOM | 2310 | CG | TYR | A | 292 | 20.567 | 17.604 | 32.710 | 1.00 | 24.39 | C |
| ATOM | 2311 | CD1 | TYR | A | 292 | 20.859 | 16.335 | 33.271 | 1.00 | 23.02 | C |
| ATOM | 2312 | CE1 | TYR | A | 292 | 22.063 | 15.660 | 32.954 | 1.00 | 20.92 | C |
| ATOM | 2313 | CZ | TYR | A | 292 | 22.957 | 16.272 | 32.081 | 1.00 | 23.22 | C |
| ATOM | 2314 | OH | TYR | A | 292 | 24.154 | 15.653 | 31.706 | 1.00 | 27.67 | O |
| ATOM | 2315 | CE2 | TYR | A | 292 | 22.683 | 17.529 | 31.527 | 1.00 | 23.95 | C |
| ATOM | 2316 | CD2 | TYR | A | 292 | 21.512 | 18.176 | 31.836 | 1.00 | 24.84 | C |
| ATOM | 2317 | C | TYR | A | 292 | 20.496 | 20.472 | 33.455 | 1.00 | 23.95 | C |
| ATOM | 2318 | O | TYR | A | 292 | 21.675 | 20.398 | 33.813 | 1.00 | 25.48 | O |
| ATOM | 2319 | N | VAL | A | 293 | 20.080 | 21.367 | 32.572 | 1.00 | 23.92 | N |
| ATOM | 2320 | CA | VAL | A | 293 | 21.036 | 22.260 | 31.934 | 1.00 | 24.80 | C |
| ATOM | 2321 | CB | VAL | A | 293 | 20.505 | 22.840 | 30.545 | 1.00 | 25.94 | C |
| ATOM | 2322 | CG1 | VAL | A | 293 | 21.393 | 23.985 | 30.004 | 1.00 | 23.60 | C |
| ATOM | 2323 | CG2 | VAL | A | 293 | 20.421 | 21.733 | 29.514 | 1.00 | 25.40 | C |
| ATOM | 2324 | C | VAL | A | 293 | 21.440 | 23.357 | 32.903 | 1.00 | 24.28 | C |
| ATOM | 2325 | O | VAL | A | 293 | 22.535 | 23.794 | 32.892 | 1.00 | 24.58 | O |
| ATOM | 2326 | N | MET | A | 294 | 20.553 | 23.814 | 33.750 | 1.00 | 25.37 | N |
| ATOM | 2327 | CA | MET | A | 294 | 20.989 | 24.761 | 34.769 | 1.00 | 26.38 | C |
| ATOM | 2328 | CB | MET | A | 294 | 19.827 | 25.343 | 35.516 | 1.00 | 26.19 | C |
| ATOM | 2329 | CG | MET | A | 294 | 18.841 | 26.100 | 34.670 | 1.00 | 26.19 | C |
| ATOM | 2330 | SD | MET | A | 294 | 17.570 | 26.782 | 35.777 | 1.00 | 32.59 | S |
| ATOM | 2331 | CE | MET | A | 294 | 16.323 | 26.009 | 35.326 | 1.00 | 31.42 | C |
| ATOM | 2332 | C | MET | A | 294 | 21.987 | 24.141 | 35.754 | 1.00 | 27.49 | C |
| ATOM | 2333 | O | MET | A | 294 | 22.983 | 24.783 | 36.116 | 1.00 | 28.91 | O |
| ATOM | 2334 | N | LYS | A | 295 | 21.756 | 22.898 | 36.182 | 1.00 | 28.77 | N |
| ATOM | 2335 | CA | LYS | A | 295 | 22.733 | 22.171 | 37.042 | 1.00 | 28.47 | C |
| ATOM | 2336 | CB | LYS | A | 295 | 22.162 | 20.821 | 37.474 | 1.00 | 28.58 | C |
| ATOM | 2337 | CG | LYS | A | 295 | 23.132 | 20.014 | 38.299 | 1.00 | 28.90 | C |
| ATOM | 2338 | CD | LYS | A | 295 | 22.548 | 18.710 | 38.724 | 1.00 | 32.79 | C |
| ATOM | 2339 | CE | LYS | A | 295 | 23.622 | 17.834 | 39.449 | 1.00 | 32.66 | C |
| ATOM | 2340 | NZ | LYS | A | 295 | 23.010 | 16.618 | 40.078 | 1.00 | 34.26 | N |
| ATOM | 2341 | C | LYS | A | 295 | 24.088 | 21.939 | 36.349 | 1.00 | 28.51 | C |
| ATOM | 2342 | O | LYS | A | 295 | 25.144 | 22.267 | 36.868 | 1.00 | 28.43 | O |
| ATOM | 2343 | N | HIS | A | 296 | 24.052 | 21.358 | 35.162 | 1.00 | 29.10 | N |
| ATOM | 2344 | CA | HIS | A | 296 | 25.288 | 20.916 | 34.529 | 1.00 | 29.17 | C |
| ATOM | 2345 | CB | HIS | A | 296 | 25.026 | 19.614 | 33.719 | 1.00 | 29.20 | C |
| ATOM | 2346 | CG | HIS | A | 296 | 24.790 | 18.437 | 34.621 | 1.00 | 29.76 | C |
| ATOM | 2347 | ND1 | HIS | A | 296 | 25.825 | 17.767 | 35.243 | 1.00 | 29.56 | N |
| ATOM | 2348 | CE1 | HIS | A | 296 | 25.324 | 16.833 | 36.043 | 1.00 | 32.53 | C |
| ATOM | 2349 | NE2 | HIS | A | 296 | 24.001 | 16.898 | 35.995 | 1.00 | 30.90 | N |
| ATOM | 2350 | CD2 | HIS | A | 296 | 23.643 | 17.913 | 35.132 | 1.00 | 31.50 | C |
| ATOM | 2351 | C | HIS | A | 296 | 26.113 | 22.000 | 33.801 | 1.00 | 29.32 | C |
| ATOM | 2352 | O | HIS | A | 296 | 27.342 | 21.836 | 33.621 | 1.00 | 29.52 | O |
| ATOM | 2353 | N | TYR | A | 297 | 25.440 | 23.088 | 33.396 | 1.00 | 29.04 | N |
| ATOM | 2354 | CA | TYR | A | 297 | 26.037 | 24.165 | 32.607 | 1.00 | 28.73 | C |
| ATOM | 2355 | CB | TYR | A | 297 | 25.427 | 24.215 | 31.217 | 1.00 | 27.99 | C |
| ATOM | 2356 | CG | TYR | A | 297 | 25.692 | 22.959 | 30.444 | 1.00 | 29.27 | C |
| ATOM | 2357 | CD1 | TYR | A | 297 | 26.811 | 22.863 | 29.587 | 1.00 | 29.35 | C |
| ATOM | 2358 | CE1 | TYR | A | 297 | 27.060 | 21.669 | 28.864 | 1.00 | 31.53 | C |
| ATOM | 2359 | CZ | TYR | A | 297 | 26.185 | 20.580 | 29.023 | 1.00 | 33.60 | C |
| ATOM | 2360 | OH | TYR | A | 297 | 26.409 | 19.399 | 28.331 | 1.00 | 35.63 | O |
| ATOM | 2361 | CE2 | TYR | A | 297 | 25.079 | 20.676 | 29.886 | 1.00 | 28.76 | C |
| ATOM | 2362 | CD2 | TYR | A | 297 | 24.863 | 21.841 | 30.595 | 1.00 | 27.15 | C |
| ATOM | 2363 | C | TYR | A | 297 | 25.871 | 25.527 | 33.261 | 1.00 | 29.51 | C |
| ATOM | 2364 | O | TYR | A | 297 | 26.384 | 26.534 | 32.738 | 1.00 | 30.54 | O |
| ATOM | 2365 | N | ARG | A | 298 | 25.150 | 25.591 | 34.381 | 1.00 | 29.30 | N |
| ATOM | 2366 | CA | ARG | A | 298 | 25.054 | 26.858 | 35.069 | 1.00 | 30.65 | C |
| ATOM | 2367 | CB | ARG | A | 298 | 26.487 | 27.343 | 35.428 | 1.00 | 31.37 | C |
| ATOM | 2368 | CG | ARG | A | 298 | 26.663 | 27.825 | 36.855 | 1.00 | 37.22 | C |
| ATOM | 2369 | CD | ARG | A | 298 | 27.959 | 27.352 | 37.543 | 1.00 | 44.77 | C |
| ATOM | 2370 | NE | ARG | A | 298 | 27.757 | 27.088 | 38.980 | 1.00 | 50.22 | N |
| ATOM | 2371 | CZ | ARG | A | 298 | 27.801 | 28.010 | 39.966 | 1.00 | 50.84 | C |
| ATOM | 2372 | NH1 | ARG | A | 298 | 28.040 | 29.293 | 39.702 | 1.00 | 51.31 | N |
| ATOM | 2373 | NH2 | ARG | A | 298 | 27.601 | 27.640 | 41.237 | 1.00 | 51.31 | N |
| ATOM | 2374 | C | ARG | A | 298 | 24.333 | 27.972 | 34.258 | 1.00 | 29.40 | C |
| ATOM | 2375 | O | ARG | A | 298 | 24.667 | 29.138 | 34.414 | 1.00 | 30.05 | O |
| ATOM | 2376 | N | PHE | A | 299 | 23.390 | 27.637 | 33.384 | 1.00 | 27.64 | N |
| ATOM | 2377 | CA | PHE | A | 299 | 22.555 | 28.662 | 32.755 | 1.00 | 26.17 | C |
| ATOM | 2378 | CB | PHE | A | 299 | 21.531 | 28.030 | 31.806 | 1.00 | 25.34 | C |
| ATOM | 2379 | CG | PHE | A | 299 | 22.071 | 27.687 | 30.435 | 1.00 | 25.93 | C |
| ATOM | 2380 | CD1 | PHE | A | 299 | 23.197 | 26.887 | 30.283 | 1.00 | 25.32 | C |
| ATOM | 2381 | CE1 | PHE | A | 299 | 23.662 | 26.569 | 29.046 | 1.00 | 26.13 | C |
| ATOM | 2382 | CZ | PHE | A | 299 | 22.999 | 27.040 | 27.892 | 1.00 | 28.92 | C |
| ATOM | 2383 | CE2 | PHE | A | 299 | 21.876 | 27.831 | 28.013 | 1.00 | 24.49 | C |
| ATOM | 2384 | CD2 | PHE | A | 299 | 21.414 | 28.143 | 29.286 | 1.00 | 27.94 | C |
| ATOM | 2385 | C | PHE | A | 299 | 21.794 | 29.334 | 33.891 | 1.00 | 25.36 | C |
| ATOM | 2386 | O | PHE | A | 299 | 21.601 | 28.696 | 34.935 | 1.00 | 25.87 | O |
| ATOM | 2387 | N | THR | A | 300 | 21.388 | 30.588 | 33.708 | 1.00 | 23.89 | N |
| ATOM | 2388 | CA | THR | A | 300 | 20.384 | 31.179 | 34.557 | 1.00 | 24.99 | C |
| ATOM | 2389 | CB | THR | A | 300 | 20.447 | 32.719 | 34.558 | 1.00 | 25.07 | C |
| ATOM | 2390 | OG1 | THR | A | 300 | 20.228 | 33.212 | 33.225 | 1.00 | 27.44 | O |
| ATOM | 2391 | CG2 | THR | A | 300 | 21.893 | 33.273 | 34.970 | 1.00 | 24.30 | C |
| ATOM | 2392 | C | THR | A | 300 | 18.996 | 30.706 | 34.061 | 1.00 | 25.91 | C |
| ATOM | 2393 | O | THR | A | 300 | 18.877 | 30.102 | 33.000 | 1.00 | 25.20 | O |
| ATOM | 2394 | N | HIS | A | 301 | 17.954 | 30.974 | 34.830 | 1.00 | 25.99 | N |
| ATOM | 2395 | CA | HIS | A | 301 | 16.639 | 30.650 | 34.369 | 1.00 | 27.68 | C |
| ATOM | 2396 | CB | HIS | A | 301 | 15.606 | 30.967 | 35.440 | 1.00 | 26.16 | C |
| ATOM | 2397 | CG | HIS | A | 301 | 15.612 | 32.396 | 35.876 | 1.00 | 29.73 | C |
| ATOM | 2398 | ND1 | HIS | A | 301 | 14.654 | 33.309 | 35.469 | 1.00 | 31.73 | N |
| ATOM | 2399 | CE1 | HIS | A | 301 | 14.921 | 34.491 | 36.007 | 1.00 | 28.49 | C |
| ATOM | 2400 | NE2 | HIS | A | 301 | 16.020 | 34.378 | 36.738 | 1.00 | 30.38 | N |
| ATOM | 2401 | CD2 | HIS | A | 301 | 16.469 | 33.082 | 36.679 | 1.00 | 29.77 | C |
| ATOM | 2402 | C | HIS | A | 301 | 16.358 | 31.413 | 33.030 | 1.00 | 28.75 | C |
| ATOM | 2403 | O | HIS | A | 301 | 15.688 | 30.888 | 32.124 | 1.00 | 28.59 | O |
| ATOM | 2404 | N | ALA | A | 302 | 16.883 | 32.635 | 32.907 | 1.00 | 29.01 | N |
| ATOM | 2405 | CA | ALA | A | 302 | 16.526 | 33.478 | 31.748 | 1.00 | 28.38 | C |
| ATOM | 2406 | CB | ALA | A | 302 | 16.968 | 34.964 | 31.962 | 1.00 | 28.05 | C |
| ATOM | 2407 | C | ALA | A | 302 | 17.132 | 32.906 | 30.500 | 1.00 | 26.94 | C |
| ATOM | 2408 | O | ALA | A | 302 | 16.461 | 32.743 | 29.495 | 1.00 | 26.12 | O |
| ATOM | 2409 | N | GLU | A | 303 | 18.408 | 32.570 | 30.599 | 1.00 | 26.60 | N |
| ATOM | 2410 | CA | GLU | A | 303 | 19.162 | 31.992 | 29.477 | 1.00 | 26.59 | C |
| ATOM | 2411 | CB | GLU | A | 303 | 20.615 | 31.783 | 29.898 | 1.00 | 27.08 | C |
| ATOM | 2412 | CG | GLU | A | 303 | 21.403 | 33.071 | 30.072 | 1.00 | 30.49 | C |
| ATOM | 2413 | CD | GLU | A | 303 | 22.668 | 32.911 | 30.906 | 1.00 | 31.79 | C |
| ATOM | 2414 | OE1 | GLU | A | 303 | 22.993 | 31.789 | 31.386 | 1.00 | 35.13 | O |
| ATOM | 2415 | OE2 | GLU | A | 303 | 23.332 | 33.941 | 31.097 | 1.00 | 34.11 | O |
| ATOM | 2416 | C | GLU | A | 303 | 18.648 | 30.643 | 28.991 | 1.00 | 25.89 | C |
| ATOM | 2417 | O | GLU | A | 303 | 18.729 | 30.343 | 27.793 | 1.00 | 25.38 | O |
| ATOM | 2418 | N | ILE | A | 304 | 18.199 | 29.812 | 29.941 | 1.00 | 24.31 | N |
| ATOM | 2419 | CA | ILE | A | 304 | 17.749 | 28.488 | 29.632 | 1.00 | 23.08 | C |
| ATOM | 2420 | CB | ILE | A | 304 | 17.887 | 27.479 | 30.876 | 1.00 | 22.75 | C |
| ATOM | 2421 | CG1 | ILE | A | 304 | 17.767 | 26.064 | 30.358 | 1.00 | 22.51 | C |
| ATOM | 2422 | CD1 | ILE | A | 304 | 18.648 | 25.847 | 29.070 | 1.00 | 22.88 | C |
| ATOM | 2423 | CG2 | ILE | A | 304 | 16.836 | 27.724 | 31.975 | 1.00 | 23.09 | C |
| ATOM | 2424 | C | ILE | A | 304 | 16.324 | 28.535 | 29.033 | 1.00 | 22.61 | C |
| ATOM | 2425 | O | ILE | A | 304 | 16.028 | 27.853 | 28.050 | 1.00 | 21.59 | O |
| ATOM | 2426 | N | ILE | A | 305 | 15.457 | 29.358 | 29.619 | 1.00 | 22.28 | N |
| ATOM | 2427 | CA | ILE | A | 305 | 14.134 | 29.563 | 29.061 | 1.00 | 21.28 | C |
| ATOM | 2428 | CB | ILE | A | 305 | 13.279 | 30.412 | 29.943 | 1.00 | 20.28 | C |
| ATOM | 2429 | CG1 | ILE | A | 305 | 12.883 | 29.628 | 31.221 | 1.00 | 19.47 | C |
| ATOM | 2430 | CD1 | ILE | A | 305 | 11.972 | 30.461 | 32.183 | 1.00 | 17.33 | C |
| ATOM | 2431 | CG2 | ILE | A | 305 | 12.032 | 30.866 | 29.170 | 1.00 | 21.08 | C |
| ATOM | 2432 | C | ILE | A | 305 | 14.215 | 30.091 | 27.608 | 1.00 | 21.56 | C |
| ATOM | 2433 | O | ILE | A | 305 | 13.497 | 29.586 | 26.748 | 1.00 | 21.61 | O |
| ATOM | 2434 | N | ALA | A | 306 | 15.118 | 31.041 | 27.343 | 1.00 | 21.22 | N |
| ATOM | 2435 | CA | ALA | A | 306 | 15.409 | 31.488 | 25.976 | 1.00 | 21.38 | C |
| ATOM | 2436 | CB | ALA | A | 306 | 16.422 | 32.706 | 25.927 | 1.00 | 20.97 | C |
| ATOM | 2437 | C | ALA | A | 306 | 15.923 | 30.342 | 25.130 | 1.00 | 21.00 | C |
| ATOM | 2438 | O | ALA | A | 306 | 15.340 | 30.052 | 24.084 | 1.00 | 21.91 | O |
| ATOM | 2439 | N | TRP | A | 307 | 16.989 | 29.675 | 25.567 | 1.00 | 20.08 | N |
| ATOM | 2440 | CA | TRP | A | 307 | 17.560 | 28.594 | 24.761 | 1.00 | 19.20 | C |
| ATOM | 2441 | CB | TRP | A | 307 | 18.732 | 27.890 | 25.434 | 1.00 | 19.01 | C |
| ATOM | 2442 | CG | TRP | A | 307 | 19.309 | 26.900 | 24.464 | 1.00 | 21.98 | C |
| ATOM | 2443 | CD1 | TRP | A | 307 | 19.382 | 25.536 | 24.603 | 1.00 | 18.19 | C |
| ATOM | 2444 | NE1 | TRP | A | 307 | 19.927 | 24.985 | 23.453 | 1.00 | 20.57 | N |
| ATOM | 2445 | CE2 | TRP | A | 307 | 20.158 | 25.974 | 22.525 | 1.00 | 19.53 | C |
| ATOM | 2446 | CD2 | TRP | A | 307 | 19.808 | 27.197 | 23.125 | 1.00 | 20.75 | C |
| ATOM | 2447 | CE3 | TRP | A | 307 | 19.995 | 28.383 | 22.383 | 1.00 | 22.62 | C |
| ATOM | 2448 | CZ3 | TRP | A | 307 | 20.533 | 28.318 | 21.090 | 1.00 | 18.34 | C |
| ATOM | 2449 | CH2 | TRP | A | 307 | 20.878 | 27.093 | 20.536 | 1.00 | 19.76 | C |
| ATOM | 2450 | CZ2 | TRP | A | 307 | 20.692 | 25.905 | 21.227 | 1.00 | 21.01 | C |
| ATOM | 2451 | C | TRP | A | 307 | 16.515 | 27.551 | 24.304 | 1.00 | 19.74 | C |
| ATOM | 2452 | O | TRP | A | 307 | 16.429 | 27.250 | 23.116 | 1.00 | 20.13 | O |
| ATOM | 2453 | N | ILE | A | 308 | 15.743 | 27.006 | 25.248 | 1.00 | 19.15 | N |
| ATOM | 2454 | CA | ILE | A | 308 | 14.748 | 26.002 | 24.953 | 1.00 | 19.52 | C |
| ATOM | 2455 | CB | ILE | A | 308 | 14.238 | 25.283 | 26.268 | 1.00 | 18.70 | C |
| ATOM | 2456 | CG1 | ILE | A | 308 | 15.462 | 24.700 | 26.996 | 1.00 | 19.28 | C |
| ATOM | 2457 | CD1 | ILE | A | 308 | 15.199 | 23.972 | 28.266 | 1.00 | 20.94 | C |
| ATOM | 2458 | CG2 | ILE | A | 308 | 13.193 | 24.135 | 25.937 | 1.00 | 17.18 | C |
| ATOM | 2459 | C | ILE | A | 308 | 13.627 | 26.577 | 24.098 | 1.00 | 20.56 | C |
| ATOM | 2460 | O | ILE | A | 308 | 13.157 | 25.936 | 23.150 | 1.00 | 21.92 | O |
| ATOM | 2461 | N | ARG | A | 309 | 13.168 | 27.770 | 24.412 | 1.00 | 20.98 | N |
| ATOM | 2462 | CA | ARG | A | 309 | 12.130 | 28.341 | 23.555 | 1.00 | 21.38 | C |
| ATOM | 2463 | CB | ARG | A | 309 | 11.500 | 29.609 | 24.154 | 1.00 | 21.45 | C |
| ATOM | 2464 | CG | ARG | A | 309 | 10.789 | 29.334 | 25.473 | 1.00 | 19.52 | C |
| ATOM | 2465 | CD | ARG | A | 309 | 9.799 | 30.383 | 25.820 | 1.00 | 19.37 | C |
| ATOM | 2466 | NE | ARG | A | 309 | 9.132 | 30.140 | 27.105 | 1.00 | 22.32 | N |
| ATOM | 2467 | CZ | ARG | A | 309 | 8.727 | 31.122 | 27.924 | 1.00 | 23.03 | C |
| ATOM | 2468 | NH1 | ARG | A | 309 | 8.907 | 32.401 | 27.554 | 1.00 | 17.74 | N |
| ATOM | 2469 | NH2 | ARG | A | 309 | 8.151 | 30.828 | 29.092 | 1.00 | 20.69 | N |
| ATOM | 2470 | C | ARG | A | 309 | 12.602 | 28.573 | 22.129 | 1.00 | 21.36 | C |
| ATOM | 2471 | O | ARG | A | 309 | 11.838 | 28.363 | 21.199 | 1.00 | 22.73 | O |
| ATOM | 2472 | N | ILE | A | 310 | 13.838 | 29.020 | 21.950 | 1.00 | 21.30 | N |
| ATOM | 2473 | CA | ILE | A | 310 | 14.405 | 29.159 | 20.618 | 1.00 | 20.35 | C |
| ATOM | 2474 | CB | ILE | A | 310 | 15.726 | 29.893 | 20.661 | 1.00 | 20.06 | C |
| ATOM | 2475 | CG1 | ILE | A | 310 | 15.481 | 31.335 | 21.122 | 1.00 | 17.43 | C |
| ATOM | 2476 | CD1 | ILE | A | 310 | 16.796 | 32.058 | 21.545 | 1.00 | 18.77 | C |
| ATOM | 2477 | CG2 | ILE | A | 310 | 16.410 | 29.874 | 19.275 | 1.00 | 17.77 | C |
| ATOM | 2478 | C | ILE | A | 310 | 14.557 | 27.849 | 19.881 | 1.00 | 21.38 | C |
| ATOM | 2479 | O | ILE | A | 310 | 14.250 | 27.807 | 18.668 | 1.00 | 22.62 | O |
| ATOM | 2480 | N | CYS | A | 311 | 15.037 | 26.799 | 20.552 | 1.00 | 21.48 | N |
| ATOM | 2481 | CA | CYS | A | 311 | 15.012 | 25.451 | 19.959 | 1.00 | 22.97 | C |
| ATOM | 2482 | CB | CYS | A | 311 | 15.682 | 24.423 | 20.866 | 1.00 | 23.11 | C |
| ATOM | 2483 | SG | CYS | A | 311 | 17.433 | 24.682 | 20.927 | 1.00 | 21.87 | S |
| ATOM | 2484 | C | CYS | A | 311 | 13.616 | 24.943 | 19.634 | 1.00 | 23.86 | C |
| ATOM | 2485 | O | CYS | A | 311 | 13.374 | 24.412 | 18.557 | 1.00 | 24.95 | O |
| ATOM | 2486 | N | ARG | A | 312 | 12.697 | 25.129 | 20.567 | 1.00 | 23.24 | N |
| ATOM | 2487 | CA | ARG | A | 312 | 11.396 | 24.531 | 20.476 | 1.00 | 22.66 | C |
| ATOM | 2488 | CB | ARG | A | 312 | 11.464 | 23.257 | 21.297 | 1.00 | 22.04 | C |
| ATOM | 2489 | CG | ARG | A | 312 | 10.202 | 22.528 | 21.564 | 1.00 | 20.09 | C |
| ATOM | 2490 | CD | ARG | A | 312 | 10.461 | 21.029 | 21.770 | 1.00 | 16.73 | C |
| ATOM | 2491 | NE | ARG | A | 312 | 9.193 | 20.349 | 21.930 | 1.00 | 17.38 | N |
| ATOM | 2492 | CZ | ARG | A | 312 | 8.453 | 19.845 | 20.921 | 1.00 | 19.68 | C |
| ATOM | 2493 | NH1 | ARG | A | 312 | 8.892 | 19.915 | 19.655 | 1.00 | 18.80 | N |
| ATOM | 2494 | NH2 | ARG | A | 312 | 7.261 | 19.277 | 21.183 | 1.00 | 14.23 | N |
| ATOM | 2495 | C | ARG | A | 312 | 10.400 | 25.543 | 21.074 | 1.00 | 23.34 | C |
| ATOM | 2496 | O | ARG | A | 312 | 10.159 | 25.540 | 22.306 | 1.00 | 24.46 | O |
| ATOM | 2497 | N | PRO | A | 313 | 9.864 | 26.442 | 20.237 | 1.00 | 21.93 | N |
| ATOM | 2498 | CA | PRO | A | 313 | 8.873 | 27.408 | 20.697 | 1.00 | 21.72 | C |
| ATOM | 2499 | CB | PRO | A | 313 | 8.302 | 27.958 | 19.376 | 1.00 | 19.84 | C |
| ATOM | 2500 | CG | PRO | A | 313 | 9.494 | 27.995 | 18.540 | 1.00 | 19.85 | C |
| ATOM | 2501 | CD | PRO | A | 313 | 10.160 | 26.647 | 18.812 | 1.00 | 21.54 | C |
| ATOM | 2502 | C | PRO | A | 313 | 7.768 | 26.817 | 21.580 | 1.00 | 21.78 | C |
| ATOM | 2503 | O | PRO | A | 313 | 7.321 | 25.702 | 21.274 | 1.00 | 22.83 | O |
| ATOM | 2504 | N | GLY | A | 314 | 7.348 | 27.576 | 22.605 | 1.00 | 20.96 | N |
| ATOM | 2505 | CA | GLY | A | 314 | 6.244 | 27.265 | 23.496 | 1.00 | 21.48 | C |
| ATOM | 2506 | C | GLY | A | 314 | 6.671 | 26.578 | 24.793 | 1.00 | 22.87 | C |
| ATOM | 2507 | O | GLY | A | 314 | 5.889 | 26.493 | 25.722 | 1.00 | 23.29 | O |
| ATOM | 2508 | N | SER | A | 315 | 7.916 | 26.112 | 24.856 | 1.00 | 23.03 | N |
| ATOM | 2509 | CA | SER | A | 315 | 8.460 | 25.432 | 26.026 | 1.00 | 23.98 | C |
| ATOM | 2510 | CB | SER | A | 315 | 9.912 | 25.035 | 25.759 | 1.00 | 22.83 | C |
| ATOM | 2511 | OG | SER | A | 315 | 9.963 | 24.271 | 24.581 | 1.00 | 25.14 | O |
| ATOM | 2512 | C | SER | A | 315 | 8.392 | 26.191 | 27.367 | 1.00 | 24.02 | C |
| ATOM | 2513 | O | SER | A | 315 | 8.808 | 27.357 | 27.425 | 1.00 | 24.80 | O |
| ATOM | 2514 | N | ILE | A | 316 | 7.958 | 25.501 | 28.442 | 1.00 | 22.84 | N |
| ATOM | 2515 | CA | ILE | A | 316 | 8.123 | 26.007 | 29.815 | 1.00 | 23.04 | C |
| ATOM | 2516 | CB | ILE | A | 316 | 9.542 | 26.691 | 30.066 | 1.00 | 22.94 | C |
| ATOM | 2517 | CG1 | ILE | A | 316 | 10.724 | 25.804 | 29.631 | 1.00 | 22.36 | C |
| ATOM | 2518 | CD1 | ILE | A | 316 | 12.063 | 26.518 | 29.851 | 1.00 | 20.74 | C |
| ATOM | 2519 | CG2 | ILE | A | 316 | 9.733 | 27.162 | 31.550 | 1.00 | 22.71 | C |
| ATOM | 2520 | C | ILE | A | 316 | 7.045 | 27.033 | 30.010 | 1.00 | 23.25 | C |
| ATOM | 2521 | O | ILE | A | 316 | 7.217 | 28.184 | 29.573 | 1.00 | 24.13 | O |
| ATOM | 2522 | N | ILE | A | 317 | 5.937 | 26.622 | 30.617 | 1.00 | 22.59 | N |
| ATOM | 2523 | CA | ILE | A | 317 | 4.710 | 27.426 | 30.647 | 1.00 | 23.70 | C |
| ATOM | 2524 | CB | ILE | A | 317 | 3.503 | 26.642 | 30.007 | 1.00 | 23.03 | C |
| ATOM | 2525 | CG1 | ILE | A | 317 | 3.719 | 26.395 | 28.476 | 1.00 | 24.69 | C |
| ATOM | 2526 | CD1 | ILE | A | 317 | 3.088 | 25.017 | 27.913 | 1.00 | 21.11 | C |
| ATOM | 2527 | CG2 | ILE | A | 317 | 2.218 | 27.383 | 30.227 | 1.00 | 20.39 | C |
| ATOM | 2528 | C | ILE | A | 317 | 4.332 | 27.765 | 32.087 | 1.00 | 24.71 | C |
| ATOM | 2529 | O | ILE | A | 317 | 4.508 | 26.923 | 32.952 | 1.00 | 24.80 | O |
| ATOM | 2530 | N | GLY | A | 318 | 3.782 | 28.973 | 32.309 | 1.00 | 25.80 | N |
| ATOM | 2531 | CA | GLY | A | 318 | 3.171 | 29.418 | 33.555 | 1.00 | 25.70 | C |
| ATOM | 2532 | C | GLY | A | 318 | 4.075 | 29.350 | 34.784 | 1.00 | 27.49 | C |
| ATOM | 2533 | O | GLY | A | 318 | 5.173 | 29.974 | 34.804 | 1.00 | 27.87 | O |
| ATOM | 2534 | N | PRO | A | 319 | 3.668 | 28.560 | 35.795 | 1.00 | 27.14 | N |
| ATOM | 2535 | CA | PRO | A | 319 | 4.427 | 28.503 | 37.067 | 1.00 | 26.56 | C |
| ATOM | 2536 | CB | PRO | A | 319 | 3.535 | 27.667 | 38.017 | 1.00 | 26.49 | C |
| ATOM | 2537 | CG | PRO | A | 319 | 2.247 | 27.241 | 37.207 | 1.00 | 27.13 | C |
| ATOM | 2538 | CD | PRO | A | 319 | 2.481 | 27.686 | 35.781 | 1.00 | 26.95 | C |
| ATOM | 2539 | C | PRO | A | 319 | 5.798 | 27.881 | 36.884 | 1.00 | 26.11 | C |
| ATOM | 2540 | O | PRO | A | 319 | 6.738 | 28.138 | 37.669 | 1.00 | 25.62 | O |
| ATOM | 2541 | N | GLN | A | 320 | 5.926 | 27.064 | 35.835 | 1.00 | 26.11 | N |
| ATOM | 2542 | CA | GLN | A | 320 | 7.221 | 26.437 | 35.491 | 1.00 | 24.92 | C |
| ATOM | 2543 | CB | GLN | A | 320 | 7.049 | 25.429 | 34.370 | 1.00 | 24.70 | C |
| ATOM | 2544 | CG | GLN | A | 320 | 5.881 | 24.461 | 34.546 | 1.00 | 20.70 | C |
| ATOM | 2545 | CD | GLN | A | 320 | 5.639 | 23.616 | 33.289 | 1.00 | 24.98 | C |
| ATOM | 2546 | OE1 | GLN | A | 320 | 5.979 | 24.022 | 32.142 | 1.00 | 28.44 | O |
| ATOM | 2547 | NE2 | GLN | A | 320 | 5.086 | 22.444 | 33.484 | 1.00 | 24.69 | N |
| ATOM | 2548 | C | GLN | A | 320 | 8.297 | 27.449 | 35.130 | 1.00 | 25.20 | C |
| ATOM | 2549 | O | GLN | A | 320 | 9.476 | 27.234 | 35.385 | 1.00 | 24.41 | O |
| ATOM | 2550 | N | GLN | A | 321 | 7.887 | 28.591 | 34.586 | 1.00 | 26.34 | N |
| ATOM | 2551 | CA | GLN | A | 321 | 8.851 | 29.697 | 34.413 | 1.00 | 26.50 | C |
| ATOM | 2552 | CB | GLN | A | 321 | 8.214 | 30.894 | 33.716 | 1.00 | 26.11 | C |
| ATOM | 2553 | CG | GLN | A | 321 | 7.553 | 30.574 | 32.409 | 1.00 | 25.65 | C |
| ATOM | 2554 | CD | GLN | A | 321 | 6.754 | 31.729 | 31.873 | 1.00 | 23.31 | C |
| ATOM | 2555 | OE1 | GLN | A | 321 | 7.122 | 32.311 | 30.847 | 1.00 | 23.14 | O |
| ATOM | 2556 | NE2 | GLN | A | 321 | 5.651 | 32.059 | 32.544 | 1.00 | 17.67 | N |
| ATOM | 2557 | C | GLN | A | 321 | 9.473 | 30.152 | 35.747 | 1.00 | 27.41 | C |
| ATOM | 2558 | O | GLN | A | 321 | 10.704 | 30.151 | 35.870 | 1.00 | 27.71 | O |
| ATOM | 2559 | N | HIS | A | 322 | 8.620 | 30.600 | 36.688 | 1.00 | 27.47 | N |
| ATOM | 2560 | CA | HIS | A | 322 | 9.030 | 31.138 | 37.975 | 1.00 | 28.75 | C |
| ATOM | 2561 | CB | HIS | A | 322 | 7.840 | 31.718 | 38.728 | 1.00 | 27.95 | C |
| ATOM | 2562 | CG | HIS | A | 322 | 7.106 | 32.763 | 37.952 | 1.00 | 29.42 | C |
| ATOM | 2563 | ND1 | HIS | A | 322 | 7.627 | 34.025 | 37.713 | 1.00 | 25.63 | N |
| ATOM | 2564 | CE1 | HIS | A | 322 | 6.765 | 34.711 | 36.983 | 1.00 | 28.78 | C |
| ATOM | 2565 | NE2 | HIS | A | 322 | 5.724 | 33.936 | 36.713 | 1.00 | 30.15 | N |
| ATOM | 2566 | CD2 | HIS | A | 322 | 5.906 | 32.718 | 37.318 | 1.00 | 29.51 | C |
| ATOM | 2567 | C | HIS | A | 322 | 9.723 | 30.078 | 38.831 | 1.00 | 29.92 | C |
| ATOM | 2568 | O | HIS | A | 322 | 10.660 | 30.390 | 39.592 | 1.00 | 30.91 | O |
| ATOM | 2569 | N | PHE | A | 323 | 9.273 | 28.832 | 38.677 | 1.00 | 30.41 | N |
| ATOM | 2570 | CA | PHE | A | 323 | 9.885 | 27.686 | 39.314 | 1.00 | 30.38 | C |
| ATOM | 2571 | CB | PHE | A | 323 | 9.115 | 26.400 | 38.944 | 1.00 | 30.15 | C |
| ATOM | 2572 | CG | PHE | A | 323 | 9.885 | 25.125 | 39.211 | 1.00 | 30.39 | C |
| ATOM | 2573 | CD1 | PHE | A | 323 | 9.937 | 24.583 | 40.494 | 1.00 | 30.76 | C |
| ATOM | 2574 | CE1 | PHE | A | 323 | 10.644 | 23.417 | 40.745 | 1.00 | 31.31 | C |
| ATOM | 2575 | CZ | PHE | A | 323 | 11.349 | 22.776 | 39.686 | 1.00 | 32.02 | C |
| ATOM | 2576 | CE2 | PHE | A | 323 | 11.316 | 23.340 | 38.397 | 1.00 | 30.55 | C |
| ATOM | 2577 | CD2 | PHE | A | 323 | 10.588 | 24.490 | 38.175 | 1.00 | 29.96 | C |
| ATOM | 2578 | C | PHE | A | 323 | 11.392 | 27.618 | 38.992 | 1.00 | 31.03 | C |
| ATOM | 2579 | O | PHE | A | 323 | 12.227 | 27.419 | 39.916 | 1.00 | 31.65 | O |
| ATOM | 2580 | N | LEU | A | 324 | 11.775 | 27.803 | 37.724 | 1.00 | 30.84 | N |
| ATOM | 2581 | CA | LEU | A | 324 | 13.223 | 27.734 | 37.402 | 1.00 | 31.48 | C |
| ATOM | 2582 | CB | LEU | A | 324 | 13.486 | 27.602 | 35.902 | 1.00 | 31.19 | C |
| ATOM | 2583 | CG | LEU | A | 324 | 12.899 | 26.345 | 35.186 | 1.00 | 30.00 | C |
| ATOM | 2584 | CD1 | LEU | A | 324 | 12.917 | 26.559 | 33.697 | 1.00 | 22.58 | C |
| ATOM | 2585 | CD2 | LEU | A | 324 | 13.592 | 25.038 | 35.608 | 1.00 | 25.53 | C |
| ATOM | 2586 | C | LEU | A | 324 | 14.054 | 28.876 | 38.001 | 1.00 | 32.49 | C |
| ATOM | 2587 | O | LEU | A | 324 | 15.191 | 28.667 | 38.378 | 1.00 | 31.83 | O |
| ATOM | 2588 | N | GLU | A | 325 | 13.487 | 30.081 | 38.083 | 1.00 | 34.21 | N |
| ATOM | 2589 | CA | GLU | A | 325 | 14.159 | 31.204 | 38.734 | 1.00 | 35.98 | C |
| ATOM | 2590 | CB | GLU | A | 325 | 13.308 | 32.496 | 38.694 | 1.00 | 36.92 | C |
| ATOM | 2591 | CG | GLU | A | 325 | 13.797 | 33.638 | 39.609 | 1.00 | 40.78 | C |
| ATOM | 2592 | CD | GLU | A | 325 | 13.345 | 35.028 | 39.156 | 1.00 | 47.61 | C |
| ATOM | 2593 | OE1 | GLU | A | 325 | 12.320 | 35.124 | 38.423 | 1.00 | 49.04 | O |
| ATOM | 2594 | OE2 | GLU | A | 325 | 14.029 | 36.034 | 39.514 | 1.00 | 49.33 | O |
| ATOM | 2595 | C | GLU | A | 325 | 14.419 | 30.804 | 40.168 | 1.00 | 36.55 | C |
| ATOM | 2596 | O | GLU | A | 325 | 15.499 | 31.105 | 40.730 | 1.00 | 36.55 | O |
| ATOM | 2597 | N | GLU | A | 326 | 13.419 | 30.137 | 40.754 | 1.00 | 37.02 | N |
| ATOM | 2598 | CA | GLU | A | 326 | 13.468 | 29.753 | 42.163 | 1.00 | 38.44 | C |
| ATOM | 2599 | CB | GLU | A | 326 | 12.097 | 29.341 | 42.629 | 1.00 | 38.24 | C |
| ATOM | 2600 | CG | GLU | A | 326 | 11.974 | 29.364 | 44.128 | 1.00 | 46.60 | C |
| ATOM | 2601 | CD | GLU | A | 326 | 11.204 | 28.154 | 44.671 | 1.00 | 56.34 | C |
| ATOM | 2602 | OE1 | GLU | A | 326 | 9.997 | 28.304 | 45.056 | 1.00 | 55.91 | O |
| ATOM | 2603 | OE2 | GLU | A | 326 | 11.821 | 27.051 | 44.711 | 1.00 | 61.04 | O |
| ATOM | 2604 | C | GLU | A | 326 | 14.545 | 28.679 | 42.499 | 1.00 | 37.49 | C |
| ATOM | 2605 | O | GLU | A | 326 | 15.241 | 28.827 | 43.487 | 1.00 | 38.16 | O |
| ATOM | 2606 | N | LYS | A | 327 | 14.691 | 27.646 | 41.660 | 1.00 | 36.35 | N |
| ATOM | 2607 | CA | LYS | A | 327 | 15.657 | 26.555 | 41.849 | 1.00 | 35.48 | C |
| ATOM | 2608 | CB | LYS | A | 327 | 15.189 | 25.297 | 41.085 | 1.00 | 36.09 | C |
| ATOM | 2609 | CG | LYS | A | 327 | 13.916 | 24.631 | 41.583 | 1.00 | 39.72 | C |
| ATOM | 2610 | CD | LYS | A | 327 | 14.094 | 23.872 | 42.889 | 1.00 | 45.35 | C |
| ATOM | 2611 | CE | LYS | A | 327 | 13.058 | 24.351 | 43.912 | 1.00 | 47.94 | C |
| ATOM | 2612 | NZ | LYS | A | 327 | 13.345 | 23.880 | 45.326 | 1.00 | 51.88 | N |
| ATOM | 2613 | C | LYS | A | 327 | 17.042 | 26.869 | 41.312 | 1.00 | 34.69 | C |
| ATOM | 2614 | O | LYS | A | 327 | 17.985 | 26.073 | 41.459 | 1.00 | 34.75 | O |
| ATOM | 2615 | N | GLN | A | 328 | 17.174 | 27.983 | 40.610 | 1.00 | 33.74 | N |
| ATOM | 2616 | CA | GLN | A | 328 | 18.426 | 28.258 | 39.989 | 1.00 | 33.00 | C |
| ATOM | 2617 | CB | GLN | A | 328 | 18.452 | 29.658 | 39.396 | 1.00 | 32.91 | C |
| ATOM | 2618 | CG | GLN | A | 328 | 19.763 | 29.951 | 38.655 | 1.00 | 32.48 | C |
| ATOM | 2619 | CD | GLN | A | 328 | 19.751 | 31.318 | 38.096 | 1.00 | 33.62 | C |
| ATOM | 2620 | OE1 | GLN | A | 328 | 18.863 | 31.656 | 37.303 | 1.00 | 32.99 | O |
| ATOM | 2621 | NE2 | GLN | A | 328 | 20.694 | 32.147 | 38.537 | 1.00 | 30.88 | N |
| ATOM | 2622 | C | GLN | A | 328 | 19.572 | 28.044 | 40.978 | 1.00 | 33.13 | C |
| ATOM | 2623 | O | GLN | A | 328 | 20.415 | 27.209 | 40.714 | 1.00 | 33.14 | O |
| ATOM | 2624 | N | ALA | A | 329 | 19.604 | 28.754 | 42.118 | 1.00 | 33.32 | N |
| ATOM | 2625 | CA | ALA | A | 329 | 20.810 | 28.654 | 42.991 | 1.00 | 34.35 | C |
| ATOM | 2626 | CB | ALA | A | 329 | 20.822 | 29.738 | 44.175 | 1.00 | 34.37 | C |
| ATOM | 2627 | C | ALA | A | 329 | 21.003 | 27.216 | 43.523 | 1.00 | 33.13 | C |
| ATOM | 2628 | O | ALA | A | 329 | 22.093 | 26.671 | 43.556 | 1.00 | 31.93 | O |
| ATOM | 2629 | N | SER | A | 330 | 19.897 | 26.621 | 43.895 | 1.00 | 32.84 | N |
| ATOM | 2630 | CA | SER | A | 330 | 19.896 | 25.270 | 44.392 | 1.00 | 33.83 | C |
| ATOM | 2631 | CB | SER | A | 330 | 18.500 | 24.939 | 44.867 | 1.00 | 32.51 | C |
| ATOM | 2632 | OG | SER | A | 330 | 18.407 | 23.570 | 44.830 | 1.00 | 32.66 | O |
| ATOM | 2633 | C | SER | A | 330 | 20.389 | 24.220 | 43.368 | 1.00 | 34.50 | C |
| ATOM | 2634 | O | SER | A | 330 | 21.192 | 23.329 | 43.720 | 1.00 | 35.41 | O |
| ATOM | 2635 | N | LEU | A | 331 | 19.923 | 24.314 | 42.117 | 1.00 | 35.37 | N |
| ATOM | 2636 | CA | LEU | A | 331 | 20.424 | 23.449 | 41.023 | 1.00 | 35.72 | C |
| ATOM | 2637 | CB | LEU | A | 331 | 19.667 | 23.713 | 39.724 | 1.00 | 35.58 | C |
| ATOM | 2638 | CG | LEU | A | 331 | 18.179 | 23.354 | 39.709 | 1.00 | 35.06 | C |
| ATOM | 2639 | CD1 | LEU | A | 331 | 17.461 | 24.003 | 38.579 | 1.00 | 36.01 | C |
| ATOM | 2640 | CD2 | LEU | A | 331 | 18.063 | 21.844 | 39.614 | 1.00 | 38.47 | C |
| ATOM | 2641 | C | LEU | A | 331 | 21.894 | 23.676 | 40.774 | 1.00 | 36.94 | C |
| ATOM | 2642 | O | LEU | A | 331 | 22.619 | 22.759 | 40.463 | 1.00 | 37.72 | O |
| ATOM | 2643 | N | TRP | A | 332 | 22.342 | 24.913 | 40.909 | 1.00 | 38.52 | N |
| ATOM | 2644 | CA | TRP | A | 332 | 23.739 | 25.241 | 40.696 | 1.00 | 40.11 | C |
| ATOM | 2645 | CB | TRP | A | 332 | 23.914 | 26.766 | 40.649 | 1.00 | 40.56 | C |
| ATOM | 2646 | CG | TRP | A | 332 | 23.540 | 27.467 | 39.347 | 1.00 | 39.55 | C |
| ATOM | 2647 | CD1 | TRP | A | 332 | 22.910 | 26.931 | 38.257 | 1.00 | 39.50 | C |
| ATOM | 2648 | NE1 | TRP | A | 332 | 22.744 | 27.883 | 37.277 | 1.00 | 40.02 | N |
| ATOM | 2649 | CE2 | TRP | A | 332 | 23.273 | 29.067 | 37.717 | 1.00 | 40.59 | C |
| ATOM | 2650 | CD2 | TRP | A | 332 | 23.789 | 28.838 | 39.026 | 1.00 | 41.24 | C |
| ATOM | 2651 | CE3 | TRP | A | 332 | 24.381 | 29.919 | 39.722 | 1.00 | 39.62 | C |
| ATOM | 2652 | CZ3 | TRP | A | 332 | 24.444 | 31.170 | 39.099 | 1.00 | 40.71 | C |
| ATOM | 2653 | CH2 | TRP | A | 332 | 23.945 | 31.357 | 37.779 | 1.00 | 42.82 | C |
| ATOM | 2654 | CZ2 | TRP | A | 332 | 23.351 | 30.325 | 37.078 | 1.00 | 40.80 | C |
| ATOM | 2655 | C | TRP | A | 332 | 24.654 | 24.648 | 41.772 | 1.00 | 41.53 | C |
| ATOM | 2656 | O | TRP | A | 332 | 25.746 | 24.157 | 41.462 | 1.00 | 41.67 | O |
| ATOM | 2657 | N | VAL | A | 333 | 24.207 | 24.732 | 43.029 | 1.00 | 43.46 | N |
| ATOM | 2658 | CA | VAL | A | 333 | 24.898 | 24.158 | 44.186 | 1.00 | 45.50 | C |
| ATOM | 2659 | CB | VAL | A | 333 | 24.184 | 24.529 | 45.528 | 1.00 | 45.70 | C |
| ATOM | 2660 | CG1 | VAL | A | 333 | 24.440 | 23.477 | 46.653 | 1.00 | 47.02 | C |
| ATOM | 2661 | CG2 | VAL | A | 333 | 24.574 | 25.949 | 45.998 | 1.00 | 43.56 | C |
| ATOM | 2662 | C | VAL | A | 333 | 25.072 | 22.638 | 44.019 | 1.00 | 46.85 | C |
| ATOM | 2663 | O | VAL | A | 333 | 26.116 | 22.084 | 44.365 | 1.00 | 46.33 | O |
| ATOM | 2664 | N | GLN | A | 334 | 24.044 | 21.999 | 43.469 | 1.00 | 48.80 | N |
| ATOM | 2665 | CA | GLN | A | 334 | 24.074 | 20.593 | 43.099 | 1.00 | 50.76 | C |
| ATOM | 2666 | CB | GLN | A | 334 | 22.696 | 20.191 | 42.597 | 1.00 | 50.81 | C |
| ATOM | 2667 | CG | GLN | A | 334 | 21.684 | 19.706 | 43.625 | 1.00 | 52.47 | C |
| ATOM | 2668 | CD | GLN | A | 334 | 20.486 | 19.013 | 42.944 | 1.00 | 53.08 | C |
| ATOM | 2669 | OE1 | GLN | A | 334 | 19.415 | 19.628 | 42.811 | 1.00 | 55.63 | O |
| ATOM | 2670 | NE2 | GLN | A | 334 | 20.671 | 17.752 | 42.497 | 1.00 | 49.24 | N |
| ATOM | 2671 | C | GLN | A | 334 | 25.094 | 20.312 | 41.979 | 1.00 | 52.36 | C |
| ATOM | 2672 | O | GLN | A | 334 | 25.576 | 19.187 | 41.849 | 1.00 | 52.62 | O |
| ATOM | 2673 | N | GLY | A | 335 | 25.392 | 21.323 | 41.156 | 1.00 | 53.93 | N |
| ATOM | 2674 | CA | GLY | A | 335 | 26.309 | 21.169 | 40.040 | 1.00 | 56.09 | C |
| ATOM | 2675 | C | GLY | A | 335 | 27.755 | 21.416 | 40.425 | 1.00 | 57.55 | C |
| ATOM | 2676 | O | GLY | A | 335 | 28.681 | 21.254 | 39.627 | 1.00 | 57.14 | O |
| ATOM | 2677 | N | ASP | A | 336 | 27.937 | 21.801 | 41.677 | 1.00 | 59.72 | N |
| ATOM | 2678 | CA | ASP | A | 336 | 29.249 | 22.126 | 42.212 | 1.00 | 61.84 | C |
| ATOM | 2679 | CB | ASP | A | 336 | 29.133 | 23.191 | 43.314 | 1.00 | 62.12 | C |
| ATOM | 2680 | CG | ASP | A | 336 | 29.187 | 24.614 | 42.751 | 1.00 | 62.73 | C |
| ATOM | 2681 | OD1 | ASP | A | 336 | 30.213 | 24.963 | 42.104 | 1.00 | 62.91 | O |
| ATOM | 2682 | OD2 | ASP | A | 336 | 28.245 | 25.436 | 42.888 | 1.00 | 62.58 | O |
| ATOM | 2683 | C | ASP | A | 336 | 30.009 | 20.913 | 42.706 | 1.00 | 62.97 | C |
| ATOM | 2684 | O | ASP | A | 336 | 31.228 | 20.888 | 42.575 | 1.00 | 63.34 | O |
| ATOM | 2685 | N | ILE | A | 337 | 29.301 | 19.916 | 43.246 | 1.00 | 64.60 | N |
| ATOM | 2686 | CA | ILE | A | 337 | 29.943 | 18.668 | 43.691 | 1.00 | 66.91 | C |
| ATOM | 2687 | CB | ILE | A | 337 | 29.118 | 17.901 | 44.793 | 1.00 | 67.45 | C |
| ATOM | 2688 | CG1 | ILE | A | 337 | 27.602 | 17.870 | 44.484 | 1.00 | 68.56 | C |
| ATOM | 2689 | CD1 | ILE | A | 337 | 26.970 | 16.442 | 44.578 | 1.00 | 68.87 | C |
| ATOM | 2690 | CG2 | ILE | A | 337 | 29.459 | 18.429 | 46.217 | 1.00 | 66.68 | C |
| ATOM | 2691 | C | ILE | A | 337 | 30.470 | 17.690 | 42.609 | 1.00 | 68.01 | C |
| ATOM | 2692 | O | ILE | A | 337 | 31.471 | 17.028 | 42.877 | 1.00 | 68.87 | O |
| ATOM | 2693 | N | PHE | A | 338 | 29.824 | 17.603 | 41.428 | 1.00 | 69.15 | N |
| ATOM | 2694 | CA | PHE | A | 338 | 30.276 | 16.806 | 40.235 | 1.00 | 70.03 | C |
| ATOM | 2695 | CB | PHE | A | 338 | 31.318 | 15.702 | 40.640 | 1.00 | 70.31 | C |
| ATOM | 2696 | CG | PHE | A | 338 | 31.676 | 14.627 | 39.552 | 1.00 | 73.39 | C |
| ATOM | 2697 | CD1 | PHE | A | 338 | 32.996 | 14.124 | 39.482 | 1.00 | 74.60 | C |
| ATOM | 2698 | CE1 | PHE | A | 338 | 33.367 | 13.127 | 38.529 | 1.00 | 73.26 | C |
| ATOM | 2699 | CZ | PHE | A | 338 | 32.415 | 12.581 | 37.660 | 1.00 | 74.78 | C |
| ATOM | 2700 | CE2 | PHE | A | 338 | 31.085 | 13.038 | 37.716 | 1.00 | 76.35 | C |
| ATOM | 2701 | CD2 | PHE | A | 338 | 30.717 | 14.058 | 38.671 | 1.00 | 75.91 | C |
| ATOM | 2702 | C | PHE | A | 338 | 29.074 | 16.256 | 39.394 | 1.00 | 70.28 | C |
| ATOM | 2703 | O | PHE | A | 338 | 28.021 | 16.903 | 39.185 | 1.00 | 70.08 | O |
| ATOM | 2704 | OH2 | HOH | X | 1 | 30.392 | 44.817 | 5.609 | 1.00 | 15.49 | O |
| ATOM | 2705 | OH2 | HOH | X | 2 | 12.479 | 42.639 | 25.190 | 1.00 | 21.91 | O |
| ATOM | 2706 | OH2 | HOH | X | 3 | 1.933 | 40.117 | 24.460 | 1.00 | 10.78 | O |
| ATOM | 2707 | OH2 | HOH | X | 4 | 8.721 | 45.606 | 21.026 | 1.00 | 14.59 | O |
| ATOM | 2708 | OH2 | HOH | X | 5 | 9.444 | 10.576 | 11.676 | 1.00 | 23.82 | O |
| ATOM | 2709 | OH2 | HOH | X | 6 | 5.498 | 29.114 | 26.844 | 1.00 | 19.62 | O |
| ATOM | 2710 | OH2 | HOH | X | 7 | 10.354 | 30.633 | 21.043 | 1.00 | 14.93 | O |
| ATOM | 2711 | OH2 | HOH | X | 8 | 12.208 | 43.248 | 10.092 | 1.00 | 24.81 | O |
| ATOM | 2712 | OH2 | HOH | X | 9 | 7.539 | 29.107 | 14.472 | 1.00 | 19.31 | O |
| ATOM | 2713 | OH2 | HOH | X | 10 | 9.981 | 31.125 | 15.007 | 1.00 | 18.08 | O |
| ATOM | 2714 | OH2 | HOH | X | 11 | 2.120 | 9.839 | 24.658 | 1.00 | 24.10 | O |
| ATOM | 2715 | OH2 | HOH | X | 12 | 0.036 | 32.702 | 25.407 | 1.00 | 30.47 | O |
| ATOM | 2716 | OH2 | HOH | X | 13 | 3.274 | 20.669 | 26.828 | 1.00 | 17.68 | O |
| ATOM | 2717 | OH2 | HOH | X | 14 | 27.479 | 44.460 | 0.903 | 1.00 | 34.85 | O |
| ATOM | 2718 | OH2 | HOH | X | 15 | 10.125 | 26.950 | 11.563 | 1.00 | 14.24 | O |
| ATOM | 2719 | OH2 | HOH | X | 16 | 9.810 | 40.477 | 12.846 | 1.00 | 20.12 | O |
| ATOM | 2720 | OH2 | HOH | X | 17 | 6.687 | 36.789 | 13.629 | 1.00 | 17.24 | O |
| ATOM | 2721 | OH2 | HOH | X | 18 | 3.551 | 33.912 | 34.465 | 1.00 | 24.01 | O |
| ATOM | 2722 | OH2 | HOH | X | 19 | 16.083 | 19.978 | 15.859 | 1.00 | 19.07 | O |
| ATOM | 2723 | OH2 | HOH | X | 20 | 19.197 | 48.185 | −2.763 | 1.00 | 12.76 | O |
| ATOM | 2724 | OH2 | HOH | X | 21 | 3.779 | 19.649 | 29.755 | 1.00 | 26.55 | O |
| ATOM | 2725 | OH2 | HOH | X | 22 | 17.214 | 12.561 | 8.994 | 1.00 | 29.50 | O |
| ATOM | 2726 | OH2 | HOH | X | 23 | 6.087 | 35.107 | 22.949 | 1.00 | 27.66 | O |
| ATOM | 2727 | OH2 | HOH | X | 24 | 1.655 | 18.313 | 27.423 | 1.00 | 16.61 | O |
| ATOM | 2728 | OH2 | HOH | X | 25 | 12.820 | 20.738 | 5.433 | 1.00 | 30.27 | O |
| ATOM | 2729 | OH2 | HOH | X | 26 | 13.775 | 19.971 | 14.809 | 1.00 | 18.94 | O |
| ATOM | 2730 | OH2 | HOH | X | 27 | 8.605 | 32.143 | 8.121 | 1.00 | 19.05 | O |
| ATOM | 2731 | OH2 | HOH | X | 28 | 28.140 | 30.477 | 11.339 | 1.00 | 34.64 | O |
| ATOM | 2732 | OH2 | HOH | X | 29 | 7.818 | 34.567 | 29.048 | 1.00 | 17.78 | O |
| ATOM | 2733 | OH2 | HOH | X | 30 | 12.767 | 7.082 | 12.709 | 1.00 | 29.89 | O |
| ATOM | 2734 | OH2 | HOH | X | 31 | 8.464 | 33.339 | 24.840 | 1.00 | 24.60 | O |
| ATOM | 2735 | OH2 | HOH | X | 32 | 13.794 | 0.976 | 31.045 | 1.00 | 27.78 | O |
| ATOM | 2736 | OH2 | HOH | X | 33 | 21.983 | 15.249 | 18.468 | 1.00 | 28.65 | O |
| ATOM | 2737 | OH2 | HOH | X | 34 | 8.698 | 23.856 | 9.582 | 1.00 | 27.29 | O |
| ATOM | 2738 | OH2 | HOH | X | 35 | −3.848 | 3.911 | 24.474 | 1.00 | 33.30 | O |
| ATOM | 2739 | OH2 | HOH | X | 36 | 7.401 | 24.078 | 19.387 | 1.00 | 13.57 | O |
| ATOM | 2740 | OH2 | HOH | X | 37 | 23.748 | 23.485 | 15.061 | 1.00 | 29.29 | O |
| ATOM | 2741 | OH2 | HOH | X | 38 | 16.583 | 8.136 | 10.462 | 1.00 | 32.15 | O |
| ATOM | 2742 | OH2 | HOH | X | 39 | 19.593 | 54.974 | 7.869 | 1.00 | 35.19 | O |
| ATOM | 2743 | OH2 | HOH | X | 40 | 10.733 | 21.392 | 25.560 | 1.00 | 20.33 | O |
| ATOM | 2744 | OH2 | HOH | X | 41 | 9.181 | 23.299 | 17.795 | 1.00 | 14.83 | O |
| ATOM | 2745 | OH2 | HOH | X | 42 | 20.133 | 35.689 | 33.599 | 1.00 | 31.37 | O |
| ATOM | 2746 | OH2 | HOH | X | 43 | −0.879 | 14.382 | 31.472 | 1.00 | 21.57 | O |
| ATOM | 2747 | OH2 | HOH | X | 44 | 6.419 | 28.108 | 16.998 | 1.00 | 30.97 | O |
| ATOM | 2748 | OH2 | HOH | X | 45 | −5.292 | 36.071 | 28.744 | 1.00 | 29.29 | O |
| ATOM | 2749 | OH2 | HOH | X | 46 | 21.987 | 39.391 | −1.052 | 1.00 | 29.47 | O |
| ATOM | 2750 | OH2 | HOH | X | 47 | 26.540 | 40.335 | 28.276 | 1.00 | 23.84 | O |
| ATOM | 2751 | OH2 | HOH | X | 48 | 11.174 | 41.109 | 23.897 | 1.00 | 34.47 | O |
| ATOM | 2752 | OH2 | HOH | X | 49 | 31.235 | 46.934 | 2.188 | 1.00 | 41.24 | O |
| ATOM | 2753 | OH2 | HOH | X | 50 | 2.901 | 26.692 | 16.973 | 1.00 | 33.02 | O |
| ATOM | 2754 | OH2 | HOH | X | 51 | 8.200 | 30.499 | 22.250 | 1.00 | 21.43 | O |
| ATOM | 2755 | OH2 | HOH | X | 52 | 18.229 | 15.673 | 12.575 | 1.00 | 25.52 | O |
| ATOM | 2756 | OH2 | HOH | X | 53 | 27.195 | 37.604 | −1.067 | 1.00 | 40.56 | O |
| ATOM | 2757 | OH2 | HOH | X | 54 | 21.789 | 10.462 | 41.779 | 1.00 | 26.17 | O |
| ATOM | 2758 | OH2 | HOH | X | 55 | 14.945 | 51.976 | 15.909 | 1.00 | 32.78 | O |
| ATOM | 2759 | OH2 | HOH | X | 56 | 17.339 | 27.449 | 44.743 | 1.00 | 36.67 | O |
| ATOM | 2760 | OH2 | HOH | X | 57 | 24.378 | 28.490 | 43.957 | 1.00 | 34.99 | O |
| ATOM | 2761 | OH2 | HOH | X | 58 | 23.795 | 56.412 | 3.230 | 1.00 | 37.51 | O |
| ATOM | 2762 | OH2 | HOH | X | 59 | 0.979 | 42.476 | 17.580 | 1.00 | 17.89 | O |
| ATOM | 2763 | OH2 | HOH | X | 60 | 2.548 | 36.119 | 16.447 | 1.00 | 22.93 | O |
| ATOM | 2764 | OH2 | HOH | X | 61 | 19.332 | 57.131 | 1.158 | 1.00 | 27.06 | O |
| ATOM | 2765 | OH2 | HOH | X | 62 | −7.421 | 33.720 | 27.180 | 1.00 | 23.88 | O |
| ATOM | 2766 | OH2 | HOH | X | 63 | 20.257 | 37.842 | 1.282 | 1.00 | 32.41 | O |
| ATOM | 2767 | OH2 | HOH | X | 64 | 10.480 | 24.529 | 16.113 | 1.00 | 16.42 | O |
| ATOM | 2768 | OH2 | HOH | X | 65 | 17.418 | 3.427 | 36.865 | 1.00 | 25.34 | O |
| ATOM | 2769 | OH2 | HOH | X | 66 | 8.867 | 37.997 | 12.648 | 1.00 | 18.47 | O |
| ATOM | 2770 | OH2 | HOH | X | 67 | 8.846 | 56.310 | 11.099 | 1.00 | 31.59 | O |
| ATOM | 2771 | OH2 | HOH | X | 68 | 31.214 | 43.759 | 0.366 | 1.00 | 35.64 | O |
| ATOM | 2772 | OH2 | HOH | X | 69 | −2.109 | 35.228 | 19.095 | 1.00 | 27.26 | O |
| ATOM | 2773 | OH2 | HOH | X | 70 | 21.858 | 13.896 | 40.580 | 1.00 | 29.98 | O |
| ATOM | 2774 | OH2 | HOH | X | 71 | 3.522 | 21.534 | 12.712 | 1.00 | 28.15 | O |
| ATOM | 2775 | OH2 | HOH | X | 72 | 1.842 | 32.743 | 12.431 | 1.00 | 26.77 | O |
| ATOM | 2776 | OH2 | HOH | X | 73 | 31.373 | 37.111 | 16.604 | 1.00 | 39.52 | O |
| ATOM | 2777 | OH2 | HOH | X | 74 | 5.765 | 16.863 | 41.129 | 1.00 | 42.22 | O |
| ATOM | 2778 | OH2 | HOH | X | 75 | 24.850 | 25.175 | 8.189 | 1.00 | 25.14 | O |
| ATOM | 2779 | OH2 | HOH | X | 76 | 30.581 | 35.933 | 8.351 | 1.00 | 39.39 | O |
| ATOM | 2780 | OH2 | HOH | X | 77 | 30.453 | 32.913 | 14.167 | 1.00 | 37.72 | O |
| ATOM | 2781 | OH2 | HOH | X | 78 | 29.920 | 39.998 | 9.172 | 1.00 | 38.13 | O |
| ATOM | 2782 | OH2 | HOH | X | 79 | 33.114 | 42.201 | 22.842 | 1.00 | 44.59 | O |
| ATOM | 2783 | OH2 | HOH | X | 80 | 15.986 | 31.586 | 3.922 | 1.00 | 21.34 | O |
| ATOM | 2784 | OH2 | HOH | X | 81 | 30.333 | −2.230 | 39.216 | 1.00 | 39.91 | O |
| ATOM | 2785 | OH2 | HOH | X | 82 | 26.976 | 29.488 | 15.512 | 1.00 | 28.94 | O |
| ATOM | 2786 | OH2 | HOH | X | 83 | 27.272 | 48.972 | −3.939 | 1.00 | 36.49 | O |
| ATOM | 2787 | OH2 | HOH | X | 84 | 26.454 | 41.583 | −6.009 | 1.00 | 33.87 | O |
| ATOM | 2788 | OH2 | HOH | X | 85 | 2.954 | 38.502 | 16.381 | 1.00 | 25.62 | O |
| ATOM | 2789 | OH2 | HOH | X | 86 | 33.792 | 39.369 | 13.458 | 1.00 | 40.54 | O |
| ATOM | 2790 | OH2 | HOH | X | 87 | 17.262 | 30.350 | 43.263 | 1.00 | 34.47 | O |
| ATOM | 2791 | OH2 | HOH | X | 88 | 12.147 | 38.012 | 33.586 | 1.00 | 50.31 | O |
| ATOM | 2792 | OH2 | HOH | X | 89 | 29.156 | 26.372 | 18.466 | 1.00 | 35.16 | O |
| ATOM | 2793 | OH2 | HOH | X | 90 | 13.411 | 10.247 | 9.168 | 1.00 | 26.43 | O |
| ATOM | 2794 | OH2 | HOH | X | 91 | 11.854 | 20.770 | 42.617 | 1.00 | 42.09 | O |
| ATOM | 2795 | MG | MG | X | 200 | 5.976 | 23.897 | 15.468 | 1.00 | 47.42 | MG |
| ATOM | 2796 | MG | MG | X | 201 | −0.275 | 40.156 | 9.536 | 0.50 | 63.17 | MG |

A number of embodiments of the disclosure have been described. Nevertheless, it will be understood that various modifications may be made without departing from the spirit and scope of the disclosure. Accordingly, other embodiments are within the scope of the following claims.

All citations made in this disclosure are made with the understanding that the information contained in each such cited document is known to the skilled artisan; and each cited document is incorporated in its entirety herein by reference.

What is claimed is:

1. A method of modeling the interaction of a candidate binding agent and a cdc14A polypeptide, said method comprising:
(a) modeling a cdc14A polypeptide, defined by a plurality of atomic coordinates; and
(b) modeling the interaction of a candidate binding agent with said modeled cdc14A polypeptide.

2. The method of claim 1, wherein the cdc14A polypeptide is a human polypeptide.

3. The method of claim 1, wherein the cdc14A polypeptide has a sequence selected from the group consisting of:
(a) SEQ ID NO: 2, 4, or 6;
(b) conservative substitutions of (a);
(c) variants of (a);
(d) mutants of (a), (b), or (c); and
(e) fragments of (a), (b), (c), or (d).

4. The method of claim 1, wherein said plurality of atomic coordinates are set forth in Table 2.

5. The method of claim 1, wherein the cdc14A polypeptide is a fragment that comprises the sequence as set forth in SEQ ID NO:2, 4, or 6 from about amino acids 277-285; and wherein the plurality of atomic coordinates comprises atoms 2205-2268 of Table 2.

6. The method of claim 1, wherein the candidate binding agent is selected from the group consisting of a peptide, an anti-cdc14A antibody, a peptidomimetic, and a small molecule.

7. The method of claim 1, further including the step of determining whether the binding agent forms a complex with cdc14A.

8. The method of claim 1, wherein the candidate binding agent is modeled using a computer algorithm to predict a three-dimensional representation of the candidate binding agent.

9. The method of claim 6, wherein the binding agent has a molecular weight less than 1000.

10. A method for identifying a candidate agent that modulates cdc14 polypeptide activity, comprising:
(a) modeling a cdc14A polypeptide defined by a plurality of atomic coordinates of the cdc14A polypeptide;
(b) modeling said agent's interaction with said modeled cdc14A polypeptide; and
(c) determining whether an agent identified in step (b) interacts with cdc14A and modulates cdc14 polypeptide activity.

11. A computer program on a computer readable medium comprising instructions to cause a computer to:
(a) define a cdc14A polypeptide or fragment thereof based on a plurality of atomic coordinates of the cdc14A polypeptide; and
(b) model a potential binding agent that interacts with the cdc14A polypeptide.

12. The computer program of claim 11, wherein the plurality of atomic coordinates are as set forth in Table 2.

13. A crystalline cdc14A polypeptide comprising a sequence selected from the group consisting of:
(a) SEQ ID NO: 2, 4, or 6;
(b) conservative substitutions of (a);
(c) variants of (a);
(d) mutants of (a), (b), or (c);
(e) fragments of (a), (b), (c), or (d); and
(g) a sequence excluding amino acids 1-9 of SEQ ID NO: 2, 4, or 6.

14. The crystalline cdc14A polypeptide of claim 13, wherein the atomic coordinates of the atoms of the cdc14A polypeptide are selected from the atomic coordinates set forth in Table 2.

15. A crystalline structure selected from the group consisting of:
(a) a crystalline polypeptide comprising approximately the following cell constants a=74 Å, b=81 Å, c=69 Å, and a space group of P₂₁₂₁₂;
(b) a crystalline cdc14A polypeptide produced by the method of claim 16;
(c) a heavy-atom derivative of a crystallized form of cdc14A polypeptide;
(d) a crystalline complex comprising a cdc14A polypeptide and a candidate binding agent; and
(e) a co-crystal of a cdc14A polypeptide and binding agent,
wherein said cdc14A polypeptide has a sequence selected from the group consisting of SEQ ID NO: 2, 4 or 6.

16. A method of crystallizing cdc14A polypeptide comprising the steps of:
(a) mixing an aqueous solution comprising substantially pure cdc14A polypeptide with a reservoir solution comprising a precipitant to form a mixed volume; and
(b) subjecting the mixed volume to conditions and for a time sufficient for crystallization to occur.

17. The method of claim 16 wherein the cdc14A polypeptide is obtained from a eukaryotic cell.

18. The method of claim 16 wherein the aqueous solution of step (a) contains about 1 to 50 mg per ml of cdc14A polypeptide.

19. The method of claim 16 wherein the aqueous solution of step (a) contains about 5 to 15 mg per ml of cdc14A polypeptide.

20. The method of claim 16 wherein the precipitant is polyethylene glycol, sodium citrate, ammonium sulfate, sodium cacodylate, or a mixture thereof.

21. The method of claim 20 wherein the precipitant is polyethylene glycol buffered with sodium citrate or sodium cacodylate.

22. The method of claim 21 wherein the precipitant is present in the reservoir solution in an amount of about 16 to 18% of polyethylene glycol, and about 1 to 50 mM of sodium citrate, ammonium sulfate, or sodium cacodylate.

23. The method of claim 16 wherein the reservoir solution further comprises a detergent.

24. The method of claim 23 wherein the detergent is present in an amount of about 5 to 50 mM.

25. The method of claim 16 wherein the pH of the reservoir solution is about 4 to 10.

26. The method of claim 16 wherein step (b) is carried out by vapor diffusion crystallization, batch crystallization, liquid bridge crystallization, or dialysis crystallization.

27. The method of claim 16 wherein step (b) is carried out by vapor diffusion crystallization.

28. The method of claim 16 further comprising isolating the crystalline cdc14A polypeptide.

29. A method for determining a three-dimensional structure of a cdc14A polypeptide comprising:
(a) obtaining crystalline cdc14A polypeptide;
(b) irradiating the crystalline cdc14A polypeptide to obtain a diffraction pattern characteristic of the crystalline cdc14A polypeptide; and
(c) transforming the diffraction pattern into the three-dimensional structure of the cdc14A polypeptide.

30. A method for determining at least a portion of a three-dimensional structure of a molecular complex, said complex comprising a cdc14A polypeptide and said method comprising the steps of:
(a) determining the structural coordinates of a crystal of a cdc14A polypeptide;
(b) calculating phases from the structural coordinates;
(c) calculating an electron density map from the phases obtained in step (b); and
(d) determining the structure of at least a portion of the complex based on said electron density map.

31. The method of claim 30, wherein the structural coordinates used in step (a) are substantially the same as those described in Table 2 or describe substantially the same crystal as the coordinates in Table 2.

32. A method for evaluating the ability of a chemical entity to associate with a cdc14A polypeptide or a complex thereof, the method comprising the steps of:
(a) employing computational or experimental means to perform a fitting operation between the chemical entity and the cdc14A polypeptide or complex thereof, thereby obtaining data related to the association; and
(b) analyzing the data obtained in step (a) to determine the characteristics of the association between the chemical entity and the cdc14A or complex thereof.

33. A method for determining the binding of a test compound to a cdc14 polypeptide, comprising:
(a) introducing the test compound and a crystalline cdc14A polypeptide to conditions and for a time sufficient such that the test compound and crystalline cdc14A polypeptide form a complex;
(b) analyzing the complex to determine whether the test compound binds thereto.

34. A method of identifying a binding agent for binding to a cdc14A polypeptide, comprising:
(a) constructing a three-dimensional structure of the cdc14A polypeptide using a plurality of atomic coordinates selected from the group of atomic coordinates shown in Table 2,
(b) performing structure-based design of said binding agent using said atomic coordinates of (a); and
(c) identifying a binding agent predicted by said structure based design to bind to cdc14A polypeptide.

35. The method of claim 34, wherein the step of performing structure-based design is performed by computer-assisted means.

36. The method of claim 35, wherein the three-dimensional structure of cdc14A polypeptide is displayed visually by said computer-assisted means.

37. An electronic representation of a binding domain of a cdc14A polypeptide.

38. The electronic representation of claim 37, comprising a binding domain surface contour.

39. The electronic representation of claim 38, further comprising an electronic representation of a binding agent in a binding domain of cdc14A.

40. The electronic representation of claim 37, wherein the electronic representation uses a plurality of atomic coordinates selected from the group of atomic coordinates shown in Table 2.

41. A three-dimensional representation of a cdc14A polypeptide comprising a binding domain that is defined by atomic coordinates of at least one loop section comprising amino acids(a) 46-49 of SEQ ID NO:2; (b) 131-135 of SEQ ID NO:2; (c) 173-181 of SEQ ID NO:2; (d) 191-195 of SEQ ID NO:2; (e) 204-206 of SEQ ID NO:2; (f) 227-229 of SEQ ID NO:2; (g) 249-253 of SEQ ID NO:2; (h) 277-285 of SEQ ID NO:2; and (i) 312-320 of SEQ ID NO:2.
